SEQUENCE LISTING (701 sequences)

SEQ ID NO: 1 - protein, 41 aa, Artificial sequence
  U+2-ACTX-Hv1a
GSQYCVPVDQPCSLNTQPCCDDATCTQERNENGHTVYYCRA

SEQ ID NO: 2 - protein, 39 aa, Hadronyche versuta
QYCVPVDQPCSLNTQPCCDDATCTQERNENGHTVYYCRA

SEQ ID NO: 3 - protein, 37 aa, Atrax robustus
SPTCIPSGQPCPYNENCCSQSCTFKENENGNTVKRCD

SEQ ID NO: 4 - protein, 39 aa, Artificial sequence
  Omega-ACTX-Hv1a+2
GSSPTCIPSGQPCPYNENCCSQSCTFKENENGNTVKRCD

SEQ ID NO: 5 - protein, 39 aa, Artificial sequence
  Kappa-hexatoxin-Hv1c+2
GSAICTGADRPCAACCPCCPGTSCKAESNGVSYCRKDEP

SEQ ID NO: 6 - protein, 27 aa, Anemonia viridis
RSCCPCYWGGCPWGQNCYPEGCSGPKV

SEQ ID NO: 7 - protein, 26 aa, Artificial sequence
  Av3b
KSCCPCYWGGCPWGQNCYPEGCSGPK

SEQ ID NO: 8 - protein, 37 aa, Atrax robustus
AICTGADRPCAACCPCCPGTSCKAESNGVSYCRKDEP

SEQ ID NO: 9 - protein, 35 aa, Agelena opulenta
GGCLPHNRFCNALSGPRCCSGLKCKELSIWDSRCL

SEQ ID NO: 10 - protein, 70 aa, Agelena orientalis
MRAIISLFLISAMVFSMIQAVPEEEGLQLSEDERGGCLPHNRFCNALSGPRCCSGLKCKELSIWDSRCLG

SEQ ID NO: 11 - protein, 36 aa, Agelenopsis aperta
ECVPENGHCRDWYDECCEGFYCSCRQPPKCICRNNN

SEQ ID NO: 12 - protein, 37 aa, Agelenopsis aperta
ECATKNKRCADWAGPWCCDGLYCSCRSYPGCMCRPSS

SEQ ID NO: 13 - protein, 38 aa, Agelenopsis aperta
ADCVGDGQRCADWAGPYCCSGYYCSCRSMPYCRCRSDS

SEQ ID NO: 14 - protein, 37 aa, Agelenopsis aperta
ACVGENQQCADWAGPHCCDGYYCTCRYFPKCICRNNN

SEQ ID NO: 15 - protein, 37 aa, Agelenopsis aperta
ACVGENKQCADWAGPHCCDGYYCTCRYFPKCICRNNN

SEQ ID NO: 16 - protein, 37 aa, Agelenopsis aperta
DCVGESQQCADWAGPHCCDGYYCTCRYFPKCICVNNN

SEQ ID NO: 17 - protein, 48 aa, Agelenopsis aperta
KKKCIAKDYGRCKWGGTPCCRGRGCICSIMGTNCECKPRLIMEGLGLA

SEQ ID NO: 18 - protein, 83 aa, Agelenopsis aperta
MKLCMTLLITAIAVVTFVVATQEESAEFNEVEESREDNCIAEDYGKCTWGGTKCCRGRPCRCSMIGTNCECTPRLIMEGLSFA

SEQ ID NO: 19 - protein, 83 aa, Agelenopsis aperta; identical to SEQ ID NO: 18

SEQ ID NO: 20 - protein, 35 aa, Allagelena opulenta; identical to SEQ ID NO: 9

SEQ ID NO: 21 - protein, 47 aa, Ancylometes
ATCAGQDKPCKVNCDCCGERGECVCGGPCICRQGNVFIAWSKLMTCK

SEQ ID NO: 22 - protein, 39 aa, Aphonopelma
LFECVLSCDIKKNGKPCKPKGEKKCSGGWRCKINFCLKV

SEQ ID NO: 23 - protein, 39 aa, Aphonopelma
IFECVFSCDIEKEGKPCKPKGEKKCTGGWKCKIKLCLKI

SEQ ID NO: 24 - protein, 39 aa, Aphonopelma
IFECVFSCDIEKEGKPCKPKGEKKCSGGWKCKIKLCLKI

SEQ ID NO: 25 - protein, 37 aa, Apomastus schlingeri
CNSKGTPCTNADECCGGKCAYNVWNCIGGGCSKTCGY

SEQ ID NO: 26 - protein, 32 aa, Apomastus schlingeri
WLGCARVKEACGPWEWPCCSGLKCDGSECHPQ

SEQ ID NO: 27 - protein, 42 aa, Atrax robustus
CAKKRNWCGKNEDCCCPMKCIYAWYNQQGSCQTTITGLFKKC

SEQ ID NO: 28 - protein, 85 aa, Atrax robustus
MNTATGFIVLLVLATVLGAIEAEDAVPDFEGGFASHAREDTVGGKIRRSSVCIPSGQPCPYNEHCCSGSCTYKENENGNTVQRCD

SEQ ID NO: 29 - protein, 37 aa, Atrax robustus
SSVCIPSGQPCPYNEHCCSGSCTYKENENGNTVQRCD

SEQ ID NO: 30 - protein, 73 aa, Atrax robustus
MNTATGFIVLLVLATVLGCIEAGESHVREDAMGRARRGACTPTGQPCPYNESCCSGSCQEQLNENGHTVKRCV

SEQ ID NO: 31 - protein, 78 aa, Atrax robustus
MNTATGVIALLVLATVIGCIEAEDTRADLQGGEAAEKVFRRSPTCIPSGQPCPYNENCCSQSCTFKENENGNTVKRCD

SEQ ID NO: 32 - protein, 78 aa, Atrax robustus
MNTATGVIALLVLVTVIGCIEAEDTRADLQGGEAAEKVFRRSPTCIPSGQPCPYNENCCSQSCTFKENENGNTVKRCD

SEQ ID NO: 33 - protein, 78 aa, Atrax robustus
MNTATGVIALLVLATVIGCIEAEDTRADLQGGEAAEKVFRRSPTCIPSGQPCPYNENCCSKSCTYKENENGNTVQRCD

SEQ ID NO: 34 - protein, 78 aa, Atrax robustus
MNTATGVIALLVLATVIGCIEAEDTRADLQGGEAAEKVFRRSPTCIPSGQPCPYNENCCSQSCTFKENETGNTVKRCD

SEQ ID NO: 35 - protein, 76 aa, Atrax robustus
MNTATGFIVLLVLATVLGGIEAGESHMRKDAMGRVRRQYCVPVDQPCSLNTQPCCDDATCTQELNENDNTVYYCRA

SEQ ID NO: 36 - protein, 78 aa, Atrax robustus
MNTATGVIALLVLATVIGCIEAEDTRADLQGGEAAEKVFRRSPTCIPSGQPCPYNENCCSQSCTFKENENANTVKRCD

SEQ ID NO: 37 - protein, 98 aa, Atrax robustus
MKFSKLSLTLALILTQALFVLCGKINEDFMKNGLESQTLHDEIRKPIDSENPDTERLLDCLLDNRVCSSDRDCCGMTPSCTMGLCVPNVGGLVGGILG

SEQ ID NO: 38 - protein, 98 aa, Atrax robustus
MKFSKLSLTLALILTQVLFVLCGKINEDFMKHGLESQALHDEIRKPIDSENPDTERLLDCLLDNRVCSSDKDCCGMTPSCTMGLCVPSVGGLVGGILG

SEQ ID NO: 39 - protein, 96 aa, Atrax robustus
MKFSKLSITLAVILTQAVFVFCGMTNEDFMEKGLESNELPDAIKKPVNSGKPDTKRLLDCVLSRMCFSNANCCGLTPPCKMGLCVPNVGGLLGGIL

SEQ ID NO: 40 - protein, 96 aa, Atrax robustus
MKFSKLSITLAVILTQAVFVFCGMTNEDFMEKGLESNELHDAIKKPVNSGKPDTERLLDCVLSRMCSSDANCCGLTPTCKMGLCVPNVGGLLGGIL

SEQ ID NO: 41 - protein, 97 aa, Atrax robustus
MKFSKLSITLAVILTQAVFVFCGMTNEDFMEKGFKSNDLQYAIKQPVNSGKPDTERLLDCVLSRVCSSDENCCGLTPTCTMGLCVPNVGGLLGGLLS

SEQ ID NO: 42 - protein, 97 aa, Atrax robustus
MKFSKLSITLVVILTQAVFVFCGMTNEDFMEKGFKSNDLQYAIRQPVNSGKPDTERLLDCVLSRVCSSDENCCGLTPTCTMGLCVPNVGGLLGGLLS

SEQ ID NO: 43 - protein, 100 aa, Atrax robustus
MKFSKLSITLAVILTQAVFVLCGMKNEDFMEKGLESNELHDAIKKPVNSGKPDTERLLDCVLSRVCSPDANCCGLTPICKMGLCVPKVGGLLGGLLGGIL

SEQ ID NO: 44 - protein, 100 aa, Atrax robustus
MKFSKLSITLAVILTQAVFVLCGMKNEDFMEKGLESNELHDAIKKPVNSGKPDTERLLDCVLSRVCSSDANCCGLTPTCKMGLCVPKVGGLLGGLLGGIL

SEQ ID NO: 45 - protein, 39 aa, Brachypelma albiceps
ILECVFSCDIKKEGKPCKPKGEKKCTGGWRCKIKLCLKI

SEQ ID NO: 46 - protein, 39 aa, Brachypelma albiceps
IFECVFSCDIKKEGKPCKPKGEKKCTGGWRCKIKLCLKI

SEQ ID NO: 47 - protein, 39 aa, Brachypelma smithi; identical to SEQ ID NO: 24

SEQ ID NO: 48 - protein, 99 aa, Brachypelma smithi
MNTIQVIIFAVVLVLTVTVGQADEDSAETSLLRKLEEAEAAMFGQYLEESKNSREKRCIGESVPCDKDDPRCCREYECLKPTGYGWWYASYYCYRKKSG

SEQ ID NO: 49 - protein, 80 aa, Calisoga
MKYFVVFCVLIIAVAAFTSAAEDGEVFEENPLEFPKTIQKRCISARYPCSNSKDCCSGNCGTFWTCYIRKDPCSKECLAP

SEQ ID NO: 50 - protein, 39 aa, Calisoga
CISARYPCSNSKDCCSGNCGTFWTCFIRKDPCSKECLAP

SEQ ID NO: 51 - protein, 39 aa, Calisoga
CISARYPCSNSKDCCSGSCGIFWTCYLRKDPCSKECLAP

SEQ ID NO: 52 - protein, 31 aa, Coremiocnemis valida
ACSRAGENCYKSGRCCDGLYCKAYVVTCYKP

SEQ ID NO: 53 - protein, 68 aa, Cupiennius salei
KDDKNCIPKHHECTNDKKNCCKKGLTKMKCKCFTVADAKGATSERCACDSSLLQKFGFTGLHIIKGLF

SEQ ID NO: 54 - protein, 63 aa, Cupiennius salei
SDCTLRNHDCTDDRHSCCRSKMFKDVCTCFYPSQAKKELCTCQQPKHLKYIEKGLQKAKDYAT

SEQ ID NO: 55 - protein, 94 aa, Diguetia canities
MKVFVVLLCLSLAAVYALEERLDKDADIMLDSPADMERAKDGDVEGPAGCKKYDVECDSGECCQKQYLWYKWRPLDCRCLKSGFFSSKCVCRDV

SEQ ID NO: 56 - protein, 58 aa, Diguetia canities
AKDGDVKGPAGCMKYKSGDCRGKTCCDQQYLWYKWRNLACRCFTVEVFKKDCWCNDIS

SEQ ID NO: 57 - protein, 29 aa, Eucratoscelus constrictus
YCQKFLWTCDTERKCCEDMVCELWCKLEK

SEQ ID NO: 58 - protein, 29 aa, Eucratoscelus constrictus
YCQKFLWTCDTERKCCEDMVCELWCKYKE

SEQ ID NO: 59 - protein, 37 aa, Hadronyche formidabilis
SPTCTGADRPCAACCPCCPGTSCKGPEPNGVSYCRND

SEQ ID NO: 60 - protein, 37 aa, Hadronyche formidabilis
SPTCIRSGQPCPYNENCCSQSCTFKTNENGNTVKRCD

SEQ ID NO: 61 - protein, 36 aa, Hadronyche infensa
STCTPTDQPCPYHESCCSGSCTYKANENGNQVKRCD

SEQ ID NO: 62 - protein, 78 aa, Hadronyche infensa
MNTATGFIVLLVLATVIGCISADFQGSFEPYEEEDAERIFRRSTCTPTDQPCPYHESCCSGSCTYKANENGNQVKRCD

SEQ ID NO: 63 - protein, 78 aa, Hadronyche infensa
MNTATGFIVLLVLATVIGCISADFQGGFEPYEEEDAERIFRRSTCTPTDQPCPYHESCCSGSCTYKANENGNQVKRCD

SEQ ID NO: 64 - protein, 37 aa, Hadronyche infensa
SPTCIPTGQPCPYNENCCSQSCTYKANENGNQVKRCD

SEQ ID NO: 65 - protein, 79 aa, Hadronyche infensa
MNTATGFIVLLVLATVIGCISADFQGGFEPYEEEDAQRIFRRSPTCIPTGQPCPYNENCCSQSCTYKANENGNQVKRCD

SEQ ID NO: 66 - protein, 79 aa, Hadronyche infensa
MNTATGFIVLLVLATVIGCISADFQGGFEPYEEEDAERIFRRSPTCIPTGQPCPYNENCCSQSCTYKANENGNQVKRCD

SEQ ID NO: 67 - protein, 79 aa, Hadronyche infensa
MNTATGFIVLLVLATVIGCISVDFQGGFESYEEEDAERIFRRSPTCIPTGQPCPYNENCCSQSCTYKANENGNQVKRCD

SEQ ID NO: 68 - protein, 79 aa, Hadronyche infensa
MNTATGFIVLLVLATVIGCISTDFQGGFEPYEEEDAERIFRRSPTCIPTGQPCPYNENCCSQSCTYKANENGNQVKRCD

SEQ ID NO: 69 - protein, 37 aa, Hadronyche infensa
SSTCIRTDQPCPYNESCCSGSCTYKANENGNQVKRCD

SEQ ID NO: 70 - protein, 78 aa, Hadronyche infensa
MNTATGFIVLLVLATVIGCISADFQGGFESSVEDAERLFRRSSTCIRTDQPCPYNESCCSGSCTYKANENGNQVKRCD

SEQ ID NO: 71 - protein, 83 aa, Hadronyche venenata
MNTATGVIALLVLATVIGCIEAETRADLQGAFESYEGEAAEKIFRRSPTCIPSGQPCPYNENCCSKSCTYKEMKTATPVQRCD

SEQ ID NO: 72 - protein, 84 aa, Hadronyche venenata
MNTATGVIALVVLATVIGCIEAEETRADLQGAFESYEGEAADKIFRRSPTCIPSGQPCPYNENCCSKSCTYKENENGNTVQRCD

SEQ ID NO: 73 - protein, 84 aa, Hadronyche venenata
MNTATGVIALLVLATVIGCIEAEETRADLQGAFESYEGEGADKIFRRSPTCIPSGQPCPYNENCCSKSCTYKENENGNTVQRCD

SEQ ID NO: 74 - protein, 84 aa, Hadronyche venenata
MNTATGVIALLVLATVIGCIEVEETRADLQGAFESYEGEAAEKIFRRSPTCIPSGQPCPYNENCCSKSCTYKENENGNTVQRCD

SEQ ID NO: 75 - protein, 84 aa, Hadronyche venenata
MNTATGVIALLVLATVIGCIEAEETRADLQGAFESYEGEAADKIFRRSPTCIPSGQPCPYNENCCSKSCTYKENENGNTVQRCD

SEQ ID NO: 76 - protein, 84 aa, Hadronyche venenata
MNTATGVIALLVLATVIGCIEAEDTRADLQGGLESYEGEAADKIFRRSPTCIPSGQPCPYNENCCSKSCTYKENENGNTVQRCD

SEQ ID NO: 77 - protein, 42 aa, Hadronyche versuta
CAKKRNWCGKTEDCCCPMKCVYAWYNEQGSCQSTISALWKKC

SEQ ID NO: 78 - protein, 42 aa, Hadronyche versuta
CSRSDGWCGKTEDCCCPMKCIKAWYKQNGNCQNTISAIWKNC

SEQ ID NO: 79 - protein, 36 aa, Hadronyche versuta
TICTGADRPCAACCPCCPGTSCQGPESNGVVYCRNF

SEQ ID NO: 80 - protein, 36 aa, Hadronyche versuta
TICTGADRPCAACCPCCPGTSCQGPEPNGVSYCRND

SEQ ID NO: 81 - protein, 37 aa, Hadronyche versuta; identical to SEQ ID NO: 8

SEQ ID NO: 82 - protein, 74 aa, Hadronyche versuta
MNTATCFIVLLDVATVIGGIEAGESDMRKDVMGLFRRAICTGADRPCAACCPCCPGTSCKAESNGVSYCRKDEP

SEQ ID NO: 83 - protein, 74 aa, Hadronyche versuta
MNTATCFIVLLVVATVIGGIEAGEFDMRKDVMGLFRRAICTGADRPCAACCPCCPGTSCKAESNGVSYCRKDEP

SEQ ID NO: 84 - protein, 74 aa, Hadronyche versuta
MNTATCFIVFLVVATVIGGIEAGESDMRKDVMGLFRRAICTGADRPCAACCPCCPGTSCKAESNGVSYCRKDEP

SEQ ID NO: 85 - protein, 74 aa, Hadronyche versuta
MNTATCFIVLLVVATVIGGIEAGESDMRKDVMGLFRRVICTGADSPCAACCPCCPGTSCKAESNGVSYCRKDEP

SEQ ID NO: 86 - protein, 74 aa, Hadronyche versuta
MNTATCFIVLLVVATVIGGIEAGEFDMRKDVMGLFRRAICPGADRPCAACCPCCPGTSCKAESNGVFYCRKDEP

SEQ ID NO: 87 - protein, 37 aa, Hadronyche versuta; identical to SEQ ID NO: 3

SEQ ID NO: 88 - protein, 37 aa, Hadronyche versuta
SSTCIPSGQPCPYNENCCSQSCTYKENENGNTVKRCD

SEQ ID NO: 89 - protein, 37 aa, Hadronyche versuta
SSTCIPSGQPCPYNENCCSQSCTFKENENGNTVKRCD

SEQ ID NO: 90 - protein, 37 aa, Hadronyche versuta
SPTCIPSGQPCPYNENCCSKSCTYKENENGNTVQRCD

SEQ ID NO: 91 - protein, 37 aa, Hadronyche versuta
SPTCIPSGQPCPYNENCCSQSCTYKENENGNTVKRCD

SEQ ID NO: 92 - protein, 37 aa, Hadronyche versuta
SAVCIPSGQPCPYSKYCCSGSCTYKTNENGNSVQRCD

SEQ ID NO: 93 - protein, 76 aa, Hadronyche versuta; identical to SEQ ID NO: 35

SEQ ID NO: 94 - protein, 76 aa, Hadronyche versuta
MNTTTGFIVLLVLATILGGIEAGESHMRKDAMGRVRRQYCVPVDQPCSLNTQPCCDDATCTQELNENDNTVYYCRA

SEQ ID NO: 95 - protein, 76 aa, Hadronyche versuta
MNTATGFIVFLVLATVLGGIEAGESHMRKDAMGRVRRQYCVPVDQPCSLNTQPCCDDATCTQELNENDNTVYYCRA

SEQ ID NO: 96 - protein, 45 aa, Hadronyche versuta
LLACLFGNGRCSSNRDCCELTPVCKRGSCVSSGPGLVGGILGGIL

SEQ ID NO: 97 - protein, 98 aa, Hadronyche versuta
MKFSKLSLTLALILTQAIFVLCGKINEDFMKNDLESQALHDEIRKPIDSENPDTERLLDCLLDNRVCSSDKDCCGMTPSCTMGLCVPSVGGLVGGILG

SEQ ID NO: 98 - protein, 98 aa, Hadronyche versuta
MKFSKLSLTLALILTQAIFVLCGKINEDFMKNDLESQALRDEIRKPIDSENPDTERLLDCLLDNRVCSSDKDCCGMTPSCTMGLCVPSVGGLVGGILG

SEQ ID NO: 99 - protein, 98 aa, Hadronyche versuta
MKFSKLSLTLALILTQAIFVLCGKINEDFMKNDLESHALHDEIRKPINSENPDTERLLDCLLDNRVCSSDKDCCGMTPSCTMGLCVPSVGGLVGGILG

SEQ ID NO: 100 - protein, 98 aa, Hadronyche versuta
MKFSKLSLTLALILTQALFVLCGKINEDFMKNGLESQALHDEIRKPIDSENPDTERLLDCLLDNRVCSSDKDCCGMTPSCTMGLCVPSVGGLVGGILG

SEQ ID NO: 101 - protein, 98 aa, Hadronyche versuta
MKFSKLSLTLALILTQVIFVLCGKINEDFMKNGLESQALHDEIRKPIDSENPDTERLLDCLLDNRVCSSDKDCCGMTPSCTMGLCVPSVGGLVGGILG

SEQ ID NO: 102 - protein, 93 aa, Hadronyche versuta
MKFSKLSLTLALILTQALFVLCDFMKNGLESQALHDEIRKSIDSENPDTERLLDCLLDNRVCSSDKDCCGMTPSCTMGLCVPSVGGLVGGILG

SEQ ID NO: 103 - protein, 98 aa, Hadronyche versuta
MKFSKLSLTLALILTQAIFVLCGKINEDFMKNDLESQALHDEIRKPINSENPDTERLLDCLLDNRVCSSDKDCCGMTPSCTMGLCVPSVGGLVGGILG

SEQ ID NO: 104 - protein, 98 aa, Hadronyche versuta
MKFSKLSLTLALILTQALFVLCGKINEDFMKNGLESQALHDEIRKPIDSENPDTERLLDCLLDNRVCSSDRDCCGMTPSCTMGLCVPNVGGLVGDILG

SEQ ID NO: 105 - protein, 98 aa, Hadronyche versuta
MKFSKLSLTLALILTQALFVLCGKINEDFMKNGLESQALHDEIRKPIDSENPDTERLLDCLLDNRVCSSDKDCCGMTPSCTMGLCVPNVGGLVGGILG

SEQ ID NO: 106 - protein, 93 aa, Hadronyche versuta
MKFSKLSLTLALILTQALFVLCDFMKNGLESQALHDEIRKPIDSENPDTERLLDCLLDNRVCSSDKDCCGMTPSCTMGLCVPNVGGLVGGILG

SEQ ID NO: 107 - protein, 97 aa, Hadronyche versuta
MKFSKLSLTLALILTQVLFVLCGKIEDFMKNGLESQALHDEIRKPIDSENPDTERLLDCLLDNRVCSSDKDCCGMTPSCTMGLCVPNVGGLVGGILG

SEQ ID NO: 108 - protein, 98 aa, Hadronyche versuta
MKFSKLSLTLALILTQAIFVLCGKINEDFMKNDLESQALHDEIRKPINSENPDTERLLDCLLDSRVCSSDKDCCGMTPSCTMGLCVPSVGGLVGGILG

SEQ ID NO: 109 - protein, 98 aa, Hadronyche versuta
MKFSKLSLTLALILTQALFVLCGKINEDFMKNGLESQALHDEIRKPIDSENPDTERLLDCLLDNRICSSDKDCCGMTPSCTMGLCVPNVGGLVGGILG

SEQ ID NO: 110 - protein, 101 aa, Hadronyche versuta
MKFSKLSLTLALILTQALFVLCGKINEDFMEHGLESHALHDEIRKPIDTEKADAERLVDCVVNTLGCSSDKDCCGMTPSCTLGICAPSVRGLVGGLLGRAL

SEQ ID NO: 111 - protein, 101 aa, Hadronyche versuta
MKFSKLSLTLALILTQALFVLCMKINEDFMENGLESHALHDEIRKPIDTEKADAERLVDCVVNTLGCSSDKDCCGMTPSCTLGICAPSVGGLVGGLLGRAL

SEQ ID NO: 112 - protein, 101 aa, Hadronyche versuta
MKFSKLSLTLALILTQALFVLCGKINEDFMENGLESHALHDEIRKPIDTEKADAERLVDCVVNTLGCSSDKDCCGMTPSCTLGICAPSVGGLVGGLLGRAL

SEQ ID NO: 113 - protein, 101 aa, Hadronyche versuta
MKFSKLSLTFALILTQALFVLCGKINEDFMDNGLESHALHDEIRKPIHTEKADAERLVDCVLNTLGCSSDKDCCGMTPSCTLGICAPSVGGLVGGLLGRAL

SEQ ID NO: 114 - protein, 101 aa, Hadronyche versuta
MKFSKLSLTLALILTQALFVLCGKINEDFMENGLESHALHDEIRKPIDTEKADAERVLDCVVNTLGCSSDKDCCGMTPSCTLGICAPSVGGLVGGLLGRAL

SEQ ID NO: 115 - protein, 95 aa, Hadronyche versuta
MKFSKLSLTFALILTQTLLVLCDFMENGLESHALHDEIRKPIDTEKADAERVLDCVVNTLGCSSDKDCCGMTPSCTLGICAPSVGGLVGGLLGRA

SEQ ID NO: 116 - protein, 100 aa, Hadronyche versuta
MKFSKLSLTLALILTQALFVLCGKINEDFMENGLESHALHDEIRKPIDTEKADAERLVDCVVNTLGCSSDKDCCGMTPSCTLGICAPSVGLVGGLLGRAL

SEQ ID NO: 117 - protein, 101 aa, Hadronyche versuta
MKFSKLSLTLALILTQALLVLCGKINEDFMENGLESHALHDEIRKPLDTENPDTERQLDCVLNTLGCSSDKDCCGMTPSCTLGICAPNVGGLVGGLLGRAL

SEQ ID NO: 118 - protein, 101 aa, Hadronyche versuta
MKFSKLSLTLALILTQVLLVVCGKINEDFMENGLESHALHDEIRKPIDTEKADAERVLDCVVNTLGCSSDKDCCGMTPSCTLGICAPSVGGIVGGLLGRAL

SEQ ID NO: 119 - protein, 101 aa, Hadronyche versuta
MKFSKLSLTLALILTQALLVVCGKINEDFMENGLESHALHDEIRKPIDTEKADAERVLDCVVNTLGCSSDKDCCGMTPSCTLGICAPSVGGIVGGLLGRAL

SEQ ID NO: 120 - protein, 101 aa, Hadronyche versuta
MKFSKLSLTLALILTQALLVVCGKINEDFMENGLESHALHDEIRKSIDTEKADAERVLDCVVNTLGCSSDKDCCGMTPSCTLGICAPSVGGIVGGLLGRAL

SEQ ID NO: 121 - protein, 101 aa, Hadronyche versuta
MKFSKLSLTLALILAQAIFVLCGKINEDFMENGLESHALHDEIRKPIDTEKADAERVVDCVLNTLGCSSDKDCCGMTPSCTLGICAPSVGGLVGGLLGRAL

SEQ ID NO: 122 - protein, 101 aa, Hadronyche versuta
MKFSKLSLTLALILTQALLVVCGKINEDFMENGLESHALHDEIRKPIDTEKADAERVLDCVVNILGCSSDKDCCGMTPSCTLGICAPSVGGIVGGLLGRAL

SEQ ID NO: 123 - protein, 85 aa, Haplopelma huwenum
MKVTLIAILTCAAVLVLHTTAAEELEAESQLMEVGMPDTELAAVDEERLFECSFSCEIEKEGDKPCKKKKCKGGWKCKFNMCVKV

SEQ ID NO: 124 - protein, 84 aa, Haplopelma huwenum
MKVTLIAILTCAAVLVLHTTAAEELEESQLMEVGMPDTELAAVDEERLFECSFSCEIEKEGDKPCKKKKCKGGWKCKFNMCVKV

SEQ ID NO: 125 - protein, 85 aa, Haplopelma huwenum
MKVTLIAILTCAAVLVLHTTAAEELEAESQLMEVGMPDTESAAVDEERLFECSFSCEIEKEGDKPCKKKKCKGGWKCKFNMCVKV

SEQ ID NO: 126 - protein, 37 aa, Haplopelma huwenum
LFECSFSCEQEKEGDKPCKKKKCKGGWKCKFNMCVKV

SEQ ID NO: 127 - protein, 85 aa, Haplopelma huwenum
MKVTLIAILTCAAVLVLHTTAAEELEAESQLMEVGMPDTELAAVDEERPFECSFSCEIEKEGDKPCKKKKCKGGWKCKFNMCVKV

SEQ ID NO: 128 - protein, 84 aa, Haplopelma huwenum
MKVTLIAILTCAAVLVLHTTAAEELEESQLMEVGMPDTELAAVDEERPFECSFSCEIEKEGDKPCKKKKCKGGWKCKFNMCVKV

SEQ ID NO: 129 - protein, 85 aa, Haplopelma huwenum
MKVTLIAILTCAAVLVLHTTAAEELEAESQLMEVGMPDTELAAVDEERLFECSFSCEIEKEGDKPCKKKKCKGGWKCKFNMCVKF

SEQ ID NO: 130 - protein, 85 aa, Haplopelma huwenum
MKVTLIAILTCAAVLVLHTTAAEELEAESQLMEVGMPDTELAAVDEERLFECSFSCEIEKEGDKLCKKKKCKGGWKCKFNMCVKV

SEQ ID NO: 131 - protein, 83 aa, Haplopelma huwenum
MKVTLIAILTCAAVLVLHTTAAEELEESQLMEVGMPDTELAAVDEERLFECSISCEIEKKGESCKPKKCKGGWKCKFNMCVKV

SEQ ID NO: 132 - protein, 84 aa, Haplopelma huwenum
MKVTLIAFLTCAAVLVLHTTAAEELEAESQLMEVGMPDTELAAVDEERLFECSISCEIEKKGESCKPKKCKGGWKCKFNMCVKV

SEQ ID NO: 133 - protein, 84 aa, Haplopelma huwenum
MKVTLIAILTCAAVLVLHTTAAEELEAESQLMEVGMPDTELAAVDEERLFECSISCEIEKKGESCKPKKCKGGWKCKFNMCVKV

SEQ ID NO: 134 - protein, 83 aa, Haplopelma huwenum; identical to SEQ ID NO: 131

SEQ ID NO: 135 - protein, 84 aa, Haplopelma huwenum
MKVTLIAILTCAAVLVLHTTAAEELEAESQLMEVGMPDTELAAVDEERLFECSISCEIEKKGESCKPKECKGGWKCKFNMCVKV

SEQ ID NO: 136 - protein, 87 aa, Haplopelma huwenum
MVNMKASMFLTFAGLVLLFVVCYASESEEKEFPKEMLSSIFAVDNDFKQEERDCAGYMRECKEKLCCSGYVCSSRWKWCVLPAPWRR

SEQ ID NO: 137 - protein, 87 aa, Haplopelma huwenum; identical to SEQ ID NO: 136

SEQ ID NO: 138 - protein, 86 aa, Haplopelma huwenum
MKSIVFVALFGLALLAVVCSASEDAHKELLKEVVRAMVVDKTDAVQAEERECRWYLGGCSQDGDCCKHLQCHSNYEWCVWDGTFSK

SEQ ID NO: 139 - protein, 36 aa, Hololena curta
SCVGEYGRCRSAYEDCCDGYYCNCSQPPYCLCRNNN

SEQ ID NO: 140 - protein, 38 aa, Hololena curta; identical to SEQ ID NO: 13

SEQ ID NO: 141 - protein, 38 aa, Hololena curta
ADCVGDGQKCADWFGPYCCSGYYCSCRSMPYCRCRSDS

SEQ ID NO: 142 - protein, 42 aa, Illawara wisharti
CAKKRNWCGKNEDCCCPMKCIYAWYNQQGSCQSTITGLFKKC

SEQ ID NO: 143 - protein, 100 aa, Illawara wisharti; identical to SEQ ID NO: 43

SEQ ID NO: 144 - protein, 79 aa, Macrothele gigas
MKAPATTLILVMSLISVLWATPDLEEGDLLAELGDLIATDDEYPMKPEERGCKLTFWKCKNKKECCGWNACALGICMPR

SEQ ID NO: 145 - protein, 105 aa, Macrothele gigas
MKTLVIACVALVLVVVHGEVIEEVNEKQLQESVEEKYSLLQRLEKLDEAITAEENRNSRVRRCGSKRAWCKEKKDCCCGYNCVYAWYNQQSSCERKWKYLFTGEC

SEQ ID NO: 146 - protein, 70 aa, Macrothele gigas
MKILEKALLENDSAAEEESRNLRTKRCARKRAWCEKTENCCCPMKCIYAWYNGQSSCDHTISTIWTSCPK

SEQ ID NO: 147 - protein, 121 aa, Macrothele gigas
MMTLSPFLLLLIAAVVIGNASEGEVKNEFEERLKDEFKDPSRSEVAEVILLRELEVLEETLFGKEMTSDTEENRNSREKRCMGYDIECNENLPCCKHRKLECVETSGYWWYKRKYCRPIKG

SEQ ID NO: 148 - protein, 38 aa, Macrothele gigas
CMGYDIHCTDRLPCCFGLECVKTSGYWWYKKTYCRRKS

SEQ ID NO: 149 - protein, 99 aa, Macrothele gigas
TSQGTTPDKVQLEVNCISNLPNNEVEETDLLRELEMIEENLFGKELSFVPEENRNSRHKRCMGYDIECNERLHCCADLECVKTSGRWWYKKTYCRRKSG

SEQ ID NO: 150 - protein, 46 aa, Macrothele gigas
GGCIKWNHSCQTTTLKCCGKCVVCYCHTPWGTNCRCDRTRLFCTED

SEQ ID NO: 151 - protein, 29 aa, Macrothele raveni
GCKLTFWKCKNKKECCGWNACALGICMPR

SEQ ID NO: 152 - protein, 42 aa, Missulena bradleyi
CAKKREWCAKTEDCCCPMKCIYAWYNEQSSCQTTFSGMFKKC

SEQ ID NO: 153 - protein, 39 aa, Missulena bradleyi
SPVCTPSGQPCQPNTQPCCNNAEEEQTINCNGNTVYRCA

SEQ ID NO: 154 - protein, 55 aa, Oxyopes lineatus
AWKCLPKDSTCGDDCDCCEGLHCHCPLRNMLPAILRCSCQSKDDHINTCPKYKKS

SEQ ID NO: 155 - protein, 54 aa, Phoneutria keyserlingi
ATCAGQDKPCKETCDCCGERGECVCGLSYEGKYRCICRQGTFLIAWYKLASCKK

SEQ ID NO: 156 - protein, 32 aa, Phoneutria nigriventer
VFCRSNGQQCTSDGQCCYGKCMTAFMGKICMR

SEQ ID NO: 157 - protein, 31 aa, Phoneutria nigriventer
VFCRFNGQQCTSDGQCCYGKCRTAFMGKICM

SEQ ID NO: 158 - protein, 33 aa, Phoneutria nigriventer
VFCRFNGQQCTSDGQCCYGKCRTAFLRMICMGG

SEQ ID NO: 159 - protein, 88 aa, Phoneutria nigriventer
MKVAILILSILVLAVASETIEEYRDDFAVEELERATCAGQDKPCKETCDCCGERGECVCALSYEGKYRCICRQGNFLIAWHKLASCKK

SEQ ID NO: 160 - protein, 32 aa, Phoneutria nigriventer
SFCIPFKPCKSDENCCKKFKCKTTGIVKLCRW

SEQ ID NO: 161 - protein, 81 aa, Phoneutria nigriventer
MKVAIVFLSLLVLAFASESIEENREEFPVEESARCADINGACKSDCDCCGDSVTCDCYWSDSCKCRESNFKIGMAIRKKFC

SEQ ID NO: 162 - protein, 48 aa, Phoneutria nigriventer
CGDINAACKEDCDCCGYTTACDCYWSKSCKCREAAIVIYTAPKKKLTC

SEQ ID NO: 163 - protein, 82 aa, Phoneutria nigriventer
MKVAIVFLSLLVLAFASESIEENREEFPVEESARCGDINAACKEDCDCCGYTTACDCYWSKSCKCREAAIVIYTAPKKKLTC

SEQ ID NO: 164 - protein, 48 aa, Phoneutria nigriventer
CGDINAACKEDCDCCGYTTACDCYWSSSCKCREAAIVIYTAPKKKLTC

SEQ ID NO: 165 - protein, 82 aa, Phoneutria nigriventer
MKVAILFLSILVLAVASESIEESRDDFAVEELGRATCAGQDQPCKETCDCCGERGECVCGGPCICRQGYFWIAWYKLANCKK

SEQ ID NO: 166 - protein, 49 aa, Phoneutria nigriventer
ATCAGQDQTCKVTCDCCGERGECVCGGPCICRQGNFLIAAYKLASCKCK

SEQ ID NO: 167 - protein, 82 aa, Phoneutria nigriventer
MKVAILFLSILVLAVASESIEESRDDFAVEELGRATCAGQDQTCKVTCDCCGERGECVCGGPCICRQGNFLIAWYKLASCKK

SEQ ID NO: 168 - protein, 47 aa, Phoneutria reidyi
GTCAGQDKPCKETCDCCGERGQCVCEGPCICRQGYFWIAAYKLGNCK

SEQ ID NO: 169 - protein, 37 aa, Pireneitega luctuosa
GCLGEGEKCADWSGPSCCDGFYCSCRSMPYCRCRNNS

SEQ ID NO: 170 - protein, 37 aa, Pireneitega luctuosa
ACVGDGQRCASWSGPYCCDGYYCSCRSMPYCRCRNNS

SEQ ID NO: 171 - protein, 36 aa, Pireneitega luctuosa
ADCLNEGDWCADWSGPSCCGEMWCSCPGFGKCRCKK

SEQ ID NO: 172 - protein, 37 aa, Pireneitega luctuosa
ACATKNQRCASWAGPYCCDGFYCSCRSYPGCMCRPNS

SEQ ID NO: 173 - protein, 82 aa, Plectreurys tristis
MKHLIFSSALVCALVVCTFAEEQVNVPFLPDERAVKCIGWQETCNGNLPCCNECVMCECNIMGQNCRCNHPKATNECESRRR

SEQ ID NO: 174 - protein, 61 aa, Plectreurys tristis
EEQVNVPFLPDERAVKCIGWQETCNGQLPCCDGCVMCECNIMGQNCRCNHPKMTSECGSRR

SEQ ID NO: 175 - protein, 79 aa, Plectreurys tristis
HLILASALICALVVCTFAEEQVNVPFLPDEREVKCIGWQEYCRGNLPCCDDCVMCECNIMGQNCRCNHPRITSECGSRR

SEQ ID NO: 176 - protein, 45 aa, Plectreurys tristis
AVKCIGWQETCNGNLPCCNECVMCECNIMGQNCRCNHPKATNECE

SEQ ID NO: 177 - protein, 46 aa, Plectreurys tristis
AVKCIGWQETCNGKLPCCDGCVMCECNIMGQNCRCNHPKATSECES

SEQ ID NO: 178 - protein, 49 aa, Plectreurys tristis
GCKGFLVKCDSNSECCKTAIVKGKKKQLSCLCGAWGAGCSCSFRCGNRC

SEQ ID NO: 179 - protein, 44 aa, Plectreurys tristis
ADCSATGDTCDHTKKCCDDCYTCRCGTPWGANCRCDYYKARCDT

SEQ ID NO: 180 - protein, 46 aa, Segestria florentina
KECMTDGTVCYIHNHNDCCGSCLCSNGPIARPWEMMVGNCMCGPKA

SEQ ID NO: 181 - protein, 46 aa, Segestria florentina
KECMADETVCYIHNHNNCCGSCLCLNGPYARPWEMLVGNCKCGPKE

SEQ ID NO: 182 - protein, 46 aa, Segestria florentina
KECMVDGTVCYIHNHNDCCGSCLCLNGPIARPWEMMVGNCKCGPKA

SEQ ID NO: 183 - protein, 46 aa, Segestria florentina
KECMVDGTVCYIHNHNDCCGSCLCLNGPIARPWKMMVGNCKCGPKA

SEQ ID NO: 184 - protein, 46 aa, Segestria florentina
KECMVDGTVCYIHNHNDCCGSCLCPNGPLARPWEMLVGNCKCGPKA

SEQ ID NO: 185 - protein, 46 aa, Segestria florentina
KECMTDETVCYIHNHNDCCGSCLCLNGPIARPWEMMVGNCKCGPKA

SEQ ID NO: 186 - protein, 46 aa, Segestria florentina
KECMADGTVCYIHNHNDCCGSCLCPNGPLARPWEVLVGNCKCGPKA

SEQ ID NO: 187 - protein, 46 aa, Segestria florentina
KECMADGTVCYIHNHNDCCGSCLCPNGPLARPWEMLVGNCKCGPKA

SEQ ID NO: 188 - protein, 49 aa, Artificial sequence
  Gamma-CNTX-Pn1a
GSCADINGACKSDCDCCGDSVTCDCYWSDSCKCRESNFKIGMAIRKKFC

SEQ ID NO: 189 - protein, 68 aa, Eratigena agrestis
MKLQLMICLVLLPCFFCEPDEICRARMTNKEFTYKSNVCNNCGDQVAACEAECFRNDVYTACHEAQKG

SEQ ID NO: 190 - protein, 51 aa, Eratigena agrestis
EPDEICRARMTNKEFTYKSNVCNNCGDQVAACEAECFRNDVYTACHEAQKG

SEQ ID NO: 191 - protein, 50 aa, Eratigena agrestis
EPDEICRARMTNKEFTYKSNVCNNCGDQVAACEAECFRNDVYTACHEAQK

SEQ ID NO: 192 - protein, 51 aa, Artificial sequence
  TVP-R9Q
EPDEICRAQMTNKEFTYKSNVCNNCGDQVAACEAECFRNDVYTACHEAQKG

SEQ ID NO: 193 - protein, 50 aa, Artificial sequence
  TVP-R9Q deltaG
EPDEICRAQMTNKEFTYKSNVCNNCGDQVAACEAECFRNDVYTACHEAQK

SEQ ID NO: 194 - protein, 51 aa, Artificial sequence
  TVP-K18A
EPDEICRARMTNKEFTYASNVCNNCGDQVAACEAECFRNDVYTACHEAQKG

SEQ ID NO: 195 - protein, 50 aa, Artificial sequence
  TVP-K18A deltaG
EPDEICRARMTNKEFTYASNVCNNCGDQVAACEAECFRNDVYTACHEAQK

SEQ ID NO: 196 - protein, 51 aa, Artificial sequence
  TVP-R38A
EPDEICRARMTNKEFTYKSNVCNNCGDQVAACEAECFANDVYTACHEAQKG

SEQ ID NO: 197 - protein, 50 aa, Artificial sequence
  TVP-R38A deltaG
EPDEICRARMTNKEFTYKSNVCNNCGDQVAACEAECFANDVYTACHEAQK

SEQ ID NO: 198 - protein, 51 aa, Artificial sequence
  TVP-A8N
EPDEICRNRMTNKEFTYKSNVCNNCGDQVAACEAECFRNDVYTACHEAQKG

SEQ ID NO: 199 - protein, 50 aa, Artificial sequence
  TVP-A8N deltaG
EPDEICRNRMTNKEFTYKSNVCNNCGDQVAACEAECFRNDVYTACHEAQK

SEQ ID NO: 200 - protein, 51 aa, Artificial sequence
  TVP-A8S
EPDEICRSRMTNKEFTYKSNVCNNCGDQVAACEAECFRNDVYTACHEAQKG

SEQ ID NO: 201 - protein, 50 aa, Artificial sequence
  TVP-A8S deltaG
EPDEICRSRMTNKEFTYKSNVCNNCGDQVAACEAECFRNDVYTACHEAQK

SEQ ID NO: 202 - protein, 51 aa, Artificial sequence
  TVP-R9N
EPDEICRANMTNKEFTYKSNVCNNCGDQVAACEAECFRNDVYTACHEAQKG

SEQ ID NO: 203 - protein, 50 aa, Artificial sequence
  TVP-R9N deltaG
EPDEICRANMTNKEFTYKSNVCNNCGDQVAACEAECFRNDVYTACHEAQK

SEQ ID NO: 204 - protein, 51 aa, Artificial sequence
  TVP-T11P
EPDEICRARMPNKEFTYKSNVCNNCGDQVAACEAECFRNDVYTACHEAQKG

SEQ ID NO: 205 - protein, 50 aa, Artificial sequence
  TVP-T11P deltaG
EPDEICRARMPNKEFTYKSNVCNNCGDQVAACEAECFRNDVYTACHEAQK

SEQ ID NO: 206 - protein, 51 aa, Artificial sequence
  T43A
EPDEICRARMTNKEFTYKSNVCNNCGDQVAACEAECFRNDVYAACHEAQKG

SEQ ID NO: 207 - protein, 50 aa, Artificial sequence
  T43A deltaG
EPDEICRARMTNKEFTYKSNVCNNCGDQVAACEAECFRNDVYAACHEAQK

SEQ ID NO: 208 - protein, 51 aa, Artificial sequence
  TVP-R9Q/T43A
EPDEICRAQMTNKEFTYKSNVCNNCGDQVAACEAECFRNDVYAACHEAQKG

SEQ ID NO: 209 - protein, 50 aa, Artificial sequence
  TVP-R9Q/T43A/deltaG
EPDEICRAQMTNKEFTYKSNVCNNCGDQVAACEAECFRNDVYAACHEAQK

SEQ ID NO: 210 - protein, 49 aa, Artificial sequence
  TVP-R9Q/T43A/deltaG50-51
EPDEICRAQMTNKEFTYKSNVCNNCGDQVAACEAECFRNDVYAACHEAQ

SEQ ID NO: 211 - protein, 51 aa, Artificial sequence
  TVP-R9A
EPDEICRAAMTNKEFTYKSNVCNNCGDQVAACEAECFRNDVYTACHEAQKG

SEQ ID NO: 212 - protein, 51 aa, Artificial sequence
  TVP-R9G
EPDEICRAGMTNKEFTYKSNVCNNCGDQVAACEAECFRNDVYTACHEAQKG

SEQ ID NO: 213 - protein, 51 aa, Artificial sequence; identical to SEQ ID NO: 202
  TVP-R9N

SEQ ID NO: 214 - protein, 51 aa, Artificial sequence
  TVP-R9L
EPDEICRALMTNKEFTYKSNVCNNCGDQVAACEAECFRNDVYTACHEAQKG

SEQ ID NO: 215 - protein, 51 aa, Artificial sequence
  TVP-R9D
EPDEICRADMTNKEFTYKSNVCNNCGDQVAACEAECFRNDVYTACHEAQKG

SEQ ID NO: 216 - protein, 51 aa, Artificial sequence
  TVP-R9V
EPDEICRAVMTNKEFTYKSNVCNNCGDQVAACEAECFRNDVYTACHEAQKG

SEQ ID NO: 217 - protein, 51 aa, Artificial sequence
  TVP-R9M
EPDEICRAMMTNKEFTYKSNVCNNCGDQVAACEAECFRNDVYTACHEAQKG

SEQ ID NO: 218 - protein, 51 aa, Artificial sequence
  TVP-R9I
EPDEICRAIMTNKEFTYKSNVCNNCGDQVAACEAECFRNDVYTACHEAQKG

SEQ ID NO: 219 - protein, 51 aa, Artificial sequence; identical to SEQ ID NO: 208
  TVP-R9Q/ T43A

SEQ ID NO: 220 - protein, 51 aa, Artificial sequence; identical to SEQ ID NO: 192
  TVP-R9Q

SEQ ID NO: 221 - protein, 51 aa, Artificial sequence
  TVP-R9C
EPDEICRACMTNKEFTYKSNVCNNCGDQVAACEAECFRNDVYTACHEAQKG

SEQ ID NO: 222 - protein, 51 aa, Artificial sequence
  TVP-R9E
EPDEICRAEMTNKEFTYKSNVCNNCGDQVAACEAECFRNDVYTACHEAQKG

SEQ ID NO: 223 - protein, 51 aa, Artificial sequence
  TVP-R9T
EPDEICRATMTNKEFTYKSNVCNNCGDQVAACEAECFRNDVYTACHEAQKG

SEQ ID NO: 224 - protein, 51 aa, Artificial sequence
  TVP-R9S
EPDEICRASMTNKEFTYKSNVCNNCGDQVAACEAECFRNDVYTACHEAQKG

SEQ ID NO: 225 - protein, 51 aa, Artificial sequence
  TVP-T43F
EPDEICRARMTNKEFTYKSNVCNNCGDQVAACEAECFRNDVYFACHEAQKG

SEQ ID NO: 226 - protein, 51 aa, Artificial sequence
  TVP-T43P
EPDEICRARMTNKEFTYKSNVCNNCGDQVAACEAECFRNDVYPACHEAQKG

SEQ ID NO: 227 - protein, 51 aa, Artificial sequence
  TVP-T43Y
EPDEICRARMTNKEFTYKSNVCNNCGDQVAACEAECFRNDVYYACHEAQKG

SEQ ID NO: 228 - protein, 51 aa, Artificial sequence
  TVP-T43K
EPDEICRARMTNKEFTYKSNVCNNCGDQVAACEAECFRNDVYKACHEAQKG

SEQ ID NO: 229 - protein, 51 aa, Artificial sequence
  TVP-T43W
EPDEICRARMTNKEFTYKSNVCNNCGDQVAACEAECFRNDVYWACHEAQKG

SEQ ID NO: 230 - protein, 51 aa, Artificial sequence
  TVP-T43H
EPDEICRARMTNKEFTYKSNVCNNCGDQVAACEAECFRNDVYHACHEAQKG

SEQ ID NO: 231 - protein, 51 aa, Artificial sequence; identical to SEQ ID NO: 206
  TVP-T43A

SEQ ID NO: 232 - protein, 51 aa, Artificial sequence
  TVP-T43G
EPDEICRARMTNKEFTYKSNVCNNCGDQVAACEAECFRNDVYGACHEAQKG

SEQ ID NO: 233 - protein, 51 aa, Artificial sequence
  TVP-T43N
EPDEICRARMTNKEFTYKSNVCNNCGDQVAACEAECFRNDVYNACHEAQKG

SEQ ID NO: 234 - protein, 51 aa, Artificial sequence
  TVP-T43L
EPDEICRARMTNKEFTYKSNVCNNCGDQVAACEAECFRNDVYLACHEAQKG

SEQ ID NO: 235 - protein, 51 aa, Artificial sequence
  TVP-T43D
EPDEICRARMTNKEFTYKSNVCNNCGDQVAACEAECFRNDVYDACHEAQKG

SEQ ID NO: 236 - protein, 51 aa, Artificial sequence
  TVP-T43V
EPDEICRARMTNKEFTYKSNVCNNCGDQVAACEAECFRNDVYVACHEAQKG

SEQ ID NO: 237 - protein, 51 aa, Artificial sequence
  TVP-T43M
EPDEICRARMTNKEFTYKSNVCNNCGDQVAACEAECFRNDVYMACHEAQKG

SEQ ID NO: 238 - protein, 51 aa, Artificial sequence
  TVP-T43I
EPDEICRARMTNKEFTYKSNVCNNCGDQVAACEAECFRNDVYIACHEAQKG

SEQ ID NO: 239 - protein, 51 aa, Artificial sequence
  TVP-T43Q
EPDEICRARMTNKEFTYKSNVCNNCGDQVAACEAECFRNDVYQACHEAQKG

SEQ ID NO: 240 - protein, 51 aa, Artificial sequence
  TVP-T43C
EPDEICRARMTNKEFTYKSNVCNNCGDQVAACEAECFRNDVYCACHEAQKG

SEQ ID NO: 241 - protein, 51 aa, Artificial sequence
  TVP-T43E
EPDEICRARMTNKEFTYKSNVCNNCGDQVAACEAECFRNDVYEACHEAQKG

SEQ ID NO: 242 - protein, 51 aa, Artificial sequence; identical to SEQ ID NO: 190
  TVP-T43T

SEQ ID NO: 243 - protein, 51 aa, Artificial sequence
  TVP-T43S
EPDEICRARMTNKEFTYKSNVCNNCGDQVAACEAECFRNDVYSACHEAQKG

SEQ ID NO: 244 - protein, 51 aa, Artificial sequence
  TVP-T43R
EPDEICRARMTNKEFTYKSNVCNNCGDQVAACEAECFRNDVYRACHEAQKG

SEQ ID NO: 245 - protein, 88 aa, Androctonus australis
MKFLLLFLVVLPIMGVFGKKNGYAVDSSGKAPECLLSNYCNNECTKVHYADKGYCCLLSCYCFGLNDDKKVLEISDTRKSYCDTTIIN

SEQ ID NO: 246 - protein, 33 aa, Pandinus imperator
GDCLPHLKRCKADNDCCGKKCKRRGTNAEKRCR

SEQ ID NO: 247 - protein, 32 aa, Centruroides noxius
VACVYRTCDKDCTSRKYRSGKCINNACKCYPY

SEQ ID NO: 248 - protein, 37 aa, Parabuthus villosus
DEEPKESCSDEMCVIYCKGEEYSTGVCDGPQKCKCSD

SEQ ID NO: 249 - protein, 37 aa, Parabuthus villosus
DEEPKETCSDEMCVIYCKGEEYSTGVCDGPQKCKCSD

SEQ ID NO: 250 - protein, 36 aa, Parabuthus granulatus
DEEPKETCSDDMCVIYCKGEEFSTGACDGPQKCKCS

SEQ ID NO: 251 - protein, 40 aa, Tityus serrulatus
WCSTCLDLACGASRECYDPCFKAFGRAHGKCMNNKCRCYT

SEQ ID NO: 252 - protein, 40 aa, Tityus trivittatus; identical to SEQ ID NO: 251

SEQ ID NO: 253 - protein, 40 aa, Tityus costatus
WCSTCLDLECGASRECYDPCFKAFGRAHGKCMNNKCRCYT

SEQ ID NO: 254 - protein, 37 aa, Androctonus australis
QNETNKKCQGGSCASVCRRVIGVAAGKCINGRCVCYP

SEQ ID NO: 255 - protein, 37 aa, Androctonus mauretanicus mauretanicus
QIETNKKCQGGSCASVCRKVIGVAAGKCINGRCVCYP

SEQ ID NO: 256 - protein, 38 aa, Tityus discrepans
QIDTNVKCSGSSKCVKICIDRYNTRGAKCINGRCTCYP

SEQ ID NO: 257 - protein, 36 aa, Mesobuthus tamulus
DLIDVKCISSQECWIACKKVTGRFEGKCQNRQCRCY

SEQ ID NO: 258 - protein, 31 aa, Mesobuthus martensii
AACYSSDCRVKCVAMGFSSGKCINSKCKCYK

SEQ ID NO: 259 - protein, 37 aa, Mesobuthus tamulus
QFTDVDCSVSKECWSVCKDLFGVDRGKCMGKKCRCYQ

SEQ ID NO: 260 - protein, 37 aa, Centruroides limbatus
  misc_feature (37)..(37): Xaa can be any naturally occurring amino acid
VFIDVSCSVSKECWAPCKAAVGTDRGKCMGKKCRCYX

SEQ ID NO: 261 - protein, 36 aa, Leiurus quinquestriatus hebraeus
GLIDVRCYDSRQCWIACKKVTGSTQGKCQNKQCRCY

SEQ ID NO: 262 - protein, 36 aa, Centruroides limbatus
HFIDVKCTTSKECWPPCKAATGKAAGKCMNKKCKCQ

SEQ ID NO: 263 - protein, 37 aa, Parabuthus transvaalicus
EVDMRCKSSKECLVKCKQATGRPNGKCMNRKCKCYPR

SEQ ID NO: 264 - protein, 37 aa, Centruroides noxius
TFIDVDCTVSKECWAPCKAAFGVDRGKCMGKKCKCYV

SEQ ID NO: 265 - protein, 37 aa, Leiurus quinquestriatus hebraeus
QFTNVSCTTSKECWSVCEKLYNTSRGKCMNKKCRCYS

SEQ ID NO: 266 - protein, 39 aa, Centruroides noxius
TIINVKCTSPKQCSKPCKELYGSSAGAKCMNGKCKCYNN

SEQ ID NO: 267 - protein, 39 aa, Centruroides margaritatus
TIINVKCTSPKQCLPPCKAQFGQSAGAKCMNGKCKCYPH

SEQ ID NO: 268 - protein, 38 aa, Centruroides limpidus limpidus
ITINVKCTSPQQCLRPCKDRFGQHAGGKCINGKCKCYP

SEQ ID NO: 269 - protein, 38 aa, Centruroides noxius
TIINEKCFATSQCWTPCKKAIGSLQSKCMNGKCKCYNG

SEQ ID NO: 270 - protein, 39 aa, Centruroides limbatus
TVIDVKCTSPKQCLPPCKAQFGIRAGAKCMNGKCKCYPH

SEQ ID NO: 271 - protein, 34 aa, Centruroides limbatus
  misc_feature (23)..(23): Xaa can be any naturally occurring amino acid
TFINVKCTSPKQCLPACKEKFGXAAGKCMNGKCK

SEQ ID NO: 272 - protein, 36 aa, Centruroides limpidus limpidus
TVIDVKCTSPKQCLPPCKEIYGRHAGAKCMNGKCKC

SEQ ID NO: 273 - protein, 39 aa, Centruroides elegans
TVINVKCTSPKQCLKPCKDLYGPHAGAKCMNGKCKCYNN

SEQ ID NO: 274 - protein, 39 aa, Centruroides elegans
TIINVKCTSPKQCLKPCKDLYGPHAGAKCMNGKCKCYNN

SEQ ID NO: 275 - protein, 38 aa, Centruroides elegans
IFINVKCSLPQQCLRPCKDRFGQHAGGKCINGKCKCYP

SEQ ID NO: 276 - protein, 39 aa, Centruroides elegans
TIINVKCTSPKQCLLPCKEIYGIHAGAKCMNGKCKCYKI

SEQ ID NO: 277 - protein, 39 aa, Centruroides elegans
TIINVKCTSPKQCLPPCKEIYGRHAGAKCMNGKCHCSKI

SEQ ID NO: 278 - protein, 38 aa, Androctonus mauretanicus mauretanicus
GVEINVKCSGSPQCLKPCKDAGMRFGKCMNRKCHCTPK

SEQ ID NO: 279 - protein, 38 aa, Leiurus quinquestriatus hebraeus
GVPINVSCTGSPQCIKPCKDAGMRFGKCMNRKCHCTPK

SEQ ID NO: 280 - protein, 38 aa, Leiurus quinquestriatus hebraeus
GVPINVPCTGSPQCIKPCKDAGMRFGKCMNRKCHCTPK

SEQ ID NO: 281 - protein, 38 aa, Leiurus quinquestriatus hebraeus
GVPINVKCTGSPQCLKPCKDAGMRFGKCINGKCHCTPK

SEQ ID NO: 282 - protein, 38 aa, Orthochirus scrobiculosus
GVIINVKCKISRQCLEPCKKAGMRFGKCMNGKCHCTPK

SEQ ID NO: 283 - protein, 38 aa, Buthus sindicus
GVPINVKCRGSPQCIQPCRDAGMRFGKCMNGKCHCTPQ

SEQ ID NO: 284 - protein, 37 aa, Buthus occitanus tunetanus
VGIPVSCKHSGQCIKPCKDAGMRFGKCMNRKCDCTPK

SEQ ID NO: 285 - protein, 37 aa, Tityus serrulatus
VFINAKCRGSPECLPKCKEAIGKAAGKCMNGKCKCYP

SEQ ID NO: 286 - protein, 37 aa, Tityus discrepans
VFINVKCTGSKQCLPACKAAVGKAAGKCMNGKCKCYT

SEQ ID NO: 287 - protein, 37 aa, Tityus cambridgei
VFINVKCRGSKECLPACKAAVGKAAGKCMNGKCKCYP

SEQ ID NO: 288 - protein, 31 aa, Leiurus quinquestriatus hebraeus
AFCNLRMCQLSCRSLGLLGKCIGDKCECVKH

SEQ ID NO: 289 - protein, 31 aa, Androctonus mauretanicus mauretanicus
TVCNLRRCQLSCRSLGLLGKCIGVKCECVKH

SEQ ID NO: 290 - protein, 31 aa, Mesobuthus tamulus
AFCNLRRCELSCRSLGLLGKCIGEECKCVPY

SEQ ID NO: 291 - protein, 31 aa, Mesobuthus tamulus
AFCNLRRCELSCRSLGLLGKCIGEECKCVPH

SEQ ID NO: 292 - protein, 35 aa, Pandinus imperator
LVKCRGTSDCGRPCQQQTGCPNSKCINRMCKCYGC

SEQ ID NO: 293 - protein, 34 aa, Scorpio maurus palmatus
VSCTGSKDCYAPCRKQTGCPNAKCINKSCKCYGC

SEQ ID NO: 294 - protein, 34 aa, Heterometrus spinifer
ASCRTPKDCADPCRKETGCPYGKCMNRKCKCNRC

SEQ ID NO: 295 - protein, 35 aa, Anuroctonus phaiodactylus
QKECTGPQHCTNFCRKNKCTHGKCMNRKCKCFNCK

SEQ ID NO: 296 - protein, 34 aa, Heterometrus spinifer
IRCSGSRDCYSPCMKQTGCPNAKCINKSCKCYGC

SEQ ID NO: 297 - protein, 36 aa, Hadrurus gertschi
TGTSCISPKQCTEPCRAKGCKHGKCMNRKCHCMLCL

SEQ ID NO: 298 - protein, 35 aa, Pandinus imperator
TISCTNEKQCYPHCKKETGYPNAKCMNRKCKCFGR

SEQ ID NO: 299 - protein, 42 aa, Centruroides elegans
DRDSCVDKSRCAKYGYYQECTDCCKKYGHNGGTCMFFKCKCA

SEQ ID NO: 300 - protein, 42 aa, Centruroides gracilis
DRDSCVDKSRCAKYGHYQECTDCCKKYGHNGGTCMFFKCKCA

SEQ ID NO: 301 - protein, 42 aa, Centruroides sculpturatus
DRDSCVDKSRCAKYGYYQECQDCCKKAGHNGGTCMFFKCKCA

SEQ ID NO: 302 - protein, 42 aa, Centruroides limpidus limpidus
DRDSCVDKSRCSKYGYYQECQDCCKKAGHNGGTCMFFKCKCA

SEQ ID NO: 303 - protein, 42 aa, Centruroides exilicauda
DRDSCVDKSRCAKYGYYQECQDCCKKAGHSGGTCMFFKCKCA

SEQ ID NO: 304 - protein, 43 aa, Centruroides noxius
DRDSCVDKSKCGKYGYYQECQDCCKNAGHNGGTCVYYKCKCNP

SEQ ID NO: 305 - protein, 36 aa, Buthus eupeus
MCMPCFTTRPDMAQQCRACCKGRGKCFGPQCLCGYD

SEQ ID NO: 306 - protein, 35 aa, Buthus sindicus
RCKPCFTTDPQMSKKCADCCGGKGKGKCYGPQCLC

SEQ ID NO: 307 - protein, 36 aa, Buthus eupeus
MCMPCFTTDHQTARRCRDCCGGRGRKCFGQCLCGYD

SEQ ID NO: 308 - protein, 35 aa, Buthus eupeus
MCMPCFTTDHNMAKKCRDCCGGNGKCFGPQCLCNR

SEQ ID NO: 309 - protein, 35 aa, Buthus eupeus
MCMPCFTTDPNMAKKCRDCCGGNGKCFGPQCLCNR

SEQ ID NO: 310 - protein, 36 aa, Buthus occitanus tunetanus
  misc_feature (32)..(33): Xaa can be any naturally occurring amino acid
VRDAYIAQNYNCVYTCFKNDYCNDICTKNGAXXGYC

SEQ ID NO: 311 - protein, 38 aa, Leiurus quinquestriatus hebraeus
RCSPCFTTDQQMTKKCYDCCGGKGKGKCYGPQCICAPY

SEQ ID NO: 312 - protein, 33 aa, Buthus occitanus tunetanus
AEIKVRDGYIVYPNNCVYHCGLDPYCNDLCTGA

SEQ ID NO: 313 - protein, 33 aa, Scorpio maurus palmatus
GDCLPHLKLCKENKDCCSKKCKRRGTNIEKRCR

SEQ ID NO: 314 - protein, 36 aa, Buthus sindicus
CGPCFTKDPETEKKCATCCGGIGRCFGPQCLCNRGY

SEQ ID NO: 315 - protein, 36 aa, Leiurus quinquestriatus quinquestriatus
MCMPCFTTDHQMARKCDDCCGGKGRGKCYGPQCLCR

SEQ ID NO: 316 - protein, 35 aa, Androctonus mauretanicus mauretanicus
CGPCFTTDPYTESKCATCCGGRGKCVGPQCLCNRI

SEQ ID NO: 317 - protein, 35 aa, Buthus eupeus
MCMPCFTTDPNMANKCRDCCGGGKKCFGPQCLCNR

SEQ ID NO: 318 - protein, 35 aa, Hemiscorpius lepturus
IKCTLSKDCYSPCKKETGCPRAKCINRNCKCYGCS

SEQ ID NO: 319 - protein, 34 aa, Leiurus quinquestriatus hebraeus
CGPCFTTDHQMEQKCAECCGGIGKCYGPQCLCNR

SEQ ID NO: 320 - protein, 70 aa, Androctonus australis
KKNGYAVDSSGKAPECLLSNYCNNECTKVHYADKGYCCLLSCYCFGLNDDKKVLEISDTRKSYCDTTIIN

SEQ ID NO: 321 - protein, 72 aa, Anuroctonus phaiodactylus
KFIRHKDESFYECGQLIGYQQYCVNACQAHGSKEKGYCKGMAPFGLPGGCYCPKLPSNRVKMCFGALESKCA

SEQ ID NO: 322 - protein, 61 aa, Buthacus arenicola
DGYIRRRDGCKVSCLFGNEGCDKECKAYGGSYGYCWTWGLACWCEGLPDDKTWKSETNTCG

SEQ ID NO: 323 - protein, 65 aa, Bothus occitanus tunetanus
VRDAYIAQNYNCVYFCMKDDYCNDLCTKNGASSGYCQWAGKYGNACWCYALPDNVPIRIPGKCHS

SEQ ID NO: 324 - protein, 60 aa, Bothus occitanus tunetanus
DGYIKGYKGCKITCVINDDYCDTECKAEGGTYGYCWKWGLACWCEDLPDEKRWKSETNTC

SEQ ID NO: 325 - protein, 64 aa, Buthus martensii
VRDAYIAKPHNCVYECARNEYCNDLCTKNGAKSGYCQWVGKYGNGCWCIELPDNVPIRVPGKCH

SEQ ID NO: 326 - protein, 64 aa, Buthus martensii
VRDAYIAKPHNCVYSCARNEWCNDLCTKNGAKSGYCQWVGKYGNGCWCIELPDNVPIRVPGKCH

SEQ ID NO: 327 - protein, 64 aa, Buthus martensii
VRDAYIAKPENCVYHCAGNEGCNKLCTDNGAESGYCQWGGRYGNACWCIKLPDDVPIRVPGKCH

SEQ ID NO: 328 - protein, 66 aa, Buthus martensii
VRDGYIALPHNCAYGCLNNEYCNNLCTKDGAKIGYCNIVGKYGNACWCIQLPDNVPIRVPGRCHPA

SEQ ID NO: 329 - protein, 72 aa, Buthus martensii
KKNGYAVDSSGKVAECLFNNYCNNECTKVYYADKGYCCLLKCYCFGLADDKPVLDIWDSTKNYCDVQIIDLS

SEQ ID NO: 330 - protein, 66 aa, buthus occitanus mardochei
GRDGYIAQPENCVYHCFPGSSGCDTLCKEKGATSGHCGFLPGSGVACWCDNLPNKVPIVVGGEKCH

SEQ ID NO: 331 - protein, 65 aa, buthus occitanus mardochei
GRDAYIAQPENCVYECAKNSYCNDLCTKNGAKSGYCQWLGKYGNACWCEDLPDNVPIRIPGKCHF

SEQ ID NO: 332 - protein, 64 aa, Hottentotta judaica
GRDAYALDNLNCAYTCGSKSYCNTECTKNGAVSGYCQWLGKYGNACWCINLPDKVPIRIPGACR

SEQ ID NO: 333 - protein, 76 aa, Hottentotta judaicus
KKNGYPLDRNGKTTECSGVNAIAPHYCNSECTKVYYAESGYCCWGACYCFGLEDDKPIGPMKDITKKYCDVQIIPS

SEQ ID NO: 334 - protein, 61 aa, Hottentotta judaicus
DGYIRKKDGCKVSCIIGNEGCRKECVAHGGSFGYCWTWGLACWCENLPDAVTWKSSTNTCG

SEQ ID NO: 335 - protein, 64 aa, Leiurus quinquestriatus hebraeus
VRDAYIAKNYNCVYECFRDAYCNELCTKNGASSGYCQWAGKYGNACWCYALPDNVPIRVPGKCR

SEQ ID NO: 336 - protein, 63 aa, Leiurus quinquestriatus hebraeus
DNGYLLNKATGCKVWCVINNASCNSECKLRRGNYGYCYFWKLACYCEGAPKSELWAYATNKCN

SEQ ID NO: 337 - protein, 61 aa, Leiurus quinquestriatus hebraeus
DGYIKRRDGCKVACLIGNEGCDKECKAYGGSYGYCWTWGLACWCEGLPDDKTWKSETNTCG

SEQ ID NO: 338 - protein, 60 aa, Leiurus quinquestriatus hebraeus
DGYIRGDGCKVSCVINHVFCDNECKAAGGSYGYCWAWGLACWCEGLPAEREWKYETNTCG

SEQ ID NO: 339 - protein, 70 aa, Leiurus quinquestriatus hebraeus
KKNGFAVDSNGKAPECFFDHYCNSECTKVYYAEKGYCCLLSCYCFGLNDDKKVLEISDTTKKYCDFTIIN

SEQ ID NO: 340 - protein, 67 aa, Leiurus quinquestriatus hebraeus
VRDGYIAQPENCVYHCFPGSSGCDTLCKEKGGTSGHCGFKVGHGLACWCNALPDNVGIIVEGEKCHS

SEQ ID NO: 341 - protein, 64 aa, Leiurus quinquestriatus hebraeus
VRDGYIAQPENCVYHCIPDCDTLCKDNGGTGGHCGFKLGHGIACWCNALPDNVGIIVDGVKCHK

SEQ ID NO: 342 - protein, 66 aa, Leiurus quinquestriatus hebraeus
VRDGYIAKPENCAHHCFPGSSGCDTLCKENGGTGGHCGFKVGHGTACWCNALPDKVGIIVDGVKCH

SEQ ID NO: 343 - protein, 70 aa, Leiurus quinquestriatus quinquestriatus
KKNGYAVDSSGKAPECLLSNYCYNECTKVHYADKGYCCLLSCYCVGLSDDKKVLEISDARKKYCDFVTIN

SEQ ID NO: 344 - protein, 61 aa, Leiurus quinquestriatus quinquestriatus
DGYIRKRDGCKLSCLFGNEGCNKECKSYGGSYGYCWTWGLACWCEGLPDEKTWKSETNTCG

SEQ ID NO: 345 - protein, 64 aa, Leiurus quinquestriatus quinquestriatus
VRDAYIAKNYNCVYECFRDSYCNDLCTKNGASSGYCQWAGKYGNACWCYALPDNVPIRVPGKCH

SEQ ID NO: 346 - protein, 65 aa, Odonthobuthus doriae
GVRDAYIADDKNCVYTCASNGYCNTECTKNGAESGYCQWIGRYGNACWCIKLPDEVPIRIPGKCR

SEQ ID NO: 347 - protein, 61 aa, Tityus serrulatus
KEGYLMDHEGCKLSCFIRPSGYCGRECGIKKGSSGYCAWPACYCYGLPNWVKVWDRATNKC

SEQ ID NO: 348 - protein, 64 aa, Tityus zulianus
KDGYLVGNDGCKYSCFTRPGTYCANECSRVKGKDGYCYAWMACYCYSMPNWVKTWDRATNRCGR

SEQ ID NO: 349 - protein, 47 aa, Anemonia erythraea
GAPCLCANSGPNTRGNDLNGIVWVFGCPSGWHDCHGRAMVGYCCQED

SEQ ID NO: 350 - protein, 42 aa, Anthopleura elegantissima
GTTCYCGKTIGIYWFGTKTCPSNRGYTGSCGYFLGICCYPVD

SEQ ID NO: 351 - protein, 42 aa, Anthopleura elegantissima
GTACSCGNSKGIYWFYRPSCPTDRGYTGSCRYFLGTCCTPAD

SEQ ID NO: 352 - protein, 43 aa, Anemonia sulcata
AAPCFCSGKPGRGDLWILRGTCPGGYGYTSNCYKWPNICCYPH

SEQ ID NO: 353 - protein, 43 aa, Anemonia sulcata
AAPCFCPGKPDRGDLWILRGTCPGGYGYTSNCYKWPNICCYPH

SEQ ID NO: 354 - protein, 48 aa, Bunodosoma granulifera
GASCRCDSDGPTSRGNTLTGTLWLIGRCPSGWHNCRGSGPFIGYCCKQ

SEQ ID NO: 355 - protein, 48 aa, Bunodosoma granulifera
GASCRCDSDGPTSRGDTLTGTLWLIGRCPSGWHNCRGSGPFIGYCCKQ

SEQ ID NO: 356 - protein, 47 aa, Anthopleura elegantissima
GIACLCDSDGPSVRGNTLSGTYWLAGCPSGWHNCKSSGQLIGACCKQ

SEQ ID NO: 357 - protein, 47 aa, Anthopleura elegantissima
GVPCLCDSDGPNVRGNTLSGTYWLAGCPSGWHNCKSSGPLIGACCKQ

SEQ ID NO: 358 - protein, 46 aa, Anemonia sulcata
GAACLCKSDGPNTRGNSMSGTIWVFGCPSGWNNCEGRAIIGYCCKQ

SEQ ID NO: 359 - protein, 47 aa, Anthopleura fuscoviridis
GVACLCDSDGPNVRGNTLSGTIWLAGCPSGWHNCKAHGPTIGWCCKQ

SEQ ID NO: 360 - protein, 48 aa, Heteractis crispa
ASCKCDDDGPDVRSATFTGTVDFAYCNAGWEKCLAVYTPVASCCRKKK

SEQ ID NO: 361 - protein, 48 aa, Stoichactis helianthus
AACKCDDEGPDIRTAPLTGTVDLGSCNAGWEKCASYYTIIADCCRKKK

SEQ ID NO: 362 - protein, 47 aa, Anthopleura elegantissima
GVPCLCDSDGPSVRGNTLSGILWLAGCPSGWHNCKAHGPTIGWCCKQ

SEQ ID NO: 363 - protein, 47 aa, Anthopleura elegantissima
GVPCLCDSDGPNVRGNTLSGILWLAGCPSGWHNCKAHGPTIGWCCKQ

SEQ ID NO: 364 - protein, 47 aa, Anemonia sulcata
GVPCLCDSDGPSVRGNTLSGIIWLAGCPSGWHNCKKHGPTIGWCCKQ

SEQ ID NO: 365 - protein, 48 aa, Anthopleura fuscoviridis
GGVPCLCDSDGPSVRGNTLSGIIWLAGCPSGWHNCKAHGPTIGWCCKQ

SEQ ID NO: 366 - protein, 48 aa, Heteractis crispa
GTCKCDDDGPDVRTATFTGSTEFANCNESWEKCLAVYTPVASCCRKKK

SEQ ID NO: 367 - protein, 48 aa, Radianthus paumotensis
ASCKCDDDGPDVRSATFTGTVDFWNCNEGWEKCTAVYTPVASCCRKKK

SEQ ID NO: 368 - protein, 31 aa, Parasicyonis actinostoloides
AGGKSTCCPCAMCKYTAGCPWGQCAHHCGCS

SEQ ID NO: 369 - protein, 48 aa, Heteractis crispa
GNCKCDDEGPYVRTAPLTGYVDLGYCNEGWEKCASYYSPIAECCRKKK

SEQ ID NO: 370 - protein, 48 aa, Radianthus paumotensis
GNCKCDDEGPNVRTAPLTGYVDLGYCNEGWEKCASYYSPIAECCRKKK

SEQ ID NO: 371 - protein, 48 aa, Heteractis crispa
GNCKCDDEGPNVRTAPLTGYVDLGYCNEGWDKCASYYSPIAECCRKKK

SEQ ID NO: 372 - protein, 46 aa, Anemonia sulcata
GVPCLCDSDGPSVRGNTLSGILWLAGCPSGWHNCKKHKPTIGWCCK

SEQ ID NO: 373 - protein, 47 aa, Heteractis crispa
GNCKCDDEGPNVRTAPLTGYVDLGYCNEGWEKCASYYSPIAECCRKK

SEQ ID NO: 374 - protein, 49 aa, Anthopleura xanthogrammica
GVSCLCDSDGPSVRGNTLSGTLWLYPSGCPSGWHNCKAHGPTIGWCCKQ

SEQ ID NO: 375 - protein, 49 aa, Anthopleura xanthogrammica
GVPCLCDSDGPRPRGNTLSGILWFYPSGCPSGWHNCKAHGPNIGWCCKK

SEQ ID NO: 376 - protein, 47 aa, Anthopleura elegantissima; identical to SEQ ID NO: 362

SEQ ID NO: 377 - protein, 36 aa, Actinia equina
GCKDNFSANTCKHVKANNNCGSQKYATNCAKTCGKC

SEQ ID NO: 378 - protein, 37 aa, Bunodosoma granulifera
VCRDWFKETACRHAKSLGNCRTSQKYRANCAKTCELC

SEQ ID NO: 379 - protein, 48 aa, Bunodosoma caissarum
GVACRCDSDGPTSRGNTLTGTLWLTGGCPSGWHNCRGSGPFIGYCCKK

SEQ ID NO: 380 - protein, 41 aa, Bunodosoma caissarum
GLPCDCHGHTGTYWLNYYSKCPKGYGYTGRCRYLVGSCCYK

SEQ ID NO: 381 - protein, 48 aa, Bunodosoma cangicum
GVACRCDSDGPTVRGNSLSGTLWLTGGCPSGWHNCRGSGPFIGYCCKK

SEQ ID NO: 382 - protein, 35 aa, Stoichactis helianthus
RSCIDTIPKSRCTAFQCKHSMKYRLSFCRKTCGTC

SEQ ID NO: 383 - protein, 47 aa, Anthopleura xanthogrammica
GVPCLCDSDGPNVRGNTLSGTYWLAGCPSGWHNCKSSGPNIGWCCKK

SEQ ID NO: 384 - protein, 47 aa, Anthopleura xanthogrammica
GVACLCDADGPSVSGNTLSGILWLAGCPSGWHNCKAHGPTIGWCCKK

SEQ ID NO: 385 - protein, 47 aa, Anthopleura xanthogrammica
GAACFCDSDGPSVSGNTLSGILWLAGCPSGWHNCKAHGPNIGWCCKK

SEQ ID NO: 386 - protein, 47 aa, Anthopleura xanthogrammica
GVPCLCDSDGPSVRGNSLSGIIWLFGCPSGWHNCRDHGPTIGWCCKK

SEQ ID NO: 387 - protein, 49 aa, Anthopleura xanthogrammica
GVSCLCDSDGPSVRGNTLSGILWFYPSGCPSGWHNCKAHGPTIGWCCKQ

SEQ ID NO: 388 - protein, 48 aa, Bunodosoma cangicum
GVACRCDSDGPTVRGDSLSGTLWLTGGCPSGWHNCRGSGPFIGYCCKK

SEQ ID NO: 389 - protein, 48 aa, Bunodosoma cangicum
GVACRCDSDGPTVHGDSLSGTLWLTGGCPSGWHNCRGSGPFIGYCCKK

SEQ ID NO: 390 - protein, 27 aa, Artificial sequence
  Av3a
KSCCPCYWGGCPWGQNCYPEGCSGPKV

SEQ ID NO: 391 - protein, 26 aa, Artificial sequence
  Av3a-deltaC
RSCCPCYWGGCPWGQNCYPEGCSGPK

SEQ ID NO: 392 - protein, 27 aa, Conus amadis
  misc_feature (27)..(27): Xaa can be any naturally occurring amino acid
CKQAGESCDIFSQNCCVGTCAFICIEX

SEQ ID NO: 393 - protein, 28 aa, Conus catus
  misc_feature (28)..(28): Xaa can be any naturally occurring amino acid
CKSKGAKCSKLMYDCCSGSCSGTVGRCX

SEQ ID NO: 394 - protein, 33 aa, Conus ermineus
  misc_feature (6)..(6): Xaa can be any naturally occurring amino acid
  misc_feature (33)..(33): Xaa can be any naturally occurring amino acid
DDCIKXYGFCSLPILKNGLCCSGACVGVCADLX

SEQ ID NO: 395 - protein, 33 aa, Conus ermineus; identical to SEQ ID NO: 394
  misc_feature (6)..(6): Xaa can be any naturally occurring amino acid
  misc_feature (33)..(33): Xaa can be any naturally occurring amino acid

SEQ ID NO: 396 - protein, 34 aa, Conus geographus
ACSGRGSRCPPQCCMGLRCGRGNPQKCIGAHEDV

SEQ ID NO: 397 - protein, 23 aa, Conus geographus
  misc_feature (23)..(23): Xaa can be any naturally occurring amino acid
RDCCTPPRKCKDRRCKPMKCCAX

SEQ ID NO: 398 - protein, 28 aa, Conus geographus
  misc_feature (28)..(28): Xaa can be any naturally occurring amino acid
CKSPGSSCSPTSYNCCRSCNPYTKRCYX

SEQ ID NO: 399 - protein, 23 aa, Conus geographus
  misc_feature (23)..(23): Xaa can be any naturally occurring amino acid
RDCCTPPKKCKDRQCKPQRCCAX

SEQ ID NO: 400 - protein, 23 aa, Conus geographus
  misc_feature (23)..(23): Xaa can be any naturally occurring amino acid
RDCCTPPKKCKDRQCKPQRCCAX

SEQ ID NO: 401 - protein, 28 aa, Conus geographus
  misc_feature (28)..(28): Xaa can be any naturally occurring amino acid
CKSPGSSCSPTSYNCCRSCNPYTKRCYX

SEQ ID NO: 402 - protein, 28 aa, Conus geographus
  misc_feature (28)..(28): Xaa can be any naturally occurring amino acid
CKSPGSSCSPTSYNCCRSCNPYTKRCYX

SEQ ID NO: 403 - protein, 23 aa, Conus geographus
  misc_feature (23)..(23): Xaa can be any naturally occurring amino acid
RDCCTPPKKCKDRQCKPQRCCAX

SEQ ID NO: 404 - protein, 23 aa, Conus geographus
  misc_feature (23)..(23): Xaa can be any naturally occurring amino acid
RDCCTPPKKCKDRQCKPQRCCAX

SEQ ID NO: 405 - protein, 28 aa, Conus gloriamaris
  misc_feature (28)..(28): Xaa can be any naturally occurring amino acid
SCNNSCQSHSDCASHCICTFRGCGAVNX

SEQ ID NO: 406 - protein, 17 aa, Conus kinoshitai
  misc_feature (17)..(17): Xaa can be any naturally occurring amino acid
CCNCSSKWCRDHSRCCX

SEQ ID NO: 407 - protein, 26 aa, Conus magus
  misc_feature (26)..(26): Xaa can be any naturally occurring amino acid
CKGKGAKCSRLMYDCCTGSCRSGKCX

SEQ ID NO: 408 - protein, 26 aa, Conus magus
  misc_feature (26)..(26): Xaa can be any naturally occurring amino acid
CKGKGAKCSRLMYDCCTGSCRSGKCX

SEQ ID NO: 409 - protein, 26 aa, Conus magus
  misc_feature (26)..(26): Xaa can be any naturally occurring amino acid
CKGKGAKCSRLMYDCCTGSCRSGKCX

SEQ ID NO: 410 - protein, 26 aa, Conus magus
  misc_feature (26)..(26): Xaa can be any naturally occurring amino acid
CKGKGAKCSRLMYDCCTGSCRSGKCX

SEQ ID NO: 411 - protein, 26 aa, Conus magus
  misc_feature (26)..(26): Xaa can be any naturally occurring amino acid
CKGKGAKCSRLMYDCCTGSCRSGKCX

SEQ ID NO: 412 - protein, 31 aa, Conus marmoreus
ACSKKWEYCIVPILGFVYCCPGLICGPFVCV

SEQ ID NO: 413 - protein, 15 aa, Conus marmoreus
DWEYHAHPKPNSFWT

SEQ ID NO: 414 - protein, 16 aa, Conus marmoreus
CCAPSACRLGCRPCCR

SEQ ID NO: 415 - protein, 16 aa, Conus marmoreus
CCAPSACRLGCRPCCR

SEQ ID NO: 416 - protein, 28 aa, Conus purpurascens
  misc_feature (28)..(28): Xaa can be any naturally occurring amino acid
CRIPNQKCFQHLDDCCSRKCNRFNKCVX

SEQ ID NO: 417 - protein, 25 aa, Conus purpurascens
  misc_feature (25)..(25): Xaa can be any naturally occurring amino acid
HPPCCLYGKCRRYPGCSSASCCQRX

SEQ ID NO: 418 - protein, 28 aa, Conus purpurascens
  misc_feature (28)..(28): Xaa can be any naturally occurring amino acid
CRIPNQKCFQHLDDCCSRKCNRFNKCVX

SEQ ID NO: 419 - protein, 25 aa, Conus purpurascens
  misc_feature (25)..(25): Xaa can be any naturally occurring amino acid
HPPCCLYGKCRRYPGCSSASCCQRX

SEQ ID NO: 420 - protein, 25 aa, Conus purpurascens
  misc_feature (25)..(25): Xaa can be any naturally occurring amino acid
GPPCCLYGSCRPFPGCYNALCCRKX

SEQ ID NO: 421 - protein, 23 aa, Conus purpurascens
  misc_feature (23)..(23): Xaa can be any naturally occurring amino acid
QRLCCGFPKSCRSRQCKPHRCCX

SEQ ID NO: 422 - protein, 22 aa, Conus stercusmuscarum
QRCCNGRRGCSSRWCRDHSRCC

SEQ ID NO: 423 - protein, 26 aa, Conus striatus
  misc_feature (26)..(26): Xaa can be any naturally occurring amino acid
CKAAGKPCSRIAYNCCTGSCRSGKCX

SEQ ID NO: 424 - protein, 27 aa, Conus striatus
  misc_feature (27)..(27): Xaa can be any naturally occurring amino acid
CKLKGQSCRKTSYDCCSGSCGRSGKCX

SEQ ID NO: 425 - protein, 21 aa, Conus striatus
  misc_feature (21)..(21): Xaa can be any naturally occurring amino acid
QNCCNGGCSSKWCRDHARCCX

SEQ ID NO: 426 - protein, 26 aa, Conus textile
CKQADEPCDVFSLDCCTGICLGVCMW

SEQ ID NO: 427 - protein, 27 aa, Conus textile
WCKQSGEMCNLLDQNCCDGYCIVLVCT

SEQ ID NO: 428 - protein, 30 aa, Conus tulipa
SCSGRDSRCPPVCCMGLMCSRGKCVSIYGE

SEQ ID NO: 429 - protein, 23 aa, Conus tulipa
  misc_feature (23)..(23): Xaa can be any naturally occurring amino acid
RHGCCKGPKGCSSRECRPQHCCX

SEQ ID NO: 430 - protein, 26 aa, Artificial sequence
  Av3bM1
KSACPCYWGGAPWGQNCYPEGCSGPK

SEQ ID NO: 431 - protein, 26 aa, Artificial sequence
  Av3bM2
KSPCPCYWGGAPWGQNCYPEGCSGPK

SEQ ID NO: 432 - protein, 26 aa, Artificial sequence
  Av3bM3
KSNCPCYWGGTPWGQNCYPEGCSGPK

SEQ ID NO: 433 - protein, 26 aa, Artificial sequence
  Av3bM4
PSCCPCYWPNCPWGQNCYPEGCSGPK

SEQ ID NO: 434 - protein, 26 aa, Artificial sequence
  Av3bM5
KSCCPCYWPNCPWGQNCYPEGCSGPK

SEQ ID NO: 435 - protein, 26 aa, Artificial sequence
  Av3bM6
TSCCPCYWPYCPWGQNCYPEGCSGPT

SEQ ID NO: 436 - protein, 26 aa, Artificial sequence
  Av3bM7
TSCCPCYWPYCPWGQNCYPEGCSGPR

SEQ ID NO: 437 - protein, 26 aa, Artificial sequence
  Av3bM8
TSCCPCYWGGCPWGQNCYPEGCSGPT

SEQ ID NO: 438 - protein, 26 aa, Artificial sequence
  Av3bM9
TSCCPCYWGGCPWGTTCYPNGCDGPT

SEQ ID NO: 439 - protein, 26 aa, Artificial sequence
  Av3bM10
TSCCPCYWGGCPWGQTCYPNGCDGPT

SEQ ID NO: 440 - protein, 26 aa, Artificial sequence
  Av3bM11
TSCCPCYWGGCPWGQTCYPNGCDGPR

SEQ ID NO: 441 - protein, 26 aa, Artificial sequence
  Av3bM12
TSCCPCYWGGCPWGTTCYPNGCDGST

SEQ ID NO: 442 - protein, 26 aa, Artificial sequence
  Av3bM13
TSCCPCYWGGCPWGQTCYPNGCDGST

SEQ ID NO: 443 - protein, 26 aa, Artificial sequence
  Av3bM14
TSCCPCYWGGCPWGQTCYPNGCDGSE

SEQ ID NO: 444 - protein, 26 aa, Artificial sequence
  Av3bM15
TSCCPCYWGGCPWGTTCYPNGCDGSR

SEQ ID NO: 445 - protein, 26 aa, Artificial sequence
  Av3bM16
TSCCPCYWGGCPWGQTCYPNGCDGSR

SEQ ID NO: 446 - protein, 26 aa, Artificial sequence
  Av3bM17
KSCAPCYWGGAPWGQNCYPEGCSGPK

SEQ ID NO: 447 - protein, 26 aa, Artificial sequence
  Av3bM18
KSACPCYWGGCPWGQNAYPEGCSGPK

SEQ ID NO: 448 - protein, 26 aa, Artificial sequence
  Av3bM19
KSCCPCYWGGCPWGQDCYPDGCDGPK

SEQ ID NO: 449 - protein, 26 aa, Artificial sequence
  Av3bM20
KSCCPCYWGGCPWGTTCYPNGCDGPK

SEQ ID NO: 450 - protein, 26 aa, Artificial sequence
  Av3bM21
KSCCPCYWGGCPWGTNCYPEGCSGPK

SEQ ID NO: 451 - protein, 26 aa, Artificial sequence
  Av3bM22
KSCCPCYWGGCPWGQTCYPEGCSGPK

SEQ ID NO: 452 - protein, 26 aa, Artificial sequence
  Av3bM23
KSCCPCYWGGCPWGQNCYPNGCSGPK

SEQ ID NO: 453 - protein, 26 aa, Artificial sequence
  Av3bM24
KSCCPCYWGGCPWGQNCYPEGCDGPK

SEQ ID NO: 454 - protein, 26 aa, Artificial sequence
  Av3bM25
KSCCPCYWPGCPWGQNCYPEGCSGPK

SEQ ID NO: 455 - protein, 26 aa, Artificial sequence
  Av3bM26
KSCCPCYWPPCPWGQNCYPEGCSGPK

SEQ ID NO: 456 - protein, 26 aa, Artificial sequence
  Av3bM27
KSCCPCYWAGCPWGQNCYPEGCSGPK

SEQ ID NO: 457 - protein, 26 aa, Artificial sequence
  Av3bM28
HSCCPCYWGGCPWGQNCYPEGCSGPK

SEQ ID NO: 458 - protein, 26 aa, Artificial sequence
  Av3bM29
QSCCPCYWGGCPWGQNCYPEGCSGPK

SEQ ID NO: 459 - protein, 26 aa, Artificial sequence
  Av3bM30
QSCCPCYWGGCPWGQNCYPEGCSGPH

SEQ ID NO: 460 - protein, 26 aa, Artificial sequence
  Av3bM31
TSCCPCYWGGCPWGQNCYPEGCSGPK

SEQ ID NO: 461 - protein, 26 aa, Artificial sequence
  Av3bM32
SSCCPCYWGGCPWGQNCYPEGCSGPK

SEQ ID NO: 462 - protein, 26 aa, Artificial sequence
  Av3bM33
SSCCPCYWGGCPWGQNCYPEGCSGPT

SEQ ID NO: 463 - protein, 26 aa, Artificial sequence
  Av3M125
KSCCPCYWPGCPWGQNCYPEGCRGPD

SEQ ID NO: 464 - protein, 26 aa, Artificial sequence
  Av3M103
KSCCPCYWGGCPWGQNCYPEGCSGPG

SEQ ID NO: 465 - protein, 26 aa, Artificial sequence
  Av3M169
KSCCPCYWGGCPWGQNCYPEGCTGPG

SEQ ID NO: 466 - protein, 26 aa, Artificial sequence
  Av3M170
KSCCPCYWGGCPWGQNCYPEGCGGPG

SEQ ID NO: 467 - protein, 27 aa, Artificial sequence
  Av3M148
KSCCPCYWGGCPWGQNCYPEGCSGPKG

SEQ ID NO: 468 - protein, 28 aa, Artificial sequence
  Av3M165
KSCCPCYWGGCPWGQNCYPEGCSGPKVG

SEQ ID NO: 469 - protein, 26 aa, Artificial sequence
  Av3bM97
KSCCPCYWGGCPWGQNCYPEGCSGPA

SEQ ID NO: 470 - protein, 26 aa, Artificial sequence
  Av3bM98
KSCCPCYWGGCPWGQNCYPEGCSGPR

SEQ ID NO: 471 - protein, 26 aa, Artificial sequence
  Av3bM99
KSCCPCYWGGCPWGQNCYPEGCSGPN

SEQ ID NO: 472 - protein, 26 aa, Artificial sequence
  Av3bM100
KSCCPCYWGGCPWGQNCYPEGCSGPD

SEQ ID NO: 473 - protein, 26 aa, Artificial sequence
  Av3bM101
KSCCPCYWGGCPWGQNCYPEGCSGPE

SEQ ID NO: 474 - protein, 26 aa, Artificial sequence
  Av3bM102
KSCCPCYWGGCPWGQNCYPEGCSGPQ

SEQ ID NO: 475 - protein, 26 aa, Artificial sequence
  Av3bM104
KSCCPCYWGGCPWGQNCYPEGCSGPH

SEQ ID NO: 476 - protein, 26 aa, Artificial sequence
  Av3bM111
KSCCPCYWGGCPWGQNCYPEGCSGPT

SEQ ID NO: 477 - protein, 26 aa, Artificial sequence
  Av3bM146
KSCCPCYWGGCPWGQNCYPEGCSGGV

SEQ ID NO: 478 - protein, 26 aa, Artificial sequence
  Av3bM147
KSCCPCYWGGCPWGQNCYPEGCSGRV

SEQ ID NO: 479 - protein, 27 aa, Artificial sequence
  Av3bM148
KSCCPCYWGGCPWGQNCYPEGCSGPKG

SEQ ID NO: 480 - protein, 26 aa, Artificial sequence
  Av3bM156
KSCCPCYWGGCPWGQNCYPEGCDGPA

SEQ ID NO: 481 - protein, 26 aa, Artificial sequence
  Av3bM157
KSCCPCYWGGCPWGQNCYPEGCDGPT

SEQ ID NO: 482 - protein, 28 aa, Artificial sequence
  Av3bM168
KSCCPCYWGGCPWGQNCYPEGCSGPKVI

SEQ ID NO: 483 - protein, 26 aa, Artificial sequence
  Av3bM171
KSCCPCYWGGCPWGQNCYPEGCDGPG

SEQ ID NO: 484 - protein, 25 aa, Artificial sequence
  Av3bM172
KSCCPCYWGGCPWGQNCYPEGCDGP

SEQ ID NO: 485 - protein, 26 aa, Artificial sequence
  Av3bM34
ASCCPCYWGGCPWGQNCYPEGCSGPK

SEQ ID NO: 486 - protein, 26 aa, Artificial sequence
  Av3bM35
NSCCPCYWGGCPWGQNCYPEGCSGPK

SEQ ID NO: 487 - protein, 26 aa, Artificial sequence
  Av3bM36
DSCCPCYWGGCPWGQNCYPEGCSGPK

SEQ ID NO: 488 - protein, 26 aa, Artificial sequence
  Av3bM37
ESCCPCYWGGCPWGQNCYPEGCSGPK

SEQ ID NO: 489 - protein, 26 aa, Artificial sequence
  Av3bM38
GSCCPCYWGGCPWGQNCYPEGCSGPK

SEQ ID NO: 490 - protein, 26 aa, Artificial sequence
  Av3bM39
ISCCPCYWGGCPWGQNCYPEGCSGPK

SEQ ID NO: 491 - protein, 26 aa, Artificial sequence
  Av3bM40
LSCCPCYWGGCPWGQNCYPEGCSGPK

SEQ ID NO: 492 - protein, 26 aa, Artificial sequence
  Av3bM41
MSCCPCYWGGCPWGQNCYPEGCSGPK

SEQ ID NO: 493 - protein, 26 aa, Artificial sequence
  Av3bM42
FSCCPCYWGGCPWGQNCYPEGCSGPK

SEQ ID NO: 494 - protein, 26 aa, Artificial sequence
  Av3bM43
PSCCPCYWGGCPWGQNCYPEGCSGPK

SEQ ID NO: 495 - protein, 26 aa, Artificial sequence
  Av3bM44
WSCCPCYWGGCPWGQNCYPEGCSGPK

SEQ ID NO: 496 - protein, 26 aa, Artificial sequence
  Av3bM45
YSCCPCYWGGCPWGQNCYPEGCSGPK

SEQ ID NO: 497 - protein, 26 aa, Artificial sequence
  Av3bM46
VSCCPCYWGGCPWGQNCYPEGCSGPK

SEQ ID NO: 498 - protein, 26 aa, Artificial sequence
  Av3bM47
KSCCPCYWRGCPWGQNCYPEGCSGPK

SEQ ID NO: 499 - protein, 26 aa, Artificial sequence
  Av3bM48
KSCCPCYWNGCPWGQNCYPEGCSGPK

SEQ ID NO: 500 - protein, 26 aa, Artificial sequence
  Av3bM49
KSCCPCYWDGCPWGQNCYPEGCSGPK

SEQ ID NO: 501 - protein, 26 aa, Artificial sequence
  Av3bM50
KSCCPCYWEGCPWGQNCYPEGCSGPK

SEQ ID NO: 502 - protein, 26 aa, Artificial sequence
  Av3bM51
KSCCPCYWQGCPWGQNCYPEGCSGPK

SEQ ID NO: 503 - protein, 26 aa, Artificial sequence
  Av3bM52
KSCCPCYWHGCPWGQNCYPEGCSGPK

SEQ ID NO: 504 - protein, 26 aa, Artificial sequence
  Av3bM53
KSCCPCYWIGCPWGQNCYPEGCSGPK

SEQ ID NO: 505 - protein, 26 aa, Artificial sequence
  Av3bM54
KSCCPCYWLGCPWGQNCYPEGCSGPK

SEQ ID NO: 506 - protein, 26 aa, Artificial sequence
  Av3bM55
KSCCPCYWKGCPWGQNCYPEGCSGPK

SEQ ID NO: 507 - protein, 26 aa, Artificial sequence
  Av3bM56
KSCCPCYWMGCPWGQNCYPEGCSGPK

SEQ ID NO: 508 - protein, 26 aa, Artificial sequence
  Av3bM57
KSCCPCYWFGCPWGQNCYPEGCSGPK

SEQ ID NO: 509 - protein, 26 aa, Artificial sequence
  Av3bM58
KSCCPCYWSGCPWGQNCYPEGCSGPK

SEQ ID NO: 510 - protein, 26 aa, Artificial sequence
  Av3bM59
KSCCPCYWTGCPWGQNCYPEGCSGPK

SEQ ID NO: 511 - protein, 26 aa, Artificial sequence
  Av3bM60
KSCCPCYWWGCPWGQNCYPEGCSGPK

SEQ ID NO: 512 - protein, 26 aa, Artificial sequence
  Av3bM61
KSCCPCYWYGCPWGQNCYPEGCSGPK

SEQ ID NO: 513 - protein, 26 aa, Artificial sequence
  Av3bM62
KSCCPCYWVGCPWGQNCYPEGCSGPK

SEQ ID NO: 514 - protein, 26 aa, Artificial sequence
  Av3bM63
KSCCPCYWGGCPWGQNCYPAGCSGPK

SEQ ID NO: 515 - protein, 26 aa, Artificial sequence
  Av3bM64
KSCCPCYWGGCPWGQNCYPRGCSGPK

SEQ ID NO: 516 - protein, 26 aa, Artificial sequence
  Av3bM65
KSCCPCYWGGCPWGQNCYPDGCSGPK

SEQ ID NO: 517 - protein, 26 aa, Artificial sequence
  Av3bM66
KSCCPCYWGGCPWGQNCYPQGCSGPK

SEQ ID NO: 518 - protein, 26 aa, Artificial sequence
  Av3bM67
KSCCPCYWGGCPWGQNCYPGGCSGPK

SEQ ID NO: 519 - protein, 26 aa, Artificial sequence
  Av3bM68
KSCCPCYWGGCPWGQNCYPHGCSGPK

SEQ ID NO: 520 - protein, 26 aa, Artificial sequence
  Av3bM69
KSCCPCYWGGCPWGQNCYPIGCSGPK

SEQ ID NO: 521 - protein, 26 aa, Artificial sequence
  Av3bM70
KSCCPCYWGGCPWGQNCYPLGCSGPK

SEQ ID NO: 522 - protein, 26 aa, Artificial sequence
  Av3bM71
KSCCPCYWGGCPWGQNCYPKGCSGPK

SEQ ID NO: 523 - protein, 26 aa, Artificial sequence
  Av3bM72
KSCCPCYWGGCPWGQNCYPMGCSGPK

SEQ ID NO: 524 - protein, 26 aa, Artificial sequence
  Av3bM73
KSCCPCYWGGCPWGQNCYPFGCSGPK

SEQ ID NO: 525 - protein, 26 aa, Artificial sequence
  Av3bM74
KSCCPCYWGGCPWGQNCYPPGCSGPK

SEQ ID NO: 526 - protein, 26 aa, Artificial sequence
  Av3bM75
KSCCPCYWGGCPWGQNCYPSGCSGPK

SEQ ID NO: 527 - protein, 26 aa, Artificial sequence
  Av3bM76
KSCCPCYWGGCPWGQNCYPTGCSGPK

SEQ ID NO: 528 - protein, 26 aa, Artificial sequence
  Av3bM77
KSCCPCYWGGCPWGQNCYPWGCSGPK

SEQ ID NO: 529 - protein, 26 aa, Artificial sequence
  Av3bM78
KSCCPCYWGGCPWGQNCYPYGCSGPK

SEQ ID NO: 530 - protein, 26 aa, Artificial sequence
  Av3bM79
KSCCPCYWGGCPWGQNCYPVGCSGPK

SEQ ID NO: 531 - protein, 26 aa, Artificial sequence
  Av3bM80
KSCCPCYWGGCPWGQNCYPEGCAGPK

SEQ ID NO: 532 - protein, 26 aa, Artificial sequence
  Av3bM81
KSCCPCYWGGCPWGQNCYPEGCRGPK

SEQ ID NO: 533 - protein, 26 aa, Artificial sequence
  Av3bM82
KSCCPCYWGGCPWGQNCYPEGCNGPK

SEQ ID NO: 534 - protein, 26 aa, Artificial sequence
  Av3bM83
KSCCPCYWGGCPWGQNCYPEGCEGPK

SEQ ID NO: 535 - protein, 26 aa, Artificial sequence
  Av3bM84
KSCCPCYWGGCPWGQNCYPEGCQGPK

SEQ ID NO: 536 - protein, 26 aa, Artificial sequence
  Av3bM85
KSCCPCYWGGCPWGQNCYPEGCGGPK

SEQ ID NO: 537 - protein, 26 aa, Artificial sequence
  Av3bM86
KSCCPCYWGGCPWGQNCYPEGCHGPK

SEQ ID NO: 538 - protein, 26 aa, Artificial sequence
  Av3bM87
KSCCPCYWGGCPWGQNCYPEGCIGPK

SEQ ID NO: 539 - protein, 26 aa, Artificial sequence
  Av3bM88
KSCCPCYWGGCPWGQNCYPEGCLGPK

SEQ ID NO: 540 - protein, 26 aa, Artificial sequence
  Av3bM89
KSCCPCYWGGCPWGQNCYPEGCKGPK

SEQ ID NO: 541 - protein, 26 aa, Artificial sequence
  Av3bM90
KSCCPCYWGGCPWGQNCYPEGCMGPK

SEQ ID NO: 542 - protein, 26 aa, Artificial sequence
  Av3bM91
KSCCPCYWGGCPWGQNCYPEGCFGPK

SEQ ID NO: 543 - protein, 26 aa, Artificial sequence
  Av3bM92
KSCCPCYWGGCPWGQNCYPEGCPGPK

SEQ ID NO: 544 - protein, 26 aa, Artificial sequence
  Av3bM93
KSCCPCYWGGCPWGQNCYPEGCTGPK

SEQ ID NO: 545 - protein, 26 aa, Artificial sequence
  Av3bM94
KSCCPCYWGGCPWGQNCYPEGCWGPK

SEQ ID NO: 546 - protein, 26 aa, Artificial sequence
  Av3bM95
KSCCPCYWGGCPWGQNCYPEGCYGPK

SEQ ID NO: 547 - protein, 26 aa, Artificial sequence
  Av3bM96
KSCCPCYWGGCPWGQNCYPEGCVGPK

SEQ ID NO: 548 - protein, 26 aa, Artificial sequence
  Av3bM105
KSCCPCYWGGCPWGQNCYPEGCSGPI

SEQ ID NO: 549 - protein, 26 aa, Artificial sequence
  Av3bM106
KSCCPCYWGGCPWGQNCYPEGCSGPL

SEQ ID NO: 550 - protein, 26 aa, Artificial sequence
  Av3bM107
KSCCPCYWGGCPWGQNCYPEGCSGPM

SEQ ID NO: 551 - protein, 26 aa, Artificial sequence
  Av3bM108
KSCCPCYWGGCPWGQNCYPEGCSGPF

SEQ ID NO: 552 - protein, 26 aa, Artificial sequence
  Av3bM109
KSCCPCYWGGCPWGQNCYPEGCSGPP

SEQ ID NO: 553 - protein, 26 aa, Artificial sequence
  Av3bM110
KSCCPCYWGGCPWGQNCYPEGCSGPS

SEQ ID NO: 554 - protein, 26 aa, Artificial sequence
  Av3bM112
KSCCPCYWGGCPWGQNCYPEGCSGPW

SEQ ID NO: 555 - protein, 26 aa, Artificial sequence
  Av3bM113
KSCCPCYWGGCPWGQNCYPEGCSGPY

SEQ ID NO: 556 - protein, 26 aa, Artificial sequence
  Av3bM114
KSCCPCYWGGCPWGQNCYPEGCSGPV

SEQ ID NO: 557 - protein, 26 aa, Artificial sequence
  Av3bM115
HSCCPCYWPGCPWGQNCYPDGCDGPK

SEQ ID NO: 558 - protein, 26 aa, Artificial sequence
  Av3bM116
KSCCPCYWPGCPWGQNCYPNGCDGPR

SEQ ID NO: 559 - protein, 26 aa, Artificial sequence
  Av3bM117
KSCCPCYWPGCPWGQNCYPDGCDGPR

SEQ ID NO: 560 - protein, 26 aa, Artificial sequence
  Av3bM118
KSCCPCYWPGCPWGQNCYPNGCDGPT

SEQ ID NO: 561 - protein, 26 aa, Artificial sequence
  Av3bM119
KSCCPCYWPGCPWGQNCYPNGCRGPT

SEQ ID NO: 562 - protein, 26 aa, Artificial sequence
  Av3bM120
KSCCPCYWPGCPWGQNCYPNGCRGPR

SEQ ID NO: 563 - protein, 26 aa, Artificial sequence
  Av3bM121
KSCCPCYWGGCPWGQNCYPEGCSGPD

SEQ ID NO: 564 - protein, 26 aa, Artificial sequence
  Av3bM122
KSCCPCYWGGCPWGQNCYPEGCSGPE

SEQ ID NO: 565 - protein, 26 aa, Artificial sequence
  Av3bM123
KSCCPCYWPGCPWGQNCYPEGCSGPD

SEQ ID NO: 566 - protein, 26 aa, Artificial sequence
  Av3bM124
KSCCPCYWPGCPWGQNCYPEGCSGPE

SEQ ID NO: 567 - protein, 26 aa, Artificial sequence
  Av3bM125
KSCCPCYWPGCPWGQNCYPEGCRGPD

SEQ ID NO: 568 - protein, 26 aa, Artificial sequence
  Av3bM126
KSCCPCYWPGCPWGQNCYPEGCRGPE

SEQ ID NO: 569 - protein, 27 aa, Artificial sequence
  Av3bM127
GSCCPCGDGGCQTGQRCFPEGCDGPKV

SEQ ID NO: 570 - protein, 26 aa, Artificial sequence
  Av3bM128
GSCCPCGDGGCQTGQRCFPEGCDGPK

SEQ ID NO: 571 - protein, 26 aa, Artificial sequence
  Av3bM129
GSCCPCHDGGCWSGQRCYPEGCDGPK

SEQ ID NO: 572 - protein, 26 aa, Artificial sequence
  Av3bM130
GSCCPCGGGGCPHGQRCYPEGCDGPK

SEQ ID NO: 573 - protein, 26 aa, Artificial sequence
  Av3bM131
GSCCPCGDGGCQWGQRCYPEGCDGPK

SEQ ID NO: 574 - protein, 26 aa, Artificial sequence
  Av3bM132
HSCCPCWWGGCIWGQRCYPEGCSGPK

SEQ ID NO: 575 - protein, 26 aa, Artificial sequence
  Av3bM133
HSCCPCGDGGCPNGQRCYPEGCDGPK

SEQ ID NO: 576 - protein, 26 aa, Artificial sequence
  Av3bM134
HSCCPCFDGGCPFGQRCFPEGCDGPK

SEQ ID NO: 577 - protein, 26 aa, Artificial sequence
  Av3bM135
HSCCPCGAGGCPVGQRCYPEGCDGPK

SEQ ID NO: 578 - protein, 26 aa, Artificial sequence
  Av3bM136
QSCCPCYWGGCHHGQDCGPEGCSGPK

SEQ ID NO: 579 - protein, 26 aa, Artificial sequence
  Av3bM137
KSCCPCWWGGCDWGQDCGPEGCSGPK

SEQ ID NO: 580 - protein, 26 aa, Artificial sequence
  Av3bM138
KSCCPCYWGGCHTGQDCGPEGCSGPK

SEQ ID NO: 581 - protein, 26 aa, Artificial sequence
  Av3bM143
HSCCPCYWGGCPWGQNCYPEGCDGPK

SEQ ID NO: 582 - protein, 27 aa, Artificial sequence
  Av3bM144
KPCCPCYWGGCPWGQNCYPEGCSGPKV

SEQ ID NO: 583 - protein, 27 aa, Artificial sequence
  Av3bM145
KSCCPCYWGGCPWGQNCYPEGCSGMKV

SEQ ID NO: 584 - protein, 27 aa, Artificial sequence
  Av3bM149
KSCCPCYWGGCPWGQNCYPEGCSGPKF

SEQ ID NO: 585 - protein, 27 aa, Artificial sequence
  Av3bM150
KSCCPCYWGGCPWGQNCYPEGCSGPKI

SEQ ID NO: 586 - protein, 26 aa, Artificial sequence
  Av3bM151
VSCCPCYWGGCPWGQNCYPEGCDGPK

SEQ ID NO: 587 - protein, 26 aa, Artificial sequence
  Av3bM152
ISCCPCYWGGCPWGQNCYPEGCDGPK

SEQ ID NO: 588 - protein, 26 aa, Artificial sequence
  Av3bM153
LSCCPCYWGGCPWGQNCYPEGCDGPK

SEQ ID NO: 589 - protein, 26 aa, Artificial sequence
  Av3bM154
KSCCPCYWQGCPWGQNCYPEGCDGPK

SEQ ID NO: 590 - protein, 26 aa, Artificial sequence
  Av3bM155
KSCCPCYWPGCPWGQNCYPEGCDGPK

SEQ ID NO: 591 - protein, 26 aa, Artificial sequence
  Av3bM158
VSCCPCYWPGCPWGQNCYPEGCRGPD

SEQ ID NO: 592 - protein, 26 aa, Artificial sequence
  Av3bM159
ISCCPCYWPGCPWGQNCYPEGCRGPD

SEQ ID NO: 593 - protein, 26 aa, Artificial sequence
  Av3bM160
LSCCPCYWPGCPWGQNCYPEGCRGPD

SEQ ID NO: 594 - protein, 26 aa, Artificial sequence
  Av3bM161
VSCCPCYWPGCPWGQNCYPEGCTGPT

SEQ ID NO: 595 - protein, 26 aa, Artificial sequence
  Av3bM162
VSCCPCYWPGCPWGQNCYPEGCTGPK

SEQ ID NO: 596 - protein, 25 aa, Artificial sequence
  Av3bM163
KSCCPCYWGGCPWGQNCYPEGCSGP

SEQ ID NO: 597 - protein, 24 aa, Artificial sequence
  Av3bM164
KSCCPCYWGGCPWGQNCYPEGCSG

SEQ ID NO: 598 - protein, 28 aa, Artificial sequence
  Av3bM166
KSCCPCYWGGCPWGQNCYPEGCSGPKVQ

SEQ ID NO: 599 - protein, 28 aa, Artificial sequence
  Av3bM167
KSCCPCYWGGCPWGQNCYPEGCSGPKVD

SEQ ID NO: 600 - protein, 94 aa, Diguetia canities; identical to SEQ ID NO: 55

SEQ ID NO: 601 - protein, 56 aa, Diguetia canities
AKDGDVEGPAGCKKYDVECDSGECCQKQYLWYKWRPLDCRCLKSGFFSSKCVCRDV

SEQ ID NO: 602 - protein, 56 aa, Artificial sequence
  C41T, C51A
AKDGDVEGPAGCKKYDVECDSGECCQKQYLWYKWRPLDCRTLKSGFFSSKAVCRDV

SEQ ID NO: 603 - protein, 56 aa, Artificial sequence
  C41A, C51A (A/A)
AKDGDVEGPAGCKKYDVECDSGECCQKQYLWYKWRPLDCRALKSGFFSSKAVCRDV

SEQ ID NO: 604 - protein, 56 aa, Artificial sequence
  C41S, C51A (S/A)
AKDGDVEGPAGCKKYDVECDSGECCQKQYLWYKWRPLDCRSLKSGFFSSKAVCRDV

SEQ ID NO: 605 - protein, 56 aa, Artificial sequence
  C41V, C51A (V/A)
AKDGDVEGPAGCKKYDVECDSGECCQKQYLWYKWRPLDCRVLKSGFFSSKAVCRDV

SEQ ID NO: 606 - protein, 56 aa, Artificial sequence
  C41A, C51T (A/T)
AKDGDVEGPAGCKKYDVECDSGECCQKQYLWYKWRPLDCRALKSGFFSSKTVCRDV

SEQ ID NO: 607 - protein, 56 aa, Artificial sequence
  C41A, C51S (A/S)
AKDGDVEGPAGCKKYDVECDSGECCQKQYLWYKWRPLDCRALKSGFFSSKSVCRDV

SEQ ID NO: 608 - protein, 56 aa, Artificial sequence
  C41A, C51V (A/V)
AKDGDVEGPAGCKKYDVECDSGECCQKQYLWYKWRPLDCRALKSGFFSSKVVCRDV

SEQ ID NO: 609 - protein, 56 aa, Artificial sequence
  C41T, C51S
AKDGDVEGPAGCKKYDVECDSGECCQKQYLWYKWRPLDCRTLKSGFFSSKSVCRDV

SEQ ID NO: 610 - protein, 56 aa, Artificial sequence
  C41S, C51S
AKDGDVEGPAGCKKYDVECDSGECCQKQYLWYKWRPLDCRSLKSGFFSSKSVCRDV

SEQ ID NO: 611 - protein, 56 aa, Artificial sequence
  C41T, C51A, V17A
AKDGDVEGPAGCKKYDAECDSGECCQKQYLWYKWRPLDCRTLKSGFFSSKAVCRDV

SEQ ID NO: 612 - protein, 56 aa, Artificial sequence
  C41T, C51A, D20A
AKDGDVEGPAGCKKYDVECASGECCQKQYLWYKWRPLDCRTLKSGFFSSKAVCRDV

SEQ ID NO: 613 - protein, 56 aa, Artificial sequence
  C41T, C51A, S21A
AKDGDVEGPAGCKKYDVECDAGECCQKQYLWYKWRPLDCRTLKSGFFSSKAVCRDV

SEQ ID NO: 614 - protein, 56 aa, Artificial sequence
  C41T, C51A, W31A
AKDGDVEGPAGCKKYDVECDSGECCQKQYLAYKWRPLDCRTLKSGFFSSKAVCRDV

SEQ ID NO: 615 - protein, 56 aa, Artificial sequence
  C41T, C51A, Y32A
AKDGDVEGPAGCKKYDVECDSGECCQKQYLWAKWRPLDCRTLKSGFFSSKAVCRDV

SEQ ID NO: 616 - protein, 56 aa, Artificial sequence
  C41T, C51A, P36A
AKDGDVEGPAGCKKYDVECDSGECCQKQYLWYKWRALDCRTLKSGFFSSKAVCRDV

SEQ ID NO: 617 - protein, 56 aa, Artificial sequence
  C41T, C51A, D38A
AKDGDVEGPAGCKKYDVECDSGECCQKQYLWYKWRPLACRTLKSGFFSSKAVCRDV

SEQ ID NO: 618 - protein, 56 aa, Artificial sequence
  C41T, C51A, L42A
AKDGDVEGPAGCKKYDVECDSGECCQKQYLWYKWRPLDCRTAKSGFFSSKAVCRDV

SEQ ID NO: 619 - protein, 56 aa, Artificial sequence
  C41T, C51A, V52A
AKDGDVEGPAGCKKYDVECDSGECCQKQYLWYKWRPLDCRTLKSGFFSSKAACRDV

SEQ ID NO: 620 - protein, 56 aa, Artificial sequence
  C41T, C51A, W31F
AKDGDVEGPAGCKKYDVECDSGECCQKQYLFYKWRPLDCRTLKSGFFSSKAVCRDV

SEQ ID NO: 621 - protein, 56 aa, Artificial sequence
  C41T, C51A, Y32S
AKDGDVEGPAGCKKYDVECDSGECCQKQYLWSKWRPLDCRTLKSGFFSSKAVCRDV

SEQ ID NO: 622 - protein, 56 aa, Artificial sequence
  C41T, C51A, W31F, Y32S, P36A
AKDGDVEGPAGCKKYDVECDSGECCQKQYLFSKWRALDCRTLKSGFFSSKAVCRDV

SEQ ID NO: 623 - protein, 56 aa, Artificial sequence
  C41T, C51A, D20A, L42N
AKDGDVEGPAGCKKYDVECASGECCQKQYLWYKWRPLDCRTNKSGFFSSKAVCRDV

SEQ ID NO: 624 - protein, 56 aa, Artificial sequence
  C41T, C51A, D20A, L42V
AKDGDVEGPAGCKKYDVECASGECCQKQYLWYKWRPLDCRTVKSGFFSSKAVCRDV

SEQ ID NO: 625 - protein, 56 aa, Artificial sequence; identical to SEQ ID NO: 617
  C41T, C51A, D38A

SEQ ID NO: 626 - protein, 56 aa, Artificial sequence
  C41T, C51A, D38K
AKDGDVEGPAGCKKYDVECDSGECCQKQYLWYKWRPLKCRTLKSGFFSSKAVCRDV

SEQ ID NO: 627 - protein, 56 aa, Artificial sequence
  C41T, C51A, D38S
AKDGDVEGPAGCKKYDVECDSGECCQKQYLWYKWRPLSCRTLKSGFFSSKAVCRDV

SEQ ID NO: 628 - protein, 56 aa, Artificial sequence
  C41T, C51A, D38A, V52T
AKDGDVEGPAGCKKYDVECDSGECCQKQYLWYKWRPLACRTLKSGFFSSKATCRDV

SEQ ID NO: 629 - protein, 56 aa, Artificial sequence
  C41T, C51A, D38A, V52A
AKDGDVEGPAGCKKYDVECDSGECCQKQYLWYKWRPLACRTLKSGFFSSKAACRDV

SEQ ID NO: 630 - protein, 56 aa, Artificial sequence
  C41T, C51A, D38A, V17E
AKDGDVEGPAGCKKYDEECDSGECCQKQYLWYKWRPLACRTLKSGFFSSKAVCRDV

SEQ ID NO: 631 - protein, 56 aa, Artificial sequence
  C41T, C51A, D38A, L42V
AKDGDVEGPAGCKKYDVECDSGECCQKQYLWYKWRPLACRTVKSGFFSSKAVCRDV

SEQ ID NO: 632 - protein, 56 aa, Artificial sequence
  C41T, C51A, D38A, L42S
AKDGDVEGPAGCKKYDVECDSGECCQKQYLWYKWRPLACRTSKSGFFSSKAVCRDV

SEQ ID NO: 633 - protein, 56 aa, Artificial sequence
  C41T, C51A, D38A, L42E
AKDGDVEGPAGCKKYDVECDSGECCQKQYLWYKWRPLACRTEKSGFFSSKAVCRDV

SEQ ID NO: 634 - protein, 56 aa, Artificial sequence
  C41T, C51A, D38A, L42Q
AKDGDVEGPAGCKKYDVECDSGECCQKQYLWYKWRPLACRTQKSGFFSSKAVCRDV

SEQ ID NO: 635 - protein, 56 aa, Artificial sequence
  C41T, C51A, D38A, D20A
AKDGDVEGPAGCKKYDVECASGECCQKQYLWYKWRPLACRTLKSGFFSSKAVCRDV

SEQ ID NO: 636 - protein, 56 aa, Artificial sequence
  C41T, C51A, D20A, Y32S
AKDGDVEGPAGCKKYDVECASGECCQKQYLWSKWRPLDCRTLKSGFFSSKAVCRDV

SEQ ID NO: 637 - protein, 56 aa, Artificial sequence
  C41T, C51A, D38A, Y32S
AKDGDVEGPAGCKKYDVECDSGECCQKQYLWSKWRPLACRTLKSGFFSSKAVCRDV

SEQ ID NO: 638 - protein, 56 aa, Artificial sequence
  C41T, C51A, D20A, D38A, Y32S
AKDGDVEGPAGCKKYDVECASGECCQKQYLWSKWRPLACRTLKSGFFSSKAVCRDV

SEQ ID NO: 639 - protein, 56 aa, Artificial sequence
  C41T, C51A, D20A, W31F, Y32S, P36A
AKDGDVEGPAGCKKYDVECASGECCQKQYLFSKWRALDCRTLKSGFFSSKAVCRDV

SEQ ID NO: 640 - protein, 56 aa, Artificial sequence
  D38A
AKDGDVEGPAGCKKYDVECDSGECCQKQYLWYKWRPLACRCLKSGFFSSKCVCRDV

SEQ ID NO: 641 - protein, 56 aa, Artificial sequence
  C41S, C51T, D38A (S/T + D38A)
AKDGDVEGPAGCKKYDVECDSGECCQKQYLWYKWRPLACRSLKSGFFSSKTVCRDV

SEQ ID NO: 642 - protein, 56 aa, Artificial sequence
  C41T, C51T, D38A (T/T + D38A)
AKDGDVEGPAGCKKYDVECDSGECCQKQYLWYKWRPLACRTLKSGFFSSKTVCRDV

SEQ ID NO: 643 - protein, 56 aa, Artificial sequence
  C41S, C51S, D38A (S/S + D38A)
AKDGDVEGPAGCKKYDVECDSGECCQKQYLWYKWRPLACRSLKSGFFSSKSVCRDV

SEQ ID NO: 644 - protein, 56 aa, Artificial sequence
  C41T, C51S, D38A (T/S + D38A)
AKDGDVEGPAGCKKYDVECDSGECCQKQYLWYKWRPLACRTLKSGFFSSKSVCRDV

SEQ ID NO: 645 - protein, 56 aa, Artificial sequence
  C41V, C51T, D38A (V/T + D38A)
AKDGDVEGPAGCKKYDVECDSGECCQKQYLWYKWRPLACRVLKSGFFSSKTVCRDV

SEQ ID NO: 646 - protein, 56 aa, Artificial sequence
  C41T, C51V, D38A (T/V + D38A)
AKDGDVEGPAGCKKYDVECDSGECCQKQYLWYKWRPLACRTLKSGFFSSKVVCRDV

SEQ ID NO: 647 - protein, 56 aa, Artificial sequence
  C41S, C51V, D38A (S/V + D38A)
AKDGDVEGPAGCKKYDVECDSGECCQKQYLWYKWRPLACRSLKSGFFSSKVVCRDV

SEQ ID NO: 648 - protein, 56 aa, Artificial sequence
  C41V, C51S, D38A (V/S + D38A)
AKDGDVEGPAGCKKYDVECDSGECCQKQYLWYKWRPLACRVLKSGFFSSKSVCRDV

SEQ ID NO: 649 - protein, 56 aa, Artificial sequence
  C41S, C51S, D38A/L42V  (S/S + D38A/L42V)
AKDGDVEGPAGCKKYDVECDSGECCQKQYLWYKWRPLACRSVKSGFFSSKSVCRDV

SEQ ID NO: 650 - protein, 56 aa, Artificial sequence
  C41N/ C51A/ D38A/ L42V
AKDGDVEGPAGCKKYDVECDSGECCQKQYLWYKWRPLACRNVKSGFFSSKAVCRDV

SEQ ID NO: 651 - protein, 56 aa, Artificial sequence
  C41D/ C51A/ D38A/ L42V
AKDGDVEGPAGCKKYDVECDSGECCQKQYLWYKWRPLACRDVKSGFFSSKAVCRDV

SEQ ID NO: 652 - protein, 56 aa, Artificial sequence
  C41S/ C51A/ D38A/ L42V
AKDGDVEGPAGCKKYDVECDSGECCQKQYLWYKWRPLACRSVKSGFFSSKAVCRDV

SEQ ID NO: 653 - protein, 56 aa, Artificial sequence
  C41M/ C51A/ D38A/ L42V
AKDGDVEGPAGCKKYDVECDSGECCQKQYLWYKWRPLACRMVKSGFFSSKAVCRDV

SEQ ID NO: 654 - protein, 56 aa, Artificial sequence
  C41T/ C51G/ D38A/ L42V
AKDGDVEGPAGCKKYDVECDSGECCQKQYLWYKWRPLACRTVKSGFFSSKGVCRDV

SEQ ID NO: 655 - protein, 56 aa, Artificial sequence
  C41T/ C51D/ D38A/ L42V
AKDGDVEGPAGCKKYDVECDSGECCQKQYLWYKWRPLACRTVKSGFFSSKDVCRDV

SEQ ID NO: 656 - protein, 56 aa, Artificial sequence
  C41T/ C51N/ D38A/ L42V
AKDGDVEGPAGCKKYDVECDSGECCQKQYLWYKWRPLACRTVKSGFFSSKNVCRDV

SEQ ID NO: 657 - protein, 56 aa, Artificial sequence
  C41T/ C51Q/ D38A/ L42V
AKDGDVEGPAGCKKYDVECDSGECCQKQYLWYKWRPLACRTVKSGFFSSKQVCRDV

SEQ ID NO: 658 - protein, 56 aa, Artificial sequence
  C41T/ C51E/ D38A/ L42V
AKDGDVEGPAGCKKYDVECDSGECCQKQYLWYKWRPLACRTVKSGFFSSKEVCRDV

SEQ ID NO: 659 - protein, 56 aa, Artificial sequence
  C41T/ C51V/ D38A/ L42V
AKDGDVEGPAGCKKYDVECDSGECCQKQYLWYKWRPLACRTVKSGFFSSKVVCRDV

SEQ ID NO: 660 - protein, 56 aa, Artificial sequence
  C41T/ C51H/ D38A/ L42V
AKDGDVEGPAGCKKYDVECDSGECCQKQYLWYKWRPLACRTVKSGFFSSKHVCRDV

SEQ ID NO: 661 - protein, 56 aa, Artificial sequence
  C41T/ C51M/ D38A/ L42V
AKDGDVEGPAGCKKYDVECDSGECCQKQYLWYKWRPLACRTVKSGFFSSKMVCRDV

SEQ ID NO: 662 - protein, 56 aa, Artificial sequence
  C41V/ C51V/ D38A/ L42V
AKDGDVEGPAGCKKYDVECDSGECCQKQYLWYKWRPLACRVVKSGFFSSKVVCRDV

SEQ ID NO: 663 - protein, 56 aa, Artificial sequence
  C41M/ C51M/ D38A/ L42V
AKDGDVEGPAGCKKYDVECDSGECCQKQYLWYKWRPLACRMVKSGFFSSKMVCRDV

SEQ ID NO: 664 - protein, 56 aa, Artificial sequence
  C41K/ C51E/ D38A/ L42V
AKDGDVEGPAGCKKYDVECDSGECCQKQYLWYKWRPLACRKVKSGFFSSKEVCRDV

SEQ ID NO: 665 - protein, 56 aa, Artificial sequence
  C41E/ C51K/ D38A/ L42V
AKDGDVEGPAGCKKYDVECDSGECCQKQYLWYKWRPLACREVKSGFFSSKKVCRDV

SEQ ID NO: 666 - protein, 56 aa, Artificial sequence
  C41T/ C51A/ D20V/ D38A/ L42V
AKDGDVEGPAGCKKYDVECVSGECCQKQYLWYKWRPLACRTVKSGFFSSKAVCRDV

SEQ ID NO: 667 - protein, 56 aa, Artificial sequence
  C41T/ C51A/ D20G/ D38A/ L42V
AKDGDVEGPAGCKKYDVECGSGECCQKQYLWYKWRPLACRTVKSGFFSSKAVCRDV

SEQ ID NO: 668 - protein, 56 aa, Artificial sequence
  C41T/ C51A/ D20K/ D38A/ L42V
AKDGDVEGPAGCKKYDVECKSGECCQKQYLWYKWRPLACRTVKSGFFSSKAVCRDV

SEQ ID NO: 669 - protein, 56 aa, Artificial sequence
  C41T/ C51A/ D20E/ D38A/ L42V
AKDGDVEGPAGCKKYDVECESGECCQKQYLWYKWRPLACRTVKSGFFSSKAVCRDV

SEQ ID NO: 670 - protein, 56 aa, Artificial sequence
  C41T/ C51A/ D20L/ D38A/ L42V
AKDGDVEGPAGCKKYDVECLSGECCQKQYLWYKWRPLACRTVKSGFFSSKAVCRDV

SEQ ID NO: 671 - protein, 56 aa, Artificial sequence
  C41T/ C51A/ D20N/ D38A/ L42V
AKDGDVEGPAGCKKYDVECNSGECCQKQYLWYKWRPLACRTVKSGFFSSKAVCRDV

SEQ ID NO: 672 - protein, 56 aa, Artificial sequence
  C41T/ C51A/ D20Y/ D38A/ L42V
AKDGDVEGPAGCKKYDVECYSGECCQKQYLWYKWRPLACRTVKSGFFSSKAVCRDV

SEQ ID NO: 673 - protein, 56 aa, Artificial sequence
  C41T/ C51A/ S21G/ D38A/ L42V
AKDGDVEGPAGCKKYDVECDGGECCQKQYLWYKWRPLACRTVKSGFFSSKAVCRDV

SEQ ID NO: 674 - protein, 56 aa, Artificial sequence
  C41T/ C51A/ E18P/ D38A/ L42V
AKDGDVEGPAGCKKYDVPCDSGECCQKQYLWYKWRPLACRTVKSGFFSSKAVCRDV

SEQ ID NO: 675 - protein, 56 aa, Artificial sequence
  C41T/ C51A/ E18K/ D38A/ L42V
AKDGDVEGPAGCKKYDVKCDSGECCQKQYLWYKWRPLACRTVKSGFFSSKAVCRDV

SEQ ID NO: 676 - protein, 56 aa, Artificial sequence
  C41T/ C51A/ E18S/ D38A/ L42V
AKDGDVEGPAGCKKYDVSCDSGECCQKQYLWYKWRPLACRTVKSGFFSSKAVCRDV

SEQ ID NO: 677 - protein, 56 aa, Artificial sequence
  C41T/ C51A/ E18D/ D38A/ L42V
AKDGDVEGPAGCKKYDVDCDSGECCQKQYLWYKWRPLACRTVKSGFFSSKAVCRDV

SEQ ID NO: 678 - protein, 56 aa, Artificial sequence
  Y32S, P36A
AKDGDVEGPAGCKKYDVECDSGECCQKQYLWSKWRALDCRCLKSGFFSSKCVCRDV

SEQ ID NO: 679 - protein, 56 aa, Artificial sequence
  Y32K, P36A
AKDGDVEGPAGCKKYDVECDSGECCQKQYLWKKWRALDCRCLKSGFFSSKCVCRDV

SEQ ID NO: 680 - protein, 56 aa, Artificial sequence
  Y32H, P36A
AKDGDVEGPAGCKKYDVECDSGECCQKQYLWHKWRALDCRCLKSGFFSSKCVCRDV

SEQ ID NO: 681 - protein, 56 aa, Artificial sequence
  W31F, Y32S
AKDGDVEGPAGCKKYDVECDSGECCQKQYLFSKWRPLDCRCLKSGFFSSKCVCRDV

SEQ ID NO: 682 - protein, 56 aa, Artificial sequence
  W31F, Y32S, P36A
AKDGDVEGPAGCKKYDVECDSGECCQKQYLFSKWRALDCRCLKSGFFSSKCVCRDV

SEQ ID NO: 683 - protein, 56 aa, Artificial sequence
  Y32H, P36A, C41A, C51A
AKDGDVEGPAGCKKYDVECDSGECCQKQYLWHKWRALDCRALKSGFFSSKAVCRDV

SEQ ID NO: 684 - protein, 56 aa, Artificial sequence
  C41T/ C51A/ Y29A
AKDGDVEGPAGCKKYDVECDSGECCQKQALWYKWRPLDCRTLKSGFFSSKAVCRDV

SEQ ID NO: 685 - protein, 56 aa, Artificial sequence
  C41T/ C51A/ G45A
AKDGDVEGPAGCKKYDVECDSGECCQKQYLWYKWRPLDCRTLKSAFFSSKAVCRDV

SEQ ID NO: 686 - protein, 56 aa, Artificial sequence
  C41T/ C51A/ F47A
AKDGDVEGPAGCKKYDVECDSGECCQKQYLWYKWRPLDCRTLKSGFASSKAVCRDV

SEQ ID NO: 687 - protein, 56 aa, Artificial sequence
  C41T/ C51A/ R54A
AKDGDVEGPAGCKKYDVECDSGECCQKQYLWYKWRPLDCRTLKSGFFSSKAVCADV

SEQ ID NO: 688 - protein, 56 aa, Artificial sequence; identical to SEQ ID NO: 615
  C41T/ C51A/ Y32A

SEQ ID NO: 689 - protein, 56 aa, Artificial sequence; identical to SEQ ID NO: 616
  C41T/ C51A/ P36A

SEQ ID NO: 690 - protein, 56 aa, Artificial sequence
  C41T, C51A, D38A, L42H
AKDGDVEGPAGCKKYDVECASGECCQKQYLWYKWRPLDCRTHKSGFFSSKAVCRDV

SEQ ID NO: 691 - protein, 56 aa, Artificial sequence
  Y32S, D38A, C41S, L42I, C51S
AKDGDVEGPAGCKKYDVECDSGECCQKQYLWSKWRPLACRSIKSGFFSSKSVCRDV

SEQ ID NO: 692 - protein, 56 aa, Artificial sequence
  D38A/ L42I/ C41S/ C51S
AKDGDVEGPAGCKKYDVECDSGECCQKQYLWYKWRPLACRSIKSGFFSSKSVCRDV

SEQ ID NO: 693 - protein, 56 aa, Artificial sequence
  K2L/ D38A/ C41S/ C51S
ALDGDVEGPAGCKKYDVECDSGECCQKQYLWYKWRPLACRSLKSGFFSSKSVCRDV

SEQ ID NO: 694 - protein, 56 aa, Artificial sequence
  Y32S/ D38A/ C41S/C51S
AKDGDVEGPAGCKKYDVECDSGECCQKQYLWSKWRPLACRSLKSGFFSSKSVCRDV

SEQ ID NO: 695 - protein, 56 aa, Artificial sequence
  K2L/ Y32S/ D38A/ C41S/ C51S
ALDGDVEGPAGCKKYDVECDSGECCQKQYLWSKWRPLACRSLKSGFFSSKSVCRDV

SEQ ID NO: 696 - protein, 56 aa, Artificial sequence
  D38T/ C41S/ C51S
AKDGDVEGPAGCKKYDVECDSGECCQKQYLWYKWRPLTCRSLKSGFFSSKSVCRDV

SEQ ID NO: 697 - protein, 56 aa, Artificial sequence
  D38S/ C41S/ C51S
AKDGDVEGPAGCKKYDVECDSGECCQKQYLWYKWRPLSCRSLKSGFFSSKSVCRDV

SEQ ID NO: 698 - protein, 56 aa, Artificial sequence
  D38M/ C41S/ C51S
AKDGDVEGPAGCKKYDVECDSGECCQKQYLWYKWRPLMCRSLKSGFFSSKSVCRDV

SEQ ID NO: 699 - protein, 56 aa, Artificial sequence
  K2L/ Y32S/ L42I
ALDGDVEGPAGCKKYDVECDSGECCQKQYLWSKWRPLDCRCIKSGFFSSKCVCRDV

SEQ ID NO: 700 - protein, 56 aa, Artificial sequence
  K2L/ Y32S/ D38A/ L42I/ C41S/ C51S
ALDGDVEGPAGCKKYDVECDSGECCQKQYLWSKWRPLACRSIKSGFFSSKSVCRDV

SEQ ID NO: 701 - protein, 56 aa, Artificial sequence
  K2L/ D38A/ L42I/ C41S/ C51S
ALDGDVEGPAGCKKYDVECDSGECCQKQYLWYKWRPLACRSIKSGFFSSKSVCRDV

(19) United States
(12) Patent Application Publication
(10) Pub. No.: US 2024/0389602 A1
(43) Pub. Date: Nov. 28, 2024

(54) LIPOSOME FORMULATIONS FOR PESTICIDE DELIVERY AND METHODS FOR PRODUCING AND USING THE SAME

(71) Applicant: Vestaron Corporation, Durham, NC (US)

(72) Inventors: Robert M. KENNEDY, Dexter, MI (US); Jacob LADD, Plainwell, MI (US)

(21) Appl. No.: 18/552,621

(22) PCT Filed: Apr. 1, 2022
(86) PCT No.: PCT/US2022/023079

§ 371 Date: Sep. 26, 2023

Related U.S. Application Data
(60) Provisional application No. 63/169,696, filed on Apr. 1, 2021.

(51) Int. Cl. A01N 63/50; A01N 25/04; A01P 7/04

(52) U.S. Cl. CPC A01N 63/50; A01N 25/04; A01P 7/04

(57) ABSTRACT

New liposome formulations for pesticide delivery and methods for producing and using the same are provided. The present disclosure describes methods of making liposomes that encapsulate insecticidal proteins, and the use of the same to control or inhibit pests. Also described are liposome compositions and formulations comprising insecticidal proteins, and methods regarding the same to protect plants and animals from pests.

### CROSS REFERENCE TO RELATED APPLICATIONS

This application claims the benefit of, and priority to, U.S. Provisional Application Ser. No. 63/169,696, filed on Apr. 1, 2021. The entire contents of the aforementioned application are incorporated herein.

### SEQUENCE LISTING

This application incorporates by reference in its entirety the Sequence Listing entitled “225312-505615_ST25.txt” (343 KB), which was created on Mar. 8, 2022 at 1:03 PM, and filed electronically herewith.

### TECHNICAL FIELD

The present disclosure provides liposome-encapsulated insecticidal proteins, compositions, and formulations comprising liposome-encapsulated insecticidal proteins; methods of producing the same; and new formulations, and methods for the control of insects.

### BACKGROUND

Deleterious insects represent a worldwide threat to human health and food security. Insects pose a threat to human health because they are a vector for disease. One of the most notorious insect-vectors of disease is the mosquito. Mosquitoes in the genus Anopheles are the principal vectors of Zika virus, Chikungunya virus, and malaria—a disease caused by protozoa in the genus Trypanosoma. Another mosquito, Aedes aegypti, is the main vector of the viruses that cause Yellow fever and Dengue. And, Aedes spp. mosquitos are also the vectors for the viruses responsible for various types of encephalitis. Wuchereria bancrofti and Brugia malayi, parasitic roundworms that cause filariasis, are usually spread by mosquitoes in the genera Culex, Mansonia, and Anopheles.

Similar to the mosquito, other members of the Diptera order have likewise plagued humankind since time immemorial. In addition to producing painful bites, Horseflies and deerflies transmit the bacterial pathogens of tularemia (Pasteurella tularensis) and anthrax (Bacillus anthracis), as well as a parasitic roundworm (Loa loa) that causes loiasis in tropical Africa.

Blowflies (Chrysomya megacephala) and houseflies (Musca domestica) will in one moment take off from carrion and dung, and in the next moment alight in our homes and on our food-spreading dysentery, typhoid fever, cholera, poliomyelitis, yaws, leprosy, and tuberculosis in their wake.

Eye gnats in the genus Hippelates can carry the spirochaete pathogen that causes yaws (Treponema pertenue), and may also spread conjunctivitis (pinkeye). Tsetse flies in the genus Glossina transmit the protozoan pathogens that cause African sleeping sickness (Trypanosoma gambiense and T. rhodesiense). Sand flies in the genus Phlebotomus are vectors of a bacterium (Bartonella bacilliformis) that causes Carrion's disease (Oroyo fever) in South America. In parts of Asia and North Africa, they spread a viral agent that causes sand fly fever (Pappataci fever) as well as protozoan pathogens (Leishmania spp.) that cause Leishmaniasis.

Human food security is also threatened by insects. Insect pests indiscriminately target food crops earmarked for commercial purposes and personal use alike; indeed, the damage caused by insect pests can run the gamut from mere inconvenience to financial ruin in the former, to extremes such as malnutrition or starvation in the latter. Insect pests also cause stress and disease in domesticated animals. And, insect pests once limited by geographical and climate boundaries have expanded their range due to global travel and climate change.

### SUMMARY

The present disclosure describes a liposome comprising an insecticidal protein or agriculturally acceptable salt thereof, wherein the liposome encapsulates the insecticidal protein or agriculturally acceptable salt thereof; and wherein the liposome comprises lecithin.

In addition, the present disclosure provides a composition comprising a liposome comprising an insecticidal protein or agriculturally acceptable salt thereof, wherein the liposome encapsulates the insecticidal protein or agriculturally acceptable salt thereof, and wherein the liposome comprises lecithin.

In addition, the present disclosure provides a method of combating, controlling, or inhibiting a pest comprising, applying a pesticidally effective amount of a liposome comprising an insecticidal protein or agriculturally acceptable salt thereof, wherein the liposome encapsulates the insecticidal protein or agriculturally acceptable salt thereof, and wherein the liposome comprises lecithin, or a composition comprising the same; to the pest, a locus of the pest, a food supply of the pest, a habitat of the pest, or a breeding ground of the pest; a plant, a seed, a plant part, a locus of a plant, or an environment of a plant that is susceptible to an attack by the pest; an animal, a locus of an animal, or an environment of an animal susceptible to an attack by the pest; or a combination thereof.

In addition, the present disclosure provides a method of making a liposome comprising an insecticidal protein or agriculturally acceptable salt thereof, wherein the liposome encapsulates the insecticidal protein or agriculturally acceptable salt thereof, and wherein the liposome comprises lecithin, the method comprising: (a) preparing a homogenized aqueous solution comprising lecithin and water; (b) preparing an aqueous solution comprising an insecticidal protein; (c) mixing the homogenized aqueous solution of step (a) with the aqueous solution of step (b).

### BRIEF DESCRIPTION OF THE DRAWINGS

FIG. 1 depicts a graph showing the percentage of leaf damage when using liposome compositions of the present disclosure in a foliar spray assay against first instar corn earworms (CEW). Leaf defoliation was assessed at day 4. Treatments include the following: (1) “Hybrid+2 alone” (the insecticidal protein U+2-ACTX-Hv1a); (2) “Hybrid+2 null liposome mixture,” which is a combination of Hybrid+2 and null liposomes (i.e., liposomes encapsulating water); and (3) “Liposome-encapsulated Hybrid+2,” which is a liposome composition of the present disclosure comprising Hybrid+2 encapsulated in liposomes. All treatments used Hybrid+2 at spray solution concentrations of 0, 2, 6, and 18 mg/mL, with no surfactant.

FIG. 2 depicts a graph displaying the mortality in a foliar spray assay targeting first instar corn earworms (CEW). Mortality was assessed at day 4. The insecticidal protein evaluated was U+2-ACTX-Hv1a (Hybrid+2). Treatments include the following: (1) “Hybrid+2 alone”; (2) “Hybrid+2 null liposome mixture,” which is a combination of Hybrid+2 and null liposomes (i.e., liposomes encapsulating water); and (3) “Liposome encapsulated Hybrid+2,” which is a liposome composition of the present disclosure comprising Hybrid+2. All treatments used Hybrid+2 at spray solution concentrations of 0, 2, 6, and 18 mg/mL, with no surfactant. The Y-axis shows corn earworm (CEW) proportion mortality, which is the proportion of individual insects killed over the course of an experiment, i.e., proportion mortality=Number of dead individuals/Number of total individuals.

FIG. 3 depicts a graph showing the results of leaf damage in a foliar spray assay against second instar corn earworms (CEW). Percent of the leaf eaten was evaluated on day 4. Treatments evaluated were as follows: (1) UTC (untreated control, deionized water); (2) Liposome/Hybrid+2 composition (a composition of Hybrid+2 encapsulated in liposomes); (3) Liposomes only (null liposomes); and (4) Hybrid+2 only. None of the treatments contained any surfactant. Here, Hybrid+2 was evaluated at a dose concentration of 0, 1, 3, and 9 part per thousand (ppt).

FIG. 4 depicts a graph showing the mortality rate in a foliar spray assay in second instar CEW. Percent mortality was evaluated on day 4. Treatments evaluated were as follows: (1) UTC (untreated control, deionized water); (2) Liposome/Hybrid+2 composition (a composition of Hybrid+2 encapsulated in liposomes); (3) Liposomes only (null liposomes); and (4) Hybrid+2 only. None of the treatments contained any surfactant. Here, Hybrid+2 was evaluated at a dose concentration of 0, 1, 3, and 9 part per thousand (ppt).

FIG. 5 depicts a graph showing the effect of an injection of Hybrid+2 alone in fourth instar CEW, with regard to the percent of CEW that were either alive, knocked-down, or dead. The doses of Hybrid+2 used were: 0 pmol/g; 1146 pmol/g; 2293 pmol/g; 4586 pmol/g; 9172 pmol/g; and 18344 pmol/g. Insect conditions were assessed after 24-hours, and insects were categorized as follows: alive (walking, eating, normal behavior); knockdown (unable to walk or eat, writhing, and tremors); and dead (unmoving, discoloration).

FIG. 6 shows graph showing the effect of an injection of Hybrid+2 encapsulated in liposomes in fourth instar CEW, with regard to the percent of CEW that were either alive, knocked-down, or dead. The doses of Hybrid+2 used were: 0 pmol/g; 1146 pmol/g; 2293 pmol/g; 4586 pmol/g; 9172 pmol/g; and 18344 pmol/g. Insect conditions were assessed after 24-hours, and insects were categorized as follows: alive (walking, eating, normal behavior); knockdown (unable to walk or eat, writhing, and tremors); and dead (unmoving, discoloration).

FIG. 7 depicts a logarithmic dose-response plot for a CEW injection assay illustrating the proportion knockdown or proportion dead of fourth instar CEW, when injected with the liposome compositions of the present disclosure. Here, CEW were injected with (1) the insecticidal protein U+2-ACTX-Hv1a (Hybrid+2) alone (labeled as “Hybrid+2”), or (2) Liposome-encapsulated Hybrid+2 (labeled as “Hybrid+2 liposome”). As shown here, the KD₅₀ for Hybrid+2 alone was 6506 pmol/g, whereas Hybrid+2 encapsulated in liposomes has a KD₅₀ of 4586 pmol/g. Here, pmol/g is equal to the product of peptide solution (ppm) and injection volume (L) per insect mass (mg) times peptide molecular weight.

FIG. 8 depicts a logarithmic dose-response plot for a housefly injection assay. Houseflies were injected with Hybrid+2 alone; Liposome-encapsulated Hybrid+2 (Hybrid+2 liposome); or Hybrid+2 mixed with liposomes (Hybrid+2 null liposome). The LD₅₀ for each treatment is as follows: Hybrid+2 alone was 137 pmol/g; Liposome-encapsulated Hybrid+2 was 88 pmol/g; and Hybrid+2 mixed with null liposomes was 211 pmol/g. Here, pmol/g is equal to the product of peptide solution (ppm) and injection volume (L) per insect mass (mg) times peptide molecular weight.

FIG. 9 shows the proportion dead for houseflies were injected with Hybrid+2 alone; Liposome-encapsulated Hybrid+2; or Hybrid+2 mixed with liposomes, at a dose of 165 pmol/g of Hybrid+2.

FIG. 10 shows the proportion dead for houseflies were injected with Hybrid+2 alone; Liposome-encapsulated Hybrid+2; or Hybrid+2 mixed with liposomes, at a dose of 248 pmol/g of Hybrid+2.

FIG. 11 shows the proportion dead for houseflies were injected with Hybrid+2 alone; Liposome-encapsulated Hybrid+2; or Hybrid+2 mixed with liposomes, at a dose of 375 pmol/g of Hybrid+2.

FIG. 12 depicts a graph showing Popillia japonica (Japanese beetle) mortality at day-4, after being treated with Hybrid+2 or Hybrid+2 encapsulated in liposomes. The doses evaluated were 0, 1, 3, and 8 mg/mL of Hybrid+2 for each treatment.

FIG. 13 depicts a graph showing the results of leaf damage in a foliar spray assay targeting adult Popillia japonica (Japanese beetles). Treatments include the following: (1) Av3b alone; or (2) Av3b encapsulated in liposomes. The doses of Av3b are shown on the X-axis, and are 0, 1, 3, and 8 mg/mL.

FIG. 14 depicts a graph showing the effect of Av3b liposome compositions in a foliar spray assay on adult Popillia japonica (Japanese beetle) mortality. Treatments include the following: (1) Av3b alone; or (2) Av3b encapsulated in liposomes. The doses of Av3b are shown on the X-axis, and are 0, 1, 3, and 8 mg/mL.

FIG. 15 depicts a graph showing the results of leaf damage in a foliar spray assay targeting first instar CEW with Av3b. Treatments include the following: (1) Av3b alone; or (2) Av3b encapsulated in liposomes. The doses of Av3b are shown on the X-axis, and are 0, 1, 3, and 8 mg/mL.

FIG. 16 depicts a graph showing the effect of Av3b liposome compositions in a foliar spray assay evaluating first instar CEW mortality. Treatments include the following: (1) Av3b alone; or (2) Av3b encapsulated in liposomes. The doses of Av3b are shown on the X-axis, and are 0, 1, 3, and 8

FIG. 17 depicts a logarithmic dose-response plot illustrating proportion knockdown or proportion dead for a housefly injection assay using: (1) Av3b alone; or (2) Liposome encapsulated Av3b. As shown here, a lower dose of Av3b was needed to cause knockdown or death when encapsulated in liposomes.

FIG. 18 shows the results of a housefly injection assay. Houseflies were injected with (1) Av3b alone; or (2) Av3b encapsulated in liposomes. The proportion dead reveals that Av3b alone has an LD₅₀ of 128 pmol/g, whereas Av3b encapsulated in liposomes has an LD₅₀ of 94 pmol/g.

FIG. 19 depicts an image of the liposome composition comprising Hybrid+2 obtained by Cryo-TEM, showing representative vesicles. Unilamellar vesicles are indicated by arrows with a dotted shaft. Multilamellar vesicles are indicated by arrows with a dashed shaft. Finally, dumbbell-shaped particles are indicated by arrows with a solid shaft.

FIG. 20 depicts Cryo-TEM images from a lamellarity analysis evaluating liposome compositions of the present disclosure. Inserts (a) and (b) depict unilamellar vesicles, and inserts (c)-(e) depict multilamellar vesicles. Insert (a) shows unilamellar vesicle having a diameter of 85.6 nm; (b) shows a unilamellar vesicle having a diameter of 39.3 nm; (c) shows a multilamellar vesicle having a diameter of 136.5 nm diameter; (d) shows a multilamellar vesicle having a diameter of 117.9 nm diameter; (e) shows a multilamellar vesicle having a diameter of 136.9 nm diameter.

FIG. 21 depicts a graph showing the results of the particle size classification analysis. Here, 57.89% unilamellar vesicles possessed a diameter of 20-50 nm, and 41.52% of unilamellar vesicles possessed a diameter of 50-100 nm. Finally, 0.59% unilamellar vesicles have a diameter of >100 nm.

FIG. 22 shows a graph showing sized distribution by intensity. The average size of all the liposome particles was 155.2 nm, which included the unilamellar, multilamellar, and dumbbell-shape vesicles. The dispersion coefficient PDI was 0.292. Z-Average (d.nm)=155.2; PDI=0.292; intercept=0.962; result quality=good. The size of Peak 1 was 229.0 (d.nm), 100% intensity (Std. Dev.=141.4, d.nm).

FIG. 23 depicts a chromatograph showing the results of the LC-MS analysis of the liposome composition comprising concentrated Hybrid+2, soy lecithin, and water. Here, the peak area was compared to a known set of standards that allowed for quantification of 27.5%.

### DETAILED DESCRIPTION

### Definitions

The term “5′-end” and “3′-end” refers to the directionality, i.e., the end-to-end orientation of a nucleotide polymer (e.g., DNA). The 5′-end of a polynucleotide is the end of the polynucleotide that has the fifth carbon.

“ACTX” or “ACTX peptide” or “atracotoxin” or “HXTX” refers to a family of insecticidal peptides that have been isolated from spiders belonging to the Atracinae family. One such spider is known as the Australian Blue Mountains Funnel-web Spider, which has the scientific name Hadronyche versuta. Two examples of ACTX peptides from this species are the Omega and U peptides.

“Additive” refers to any agriculturally acceptable additive. Agriculturally acceptable additives include, without limitation, disintegrants, dispersing additives, coating additives, diluents, surfactants, absorption promoting additives, anti-caking additives, anti-microbial agents (e.g., preservatives), colorants, desiccants, plasticizers and dyes.

“Alignment” refers to a method of comparing two or more sequences (e.g., nucleotide, polynucleotide, amino acid, peptide, polypeptide, or protein sequences) for the purpose of determining their relationship to each other. Alignments are typically performed by computer programs that apply various algorithms, however, it is also possible to perform an alignment by hand. Alignment programs typically iterate through potential alignments of sequences and score the alignments using substitution tables, employing a variety of strategies to reach a potential optimal alignment score. Commonly-used alignment algorithms include, but are not limited to, CLUSTALW (see Thompson J. D., Higgins D. G., Gibson T. J., CLUSTAL W: improving the sensitivity of progressive multiple sequence alignment through sequence weighting, position-specific gap penalties and weight matrix choice, Nucleic Acids Research 22: 4673-4680, 1994); CLUSTALV (see Larkin M. A., et al., CLUSTALW2, ClustalW and ClustalX version 2, Bioinformatics 23(21): 2947-2948, 2007); Mafft; Kalign; ProbCons; and T-Coffee (see Notredame et al., T-Coffee: A novel method for multiple sequence alignments, Journal of Molecular Biology 302: 205-217, 2000). Exemplary programs that implement one or more of the foregoing algorithms include, but are not limited to, MegAlign from DNAStar (DNAStar, Inc. 3801 Regent St. Madison, Wis. 53705), MUSCLE, T-Coffee, CLUSTALX, CLUSTALV, JalView, Phylip, and Discovery Studio from Accelrys (Accelrys, Inc., 10188 Telesis Ct, Suite 100, San Diego, Calif. 92121). In some embodiments, an alignment will introduce “phase shifts” and/or “gaps” into one or both of the sequences being compared in order to maximize the similarity between the two sequences, and scoring refers to the process of quantitatively expressing the relatedness of the aligned sequences.

“Alpha-MF signal” or “aMF secretion signal” refers to a protein that directs nascent recombinant polypeptides to the secretory pathway.

“Agent” refers to one or more chemical substances, molecules, nucleotides, polynucleotides, peptides, polypeptides, proteins, poisons, insecticides, pesticides, organic compounds, inorganic compounds, prokaryote organisms, or eukaryote organisms, and agents produced therefrom.

“Agriculturally-acceptable carrier” covers all adjuvants, inert components, dispersants, surfactants, tackifiers, binders, etc. that are ordinarily used in pesticide formulation technology; these are well known to those skilled in pesticide formulation.

“Agriculturally acceptable salt” is synonymous with pharmaceutically acceptable salt, and as used herein refers to a compound that is modified by making acid or base salts thereof.

“Amphiphile” refers to a chemical compound having both hydrophilic and lipophilic properties (e.g., a phospholipid). In some embodiments, an amphiphile is referred to as having amphiphilic or amphipathic properties.

“Amphiphilic” as used herein describes a molecule having both hydrophobic and hydrophilic regions, as in a phospholipid or a detergent molecule.

“Amphoteric” refers a substance, a mixture of substances, or a supra-molecular complex (e.g., a liposome) comprising charged groups of both anionic and cationic character wherein: (1) at least one, and optionally both, of the cation and anionic amphiphiles is chargeable, having at least one charged group with a pK between 4 and 8; (2) the cationic charge prevails at pH 4; and (3) the anionic charge prevails at pH 8. As a result the substance, or mixture of substance, has an isoelectric point of neutral net charge between pH 4 and pH 8. Amphoteric character is by this definition different from zwitterionic character, as zwitterions do not have a pK in the range mentioned above. Consequently, zwitterions are essentially neutrally charged over a range of pH values; phosphatidylcholines and phosphatidylethanolamines are neutral lipids with zwitterionic character.

“Applying” or “application” or “apply” or “administering” or “administration” or “administer” means to dispense and/or otherwise provide, and refers to any method of application or route of administration. For example, applying can refer to, e.g., application of a liposome comprising an insecticidal protein or agriculturally acceptable salt thereof, wherein the liposome encapsulates the insecticidal protein or agriculturally acceptable salt thereof; and wherein the liposome comprises lecithin; or a composition comprising the same, and further comprising at least one excipient, e.g., applied as a sprayable composition, a foam; a burning formulation; a fabric treatment; a surface-treatment; a dispersant; and the like. By “co-application” or “co-administer” it is meant that two or more components are applied or administered at the same time; or a one or more components are applied or administered just prior to, or just after the application the other one or more components.

“Bioavailability” refers to the rate and extent to which an active ingredient is absorbed by a subject and becomes available at a site of action, i.e., where the active ingredient is ultimately available for biological activity in a subject's tissue and cells. Thus, an active ingredient or composition comprising the same is “bioavailable” when all or a portion of the amount of active ingredient administered is absorbed by, incorporated into, or otherwise physiologically available to a subject or patient to whom it is administered. “Oral bioavailability” refers to the extent to which an active ingredient (e.g., an insecticidal protein as disclosed herein), is absorbed into the general circulation when the active ingredient or a composition comprising the same is taken orally, as compared to, e.g., an intravenous injection. In some embodiments, bioavailability can be measured as the amount of active ingredient in the blood (serum or plasma) as a function of time. Pharmacokinetic (PK) parameters known to those in the art, e.g., such as AUC, Cₘₐₓ, or Tₘₐₓ, may be used to measure and assess bioavailability. In some embodiments, bioavailability may be assessed using measurements intended to reflect the rate and extent to which the active ingredient becomes available at the site of action.

“Binary vector” or “binary expression vector” means an expression vector which can replicate itself in both E. coli strains and Agrobacterium strains. Also, the vector contains a region of DNA (often referred to as t-DNA) bracketed by left and right border sequences that is recognized by virulence genes to be copied and delivered into a plant cell by Agrobacterium.

“bp” or “base pair” refers to a molecule comprising two chemical bases bonded to one another forming a. For example, a DNA molecule consists of two winding strands, wherein each strand has a backbone made of an alternating deoxyribose and phosphate groups. Attached to each deoxyribose is one of four bases, i.e., adenine (A), cytosine (C), guanine (G), or thymine (T), wherein adenine forms a base pair with thymine, and cytosine forms a base pair with guanine.

“C-terminus” or “C-terminal” refers to the free carboxyl group (i.e., —COOH) that is positioned on the terminal end of a polypeptide.

“cDNA” or “copy DNA” or “complementary DNA” refers to a molecule that is complementary to a molecule of RNA. In some embodiments, cDNA may be either single-stranded or double-stranded. In some embodiments, cDNA can be a double-stranded DNA synthesized from a single stranded RNA template in a reaction catalyzed by a reverse transcriptase. In yet other embodiments, “cDNA” refers to all nucleic acids that share the arrangement of sequence elements found in native mature mRNA species, where sequence elements are exons and 3′ and 5′ non-coding regions. Normally mRNA species have contiguous exons, with the intervening introns removed by nuclear RNA splicing, to create a continuous open reading frame encoding the protein. In some embodiments, “cDNA” refers to a DNA that is complementary to and derived from an mRNA template.

“CEW” refers to Corn earworm.

“Cleavable Linker” see Linker.

“Cloning” refers to the process and/or methods concerning the insertion of a DNA segment (e.g., usually a gene of interest, for example a polynucleotide operable to encode an insecticidal protein) from one source and recombining it with a DNA segment from another source (e.g., usually a vector, for example, a plasmid) and directing the recombined DNA, or “recombinant DNA” to replicate, usually by transforming the recombined DNA into a bacteria or yeast host.

“Coding sequence” or “CDS” refers to a polynucleotide or nucleic acid sequence that can be transcribed (e.g., in the case of DNA) or translated (e.g., in the case of mRNA) into a peptide, polypeptide, or protein, when placed under the control of appropriate regulatory sequences and in the presence of the necessary transcriptional and/or translational molecular factors. The boundaries of the coding sequence are determined by a translation start codon at the 5′ (amino) terminus and a translation stop codon at the 3′ (carboxy) terminus. A transcription termination sequence will usually be located 3′ to the coding sequence. In some embodiments, a coding sequence may be flanked on the 5′ and/or 3′ ends by untranslated regions. Generally, those having ordinary skill in the art distinguish the terms “coding sequence from the terms “open reading frame” and “ORF,” based upon the fact that the broadest definition of “open reading frame” simply contemplates a series of codons that does not contain a stop codon. Accordingly, while an ORF may contain introns, the coding sequence is distinguished by referring to those nucleotides (e.g., concatenated exons) that can be divided into codons that are actually translated into amino acids by the ribosomal translation machinery (i.e., a coding sequence does not contain introns); however, as used herein, the terms “coding sequence”; “CDS”; “open reading frame”; and “ORF,” are used interchangeably.

In some embodiments, a coding sequence can be used to produce a peptide, a polypeptide, or a protein product. In some embodiments, the coding sequence may or may not be fused to another coding sequence or localization signal, such as a nuclear localization signal. In some embodiments, the coding sequence may be cloned into a vector or expression construct, may be integrated into a genome, or may be present as a DNA fragment.

“Codon optimization” refers to the production of a gene in which one or more endogenous, native, and/or wild-type codons are replaced with codons that ultimately still code for the same amino acid, but that are of preference in the corresponding host.

“Colloid” refers to a phase separated mixture in which one substance of microscopically dispersed insoluble or soluble particles is suspended throughout another substance. “Colloidal” thus refers to a state of subdivision such that the molecules or polymolecular particles dispersed in a medium have at least one dimension between approximately 1 nm and 1 m, or that in a system discontinuities are found at distances of that order. See IUPAC Compendium of Chemical Terminology 1972, 31, 605. In some embodiments, the colloidal matter can refer to a liposome, a solid lipid particle, a micelle, a solid drug particle, a polymer or polymer particle, a solid gold or metal particle, a quantum dot, a dendrimer, a fullerene, a carbon nanotube, a (polymer) capsule, supramolecular assemblies, or any other nanoparticle.

“Complementary” refers to the topological compatibility or matching together of interacting surfaces of two polynucleotides as understood by those of skill in the art. Thus, two sequences are “complementary” to one another if they are capable of hybridizing to one another to form a stable anti-parallel, double-stranded nucleic acid structure. A first polynucleotide is complementary to a second polynucleotide if the nucleotide sequence of the first polynucleotide is substantially identical to the nucleotide sequence of the polynucleotide binding partner of the second polynucleotide, or if the first polynucleotide can hybridize to the second polynucleotide under stringent hybridization conditions. Thus, the polynucleotide whose sequence 5′-TATAC-3′ is complementary to a polynucleotide whose sequence is 5′-GTATA-3′.

“Conditioned medium” means the cell culture medium which has been used by cells and is enriched with cell derived materials but does not contain cells.

“Copy number” refers to the number of identical copies of a vector, an expression cassette, an amplification unit, a gene or indeed any defined nucleotide sequence, that are present in a host cell at any time. For example, in some embodiments, a gene or another defined chromosomal nucleotide sequence may be present in one, two, or more copies on the chromosome. An autonomously replicating vector may be present in one, or several hundred copies per host cell.

“CRIP” refers to cysteine rich insecticidal protein or cysteine rich insecticidal peptide. CRIPs are peptides rich in cysteine residues that, in some embodiments, are operable to form disulfide bonds between such cysteine residues. In some embodiments, CRIPs contain 4, 5, 6, 7, 8, 9, 10, or more cysteine amino acids. And, in some embodiments, the cysteine residues present in a CRIP may form 2, 3, 4, or more disulfide bonds. In some embodiments, the disulfide bonds contribute to the folding, three-dimensional structure, and activity of the insecticidal peptide. The cysteine-cysteine disulfide bonds, and the three dimensional structure they form, play a significant role in the insecticidal nature of these insecticidal peptides. In some embodiments, a CRIP may or may not comprise an inhibitor cystine knot (ICK) motif. For example, in some embodiments, a CRIP with an ICK motif can be an ACTX peptide from a spider; in other embodiments, a CRIP without an ICK motif, i.e., a non-ICK CRIP, can be, e.g., a peptide like Av2 and Av3, which are peptides isolated from sea anemones. Non-ICK CRIPS can have 4-8 cysteines which form 2-4 disulfide bonds. These cysteine-cysteine disulfide bonds stabilized toxic peptides (CRIPs) can have remarkable stability when exposed to the environment. Many CRIPs are isolated from venomous animals such as spiders, scorpions, snakes and sea snails and sea anemones and they are toxic to insects.

“Culture” or “cell culture” refers to the maintenance of cells in an artificial, in vitro environment.

“Culturing” refers to the propagation of organisms on or in various kinds of media. For example, the term “culturing” can mean growing a population of cells under suitable conditions in a liquid or solid medium. In some embodiments, culturing refers to fermentative recombinant production of a heterologous polypeptide of interest and/or other desired end products (typically in a vessel or reactor).

“Defined medium” means a medium that is composed of known chemical components but does not contain crude proteinaceous extracts or by-products such as yeast extract or peptone.

“Degeneracy” or “codon degeneracy” refers to the phenomenon that one amino acid can be encoded by different nucleotide codons. Thus, the nucleic acid sequence of a nucleic acid molecule that encodes a protein or polypeptide can vary due to degeneracies. As a result of the degeneracy of the genetic code, many nucleic acid sequences can encode a given polypeptide with a particular activity; such functionally equivalent variants are contemplated herein.

“Double expression cassette” refers to two expression cassettes contained on the same vector.

“Double transgene peptide expression vector” or “double transgene expression vector” means a yeast expression vector that contains two copies of the expression cassette.

“DNA” refers to deoxyribonucleic acid, comprising a polymer of one or more deoxyribonucleotides or nucleotides (i.e., adenine [A], guanine [G], thymine [T], or cytosine [C]), which can be arranged in single-stranded or double-stranded form. For example, one or more nucleotides creates a polynucleotide.

“dNTPs” refers to the nucleoside triphosphates that compose DNA and RNA.

“Encapsulation” or “entrapped” or “entrapment” or “encapsulated” are used interchangeably, and refers to encircling an internal phase typically resulting in an interior cavity separated from an external media. The components of the internal phase/interior cavity of a liposome are thus considered “encapsulated” within the liposome. In some embodiments, the encapsulated, internal phase of a liposome is an aqueous phase. As used herein, the term “encapsulation” or encapsulated” refers to the encapsulation of components (e.g., an insecticidal protein or agriculturally acceptable salt thereof) within the aqueous phase (e.g., the encapsulation of a hydrophilic molecule), or encapsulation within lipid bilayer (e.g., the encapsulation of a hydrophobic molecule). In some embodiments, a cargo or component (e.g., an insecticidal protein or agriculturally acceptable salt thereof) that is loaded into the interior cavity of a liposome—and therefore unavailable to the external medium until the liposome is triggered from release—would be considered as “encapsulated” within the liposome. In some embodiments, a bioactive agent such as an insecticidal protein or agriculturally acceptable salt thereof is encapsulated in the liposome and then applied or administered to the pest or area afflicted thereof. Alternatively, if the insecticidal protein or agriculturally acceptable salt thereof is lipophilic, it may associate with the lipid bilayer. In the present disclosure, the term “entrapment” and “encapsulated” shall be taken to include both the peptide in the aqueous volume of the liposome as well as peptide associated with the lipid bilayer.

“Endogenous” refers to a polynucleotide, peptide, polypeptide, protein, or process that naturally occurs and/or exists in an organism, e.g., a molecule or activity that is already present in the host cell before a particular genetic manipulation.

“Enhancer element” refers to a DNA sequence operably linked to a promoter, which can exert increased transcription activity on the promoter relative to the transcription activity that results from the promoter in the absence of the enhancer element.

“ER” or “Endoplasmic reticulum” is a subcellular organelle common to all eukaryotes where some post translation modification processes occur.

“ERSP” or “Endoplasmic reticulum signal peptide” is an N-terminus sequence of amino acids that—during protein translation of the mRNA molecule encoding an insecticidal protein—is recognized and bound by a host cell signal-recognition particle, which moves the protein translation ribosome/mRNA complex to the ER in the cytoplasm. The result is the protein translation is paused until it docks with the ER where it continues and the resulting protein is injected into the ER.

“ersp” refers to a polynucleotide encoding the peptide, ERSP.

“ER trafficking” means transportation of a cell expressed protein into ER for post-translational modification, sorting and transportation.

“Excipient” refers to any agriculturally or pharmaceutically acceptable additive, carrier, surfactant, emulsifier, thickener, preservative, solvent, disintegrant, glidant, lubricant, diluent, filler, bulking agent, binder, emollient, stiffening agent, chelating agent, stabilizer, solubilizing agents, dispersing agent, suspending agent, antioxidant, antiseptic, wetting agent, humectant, fragrant, suspending agents, pigments, colorants, isotonic agents, viscosity enhancing agents, mucoadhesive agents, and/or any combination thereof, that can be added to an agricultural composition, preparation, and/or formulation, which may be useful in achieving a desired modification to the characteristics of the agricultural composition, preparation, and/or formulation. Such modifications include, but are not limited to, physical stability, chemical stability, pesticidal efficacy, and/or any combination thereof.

“Expression cassette” refers to a segment of DNA that contains one or more (1) promoter and/or enhancer elements; (2) an appropriate mRNA stabilizing polyadenylation signal; and/or (3) the DNA sequence of interest, for example, a polynucleotide encoding an insecticidal protein. Additional elements that can included in an expression cassette are cis-acting elements such as an internal ribosome entry site (TRES); introns; and posttranscriptional regulatory elements.

“Growth medium” refers to a nutrient medium used for growing cells in vitro.

“Homologous” refers to the sequence similarity or sequence identity between two polypeptides or between two nucleic acid molecules. When a position in both of the two compared sequences is occupied by the same base or amino acid monomer subunit, e.g., if a position in each of two DNA molecules is occupied by adenine, then the molecules are homologous at that position. The percent of homology between two sequences is a function of the number of matching or homologous positions shared by the two sequences divided by the number of positions compared ×100. Thus, in some embodiments, the term “homologous” refers to the sequence similarity between two polypeptide molecules, or between two nucleic acid molecules. When a position in both of the two compared sequences is occupied by the same base or amino acid monomeric subunit, e.g., if a position in each of two DNA molecules is occupied by adenine, then the molecules are homologous at that position. The homology between two sequences is a function of the number of matching or homologous positions shared by the two sequences. For example, if 6 of 10 of the positions in two sequences are matched or homologous then the two sequences are 60% homologous. By way of example, the DNA sequences ATTGCC and TATGGC share 50% homology.

There may be partial homology, or complete homology and thus identical. “Sequence identity” refers to a measure of relatedness between two or more nucleic acid sequences or two or more polypeptide sequences, and is given as a percentage with reference to the total comparison length. The identity calculation takes into account those nucleotide residues or amino acid residues that are identical and in the same relative positions in their respective larger sequences.

“Homologous recombination” refers to the event of substitution of a segment of DNA by another one that possesses identical regions (homologous) or nearly so. For example, in some embodiments, “homologous recombination” refers to a type of genetic recombination in which nucleotide sequences are exchanged between two similar or identical molecules of DNA. Briefly, homologous recombination is most widely used by cells to accurately repair harmful breaks that occur on both strands of DNA, known as double-strand breaks. Although homologous recombination varies widely among different organisms and cell types, most forms involve the same basic steps: after a double-strand break occurs, sections of DNA around the 5′ ends of the break are cut away in a process called resection. In the strand invasion step that follows, an overhanging 3′ end of the broken DNA molecule then “invades” a similar or identical DNA molecule that is not broken. After strand invasion, the further sequence of events may follow either of two main pathways, i.e., the double-strand break repair pathway, or the synthesis-dependent strand annealing pathway. Homologous recombination is conserved across all three domains of life as well as viruses, suggesting that it is a nearly universal biological mechanism. For example, in some embodiments, homologous recombination can occur using a site-specific integration (SSI) sequence, whereby there is a strand exchange crossover event between nucleic acid sequences substantially similar in nucleotide composition. These crossover events can take place between sequences contained in the targeting construct of the disclosure (i.e., the SSI sequence) and endogenous genomic nucleic acid sequences (e.g., the polynucleotide encoding the peptide subunit). In addition, in some embodiments, it is possible that more than one site-specific homologous recombination event can occur, which would result in a replacement event in which nucleic acid sequences contained within the targeting construct have replaced specific sequences present within the endogenous genomic sequences.

“Hybrid peptide,” aka “hybrid toxin,” aka “hybrid-ACTX-Hv1a,” aka “native hybrid ACTX-Hv1a,” as well as “U peptide,” aka “U toxin,” aka “native U,” aka “U-ACTX-Hv1a,” aka “native U-ACTX-Hv1a,” all refer to an ACTX peptide, which was discovered from a spider known as the Australian Blue Mountains Funnel-web Spider, Hydronyche versuta, and is a positive allosteric modulators of the nicotinic acetylcholine receptor, and may also be a dual antagonist to insect voltage-gated Ca²⁺ channels and voltage-gated K⁺ channels. See Chambers et al., Insecticidal spider toxins are high affinity positive allosteric modulators of the nicotinic acetylcholine receptor. FEBS Lett. 2019 June; 593(12):1336-1350; and Windley et al., Lethal effects of an insecticidal spider venom peptide involve positive allosteric modulation of insect nicotinic acetylcholine receptors. Neuropharmacology. 2017 December; 127:224-242, the disclosures of which are incorporated herein by reference in their entireties.

“Hybrid+2” or “U+2 peptide” or “U+2 protein” or “U+2 toxin” or “U+2” or “U+2-ACTX-Hv1a” or “Spear” all refer to a U-ACTX-Hv1a having an additional dipeptide operably linked to the native peptide. The additional dipeptide that is operably linked to the U peptide is indicated by the “+2” or “plus 2” can be selected from among several peptides, any of which may result in a “U+2 peptide” with unique properties as discussed herein. In some preferred embodiments, the dipeptide is “GS”; an exemplary U+2-ACTX-Hv1a peptide is set forth in SEQ ID NO: 1.

“Hybridize” refers to the annealing of one single-stranded polynucleotide to another polynucleotide based on the well-understood principle of sequence complementarity. In some embodiments, the other polynucleotide is a single-stranded polynucleotide. The propensity for hybridization between polynucleotides depends on the temperature and ionic strength of their milieu, the length of the polynucleotides, and the degree of complementarity. The effect of these parameters on hybridization are well known in the art.

“Hybridization” refers to any process by which a strand of polynucleotide binds with a complementary strand through base pairing. Two single-stranded polynucleotides “hybridize” when they form a double-stranded duplex. Thus, as used herein, the term “hybridize” refers to the annealing of one single-stranded polynucleotide to another polynucleotide based on the well-understood principle of sequence complementarity. In some embodiments, the other polynucleotide is a single-stranded polynucleotide. The propensity for hybridization between polynucleotides depends on the temperature and ionic strength of their milieu, the length of the polynucleotides, and the degree of complementarity. The effect of these parameters on hybridization are well known in the art. When two single-stranded polynucleotides hybridize and form a double-stranded duplex, the region of double-strandedness can include the full-length of one or both of the single-stranded polynucleotides, or all of one single stranded polynucleotide and a subsequence of the other single stranded polynucleotide, or the region of double-strandedness can include a subsequence of each polynucleotide. Hybridization also includes the formation of duplexes which contain certain mismatches, provided that the two strands are still forming a double stranded helix. See “Stringent hybridization conditions” below.

“Hydrophilic” as used herein describes a polar molecule or part of a molecule that forms enough energetically favorable interactions with water molecules to dissolve readily in water.

“Hydrophobic” as used herein refers to a non-polar molecule or part of a molecule that cannot form energetically favorable interactions with water molecules and therefore does not dissolve in water.

“IC₅₀” or “IC50” refers to half-maximal inhibitory concentration, which is a measurement of how much of an agent is needed to inhibit a biological process by half, thus providing a measure of potency of said agent.

“ICK motif” or “ICK motif protein” or “inhibitor cystine knot motif” or “cystine knot motif” or “cystine knot peptides” refers to a 16 to 60 amino acid peptide with at least 6 half-cystine core amino acids having three disulfide bridges. In some embodiments, the three disulfide bridges are covalent bonds and of the six half-cystine residues the covalent disulfide bonds are between the first and fourth, the second and fifth, and the third and sixth half-cystines, of the six core half-cystine amino acids starting from the N-terminal amino acid. In some embodiments, peptides possessing this motif comprise beta-hairpin secondary structure, normally composed of residues situated between the fourth and sixth core half-cystines of the motif, the hairpin being stabilized by the structural crosslinking provided by the motif's three disulfide bonds.

“Identity” refers to a relationship between two or more polypeptide sequences or two or more polynucleotide sequences, as determined by comparing said sequences. The term “identity” also means the degree of sequence relatedness between polypeptide or polynucleotide sequences, as the case may be, as determined by the match between strings of such sequences. “Identity” and “similarity” can be readily calculated by any one of the myriad methods known to those having ordinary skill in the art, including but not limited to those described in: Computational Molecular Biology, Lesk, A. M., ed., Oxford University Press, New York, 1988; Biocomputing: Informatics and Genome Projects, Smith, D. W., ed., Academic Press, New York, 1993; Computer Analysis of Sequence Data, Part 1, Griffin, A. M., and Griffin, H. G., eds., Humana Press, New Jersey, 1994: Sequence Analysis in Molecular Biology, von Heinje, G., Academic Press, 1987; and Sequence Analysis Primer, Gribskov, M. and Devereux, J., eds., M Stockton Press, New York, 1991; and Carillo, H., and Lipman, D., SIAM J. Applied Math., 48: 1073 (1988), the disclosures of which are incorporated herein by reference in their entireties. Furthermore, methods to determine identity and similarity are codified in publicly available computer programs. For example in some embodiments, methods to determine identity and similarity between two sequences include, but are not limited to, the GCG program package (Devereux, J., et al., Nucleic Acids Research 12(1): 387 (1984)), BLASTP, BLASTN, and FASTA (Altschul, S. F. et al., J. Molec. Biol. 215: 403-410 (1990). The BLAST X program is publicly available from NCBI and other sources (BLAST Manual, Altschul, S., et al., NCBI NLM NIH Bethesda, Md. 20894; Altschul, S., et al., J. Mol. Biol. 215: 403-410 (1990), the disclosures of which are incorporated herein by reference in their entireties.

“in vivo” refers to the natural environment (e.g., an animal or a cell) and to processes or reactions that occur within a natural environment.

“Inactive” refers to a condition wherein something is not in a state of use, e.g., lying dormant and/or not working. For example, when used in the context of a gene or when referring to a gene, the term inactive means said gene is no longer actively synthesizing a gene product, having said gene product translated into a protein, or otherwise having the gene perform its normal function. For example, in some embodiments, the term inactive can refer the failure of a gene to transcribe RNA, a failure of RNA processing (e.g., pre-mRNA processing; RNA splicing; or other post-transcriptional modifications); interference with non-coding RNA maturation; interference with RNA export (e.g., from the nucleus to the cytoplasm); interference with translation; protein folding; translocation; protein transport; and/or inhibition and/or interference with any of the molecules polynucleotides, peptides, polypeptides, proteins, transcription factors, regulators, inhibitors, or other factors that take part in any of the aforementioned processes.

“Inhibiting” or “inhibit” or “combating” or “combat” or “controlling” or “control,” or any variation of these terms, refers to making something (e.g., the number of pests, the functions and/or activities of the pest, and/or the deleterious effect of the pest on a plant or animal susceptible to attack thereof) less in size, amount, intensity, or degree. For example, in some embodiments, the application of a pesticidally effective amount of a liposome comprising an insecticidal protein or agriculturally acceptable salt thereof, wherein the liposome encapsulates the insecticidal protein or agriculturally acceptable salt thereof, and wherein the liposome comprises lecithin, or an agricultural composition comprising the same and at least one excipient, to (i) the pest, a locus of the pest, a food supply of the pest, a habitat of the pest, or a breeding ground of the pest; (ii) a plant, a seed, a plant part, a locus of a plant, or an environment of a plant that is susceptible to an attack by the pest; (iii) an animal, a locus of an animal, or an environment of an animal susceptible to an attack by the pest; or (iv) a combination thereof, results in the following effect: a decrease in the number of pests, or inhibition of the pest's activities (e.g., the pest dies stops or slows its movement; stops or slows its feeding; stops or slows its growth; becomes confused, e.g., with regard to navigation, locating food, sleeping behaviors, and/or mating; fails to pupate if applicable; interferes with reproduction of the pest; and/or precludes the pest from producing offspring and/or precludes the insect from producing fertile offspring) relative to the number of pests or activities thereof that had not been exposed to a pesticidally effective amount of a liposome comprising an insecticidal protein or agriculturally acceptable salt thereof, wherein the liposome encapsulates the insecticidal protein or agriculturally acceptable salt thereof, and wherein the liposome comprises lecithin, or an agricultural composition comprising the same and at least one excipient.

In some embodiments, combating, controlling, or inhibiting a pest, includes any measurable decrease or complete inhibition to achieve a desired result. For example, there may be a decrease of about 1%, 2%, 3%, 4%, 5%, 6%, 7%, 8%, 9%, 10%, 15%, 20%, 25%, 30%, 35%, 40%, 45%, 50%, 55%, 60%, 65%, 70%, 75%, 80%, 85%, 90%, 95%, 99%, or more, in the number of pests or the activities thereof treated with peptides and/or compositions of the present disclosure, compared to untreated pests. About as used herein means within +10%, preferably +5% of a given value.

Thus, in some embodiments, the terms “combating, controlling, or inhibiting a pest,” refers to a decrease in the number of pests, or an inhibition of the activities of the pests (e.g., movement; feeding; growth; level of awareness or alertness, e.g., with regard to navigation, locating food, sleeping behaviors, and/or mating; pupation if applicable; reproduction; ability to produce offspring and/or ability to produce fertile offspring) that have received a pesticidally effective amount of a liposome comprising an insecticidal protein or agriculturally acceptable salt thereof, wherein the liposome encapsulates the insecticidal protein or agriculturally acceptable salt thereof; and wherein the liposome comprises lecithin, or an agricultural composition comprising the same and at least one excipient, that is at least about 0.1%, at least about 0.2%, at least about 0.3%, at least about 0.4%, at least about 0.5%, at least about 0.6%, at least about 0.7%, at least about 0.8%, at least about 0.9%, at least about 1%, at least about 1.25%, at least about 1.5%, at least about 1.75%, at least about 2%, at least about 2.25%, at least about 2.5%, at least about 2.75%, at least about 3%, at least about 3.25%, at least about 3.5%, at least about 3.75%, at least about 4%, at least about 4.25%, at least about 4.5%, at least about 4.75%, at least about 5%, at least about 5.25%, at least about 5.5%, at least about 5.75%, at least about 6%, at least about 6.25%, at least about 6.5%, at least about 6.75%, at least about 7%, at least about 7.25%, at least about 7.5%, at least about 7.75%, at least about 8%, at least about 8.25%, at least about 8.5%, at least about 8.75%, at least about 9%, at least about 9.25%, at least about 9.5%, at least about 9.75%, at least about 10%, at least about 11%, at least about 12%, at least about 13%, at least about 14%, at least about 15%, at least about 16%, at least about 17%, at least about 18%, at least about 19%, at least about 20%, at least about 21%, at least about 22%, at least about 23%, at least about 24%, at least about 25%, at least about 26%, at least about 27%, at least about 28%, at least about 29%, at least about 30%, at least about 31%, at least about 32%, at least about 33%, at least about 34%, at least about 35%, at least about 36%, at least about 37%, at least about 38%, at least about 39%, at least about 40%, at least about 41%, at least about 42%, at least about 43%, at least about 44%, at least about 45%, at least about 46%, at least about 47%, at least about 48%, at least about 49%, at least about 50%, at least about 50%, at least about 51%, at least about 52%, at least about 53%, at least about 54%, at least about 55%, at least about 56%, at least about 57%, at least about 58%, at least about 59%, at least about 60%, at least about 61%, at least about 62%, at least about 63%, at least about 64%, at least about 65%, at least about 66%, at least about 67%, at least about 68%, at least about 69%, at least about 70%, at least about 71%, at least about 72%, at least about 73%, at least about 74%, at least about 75%, at least about 80%, at least about 85%, at least about 90%, at least about 95%, at least about 100%, or a greater than a 100%, relative to the number of pests, or the inhibition of activities of the pests (e.g., movement; feeding; growth; level of awareness or alertness, e.g., with regard to navigation, locating food, sleeping behaviors, and/or mating; pupation if applicable; reproduction; ability to produce offspring and/or ability to produce fertile offspring) that have not received a pesticidally effective amount of a liposome comprising an insecticidal protein or agriculturally acceptable salt thereof, wherein the liposome encapsulates the insecticidal protein or agriculturally acceptable salt thereof, and wherein the liposome comprises lecithin, or an agricultural composition comprising the same and at least one excipient.

“Inoperable” refers to the condition of a thing not functioning, malfunctioning, or no longer able to function. For example, when used in the context of a gene or when referring to a gene, the term inoperable means said gene is no longer able to operate as it normally would, either permanently or transiently. For example, “inoperable,” in some embodiments, means that a gene is no longer able to synthesize a gene product, having said gene product translated into a protein, or is otherwise unable to gene perform its normal function. For example, in some embodiments, the term inoperable can refer the failure of a gene to transcribe RNA, a failure of RNA processing (e.g., pre-mRNA processing; RNA splicing; or other post-transcriptional modifications); interference with non-coding RNA maturation; interference with RNA export (e.g., from the nucleus to the cytoplasm); interference with translation; protein folding; translocation; protein transport; and/or inhibition and/or interference with any of the molecules polynucleotides, peptides, polypeptides, proteins, transcription factors, regulators, inhibitors, or other factors that take part in any of the aforementioned processes.

“Insect” includes all organisms in the class “Insecta.” The term “pre-adult” insects refers to any form of an organism prior to the adult stage, including, for example, eggs, larvae, and nymphs. As used herein, the term “insect refers to any arthropod and nematode, including acarids, and insects known to infest all crops, vegetables, and trees and includes insects that are considered pests in the fields of forestry, horticulture and agriculture. Examples of specific crops that might be protected with the methods disclosed herein are soybean, corn, cotton, alfalfa and the vegetable crops. A list of specific crops and insects is enclosed herein.

“Insect gut environment” or “gut environment” means the specific pH and proteinase conditions found within the fore, mid or hind gut of an insect or insect larva.

“Insect hemolymph environment” means the specific pH and proteinase conditions of found within an insect or insect larva.

“Insecticidal activity” means that upon or after exposing the insect to compounds, agents, or peptides, the insect either dies stops or slows its movement; stops or slows its feeding; stops or slows its growth; becomes confused (e.g., with regard to navigation, locating food, sleeping behaviors, and/or mating); fails to pupate; fails to find a mate; fails to successfully reproduce; fails to produce offspring; fails to produce fertile offspring; or any combination thereof.

“Insecticidal protein” refers to any peptide, amino acid sequence, polypeptide, protein or agriculturally acceptable salt thereof, having insecticidal activity against one or more pests. For example, in some embodiments, an insecticidal protein or agriculturally acceptable salt thereof can be any protein, wherein upon or after exposing a pest to said protein, the pest either: dies stops or slows its movement; stops or slows its feeding; stops or slows its growth; becomes confused (e.g., with regard to navigation, locating food, sleeping behaviors, and/or mating); fails to pupate; fails to find a mate; fails to successfully reproduce; fails to produce offspring; fails to produce fertile offspring; or any combination thereof.

In some embodiments, an insecticidal protein or agriculturally acceptable salt thereof can be a protein that is about 25-50 amino acids in length, and has insecticidal activity. In other embodiments, an insecticidal protein or agriculturally acceptable salt thereof can be a cysteine-rich insecticidal protein (CRIP). In yet other embodiments, an insecticidal protein can be a peptide, polypeptide, protein or toxin derived or isolated from: an arthropod, an amphibian, a reptile, a cnidarian, a mollusk, a fish, or a mammal. For example, an insecticidal protein can be a protein derived or isolated from: an athropod, e.g., a spider, a scorpion, a bee, a wasp, a centipede, a crustacean; a reptile, e.g., a snake or a lizard; an amphibian, e.g., a frog or a salamander; a hydrozoan, a cephalopod, an octopus, a squid, a cuttlefish, a fish, or a mammal. Accordingly, in some embodiments, an insecticidal protein or agriculturally acceptable salt thereof, can be an arthropod toxin, an amphibian toxin, a reptile toxin, a cnidarian toxin, a mollusk toxin, a fish toxin, a mammalian toxin, or a variant thereof.

In some embodiments, an insecticidal protein can be a wild-type protein, or a non-naturally occurring protein made via chemical or recombinant methods. For example, in some embodiments, an insecticidal protein of the present disclosure can be obtained directly from the source (e.g., isolating said insecticidal protein from an animal). In other embodiments, an insecticidal protein having a wild-type or mutant insecticidal protein amino acid sequence can be generated by chemically synthesizing a wild-type- or mutant-insecticidal-protein encoding polynucleotide, or chemically synthesizing a wild-type- or mutant-insecticidal-protein amino acid sequence. In yet other embodiments, an insecticidal protein having a wild-type or mutant insecticidal protein amino acid sequence can be generated by recombinantly expressing a wild-type- or mutant-insecticidal-protein encoding polynucleotide, or recombinantly expressing a wild-type- or mutant-insecticidal-protein amino acid sequence, in an recombinant expression system, e.g., a yeast recombinant expression system.

“Integrative expression vector” or “integrative vector” means a yeast expression vector which can insert itself into a specific locus of the yeast cell genome and stably becomes a part of the yeast genome.

“Intervening linker” refers to a short peptide sequence in the protein separating different parts of the protein, or a short DNA sequence that is placed in the reading frame in the ORF to separate the upstream and downstream DNA sequences. For example, in some embodiments, an intervening linker may be used allowing proteins to achieve their independent secondary and tertiary structure formation during translation. In some embodiments, the intervening linker can be either resistant or susceptible to cleavage in plant cellular environments, in the insect and/or lepidopteran gut environment, and in the insect hemolymph and lepidopteran hemolymph environment.

“Isolated” refers to separating a thing and/or a component from its natural environment, e.g., a toxin isolated from a given genus or species means that toxin is separated from its natural environment.

“Kappa-ACTX peptide” or “x-ACTX” refers to an excitatory toxin that inhibits insect calcium-activated potassium (KCa) channels (Slo-type). As used herein, “Kappa-ACTX peptide” can refer to peptides isolated from the Australian Blue Mountains Funnel-web Spider, Hadronyche versuta, or variants thereof.

“kb” refers to kilobase, i.e., 1000 bases. As used herein, the term “kb” means a length of nucleic acid molecules. For example, 1 kb refers to a nucleic acid molecule that is 1000 nucleotides long. A length of double-stranded DNA that is 1 kb long, contains two thousand nucleotides (i.e., one thousand on each strand). Alternatively, a length of single-stranded RNA that is 1 kb long, contains one thousand nucleotides.

“KD₅₀” or “Knockdown dose 50” refers to the median dose required to cause paralysis or cessation of movement in 50% of a population. As used herein, a “knockdown” of an insect is considered to have occurred upon an observation that the insect is unable to walk; unable to eat; is writhing; and/or is exhibiting tremors.

“kDa” refers to kilodalton, a unit equaling 1,000 daltons; a “Dalton” or “dalton” is a unit of molecular weight (MW).

“Knock in” or “knock-in” or “knocks-in” or “knocking-in” refers to the replacement of an endogenous gene with an exogenous or heterologous gene, or part thereof. For example, in some embodiments, the term “knock-in” refers to the introduction of a nucleic acid sequence encoding a desired protein to a target gene locus by homologous recombination, thereby causing the expression of the desired protein. In some embodiments, a “knock-in” mutation can modify a gene sequence to create a loss-of-function or gain-of-function mutation. The term “knock-in” can refer to the procedure by which a exogenous or heterologous polynucleotide sequence or fragment thereof is introduced into the genome, (e.g., “they performed a knock-in” or “they knocked-in the heterologous gene”), or the resulting cell and/or organism (e.g., “the cell is a “knock-in” or “the animal is a “knock-in”).

“Knock out” or “knockout” or “knock-out” or “knocks-out” or “knocking-out” refers to a partial or complete suppression of the expression gene product (e.g., mRNA) of a protein encoded by an endogenous DNA sequence in a cell. In some embodiments, the “knock-out” can be effectuated by targeted deletion of a whole gene, or part of a gene encoding a peptide, polypeptide, or protein. As a result, the deletion may render a gene inactive, partially inactive, inoperable, partly inoperable, or otherwise reduce the expression of the gene or its products in any cell in the whole organism and/or cell in which it is normally expressed. The term “knock-out” can refer to the procedure by which an endogenous gene is made completely or partially inactive or inoperable (e.g., “they performed a knock-out” or “they knocked-out the endogenous gene”), or the resulting cell and/or organism (e.g., “the cell is a “knock-out” or “the animal is a “knock-out”).

“l” or “linker” refers to a nucleotide encoding intervening linker peptide.

“L” in the proper context refers to an intervening linker peptide, which links a translational stabilizing protein (STA) with an additional polypeptide, e.g., an insecticidal protein, and/or multiple insecticidal proteins. When referring to amino acids, “L” can also mean leucine.

“LAC4 promoter” or “Lac4 promoter” or “pLac4” refers to a DNA segment comprised of the promoter sequence derived from the K. lactis β-galactosidase gene. The LAC4 promoters is strong and inducible reporter that is used to drive expression of exogenous genes transformed into yeast.

“LAC4 terminator” or “Lac4 terminator” refers to a DNA segment comprised of the transcriptional terminator sequence derived from the K. lactis P-galactosidase gene.

“Lamellarity” refers to the number of lipid bilayers in a liposome.

“Lepidopteran gut environment” means the specific pH and proteinase conditions of found within the fore, mid or hind gut of a lepidopteran insect or larva.

“Lepidopteran hemolymph environment” means the specific pH and proteinase conditions of found within lepidopteran insect or larva.

“LD₂₀” refers to a dose required to kill 20% of a population.

“LD₅₀” refers to lethal dose 50 which means the dose required to kill 50% of a population.

“Linker” or “LINKER” or “peptide linker” or “L” or “intervening linker” refers to a short peptide sequence operable to link two peptides together. Linker can also refer to a short DNA sequence that is placed in the reading frame of an ORF to separate an upstream and downstream DNA sequences. In some embodiments, a linker can be cleavable by an insect protease. In some embodiments, a linker may allow proteins to achieve their independent secondary and tertiary structure formation during translation. In some embodiments, the linker can be either resistant or susceptible to cleavage in plant cellular environments, in the insect and/or lepidopteran gut environment, and/or in the insect hemolymph and lepidopteran hemolymph environment. In some embodiments, a linker can be cleaved by a protease, e.g., in some embodiments, a linker can be cleaved by a plant protease (e.g., papain, bromelain, ficin, actinidin, zingibain, and/or cardosins), an insect protease, a fungal protease, a vertebrate protease, an invertebrate protease, a bacteria protease, a mammal protease, a reptile protease, or an avian protease. In some embodiments, a linker can be cleavable or non-cleavable. In some embodiments, a linker comprises a binary or tertiary region, wherein each region is cleavable by at least two types of proteases: one of which is an insect and/or nematode protease and the other one of which is a human protease. In some embodiments, a linker can have one of (at least) three roles: to cleave in the insect gut environment, to cleave in the plant cell, or to be designed not to intentionally cleave.

“Lipid” refers to a group of organic compounds that are esters of fatty acids and are typically characterized by being insoluble in water, but soluble in many organic solvents. In some embodiments, a lipid can be amphipathic, neutral, noncationic, anionic, or cationic. In some embodiments, lipid molecules can include fats, waxes, steroids, cholesterol, fat-soluble vitamins, monoglycerides, diglycerides, triglycerides, phospholipids, sphingolipids, glycolipids, cationic or anionic lipids, derivatized lipids, and the like, as described in detail below. In some embodiments, a lipid can be a sterol, sterol-like molecule, or derivative thereof. Sterols are a class of lipids containing a common steroid core of a fused four-ring structure with a hydrocarbon side chain and an alcohol group. Suitable lipids useful for forming the instant liposomes can be cationic, zwitterionic, neutral, or anionic. Lipids can form micelles, monolayers, and bilayer membranes. In some embodiments, the lipids can self-assemble into liposomes, i.e., a plurality of lipids, or multiple lipids, can join together to form liposomes. An exemplary disclosure providing a description of lipids is provided in U.S. Pat. No. 9,005,654, entitled “Systems and methods for manufacturing liposomes,” the disclosure of which is incorporated herein by reference in its entirety.

“Liposome” refers to vesicles comprising one or more concentrically ordered bilayers that encapsulate an aqueous phase. In some embodiments, a liposome comprises a plurality of amphipathic lipids having both hydrophobic and polar head group moieties, and which can form spontaneously into bilayer vesicles in an aqueous solution. In some embodiments, the hydrophobic moiety of a lipid composing a liposome is in contact with the interior, hydrophobic region of the bilayer membrane; the polar head group moiety is oriented toward the exterior, polar surface of the bilayer membrane. In some embodiments, the vesicle-forming lipids of this type typically include one or two hydrophobic acyl hydrocarbon chains or a steroid group, and may contain a chemically reactive group, such as an amine, acid, ester, aldehyde or 5 alcohol, at the polar head group. Included in this class, and without limitation, are the phospholipids, such as phosphatidyl choline (PC), phosphatidyl ethanolamine (PE), phosphatidic acid (PA), phosphatidyl inositol (PI), and sphingomyelin (SM), where the two hydrocarbon chains are typically between about 14-22 carbon atoms in length, and have varying degrees of unsaturation.

Liposomes are typically classified according to size and lamellarity. The term liposome, as used herein, contemplates all types of liposomes known to those having ordinary skill in the art, and any type of liposome disclosed herein; for example, the term liposome includes unilamellar, multilamellar, and multi-vesicular vesicle. In some embodiments, a liposome can be a small unilamellar vesicle (SUV); a large unilamellar vesicle (LUV); or a giant unilamellar vesicle (GUV). In other embodiments, a liposome can be a multi unilamellar vesicle (MLV) or a multi vesicular vesicle (MVV). Unilamellar vesicles typically comprise a single lipid bilayer, have a diameter in the range of about 20 nm to about 400 nm. In some embodiments, liposomes can be multilamellar, having a general diameter in the range of about 1 m to about 10 m. In some embodiments, a liposome can comprise a single or multiple concentric lipid bilayers encapsulating an aqueous compartment.

In some embodiments, a liposome comprises a plurality of amphipathic lipids having both hydrophobic and polar head group moieties, and which can form spontaneously into bilayer vesicles in an aqueous solution. In some embodiments, the hydrophobic moiety of a lipid composing a liposome is in contact with the interior, hydrophobic region of the bilayer membrane; the polar head group moiety is oriented toward the exterior, polar surface of the bilayer membrane. In some embodiments, the vesicle-forming lipids of this type typically include one or two hydrophobic acyl hydrocarbon chains or a steroid group, and may contain a chemically reactive group, such as an amine, acid, ester, aldehyde or 5 alcohol, at the polar head group. Included in this class are the phospholipids, such as phosphatidyl choline (PC), phosphatidyl ethanolamine (PE), phosphatidic acid (PA), phosphatidyl inositol (PI), and sphingomyelin (SM), where the two hydrocarbon chains are typically between about 14-22 carbon atoms in length, and have varying degrees of unsaturation.

“Locus of a pest” refers to the habitat of a pest; food supply of a pest; breeding ground of a pest; area traveled by or inhabited by a pest; material infested, eaten, used by a pest; and/or any environment in which a pest inhabits, uses, is present in, or is expected to be. In some embodiments, the locus of a pest includes, without limitation, a pest habitat; a pest food supply; a pest breeding ground; a pest area; a pest environment; any surface or location that may be frequented and/or infested by a pest; any plant or animal, or a locus of a plant or animal, susceptible to attack by a pest; and/or any surface or location where a pest may be found, may be expected to be found, or is likely to be attacked by a pest.

“Locus of a plant” refers to any place in which a plant is growing; any place where plant propagation materials of a plant are sown; any place where plant propagation materials of a plant will be placed into the soil; or any area where plants are stored, including without limitation, live plants and/or harvested plants, leaves, seeds, fruits, or parts thereof.

“Locus of an animal” refers to any place where animals live, eat, breed, sleep, or otherwise are present in.

“Medium” (plural “media”) refers to a nutritive solution for culturing cells in cell culture.

“Micelle” refers to an aggregate of molecules in a colloidal solution. In some embodiments, a micelle is an aggregate of amphiphilic molecules such as lipids, assembled so as to form a particle with a hydrophobic interior and a hydrophilic exterior. Micelles are generally spherical assemblies with diameters below 100 nm, although a range of micelle diameters and varying micelle shapes, such as discoid micelles, are known in the art. While liposomes are composed of a lipid bilayer separating an aqueous internal compartment from the bulk aqueous phase, micelles are closed lipid monolayers with a fatty acid core and polar surface, or polar core with fatty acids on the surface (inverted micelle).

“MOA” refers to mechanism of action.

“Modified-insecticidal protein” refers to any amino acid sequence, peptide, polypeptide, protein, configuration, or arrangement, comprising: (1) at least one insecticidal protein; (2) two or more insecticidal proteins; or (3) at least one insecticidal protein, or two or more insecticidal proteins, and additional peptides, polypeptides, or proteins. For example, in some embodiments, these additional peptides, polypeptides, or proteins have the ability to increase the mortality and/or inhibit the growth of insects when the insects are exposed to an insecticidal protein, relative to a insecticidal protein alone; increase the expression of said insecticidal protein, e.g., in a host cell or an expression system; and/or affect the post-translational processing of the insecticidal protein. In some embodiments, an insecticidal protein can be a polymer comprising two or more insecticidal proteins. In some embodiments, an insecticidal protein can be a polymer comprising two or more insecticidal proteins, wherein the insecticidal proteins are operably linked via a linker peptide, e.g., a cleavable and/or non-cleavable linker. In some embodiments, an insecticidal protein can refer to a one or more insecticidal proteins operably linked with one or more proteins such as a stabilizing domain (STA); an endoplasmic reticulum signaling protein (ERSP); an insect cleavable or insect non-cleavable linker (L); and/or any other combination thereof. In some embodiments, an insecticidal protein can be a non-naturally occurring protein comprising (1) a wild-type insecticidal protein; and (2) additional peptides, polypeptides, or proteins, e.g., an ERSP; a linker; a STA; a UBI; or a histidine tag or similar marker.

“Molecular weight (MW)” refers to the mass or weight of a molecule, and is typically measured in “daltons (Da)” or kilodaltons (kDa). In some embodiments, MW can be calculated using sodium dodecyl sulfate polyacrylamide gel electrophoresis (SDS-PAGE), analytical ultracentrifugation, or light scattering. In some embodiments, the SDS-PAGE method is as follows: the sample of interest is separated on a gel with a set of molecular weight standards. The sample is run, and the gel is then processed with a desired stain, followed by destaining for about 2 to 14 hours. The next step is to determine the relative migration distance (Rf) of the standards and protein of interest. The migration distance can be determined using the following equation:

$$Rf = \frac{M i g r ation distance of the protein}{M i g r ation distance of the dye front} \qquad Formula ( I )$$

Next, the logarithm of the MW can be determined based on the values obtained for the bands in the standard; e.g., in some embodiments, the logarithm of the molecular weight of an SDS-denatured polypeptide and its relative migration distance (Rf) is plotted into a graph. After plotting the graph, interpolating the value derived will provide the molecular weight of the unknown protein band. In some embodiments, a reference ladder can be used to determine approximate MW; these methods are well known to those having ordinary skill in the art.

“Motif” refers to dominant feature and/or distinct pattern in a molecule; e.g., a distinct pattern of amino acids that operate in a function-specific protein sequence. In some embodiments, a motif is a polynucleotide or polypeptide sequence that is implicated in having some biological significance and/or exerts some effect or is involved in some biological process.

“Multiple cloning site” or “MCS” refers to a segment of DNA found on a vector that contains numerous restriction sites in which a DNA sequence of interest can be inserted.

“Mutant” refers to an organism, polynucleotide, DNA sequence, amino acid sequence, peptide, polypeptide, or protein, that has an alteration or variation (for example, a variation in the nucleotide sequence or the amino acid sequence, and/or a variation in a gene that is reflected in the phenotype of an organism), which causes said nucleotide sequence, amino acid sequence, and/or organism to be different from the naturally occurring or wild-type organism, wild-type sequence, and/or reference sequence with which the mutant is being compared. In some embodiments, this alteration or variation can be one or more nucleotide and/or amino acid substitutions or modifications (e.g., deletion or addition). In some embodiments, the one or more amino acid substitutions or modifications can be conservative; here, such a conservative amino acid substitution and/or modification in a “mutant” does not substantially diminish the activity of the mutant in relation to its non-mutant form. For example, in some embodiments, a “mutant” possesses one or more conservative amino acid substitutions when compared to a peptide with a disclosed and/or claimed sequence, as indicated by a SEQ ID NO.

“N-terminus” or “N-terminal” refers to the free amine group (i.e., —NH₂) that is positioned on beginning or start of a polypeptide.

“NCBI” refers to the National Center for Biotechnology Information.

“nm” refers to nanometers.

“Non-Polar amino acid” is an amino acid that is weakly hydrophobic and includes glycine, alanine, proline, valine, leucine, isoleucine, phenylalanine and methionine. Glycine or gly is the most preferred non-polar amino acid for the dipeptides of this disclosure.

“Normalized peptide yield” means the peptide yield in the conditioned medium divided by the corresponding cell density at the point the peptide yield is measured. The peptide yield can be represented by the mass of the produced peptide in a unit of volume, for example, mg per liter or mg/L, or by the UV absorbance peak area of the produced peptide in the HPLC chromatograph, for example, mAu·sec. The cell density can be represented by visible light absorbance of the culture at wavelength of 600 nm (OD600).

“OD” refers to optical density. Typically, OD is measured using a spectrophotometer. When measuring growth over time of a cell population, OD600 is preferable to UV spectroscopy; this is because at a 600 nm wavelength, the cells will not be harmed as they would under too much UV light.

“OD660 nm” or “OD_{660 nm}” refers to optical densities of a liquid sample measured (for example, yeast cell culture) when measured in a spectrophotometer at 660 nanometers (nm).

“Omega peptide” or “omega toxin,” or “omega-ACTX-Hv1a,” or “native omegaACTX-Hv1a” or “Omega-ACTX” or “co-ACTX” all refer to an ACTX peptide which was first isolated from a spider known as the Australian Blue Mountains Funnel-web Spider, Hadronyche versuta. Omega peptide is a positive allosteric modulators of the nicotinic acetylcholine receptor, and may also be a dual antagonist to insect voltage-gated Ca²⁺ channels and voltage-gated K⁺ channels. See Chambers et al., Insecticidal spider toxins are high affinity positive allosteric modulators of the nicotinic acetylcholine receptor. FEBS Lett. 2019 June; 593(12):1336-1350; and Windley et al., Lethal effects of an insecticidal spider venom peptide involve positive allosteric modulation of insect nicotinic acetylcholine receptors. Neuropharmacology. 2017 December; 127:224-242, the disclosures of which are incorporated herein by reference in their entireties.

“One letter code” means the peptide sequence which is listed in its one letter code to distinguish the various amino acids in the primary structure of a protein: alanine=A, arginine=R, asparagine=N, aspartic acid=D, asparagine or aspartic acid=B, cysteine=C, glutamic acid=E, glutamine=Q, glutamine or glutamic acid=Z, glycine=G, histidine=H, isoleucine=I, leucine=L, lysine=K, methionine=M, phenylalanine=F, proline=P, serine=S, threonine=T, tryptophan=W, tyrosine=Y, and valine=V.

“Open reading frame” or “ORF” refers to a length of RNA or DNA sequence, between a translation start signal (e.g., AUG or ATG, respectively) and any one or more of the known termination codons, which encodes one or more polypeptide sequences. Put another way, the ORF describes the frame of reference as seen from the point of view of a ribosome translating the RNA code, insofar that the ribosome is able to keep reading (i.e., adding amino acids to the nascent protein) because it has not encountered a stop codon. Thus, “open reading frame” or “ORF” refers to the amino acid sequence encoded between translation initiation and termination codons of a coding sequence. Here, the terms “initiation codon” and “termination codon” refer to a unit of three adjacent nucleotides (i.e., a codon) in a coding sequence that specifies initiation and chain termination, respectively, of protein synthesis (mRNA translation).

In some embodiments, an ORF is a continuous stretch of codons that begins with a start codon (usually ATG for DNA, and AUG for RNA) and ends at a stop codon (usually UAA, UAG or UGA). In other embodiments, an ORF can be length of RNA or DNA sequence, between a translation start signal (e.g., AUG or ATG) and any one or more of the known termination codons, wherein said length of RNA or DNA sequence encodes one or more polypeptide sequences. In some other embodiments, an ORF can be a DNA sequence encoding a protein which begins with an ATG start codon and ends with a TGA, TAA or TAG stop codon. ORF can also mean the translated protein that the DNA encodes. Generally, those having ordinary skill in the art distinguish the terms “open reading frame” and “ORF,” from the term “coding sequence,” based upon the fact that the broadest definition of “open reading frame” simply contemplates a series of codons that does not contain a stop codon. Accordingly, while an ORF may contain introns, the coding sequence is distinguished by referring to those nucleotides (e.g., concatenated exons) that can be divided into codons that are actually translated into amino acids by the ribosomal translation machinery (i.e., a coding sequence does not contain introns); however, as used herein, the terms “coding sequence”; “CDS”; “open reading frame”; and “ORF,” are used interchangeably.

“Operable” refers to the ability to be used, the ability to do something, and/or the ability to accomplish some function or result. For example, in some embodiments, “operable” refers to the ability of a polynucleotide, DNA sequence, RNA sequence, or other nucleotide sequence or gene to encode a peptide, polypeptide, and/or protein. For example, in some embodiments, a polynucleotide may be operable to encode a protein, which means that the polynucleotide contains information that imbues it with the ability to create a protein (e.g., by transcribing mRNA, which is in turn translated to protein).

“Operably linked” refers to a juxtaposition wherein the components so described are in a relationship permitting them to function in their intended manner. For example, in some embodiments, operably linked can refer to two or more DNA, peptide, or polypeptide sequences. In other embodiments, operably linked can mean that the two adjacent DNA sequences are placed together such that the transcriptional activation of one DNA sequence can act on the other DNA sequence. In yet other embodiments, the term “operably linked” can refer to two or more peptides and/or polypeptides, wherein said two or more peptides and/or polypeptides are connected in such a way as to yield a single polypeptide chain; alternatively, the term operably linked can refer to two or more peptides that are connected in such a way that one peptide exerts some effect on the other. In yet other embodiments, operably linked can refer to two adjacent DNA sequences are placed together such that the transcriptional activation of one can act on the other.

“Pest” includes, but is not limited to: insects, fungi, bacteria, nematodes, mites, ticks, and the like.

“Pesticidally-effective amount” refers to an amount of the pesticide that is able to bring about death to at least one pest, or to noticeably reduce pest growth, feeding, or normal physiological development. This amount will vary depending on such factors as, for example, the specific target pests to be controlled, the specific environment, location, plant, crop, or agricultural site to be treated, the environmental conditions, and the method, rate, concentration, stability, and quantity of application of the pesticidally-effective polypeptide composition. The formulations may also vary with respect to climatic conditions, environmental considerations, and/or frequency of application and/or severity of pest infestation.

“Plant” shall mean whole plants, plant tissues, plant cells, plant parts, plant organs (e.g., leaves, stems, roots, etc.), seeds, propagules, embryos and progeny of the same. Plant cells can be differentiated or undifferentiated (e.g. callus, suspension culture cells, protoplasts, leaf cells, root cells, phloem cells, and pollen).

“Plasmid” refers to a DNA segment that acts as a carrier for a gene of interest, and, when transformed or transfected into an organism, can replicate and express the DNA sequence contained within the plasmid independently of the host organism. Plasmids are a type of vector, and can be “cloning vectors” (i.e., simple plasmids used to clone a DNA fragment and/or select a host population carrying the plasmid via some selection indicator) or “expression plasmids” (i.e., plasmids used to produce large amounts of polynucleotides and/or polypeptides).

“Polar amino acid” is an amino acid that is polar and includes serine, threonine, cysteine, asparagine, glutamine, histidine, tryptophan and tyrosine; preferred polar amino acids are serine, threonine, cysteine, asparagine and glutamine; with serine being most highly preferred.

“Polynucleotide” refers to a polymeric-form of nucleotides (e.g., ribonucleotides, deoxyribonucleotides, or analogs thereof) of any length; e.g., a sequence of two or more ribonucleotides or deoxyribonucleotides. As used herein, the term “polynucleotide” includes double- and single-stranded DNA, as well as double- and single-stranded RNA; it also includes modified and unmodified forms of a polynucleotide (modifications to and of a polynucleotide, for example, can include methylation, phosphorylation, and/or capping). In some embodiments, a polynucleotide can be one of the following: a gene or gene fragment (for example, a probe, primer, EST, or SAGE tag); genomic DNA; genomic DNA fragment; exon; intron; messenger RNA (mRNA); transfer RNA; ribosomal RNA; ribozyme; cDNA; recombinant polynucleotide; branched polynucleotide; plasmid; vector; isolated DNA of any sequence; isolated RNA of any sequence; nucleic acid probe; primer or amplified copy of any of the foregoing.

In yet other embodiments, a polynucleotide can refer to a polymeric-form of nucleotides operable to encode the open reading frame of a gene.

In some embodiments, a polynucleotide can refer to cDNA.

In some embodiments, polynucleotides can have any three-dimensional structure and may perform any function, known or unknown. The structure of a polynucleotide can also be referenced to by its 5′- or 3′-end or terminus, which indicates the directionality of the polynucleotide. Adjacent nucleotides in a single-strand of polynucleotides are typically joined by a phosphodiester bond between their 3′ and 5′ carbons. However, different internucleotide linkages could also be used, such as linkages that include a methylene, phosphoramidate linkages, etc. This means that the respective 5′ and 3′ carbons can be exposed at either end of the polynucleotide, which may be called the 5′ and 3′ ends or termini. The 5′ and 3′ ends can also be called the phosphoryl (PO₄) and hydroxyl (OH) ends, respectively, because of the chemical groups attached to those ends. The term polynucleotide also refers to both double- and single-stranded molecules. Unless otherwise specified or required, any embodiment that makes or uses a polynucleotide encompasses both the double-stranded form and each of two complementary single-stranded forms known or predicted to make up the double-stranded form.

In some embodiments, a polynucleotide can include modified nucleotides, such as methylated nucleotides and nucleotide analogs (including nucleotides with non-natural bases, nucleotides with modified natural bases such as aza- or deaza-purines, etc.). If present, modifications to the nucleotide structure can be imparted before or after assembly of the polynucleotide.

In some embodiments, a polynucleotide can also be further modified after polymerization, such as by conjugation with a labeling component. Additionally, the sequence of nucleotides in a polynucleotide can be interrupted by non-nucleotide components. One or more ends of the polynucleotide can be protected or otherwise modified to prevent that end from interacting in a particular way (e.g. forming a covalent bond) with other polynucleotides.

In some embodiments, a polynucleotide can be composed of a specific sequence of four nucleotide bases: adenine (A); cytosine (C); guanine (G); and thymine (T). Uracil (U) can also be present, for example, as a natural replacement for thymine when the polynucleotide is RNA. Uracil can also be used in DNA. Thus, the term “sequence” refers to the alphabetical representation of a polynucleotide or any nucleic acid molecule, including natural and non-natural bases.

The term “RNA molecule” or ribonucleic acid molecule refers to a polynucleotide having a ribose sugar rather than deoxyribose sugar and typically uracil rather than thymine as one of the pyrimidine bases. An RNA molecule of the disclosure is generally single-stranded, but can also be double-stranded. In the context of an RNA molecule from an RNA sample, the RNA molecule can include the single-stranded molecules transcribed from DNA in the cell nucleus, mitochondrion or chloroplast, which have a linear sequence of nucleotide bases that is complementary to the DNA strand from which it is transcribed.

In some embodiments, a polynucleotide can further comprise one or more heterologous regulatory elements. For example, in some embodiments, the regulatory element is one or more promoters; enhancers; silencers; operators; splicing signals; polyadenylation signals; termination signals; RNA export elements, internal ribosomal entry sites (IRES); poly-U sequences; or combinations thereof.

“Post-transcriptional regulatory elements” are DNA segments and/or mechanisms that affect mRNA after it has been transcribed. Mechanisms of post-transcriptional mechanisms include splicing events; capping, splicing, and addition of a Poly (A) tail, and other mechanisms known to those having ordinary skill in the art.

“Promoter” refers to a region of DNA to which RNA polymerase binds and initiates the transcription of a gene.

“Proportion knockdown” or “proportional knockdown” refers to the proportion of individual insects knocked-down over the course of an experiment. Proportion knockdown can be calculated according to Formula (II), as follows:

$$Proportion knockdown = \frac{Number of knock down individuals}{Number of total individuals} \qquad Formula ( II )$$

wherein “knockdown” of an insect is considered to have occurred upon an observation that the insect is unable to walk; unable to eat; is writhing; and/or is exhibiting tremors.

“Proportion mortality” or “proportional mortality” or “proportion dead” refers to the proportion of individual insects killed over the course of an experiment. Proportion mortality can be calculated according to Formula (III), as follows:

$$Proportion mortality = \frac{N umber of dead individuals}{N umber of total individuals} \qquad Formula ( III )$$

“Protein” has the same meaning as “peptide” and/or “polypeptide” in this document.

“Ratio” refers to the quantitative relation between two amounts showing the number of times one value contains or is contained within the other.

“Reading frame” refers to one of the six possible reading frames, three in each direction, of the double stranded DNA molecule. The reading frame that is used determines which codons are used to encode amino acids within the coding sequence of a DNA molecule. In some embodiments, a reading frame is a way of dividing the sequence of nucleotides in a polynucleotide and/or nucleic acid (e.g., DNA or RNA) into a set of consecutive, non-overlapping triplets.

“Recombinant DNA” or “rDNA” refers to DNA that is comprised of two or more different DNA segments.

“Recombinant vector” means a DNA plasmid vector into which foreign DNA has been inserted.

“Regulatory elements” refers to a genetic element that controls some aspect of the expression and/or processing of nucleic acid sequences. For example, in some embodiments, a regulatory element can be found at the transcriptional and post-transcriptional level. Regulatory elements can be cis-regulatory elements (CREs), or trans-regulatory elements (TREs). In some embodiments, a regulatory element can be one or more promoters; enhancers; silencers; operators; splicing signals; polyadenylation signals; termination signals; RNA export elements, internal ribosomal entry sites (IRES); poly-U sequences; and/or other elements that influence gene expression, for example, in a tissue-specific manner; temporal-dependent manner; to increase or decrease expression; and/or to cause constitutive expression.

“Restriction enzyme” or “restriction endonuclease” refers to an enzyme that cleaves DNA at a specified restriction site. For example, a restriction enzyme can cleave a plasmid at an EcoRI, SacII or BstXI restriction site allowing the plasmid to be linearized, and the DNA of interest to be ligated.

“Restriction site” refers to a location on DNA comprising a sequence of 4 to 8 nucleotides, and whose sequence is recognized by a particular restriction enzyme.

“Selection gene” means a gene which confers an advantage for a genetically modified organism to grow under the selective pressure.

“Serovar” or “serotype” refers to a group of closely related microorganisms distinguished by a characteristic set of antigens. In some embodiments, a serovar is an antigenically and serologically distinct variety of microorganism.

“Size” or “Particle size” or “particle diameter” or “diameter” are used interchangeably, and refer to the diameter of the liposome, i.e., the length of the outer diameter of the liposome. If the liposomes are not spherical, the foregoing terms refer to the largest cross-sectional diameter of the liposome. The size or diameter of a liposome can be measured using any method described herein. For example, in some embodiments, light scattering, flow cytometry, electron microscopy, ultracentrifugation, gel filtration, high performance liquid chromatography (HPLC), or a combination thereof, can be used to determine the diameter or liposomes. In some embodiments, quasi-elastic or dynamic light scattering (DLS) can be used to determine the diameter of a liposome. See, e.g., U.S. Pat. No. 4,927,571, and Hupfeld et al., Liposome size analysis by dynamic/static light scattering upon size exclusion-/field flow-fractionation. J Nanosci Nanotechnol. September-October 2006; 6(9-10):3025-31. DLS is the most common analytical technique used for measuring liposomes especially liposomes that are below 1 μm in size. Evaluation of liposomes via quasi-elastic or DLS provides the mean diameter and distribution of the liposomes. Moreover, DLS can distinguish whether the liposomes are uniformly distributed around one or more particle sizes (unimodal vs. bimodal). Measuring liposomes via DLS is disclosed in greater detail below.

“sp.” refers to species.

“ssp.” or “subsp.” refers to subspecies.

“Subcloning” or “subcloned” refers to the process of transferring DNA from one vector to another, usually advantageous vector. For example, polynucleotide encoding a mutant Av3 polypeptide can be subcloned into a pLB102 plasmid subsequent to selection of yeast colonies transformed with pKLAC1 plasmids.

“SSI” is an acronym that is context dependent. In some contexts, it can refer to “site-specific integration,” which is used to refer to a sequence that will permit in vivo homologous recombination to occur at a specific site within a host organism's genome. Thus, in some embodiments, the term “site-specific integration” refers to the process directing a transgene to a target site in a host-organism's genome, allowing the integration of genes of interest into pre-selected genome locations of a host-organism. However, in other contexts, SSI can refer to “surface spraying indoors,” which is a technique of applying a variable volume sprayable volume of an insecticide onto surfaces where vectors rest, such as on walls, windows, floors and ceilings.

“STA” or “Translational stabilizing protein” or “stabilizing domain” or “stabilizing protein” (used interchangeably herein) means a peptide or protein with sufficient tertiary structure that it can accumulate in a cell without being targeted by the cellular process of protein degradation. The protein can be between 5 and 50 amino acids long. The translational stabilizing protein is coded by a DNA sequence for a protein that is operably linked with a sequence encoding an insecticidal protein in the ORE. The operably-linked STA can either be upstream or downstream of the insecticidal protein and can have any intervening sequence between the two sequences (STA and insecticidal protein) as long as the intervening sequence does not result in a frame shift of either DNA sequence. The translational stabilizing protein can also have an activity which increases delivery of the insecticidal protein across the gut wall and into the hemolymph of the insect.

“sta” means a nucleotide encoding a translational stabilizing protein.

“Stringent hybridization” or “stringent hybridization conditions” refers to conditions under which a polynucleotide (e.g., a nucleic acid probe, primer or oligonucleotide) will hybridize to its target sequence, typically in a complex mixture of nucleic acids, but not to other sequences. Stringent hybridization conditions are sequence—and length-dependent, and depend on % (percent)-identity (or %-mismatch) over a certain length of nucleotide residues. Longer sequences hybridize specifically at higher temperatures than shorter sequences. Generally, stringent conditions are selected to be about 5° C. lower than the thermal melting point (Tm) for the specific sequence at a defined ionic strength and pH. Stringent conditions may also be achieved with the addition of destabilizing agents, such as formamide.

“Susceptible to attack by a pest(s),” refer to plants, or human or animal patients or subjects, susceptible to a pest or a pest infections.

“Toxin” refers to a venom and/or a poison, especially a protein or conjugated protein produced by certain animals, higher plants, and pathogenic bacteria. For example, in some embodiments, an insecticidal protein can be a toxin, e.g., an arthropod toxin, an amphibian toxin, a reptile toxin, a cnidarian toxin, a mollusk toxin, a fish toxin, a mammalian toxin, or a variant thereof. Generally, the term “toxin” is reserved natural products, e.g., molecules and peptides found in scorpions, spiders, snakes, poisonous mushrooms, etc., whereas the term “toxicant” is reserved for man-made products and/or artificial products e.g., man-made chemical pesticides. However, as used herein, the terms “toxin” and “toxicant” are used synonymously.

“Transfection” and “transformation” both refer to the process of introducing exogenous and/or heterologous DNA or RNA (e.g., a vector containing a polynucleotide that encodes a CRIP) into a host organism (e.g., a prokaryote or a eukaryote). Generally, those having ordinary skill in the art sometimes reserve the term “transformation” to describe processes where exogenous and/or heterologous DNA or RNA are introduced into a bacterial cell; and reserve the term “transfection” for processes that describe the introduction of exogenous and/or heterologous DNA or RNA into eukaryotic cells. However, as used herein, the term “transformation” and “transfection” are used synonymously, regardless of whether a process describes the introduction exogenous and/or heterologous DNA or RNA into a prokaryote (e.g., bacteria) or a eukaryote (e.g., yeast, plants, or animals).

“Transgene” means a heterologous and/or exogenous DNA sequence encoding a protein which is transformed into a plant.

“Transgenic host cell” or “host cell” means a cell which is transformed with a gene and has been selected for its transgenic status via an additional selection gene.

“U-ACTX-Hv1a.” See Hybrid.

“U+2-ACTX-Hv1a.” See Hybrid+2.

“UBI” refers to ubiquitin. For example, in some embodiments, UBI can refer to a ubiquitin monomer isolated from Zea mays.

“var.” refers to varietas or variety. The term “var.” is used to indicate a taxonomic category that ranks below the species level and/or subspecies (where present). In some embodiments, the term “var.” represents members differing from others of the same subspecies or species in minor but permanent or heritable characteristics.

“Variant” or “variant sequence” or “variant peptide” or “variant thereof” refer to an amino acid sequence that possesses one or more amino acid substitutions or modifications (e.g., deletion or addition). In some embodiments, the one or more amino acid substitutions or modifications can be conservative; here, such a conservative amino acid substitution and/or modification in a “variant” does not substantially diminish the activity of the variant in relation to its non-varied form. For example, in some embodiments, a “variant” possesses one or more conservative amino acid substitutions when compared to a peptide with a disclosed and/or claimed sequence, as indicated by a SEQ ID NO.

“Vector” refers to the DNA segment that accepts a foreign gene of interest. The gene of interest is known as an “insert” or “transgene.”

“Wild type” or “WT” refer to the phenotype and/or genotype (i.e., the appearance or sequence) of an organism, polynucleotide sequence, and/or polypeptide sequence, as it is found and/or observed in its naturally occurring state or condition.

“Yeast expression vector” or “expression vector” or “vector” means a plasmid which can introduce a heterologous gene and/or expression cassette into yeast cells to be transcribed and translated.

“Yield” refers to the production of a peptide, and increased yields can mean increased amounts of production, increased rates of production, and an increased average or median yield and increased frequency at higher yields. The term “yield” when used in reference to plant crop growth and/or production, as in “yield of the plant” refers to the quality and/or quantity of biomass produced by the plant.

Throughout this specification, unless specifically stated otherwise or the context requires otherwise, reference to a single step, composition of matter, group of steps or group of compositions of matter shall be taken to encompass one and a plurality (i.e., one or more) of those steps, compositions of matter, groups of steps or group of compositions of matter.

Exemplary methods and techniques described in the present disclosure, unless specified otherwise, rely on convention techniques in molecular biology, microbiology, virology, recombinant DNA technology, solid phase and liquid nucleic acid synthesis, peptide synthesis in solution, solid phase peptide synthesis, immunology, cell culture, and formulation. Such procedures are described, for example, in Sambrook, Fritsch & Maniatis, Molecular Cloning: A Laboratory Manual, Cold Spring Harbor Laboratories, New York, Second Edition (1989), whole of Vols I, II, and III; DNA Cloning: A Practical Approach, Vols. I and II (D. N. Glover, ed., 1985), IRL Press, Oxford, whole of text; Oligonucleotide Synthesis: A Practical Approach (M. J. Gait, ed, 1984) IRL Press, Oxford, whole of text, and particularly the papers therein by Gait, pp 1-22; Atkinson et al, pp 35-81; Sproat et al, pp 83-115; and Wu et al, pp 135-151; 4. Nucleic Acid Hybridization: A Practical Approach (B. D. Hames & S. J. Higgins, eds., 1985) IRL Press, Oxford, whole of text; Immobilized Cells and Enzymes: A Practical Approach (1986) IRL Press, Oxford, whole of text; Perbal, B., A Practical Guide to Molecular Cloning (1984); Methods In Enzymology (S. Colowick and N. Kaplan, eds., Academic Press, Inc.), whole of series; J. F. Ramalho Ortigao, “The Chemistry of Peptide Synthesis” In: Knowledge database of Access to Virtual Laboratory website (Interactiva, Germany); Sakakibara, D., Teichman, J., Lien, E. Land Fenichel, R. L. (1976). Biochem. Biophys. Res. Commun. 73 336-342; Merrifield, R. B. (1963). J. Am. Chem. Soc. 85, 2149-2154; Barany, G. and Merrifield, R. B. (1979) in The Peptides (Gross, E. and Meienhofer, 3. eds.), vol. 2, pp. 1-284, Academic Press, New York. 12. Wiinsch, E., ed. (1974) Synthese von Peptiden in Houben-Weyls Metoden der Organischen Chemie (Muler, E., ed.), vol. 15, 4th edn., Parts 1 and 2, Thieme, Stuttgart; Bodanszky, M. (1984) Principles of Peptide Synthesis, Springer-Verlag, Heidelberg; Bodanszky, M. & Bodanszky, A. (1984) The Practice of Peptide Synthesis, Springer-Verlag, Heidelberg; Bodanszky, M. (1985) Int. J. Peptide Protein Res. 25, 449-474; Handbook of Experimental Immunology, Vols. I-IV (D. M. Weir and C. C. Blackwell, eds., 1986, Blackwell Scientific Publications); and Animal Cell Culture: Practical Approach, Third Edition (John R. W. Masters, ed., 2000); each of these references are incorporated herein by reference in their entireties.

Although the disclosure of the invention has been described in detail for purposes of clarity and understanding, it will be obvious to those with skill in the art that certain modifications can be practiced within the scope of the appended claims. All publications and patent documents cited herein are hereby incorporated by reference in their entirety for all purposes to the same extent as if each were so individually denoted.

Throughout this specification, unless the context requires otherwise, the word “comprise,” or variations such as “comprises” or “comprising,” will be understood to imply the inclusion of a stated step or element or integer or group of steps or elements or integers but not the exclusion of any other step or element or integer or group of elements or integers.

All patent applications, patents, and printed publications referred to herein are incorporated by reference in their entirety to the same extent as if each individual publication, patent, or patent application was specifically and individually indicated to be incorporated by reference in its entirety. And, all patent applications, patents, and printed publications cited herein are incorporated herein by reference in the entireties, except for any definitions, subject matter disclaimers, or disavowals, and except to the extent that the incorporated material is inconsistent with the express disclosure herein, in which case the language in this disclosure controls.

### Liposomes: Background

Liposomes are vesicles comprising one or more concentrically ordered bilayers encapsulating an aqueous phase. Liposomes may be unilamellar vesicles (possessing a single membrane bilayer) or multilamellar vesicles (onion-like structures characterized by multiple membrane bilayers, each separated from the next by an aqueous layer). The bilayer is composed of two lipid monolayers having a hydrophobic “tail” region and a hydrophilic “head” region. The structure of the membrane bilayer is such that the hydrophobic (nonpolar) “tails” of the lipid monolayers orient toward the center of the bilayer while the hydrophilic “head” orient towards the aqueous phase.

Liposomes can be classified into several categories based on their overall size and the nature of the lamellar structure. These classifications include, inter alia, small unilamellar vesicles (SUV), multilamellar vesicles (MLV), large unilamellar vesicles (LUV), oligolamellar vesicles (OLVs), and others, as discussed in greater detail below.

Due to their structure, chemical composition, and colloidal size, all of which can be well controlled during preparation protocols, liposomes exhibit several properties that can be useful in various applications. The most important properties of liposomes include the colloidal and/or special membrane and surface characteristics thereof. For example, colloidal-stable liposomes can be used as carriers for different molecules, e.g., proteins.

Liposomes also are useful due to their bilayer phase behavior, mechanical properties, permeability, and/or charge density. Moreover, because of the amphiphilic properties possessed by some liposomes, they represent a powerful solubilizing system for a wide range of compounds.

Furthermore, liposomes have a non-equilibrium structure, and are less sensitive to external changes than agents possessing an equilibrium structure (e.g., micelles). And, in addition to the aforementioned physicochemical properties, liposomes exhibit special biological characteristics, such as specific interactions with biological membranes and/or various cells.

### Types of Liposomes

Generally, liposomes can be classified based on characteristics such as size; preparation method; and/or number of lamella. See Karami et al., Liposomes as a Novel Drug Delivery System: Fundamental and Pharmaceutical Application. Asian J. Pharm. January-March 2018 (Suppl); 12 (1), S31.

Unilamellar liposomes, also referred to as single lamellar vesicles, are spherical vesicles that include one lipid bilayer membrane that defines a single closed aqueous compartment. The bilayer membrane includes two layers (or “leaflets”) of lipids; an inner layer and an outer layer. The outer layer of the lipid molecules is oriented with the hydrophilic head portions toward the external aqueous environment and the hydrophobic tails pointed downward toward the interior of the liposome. The inner layer of the lipid lay directly beneath the outer layer with the lipids oriented with the heads facing the aqueous interior of the liposome and the tails oriented toward the tails of the outer layer of lipid.

Multilamellar liposomes, also referred to as multilamellar vesicles or multiple lamellar vesicles, include more than one lipid bilayer membrane, which membranes define more than one closed aqueous compartment. The membranes are concentrically arranged so that the different membranes are separated by aqueous compartments, much like an onion.

### Small Unilamellar Vesicles (SUVs)

Small unilamellar vesicles (SUVs) range in diameter from about 20 nanometers to about to 100 nanometers (nm), and consist of a single lipid bilayer surrounding an aqueous compartment. A characteristic of SUVs is that a large amount of the total lipid, about 70%, is located in the outer layer of the bilayer. The most frequently encountered and easily prepared liposomes are the multilamellar vesicles. Where SUVs are single compartment vesicles of a fairly uniform size, MLVs vary greatly in diameter—from up to about 30,000 nm—and are multicompartmental in their structure, wherein the liposome bilayers are typically organized as closed concentric lamellae with an aqueous layer separating each lamella from the next.

In some embodiments, the present disclosure comprises, consists essentially of, or consists of, a liposome that is a small unilamellar vesicles (SUVs) formed by a single lipid bilayer.

In some embodiments, a SUV can be from about 20 nm to about 100 nm in diameter.

In some embodiments, a SUV can be from about 0.02 μm to about 0.05 μm in diameter.

### Large Unilamellar Vesicles (LUVs)

Large unilamellar vesicles (LUVs) are so named because of their large diameter, which can range from about 100 nm to about 1000 nm.

In some embodiments, the present disclosure comprises, consists essentially of, or consists of, a liposome, and/or plurality of liposomes that are large unilamellar vesicles (LUVs), formed by a single lipid bilayer.

In some embodiments, a LUV can be about 100 nm to about 1000 nm in diameter.

In some embodiments, a LUV can be from about 0.06 μm to about 0.1 μm in diameter.

In some embodiments, an LUV can be spherical. In other embodiments, an LUV can be non-spherical, e.g., dumbbell-shaped.

### Giant Unilamellar Vesicles (GUVs)

In some embodiments, the present disclosure comprises, consists essentially of, or consists of, a liposome that is a giant unilamellar vesicle (GUV)

In some embodiments, a GUV can be about 1 μm or greater in diameter.

In some embodiments, a GUV can be spherical, with a size of from about 1 m to about 1,000 m in diameter.

In accordance with the present disclosure, a droplet is a small volume of liquid, irrespective of its form. Preferably, the droplet is at least substantially ellipsoidal or at least substantially spherical. More preferably, the droplet provided in step a) is spherical and has an outer diameter of 1 to 1,000 m, even more preferably of 10 to 1200 m and most preferably of 20 to 60 m. This allows to obtain spherical giant unilamellar vesicle with a cell-like size

### Multilamellar Vesicles (MLVs)

In some embodiments, the present disclosure comprises, consists essentially of, or consists of, a liposome that is a multi-lamellar vesicle (MLV), which are formed by multiple membrane layers. As stated above, liposomes containing more than five lamellae are typically called multilamellar vesicles (MLVs).

In some embodiments, a MLV can have a diameter of varying size. In some embodiments, the diameter of a MLV may be the size of an SUV, an LUV, or a GUV.

In some embodiments, a MLV can be about 500 nm or greater in diameter, and can include vesicles that are about 1000 nm or greater in diameter.

In some embodiments, a MLV can be spherical, with a size of from about 1 m to about 1,000 m in diameter.

### Multi-Vesicular Vesicle (MVVs)

In some embodiments, the present disclosure comprises, consists essentially of, or consists of, a liposome that is multi-vesicular vesicle (MVV), which are formed by multiple membrane layers.

In some embodiments, a MVV can have a diameter of varying size. In some embodiments, the diameter of a MVV may be the size of an SUV, an LUV, or a GUV.

In some embodiments, a MVV can be from about 2 μm to about 40 μm in diameter.

### Oligolamellar Vesicles (OLVs)

Oligolamellar vesicles (OLVs) are intermediate liposomes having a larger aqueous space than MLVs, and a smaller aqueous space than LUVs. OLVs also have more than one internal compartment, and possibly several concentric lamellae, but they have fewer lamellae than MLVs.

In some embodiments, oligolamellar vesicles have a morphology comprising between two and five concentric lamellae, whereas liposomes containing more than five lamellae are typically called multilamellar vesicles (MLVs).

In some embodiments, an OLV can be about 500 nm or greater in diameter.

In some embodiments, an OLV can be from about 0.1 μm to about 10 μm in diameter.

### Stable Plurilamellar Vesicles (SPLVs)

In some embodiments, a liposome of the present disclosure can be an SPLV.

SPLVs are lipid vesicles possessing from a few to over one hundred lipid bilayers. The membrane bilayer is composed of a bimolecular layer of amphipathic lipids, in which the non-polar hydrophobic hydrocarbon “tails” point inward towards the center of the bilayer, and the polar, hydrophilic “heads” point towards the aqueous phase. Occluded by the bilayers is an aqueous compartment, part of which makes up the lumen of the vesicle, and part of which lies between adjacent layers. Complexed with the lipid bilayers can be a variety of proteins, glycoproteins, glycolipids, mucopolysaccharides, and any other hydrophobic and/or amphipathic substance. Aside from being structurally different than multilamellar vesicles (MLVs), SPLVs are also prepared differently than MLVs, possess unique properties when compared to MLVs, and present a variety of different advantages when compared to such MLVs. As a result of these differences, SPLVs overcome many of the problems presented by conventional lipid vesicles heretofore available.

### Monophasic Vesicles (MPVs)

In some embodiments, a liposome of the present disclosure can be an MPV.

MPVs are clearly distinct in their properties from liposomes with a single or several lamellae (e.g., SUVs, MLVs, etc.). MPVs share some physical properties in common with SPLVs described above. For example, MPVs exhibit greater stability in urea than do SPLVs. In addition, MPVs are more stable than SPLVs in storage, and in other environments.

An exemplary description of MPVs is provided in U.S. Pat. No. 4,588,578, the disclosure of which is incorporated herein by reference in its entirety.

### Frozen and Thawed Multilamellar Vesicles (FATMLVs)

A FATMLV is an MLV that has been exposed to at least one freeze and thaw cycle. An exemplary description of FATMLVs is provided by Bally et al., PCT Publication No. 87/00043, Jan. 15, 1987, entitled “Multilamellar Liposomes Having Improved Trapping Efficiencies”; and U.S. Pat. No. 4,975,282; the disclosures of which are incorporated herein by reference in their entireties.

### Amphoteric Liposomes

In some embodiments, the present disclosure comprises, consists essentially of, or consists of, a liposome that is an amphoteric liposome. For example, in some embodiments, the amphoteric liposome can have an anionic or neutral charge at about pH 7.5 and cationic charge at pH 4.

In some embodiments, the liposome of the present disclosure comprises, consists essentially of, or consists of, a mixture of lipids that may be neutral.

In some embodiments, the liposome of the present disclosure comprises, consists essentially of, or consists of, a mixture of one or more charged amphiphiles. In some embodiments, said one or more charged amphiphiles are amphoteric, being negatively charged or neutral at pH 7.4 and positively charged at pH 4.

By “amphoteric” herein is meant a substance, a mixture of substances or a supra-molecular complex (e.g., a liposome) comprising charged groups of both anionic and cationic character wherein:
(i) at least one of the charged groups has a pK between 4 and 8,
(ii) the cationic charge prevails at pH 4, and
(iii) the anionic charge prevails at pH 8,
resulting in an isoelectric point of neutral net charge between pH 4 and pH 8. Amphoteric character is by this definition different from zwitterionic character, as zwitterions do not have a pK in the range mentioned above. In consequence, zwitterions are essentially neutrally charged over a range of pH values. An example of such lipids are phosphatidylcholines and phosphatidylethanolamines, both of which are neutral lipids with zwitterionic character.

Accordingly, in some embodiments, said mixture may comprise a plurality of charged amphiphiles that, in combination with one another, have amphoteric character.

In some embodiments, said one or more charged amphiphiles comprise a pH sensitive anionic lipid and a pH sensitive cationic lipid. In some embodiments, said chargeable cation may have a pK value of between from about 4 and about 8; or between about 5.0 or 5.5 and about 7.0 or 7.5. In some embodiments, the chargeable anion may have a pK value of between from about 3.5 and about 7; or between about 4 or 4.5 and about 6.0 or 6.5. Examples include MoChol/CHEMS, DPIM/CHEMS and DPIM/DGSucc.

In some embodiments, amphiphiles with multiple charges can be used. For example, in some embodiments, the amphiphile can be amphipathic dicarboxylic acids, phosphatidic acid, amphipathic piperazine derivatives and the like. Such multi-charged amphiphiles may be pH sensitive amphiphiles or stable anions or cations, or they may have “mixed” character.

In some embodiments, an amphoteric liposome can have one or more membrane-bound groups composing the bilayer membrane.

In some embodiments, the overall molecule assumes its pH-dependent charge characteristics by the simultaneous presence of cationic and anionic groups in the “amphoteric substance” molecule portion. More specifically, an amphoteric substance is characterized by the fact that the sum of its charge components will be precisely zero at a particular pH value. This point is referred to as isoelectric point. Above the pI the compound has a negative charge, and below the pI it is to be regarded as a positive cation, the pI of the compounds or sterol derivatives according to the disclosure ranging between 4.5 and 8.5.

The overall charge of the molecule at a particular pH value of the medium can be calculated using the equation z=Σni×((qi−1)+(10^{(pK-pH)}/(1+10^{(pK-pH)})), or as follows:

$$Z = Σ n i \times ( q i - 1 ) + \frac{1 {0}^{p K - p H}}{1 + 1 {0}^{p K - p H}} \qquad Formula ( IV )$$

qi: absolute charge of the ionic group below the pK thereof (e.g. carboxyl=0, single-nitrogen base=1)
ni: number of such groups in the molecule.

For example, a compound according to the disclosure is formed by coupling the amino group of histidine to cholesterol hemisuccinate. At a neutral pH value of 7, the product has a negative charge because the carboxyl function which is present therein is in its fully dissociated form, and the imidazole function only has low charge. At an acid pH value of about 4, the situation is reversed: the carboxyl function now is largely discharged, while the imidazole group is fully protonated, and the overall charge of the molecule therefore is positive.

### Other Types of Liposomes

In some embodiments, liposomes can be conventional liposomes; fusogenic liposomes; pH sensitive liposomes; cationic liposomes; thermosensitive liposomes; or immune liposomes (i.e., liposomes further comprising antibodies or fragments thereof).

In some embodiments, a liposome of the present disclosure can be a specialty liposome. For example, in some embodiments, the liposome can have one or more of the following characteristics: bipolar fatty acids; methyl/methylene x-linkage; lipoprotein coating; and/or a carbohydrate coating.

In some embodiments, a liposome of the present disclosure can be a fusogenic liposome, wherein the liposome fuses with a membrane (e.g., a cell membrane). For example, in some embodiments, fusion of the liposome and cell membrane can be described as the unification of the outermost bilayer of the liposome with the plasma membrane of the cell. See Huang, L. Liposome-Cell Interactions In Vitro”, in: Liposomes, M. Ostro, ed., Marcel Dekker, Inc., New York, (1983), 87-124.

The proposed mechanism by which fusion occurs between lipid membranes involves neutralization of the charged headgroups, resulting in an effective change in the geometry of the lipid species producing nonbilayer-preferring structures. These in turn give rise to micelles or other defects in the bilayer which act as nucleation sites for membrane fusion. See Cullis, et al., Effects of fusogenic agent on membrane structure of erythrocyte ghosts and the mechanism of membrane fusion. Nature, 271:672-674, 1978; and Hope, et al., “CA.sup.2+ and pH Induced Fusion of Small Unilamellar Vesicles Consisting of phosphatidylethanolamine and Negatively Charged Phospholipids: A Freeze Fracture Study”, Biochem, Biophys, Res. Comm. 110(1): 15-22, 1983.

In some embodiments, the present disclosure comprises, consists essentially of, or consists of, a liposome that is a nanoliposomes (submicron bilayer lipid vesicles).

### Components of Liposomes

A major component of liposomes are lipids. Lipids are a group of organic compounds that are esters of fatty acids and are typically characterized by being insoluble in water, but soluble in many organic solvents. Generally, liposomes can be formed using standard vesicle-forming lipids known in the art. These standard vesicle-forming lipids generally include, e.g., a neutral and negatively charged phospholipid and a sterol, such as cholesterol; however, as described below, a variety of alternative lipids and other molecules can be used to generate liposomes of the present disclosure. Those having ordinary skill in the art will recognize that the selection of lipids is generally guided by considerations of, e.g., liposome size. lamellarity, and stability of the liposomes.

In some embodiments, the liposome composition of the present disclosure can be formed from standard vesicle-forming lipids, which generally include neutral and negatively charged phospholipids and a sterol, such as cholesterol.

In some embodiments, the selection of lipids is guided by considerations of (a) release rate in serum of the encapsulated insecticidal peptide, (b) insecticidal peptide-entrapment efficiency, (c) liposome toxicity, (d) bio-distribution and targeting properties, (e) stability of the liposome, or (f) any combination thereof.

In some embodiments, a liposome of the present disclosure comprises, consists essentially of, or consists of, one or more lipids.

In some embodiments, a lipid can be amphipathic, neutral, noncationic, anionic, or cationic. In some embodiments, lipid molecules can include fats, waxes, steroids, cholesterol, fat-soluble vitamins, monoglycerides, diglycerides, triglycerides, phospholipids, sphingolipids, glycolipids, cationic or anionic lipids, derivatized lipids, and the like, as described in detail below. In some embodiments, a lipid can be a sterol, sterol-like molecule, or derivative thereof. Sterols are a class of lipids containing a common steroid core of a fused four-ring structure with a hydrocarbon side chain and an alcohol group.

In some embodiments, a liposome of the present disclosure comprises, consists essentially of, or consists of, one or more of the following lipids: cationic, zwitterionic, neutral, or anionic.

In some embodiments, any one or more of the lipids of the present disclosure are operable to form micelles, monolayers, and bilayer membranes.

In some embodiments, the lipids can self-assemble into liposomes, i.e., a plurality of lipids, or multiple lipids, can join together to form liposomes.

In some embodiments, the lipid can be selected from any one or more sterols, cholesterol molecules, or sterol-like molecules. 02951 In some embodiments, the lipid can be a phospholipid. Phospholipids are major components of cell membranes, and comprise a hydrophobic tail, and a hydrophilic (or polar) head. 02961 In some embodiments, a liposome of the present disclosure can comprise, consist essentially of, or consist of, a natural phospholipid. 02971 In some embodiments, a liposome of the present disclosure can comprise, consist essentially of, or consist of, a synthetic phospholipid.

In some embodiments, the present disclosure comprises, consists essentially of, or consists of, a liposome composed of any one or more lipids found in the table below, or a natural or synthetic derivative thereof. A description of exemplary lipids as used herein, and their abbreviations, can be found in the table below.

TABLE 1
Lipids and their abbreviations.

| Lipid name | Abbreviation |
|---|---|
| Phosphatidylcholine | PC |
| Phosphatidylethanolamine | PE |
| Sphingomyelin | SM |
| Dimyristoylphosphatidylcholine | DMPC |
| Dipalmitoylphosphatidylcholine | DPPC |
| Distearoylphosphatidylcholine | DSPC |
| Palmitoyl-oleoylphosphatidylcholine | POPC |
| Dioleoylphosphatidylcholine | DOPC |
| Dioleoylphosphatidylethanolamine | DOPE |
| Dimyristoylphosphatidylethanolamine | DMPE |
| Dipalmitoylphosphatidylethanolamine | DPPE |
| Cholesterolhemisuccinate | CHEMS |
| Cholesterolhemimalonate | Chol-C3 |
| Cholesterolhemiglutarate | Chol-C5 |
| Cholesterolhemiadipate | Chol-C6 |
| Diacylglycerolhemisuccinate (unspecified membrane | DGS or DG-Succ |
| anchor) | |
| Dioleoylglycerolhemisuccinate | DOGS or DOG-Succ |
| Dimyristoylglycerolhemisuccinate | DMGS or DMG-Succ |
| Dipalmitoylglycerolhemisuccinate | DPGS or DPG-Succ |
| Distearoylglycerolhemisuccinate | DSGS or DSG-Succ |
| Palmitoyloleoylglycerolhemisuccinate | POGS or POG-Succ |
| Dioleoylglycerolhemimalonate | DOGM |
| Dioleoylglycerolhemiglutarate | DOGG |
| Dioleoylglycerolhemiadipate | DOGA |
| Dimyristoylglycerolhemimalonate | DMGM |
| Dimyristoylglycerolhemiglutarate | DMGG |
| Dimyristoylglycerolhemiadipate | DMGA |
| 1,2-dioleoyl-3-dimethylammonium-propane | DODAP |
| 1,2-Dioleyloxy-3-dimethylaminopropane | DODMA |
| 4-{(1,2-Dioleoyl-ethyl)amino}-4-oxobutanoic acid | DOAS |
| 4-{(1,2-Dioleoyl-ethyl)amino}-4-oxopropanoic acid | DOAM |
| 4-{(1,2-Dioleoyl-ethyl)amino}-4-oxopentanoic acid | DOAG |
| 4-{(1,2-Dioleoyl-ethyl)amino}-4-oxohexanoic acid | DOAA |
| 4-{(1,2-Dimyristoyl-ethyl)amino}-4-oxobutanoic acid | DMAS |
| 4-{(1,2-Dimyristoyl-ethyl)amino}-4-oxopropanoic acid | DMAM |
| 4-{(1,2-Dimyristoyl-ethyl)amino}-4-oxopentanoic acid | DMAG |
| 4-{(1,2-Dimyristoyl-ethyl)amino}-4-oxohexanoic acid | DMAA |
| 5,6-Dioleoyl-hexanoic acid | DOS |
| 4,5-Dioleoyl-pentanoic acid | DOM |
| 6,7-Dioleoyl-heptanoic acid | DOG |
| 7,8-Dioleoyl-octanoic acid | DOA |
| 5,6-Dimyristoyl-hexanoic acid | DMS |
| 4,5-Dimyristoyl-pentanoic acid | DMM |
| 6,7-Dimyristoyl-heptanoic acid | DMG |
| 7,8-Dioleoyl-octanoic acid | DMA |
| Dioleoylphosphatidylserine | DOPS |
| Dipalmitoylphosphatidylserine | DPPS |
| Dioleoylphosphatidylglycerol | DOPG |
| Dipalmitoylphosphatidylglycerol | DPPG |
| Cholesterol sulfate | Chol-SO4 |
| Dioleoylphosphatidic acid | DOPA |
| Sodium dodecyl sulfate | SDS |
| Cholesterol-(3-imidazol-1-yl propyl)carbamate | CHIM |
| Dimethyldioctadecylammonium bromide | DDAB |
| 1,2-Diacyl-3-Trimethylammonium-Propane | DOTAP, DMTAP, DPTAP, |
| | DSTAP |
| 1,2-Diacyl-3-Dimethylammonium-Propane | DMDAP, DPDAP, DSDAP |
| 1,2-Diacyl-sn-Glycero-3-Ethylphosphocholine | DOEPC, DMEPC, DPEPC, |
| | DSEPC |
| N-[1-(2,3-dioleyloxy)propyl]-N,N,N-trimethyl ammonium | DOTMA |
| chloride | |
| 1-[2-(oleoyloxy)ethyl]-2-oleyl-3-(2-hydroxyethyl) | DOTIM |
| imidazolinium chloride | |
| N-(a-trimethylammonioacetyl)-didodecyl-D-glutamate | TMAG |
| chloride | |
| O-(2R-1,2-di-O-(19Z,99Z-octadecadienyl)-glycerol)-N-(bis- | BCAT |
| 2-aminoethyl) carbamate | |
| Dioleyldimethylammonium chloride | DODAC |
| 1,2-dioleoyl-3-dimethyl-hydroxyethyl ammonium bromide | DORIE |
| 1,2-dimyristoyl-3-dimethyl-hydroxyethyl ammonium | DMRIE |
| bromide | |
| 1,2-dioleoyl-3-succinyl-sn-glycerol choline ester | DOSC |
| 1,2-dioleoyloxypropyl-3-dimethylhydroxyethylammonium | DORI |
| chloride | |
| N,N-di-n-hexadecyl-N, Ndihydroxyethylammoniumbromide | DHMHAC |
| N,N-di-n-hexadecyl-N-methyl,N-(2-hydroxyethyl) | DHDEAB |
| ammonium chloride | |
| N,N-myristyl-N-(1-hydroxyprop-2-yl)-N- | DMHMAC |
| methylammoniumchloride | |
| 1,2-dioleoyl-3-(4′-trimethylammonio)butanoyl-sn-glycerol | DOTB |
| Synthetic Amphiphiles INTerdisciplinary | SAINT |
| 4,(2,3-bis-acyloxy-propyl)-1-methyl-1H-imidazole | DPIM, DOIM |
| (unspecified membrane anchor) | |
| 2,3-bis-palmitoyl-propyl-pyridin-4-yl-amine | DPAPy |
| 3b-[N-(N9,N9- | DC-Chol |
| dimethylaminoethane)carbamoyl]cholesterol | |
| 3b-[N-(N9,N9- | TC-Chol |
| trimethylaminoethane)carbamoyl]cholesterol | |
| 3b(N-(N,N′-Dimethylaminoethan)-carbamoyl) cholesterol | DAC-Chol |
| 4{N-2-ethylamino[(3′-cholesteryl) carbamoyl]}piperazine | PipC2Chol |
| {N-2-ethylamino[(3′-cholesteryl) carbamoyl]}morpholine | MoC2Chol |
| {N-2-propylamino[(3′-cholesteryl) carbamoyl]}morpholine | MoC3Chol |
| N-methyl{4-N-amino[(3′-cholesteryl) | N-methyl-PipChol |
| carbamoyl]}piperazine | |
| {N-2-ethylamino[(3′-cholesteryl) carbamoyl]}pyrrolidine | PyrroC2Chol |
| {N-2-ethylamino[(3′-cholesteryl) carbamoyl]}piperidine | PipeC2Chol |
| ImC3Chol {N-2-propylamino[(3′-cholesteryl) | ImC3Chol |
| carbamoyl]}imidazole | |
| PyC2Chol {N-2-ethylamino[(3′-cholesteryl) | PyC2Chol |
| carbamoyl]}pyridine | |
| Cetyltrimethylammonium bromide | CTAB |
| [1,3-Bis-(1,2-bis-tetradecyloxy-propyl-3- | NeoPhectin ™ cationic |
| dimethylethoxyammoniumbromide)-propane-2-ol] | cardiolipins |
| N-Histidinyl-Cholesterol-hemisuccinate | HistChol |
| 4-(2-Aminoethyl)-Morpholino-Cholesterolhemisuccinate: | MoChol |
| Histaminyl-Cholesterolhemisuccinate: | HisChol |
| 4-(2-Aminoethyl)-Morpholino-Cholesterol-2,3- | DmC4Mo2 |
| dimethylhemisuccinate | |
| 4-(2-Aminoethyl)-Morpholino-Cholesterol-2,2- | DmC3Mo2 |
| dimethylhemimalonate | |
| 4-(2-Aminoethyl)-Morpholino-Cholesterol-hemimalonate | C3Mo2 |
| 4-(2-Aminopropyl)-Morpholino-Cholesterol-hemimalonate | C3Mo3 |
| 4-(2-Aminobutyl)-Morpholino-Cholesterol-hemisuccinate | C4Mo4 |
| 4-(2-Aminoethyl)-Morpholino-Cholesterol-hemiglutarate | C5Mo2 |
| 4-(2-Aminoethyl)-Morpholino-Cholesterol-hemiadipate | C6Mo2 |
| 4-(2-Aminoethyl)-Morpholino-Cholesterol-hemiadipate | C8Mo2 |
| palmitoyloleoyl-phosphatidylethanolamine | POPE |
| dioleoyl-phosphatidylethanolamine 4-(N-maleimidomethyl)- | DOPE-mal |
| cyclohexane-1-carboxylate | |
| distearoyl-phosphatidylethanolamine | DSPE |
| 16-O-monomethyl PE, 16-O-dimethyl PE, 18-1-trans PE, 1- | SOPE |
| stearoyl-2-oleoyl-phosphatidyethanolamine | |
| 1,2-dielaidoyl-sn-glycero-3-phophoethanolamine | transDOPE |

### Amphipathic Lipids

In some embodiments, a liposome of the present disclosure comprises, consists essentially of, or consists of, one or more amphipathic lipids. For example, in some embodiments, one or more amphipathic lipids can be zwitterionic, acidic, or cationic lipids.

Examples of zwitterionic amphipathic lipids are phosphatidylcholines, phosphatidylethanolamines, sphingomyelins, etc. Examples of acidic amphipathic lipids are phosphatidylglycerols, phosphatidylserines, phosphatidylinositols, phosphatidic acids, etc. Examples of cationic amphipathic lipids are diacyl trimethylammonium propanes, diacyl dimethylammonium propanes, stearylamine, etc. Examples of neutral lipids include diglycerides, such as diolein, dipalmitolein, and mixed caprylin-caprin; triglycerides, such as triolein, tripalmitolein, trilinolein, tricaprylin, and trilaurin; and combinations thereof. Additionally, cholesterol or plant sterols are used in some embodiments, e.g., to make multivesicular liposomes.

In some embodiments, the amphipathic lipids used to constitute a liposome of the present disclosure can have a hydrophilic group and a hydrophobic group. For example, suitable hydrophilic groups include, but are not limited to: phosphate-, carboxylic, sulfato-, and amino groups. In some embodiments, suitable hydrophobic groups include, but are not limited to: saturated and unsaturated aliphatic hydrocarbon groups, and aliphatic hydrocarbon groups substituted by at least one aromatic and/or cycloaliphatic group.

In some embodiments, the amphipathic compounds can be phospholipids and closely related chemical structures. For example, in some embodiments, the amphipathic compound can be, but is not limited to, one or more of the following: lecithin, phosphatidylinositol, phosphatidylethonolamine, lysophatidylethanolamine, phosphatidylserine, sphingomyelin, cardiolipin, lysolecithin, phosphatidic acid, and the cerebrosides.

In some embodiments, the amphipathic lipid can be any suitable material wherein the hydrophobic portion of the lipid material orients into a hydrophobic phase, while a hydrophilic portion orients toward the aqueous phase. Amphipathic lipids are usually the major component of a lipid vesicle. Hydrophilic characteristics derive from the presence of polar or charged groups such as carbohydrates, phosphate, carboxylic, sulfato, amino, sulfhydryl, nitro, hydroxy and other like groups. Hydrophobicity can be conferred by the inclusion of apolar groups that include, but are not limited to, long chain saturated and unsaturated aliphatic hydrocarbon groups and such groups substituted by one or more aromatic, cycloaliphatic or heterocyclic group(s).

In some embodiments, the amphipathic compounds can include, but are not limited to, phospholipids, aminolipids and sphingolipids. Representative examples of phospholipids include, but are not limited to, phosphatidylcholine, phosphatidylethanolamine, phosphatidylserine, phosphatidylinositol, phosphatidic acid, palmitoyloleoyl phosphatidylcholine, lysophosphatidylcholine, lysophosphatidylethanolamine, dipalmitoylphosphatidylcholine, dioleoylphosphatidylcholine, distearoylphosphatidylcholine, or dilinoleoylphosphatidylcholine. Other compounds lacking in phosphorus, such as sphingolipid, glycosphingolipid families, diacylglycerols and β-acyloxyacids, are also within the group designated as amphipathic lipids. Additionally, the amphipathic lipid described above can be mixed with other lipids including triglycerides and sterols.

In some embodiments, a liposome of the present disclosure can comprise, consist essentially of, or consist of, phosphatidylcholine (PC). PC is an amphipathic molecule comprising a hydrophilic polar head group, phosphocholine; a glycerol bridge; and a pair of hydrophobic acyl hydrocarbon chains.

In some preferred embodiments, the major lipid component in a liposome of the present disclosure is phosphatidylcholine. Phosphatidylcholines having a variety of acyl chain groups of varying chain length and degree of saturation are available, may be isolated, or may synthesized by well-known techniques to those having ordinary skill in the art. In general, less saturated phosphatidylcholines are more easily sized, particularly when the liposomes must be sized below about 0.3 microns, e.g., for purposes of filter sterilization.

In some embodiments, phosphatidylcholines containing saturated fatty acids with carbon chain lengths in the range of about C₁₄ to C₂₂ are may be used to compose a liposome.

In some embodiments, phosphatidylcholines with mono- or di-unsaturated fatty acids and mixtures of saturated and unsaturated fatty acids can be used to create a liposome.

In some embodiments, the lipid molecules can be: Phosphatidylcholine; L-α-Phosphatidylcholine; D-α-Phosphatidylcholine; DL-α-Phosphatidylcholine; Phosphatidylcholine from egg yolk; Phosphatidylcholine from soya bean; or L-α-Phosphatidylcholine, hydrogenated.

In some embodiments, phosphatidylcholines can be obtained from plants or animals. For example, in some embodiments, phosphatidylcholines can be derived from soy. In other embodiments, phosphatidylcholines can be derived from egg yolk.

In some embodiments, the phospholipid can be selected from: Soybean phosphatidylcholine (SPC); soy phosphatidylcholine; hydrogenated soy phosphatidylcholine; hydrogenated soybean phosphatidylcholine (HSPC); egg phosphatidylcholine (EPC); dimyristoyl phosphatidylcholine (DMPC); dipalmitoyl phosphatidylcholine (DPPC); dioleoyl phosphatidylcholine (DOPC); and/or distearoyl phosphatidylcholine (DSPC)

### Neutral Lipids

In some embodiments, a liposome of the present disclosure comprises, consists essentially of, or consists of, one or more neutral lipids. For example, in some embodiments, the neutral lipid can be any of a number of lipid species that exist either in an uncharged or neutral zwitterionic form at a selected pH.

In some embodiments, a lipid may be neutral lipid at physiological pH; such lipids include, for example, diacylphosphatidylcholine, diacylphosphatidylethanolamine, ceramide, sphingomyelin, cephalin, cholesterol, cerebrosides, and diacylglycerols.

### Noncationic Lipids

In some embodiments, a liposome of the present disclosure comprises, consists essentially of, or consists of, one or more noncationic lipids. For example, in some embodiments, the noncationic lipid can be any neutral lipid as described above, as well as anionic lipids.

In some embodiments, the noncationic lipid can be, for example, distearoylphosphatidylcholine (DSPC), dioleoylphosphatidylcholine (DOPC), dipalmitoylphosphatidylcholine (DPPC), dioleoylphosphatidylglycerol (DOPG), dipalmitoylphosphatidylglycerol (DPPG), dioleoyl-phosphatidylethanolamine (DOPE), palmitoyloleoylphosphatidylcholine (POPC), palmitoyloleoyl-phosphatidylethanolamine (POPE) and dioleoyl-phosphatidylethanolamine 4-(N-maleimidomethyl)-cyclohexane-1-carboxylate (DOPE-mal), dipalmitoyl phosphatidyl ethanolamine (DPPE), dimyristoylphosphoethanolamine (DMPE), distearoyl-phosphatidylethanolamine (DSPE), 16-O-monomethyl PE, 16-O-dimethyl PE, 18-1-trans PE, 1-stearoyl-2-oleoyl-phosphatidyethanolamine (SOPE), or 1,2-dielaidoyl-sn-glycero-3-phophoethanolamine (transDOPE).

### Anionic Lipids

In some embodiments, a liposome of the present disclosure comprises, consists essentially of, or consists of, one or more anionic lipids. For example, in some embodiments, the anionic lipid can be any lipid that is negatively charged at physiological pH.

In some embodiments, the anionic lipid can be phosphatidylglycerol, cardiolipin, diacylphosphatidylserine, diacylphosphatidic acid, N-dodecanoyl phosphatidylethanolamines, N-succinyl phosphatidylethanolamines, N-glutarylphosphatidylethanolamines, lysylphosphatidylglycerols, palmitoyloleyolphosphatidylglycerol (POPG), and other anionic modifying groups joined to neutral lipids.

### Cationic Lipids

In some embodiments, a liposome of the present disclosure comprises, consists essentially of, or consists of, one or more cationic lipids. For example, in some embodiments, the cationic lipid can be any of a number of lipid species that carry a net positive charge at a selective pH, e.g., such as physiological pH.

In some embodiments, the cationic lipid can be N,N-dioleyl-N,N-dimethylammonium chloride (DODAC); N-(2,3-dioleyloxy)propyl)-N,N,N-trimethylammonium chloride (DOTMA); N,N-distearyl-N,N-dimethylammonium bromide (DDAB); N-(2,3-dioleoyloxy)propyl)-N,N,N-trimethylammonium chloride (DOTAP); 3—(N—(N′,N′-dimethylaminoethane)-carbamoyl)cholesterol (DC-Chol), or N-(1,2-dimyristyloxyprop-3-yl)-N,N-dimethyl-N-hydroxyethyl ammonium bromide (DMRIE).

In Some Embodiments, the Cationic Lipid can be Selected from any One of the various commercial preparations of cationic lipids currently available; these include, for example and without limitation: LIPOFECTIN® (commercially available cationic liposomes comprising DOTMA and 1,2-dioleoyl-sn-3-phosphoethanolamine (DOPE), from GIBCO/BRL, Grand Island, N.Y., USA); LIPOFECTAMINE® (commercially available cationic liposomes comprising N-(1-(2,3-dioleyloxy)propyl)-N-(2-(sperminecarboxamido)ethyl)-N,N-dimethylammonium trifluoroacetate (DOSPA) and (DOPE), from GIBCO/BRL); and TRANSFECTAM® (commercially available cationic lipids comprising dioctadecylamidoglycyl carboxyspermine (DOGS) in ethanol from Promega Corp., Madison, Wis., USA).

In some embodiments, a lipid can be cationic and have a positive charge at below physiological pH. Examples of such lipids include: 1,2-dioleoyl-3-dimethylammonium-propane (DODAP), 1,2-Dioleyloxy-3-dimethylaminopropane (DODMA), 1,2-DiLinoleyloxy-N,N-dimethylaminopropane (DLinDMA), 1,2-Dilinolenyloxy-N,N-dimethylaminopropane (DLenDMA), and the like.

### Other Lipids

In some embodiments, the lipids that can be used to create liposomes of the present disclosure include the natural lecithins (e.g., egg lecithin or soybean lecithin), and synthetic lecithins, such as saturated synthetic lecithins (e.g., dimyristoylphosphatidylcholine, or dipalmitoyl-phosphatidylcholine or distearoylphosphatidylcholine) and unsaturated synthetic lecithins (e.g., dilinoleoylphosphatidylcholine.

In some embodiments, the lipids that can be used to make liposomes of the present disclosure include soybean lecithin, hydrogenated soybean lecithin, egg yolk lecithin, phosphatidylcholines, phosphatidylserines phosphatidylethanolamines, phosphatidyl inositols, sphingomyelins, phosphatidic acids, long-chain alkyl phosphates, gangliosides, glycolipids, phosphatidyl glycerols, and cholesterols.

In some embodiments, the phosphatidylcholines can include, for example, dimyristoylphosphatidylcholine, dipalmitoylphosphatidylcholine, and distearoyl phosphatidylcholine.

In some embodiments, the phosphatidylserines can be, for example, dipalmitoyl phosphatidylserine, dipalmitoyl phosphatidylserine (sodium salt), and phosphatidylserine (sodium salt) derived from bovine brain.

In some embodiments, the phosphatidylethanolamines can be, for example, dimyristoyl phosphatidylethanolamine, dipalmitoyl phosphatidylethanolamine, and distearoyl phosphatidylethanolamine.

In some embodiments, the phosphatidylinositols include, for example, phosphatidylinositol (sodium salt) derived from wheat.

In some embodiments, the sphingomyelins can be, for example, sphingomyelin derived from bovine brain.

In some embodiments, the phosphatidic acids and long-chain alkyl phosphates can be, for example, dimyristoyl phosphatidic acid, dipalmitoyl phosphatidic acid, distearoyl phosphatidic acid, and dicetyl phosphate.

In some embodiments, the gangliosides can be, for example, ganglioside GM1, ganglioside GD1a, and ganglioside GT1b.

In some embodiments, the glycolipids can be, for example, galactosyl ceramide, glucosyl ceramide, lactosyl ceramide, phosphatide, and globoside.

In some embodiments, the phosphatidyl glycerols can be, for example, dimyristoyl phosphatidylglycerol, dipalmitoyl phosphatidylglycerol, and distearoyl phosphatidylglycerol.

In other embodiments, the lipid can be a phosphonolipid, in which the fatty acids are linked to glycerol via ether linkages rather than ester linkages (e.g., as found in some members of the Archaea).

Liposomes useful in the present disclosure may also be composed of sphingomyelin or phospholipids with head groups other than choline, such as ethanolamine, serine, glycerol, and inositol. In some embodiments, liposomes include a sterol, preferably cholesterol, at molar ratios of from 0.1 to 1.0 (cholesterol:phospholipid).

In some embodiments, the liposome compositions are distearoylphosphatidylcholine/cholesterol, dipalmitoylphosphatidylcholine/cholesterol, and sphingomyelin/cholesterol.

### Steroids and Sterols

Steroids and sterols are another class of lipid molecules. Steroids are well known in the art, and can generally be identified based on their structure, i.e., four fused carbon rings and/or short tail. Notwithstanding their structural differences from other lipids, steroids are categorized as lipids due to their hydrophobic and insolubility properties. Sterols are a type of steroid having an —OH functional group, e.g., cholesterol. Accordingly, a “sterol” or steroid alcohol refers to the subgroup of steroids having a free hydroxyl, or a derivative thereof, such as exemplified by and encompassed in the class cholesterol and derivatives thereof, as well as the classes phytosterols and derivatives thereof, and fungal sterols and derivatives thereof.

In some embodiments, a liposome of the present disclosure can comprise, consist essentially of, or consist of, one or more sterols.

In some embodiments, the sterol can be natural or synthetic.

In some embodiments, a sterol can be a plant sterols also known as “phytosterols.” In other embodiments, a sterol can be an animal sterols also known as “zoosterols.”

In some embodiments, a sterol of the present disclosure can include, but is not limited to: β-sitosterol; stigmasterol; ergosterol; ergocalciferol; sitosterol; campesterol; desmosterol; fucosterol; 22-ketosterol; 20-hydroxysterol; stigmasterol; 22-hydroxycholesterol; 25-hydroxycholesterol; lanosterol; 7-dehydrocholesterol; dihydrocholesterol; 19-hydroxycholesterol; 5a-cholest-7-en-30-ol; 7-hydroxycholesterol; epicholesterol; ergosterol; dehydroergosterol; cholesterol; and combinations thereof.

In some preferred embodiments, a liposome of the present disclosure comprises, consists essentially of, or consists of, a cholesterol.

In some embodiments, the sterol can be one or more cholesterol analogues

One skilled in the art will appreciate that membrane fluidity and the ability of the liposome bind with and/or liposome uptake into cells may be adjusted to desirable levels by varying the phospholipid:sterol ratio, as well as the type of molecules (e.g. phospholipids, diacylglycerols, and/or sterols) that are selected.

In some embodiments, a liposome of the present disclosure can have a steroid component such as cholesterol, coprostanol, cholestanol, cholestane and the like. When using compounds with acidic hydrophilic groups (phosphate-, sulfato-, etc.) the obtained liposome will be anionic; with basic groups such as amino, cationic liposomes will be obtained; and with polyethylenoxy or glycol groups neutral liposomes will be obtained.

In some embodiments, a liposome can have a ratio of sterol to phospholipid that is about 1:1, 45:55, 40:60, 35:65, 30:70, 25:75, 20:80, 15:85, 10:90, 5:95, 1:99, 1:100, 1:200, 1:250, 1:500, 1:1,000, 1:5,000, or 1:10,000, or any ratio in between.

In some embodiments, other components of a liposome may include, without limitation, solvents, buffers, surfactants, salts, alcohols, and/or other excipients commonly used and known in the art. For example, in some embodiments, the ratio of liposome to component (e.g., solvents, buffers, surfactants, salts, alcohols, or other excipient) can be a liposome:component ratio of about 1:99 to about 99:1.

Any of the foregoing lipids, or any combination thereof, can be used to make a liposome of the present disclosure.

### Methods of Preparing Liposomes

Methods of preparing liposomes are well known in the art. The mechanism of liposome formation is thought to occur via one of two processes: the fragmentation of bilayers with subsequent self-closure of bilayered fragments; and/or the budding off of daughter vesicles from mother liposomes. An exemplary description of the mechanism of liposome formation can be found in D. Lasic, The mechanism of vesicle formation. Biochem J. 1988 Nov. 15; 256(1): 1-11, the disclosure of which is incorporated herein by reference in its entirety.

In some embodiments, liposomes can be generated according to any of techniques described herein, for example and without limitation: extrusion methods; the Mozafari method; the polyol dilution method; the bubble method; the heating method; the reverse phase evaporation method; an extrusion technique; the dehydration-rehydration method; reverse-phase evaporation technique, ether injection/vaporization technique; the freeze-thaw method; sonication; high pressure/homogenization; microfluidization; detergent dialysis; calcium-induced fusion of small liposome vesicles; or ether-fusion methods, all of which are well known in the art.

In some embodiments, the present disclosure comprises, consists essentially of, or consists of, a liposome manufactured by the following processes, without limitation: drying down lipids from organic solvents, dispersion of the lipids in aqueous media, purification of the resultant liposomes, and analysis of the final product.

In some embodiments, multilamellar liposomes of heterogeneous sizes can be prepared. For example, in some embodiments, vesicle-forming lipids can be dissolved in a suitable organic solvent or solvent system and dried under vacuum or an inert gas to form a thin lipid film. If desired, the film may be redissolved in a suitable solvent, such as tertiary butanol, and then lyophilized to form a more homogeneous lipid mixture which is in a more easily hydrated powder-like form. This film is covered with an aqueous buffered solution and allowed to hydrate, typically over a 15-60 minute period with agitation. The size distribution of the resulting multilamellar vesicles can be shifted toward smaller sizes by hydrating the lipids under more vigorous agitation conditions or by adding solubilizing detergents such as deoxycholate.

In some embodiments, unilamellar vesicles can be prepared by sonication or extrusion. In some embodiments, sonication can be performed with a tip sonifier, such as a Branson tip sonifier, in an ice bath. Typically, the suspension is subjected to several sonication cycles. Extrusion can be carried out by biomembrane extruders, such as the Lipex Biomembrane Extruder. Defined pore size in the extrusion filters can generate unilamellar liposomal vesicles of specific sizes. The liposomes can also be formed by extrusion through an asymmetric ceramic filter, such as a Ceraflow Microfilter, commercially available from the Norton Company, Worcester Mass.

### Thin-Film Hydration

In some embodiments, thin-film hydration may be used to prepare liposomes of the present disclosure. Thin-film hydration is a particularly useful method for the preparation of MLVs. Briefly, phospholipids can be dissolved in an organic solvent (e.g., chloroform, ethanol, dichloromethane, and/or a chloroform-methanol mixture), resulting in a clear solution. The solution can then be poured into a round bottom flask, followed by the evaporation of the organic solvent via rotary evaporation with vacuum at a temperature of 45-60° C. Subsequently, a thin and homogeneous lipid film forms on the flask is formed. In some embodiments, nitrogen may be used to remove any residual solvent. The lipid film is then dispersed using an aqueous solution and agitated in order to separate the swelling lamellae from the flask surface, and produce a sealed spherical structure. In some embodiments, the hydration step can be 1 hour to 2 hours, and performed at the temperature 60-70° C.

An exemplary description of thin-film hydration is described in Bangham et al., Diffusion of univalent ions across the lamellae of swollen phospholipids. J Mol Biol 1965; 13:238-52, the disclosure of which is incorporated herein by reference in its entirety.

### Detergent Removal

In some embodiments, the detergent removal method may be used to prepare liposomes of the present disclosure. Detergent removal is a useful technique for the preparation of liposomes-particularly LUVs. In addition, the detergent removal method is particularly suited for encapsulating proteins. Briefly, in this method detergent is removed resulting in micelles that become progressively richer in phospholipid content. Eventually, the phospholipids combine to form one or more LUVs.

In some embodiments, the detergent can be an anionic surfactant (e.g., two dicalcium sulfates); a nonionic surfactant (e.g., n-octyl-beta-d-glucopyranose); or a cationic surfactant (e.g., hexadecyltrimethyl ammonium bromide).

In some embodiments, the detergent can be removed by dialysis. For example, in some embodiments, detergent can be removed by any technique known to those having ordinary skill in the art, or, e.g., using a commercially available product. One such example of a commercially available product is the Liposomat or the LipoPrep. An exemplary machine for manufacturing liposomes according to the foregoing method is described in U.S. Pat. No. 4,622,188, the disclosure of which is incorporated herein by reference in its entirety.

In some embodiments, detergent removal can occur using gel chromatography, e.g., using a column of Sephadex G-25. In other embodiments, detergent removal can occur via adsorption and/or binding of Triton X-100 to Bio-Beads SM-2. In still other embodiments, detergent removal can be effectuated by binding of octyl glucoside to Amberlite XAD-2beads.

In some embodiments, the dialysis step of the detergent removal method can be performed using dialysis bags in large detergent free buffers (i.e., equilibrium dialysis).

Exemplary descriptions and methods concerning the detergent removal method are disclosed in Bangham et al., Diffusion of univalent ions across the lamellae of swollen phospholipids. J Mol Biol 1965; 13:238-52; Bangham et al., The action of steroids and streptolysin S on the permeability of phospholipid structures to cations. J Mol Biol 1965; 13:253-9; Racker et al., A cholate-dilution procedure for the reconstitution of the Ca++ pump, 32Pi-ATP exchange, and oxidative phosphorylation. FEBS Lett 1975; 57:14-8; Brunner et al., Single bilayer vesicles prepared without sonication: Physicochemical properties. Biochim Biophys Acta Biomembr 1976; 455:322-31; Szoka and Papahadjopoulos, Comparative properties and methods of preparation of lipid vesicles (liposomes). Ann Rev Biophys Bioeng 1980; 9:467-508; Daemen et al., Liposomal doxorubicin induced toxicity: Depletion and impairment of phagocytic activity of liver macrophages. Int Cancer 1995; 61:761-21; and Shaheen et al., Liposome as a carrier for advanced drug delivery. Pak J Biol Sci 2006; 9:1181-91; the disclosures of which are incorporated herein by reference in their entireties.

### Dehydration-Rehydration Method

In some embodiments, the dehydration-rehydration method may be used to prepare liposomes of the present disclosure. The dehydration-rehydration method can be used to generate MLVs.

In some embodiments, SUVs can be prepared according to any of the methods described herein, and then can be converted to MLVs pursuant to the dehydration-rehydration method. For example, in some embodiments, SUVs can be prepared via the sonication method as described herein, and then frozen and left freeze-dried overnight. Next, the freeze-dried powder can be rehydrated with distilled water, resulting in the generation of a MLV.

In some embodiments, the dehydration-rehydration method can achieve high loading rates of, e.g., peptides and/or polynucleotides.

An exemplary description of the dehydration-rehydration method is described in Perrie et al., G. Liposome-mediated DNA vaccination: The effect of vesicle composition. Vaccine 2001; 19:3301-10; and Gregoriadis et al., A procedure for the efficient entrapment of drugs in dehydration-rehydration liposomes (DRVs). Int J Pharm 1990; 65:235-42; the disclosures of which are incorporated herein by reference in their entireties.

### Reverse-Phase Evaporation and Reverse-Phase Evaporation Vesicles

In some embodiments, the reverse-phase evaporation method can be used to prepare a liposome of the present disclosure.

The reverse-phase evaporation method allows for liposomes having a high aqueous space-to-lipid ratio, and thus affords the opportunity for the liposome to encapsulate a high percentage of aqueous material presented. Briefly, lipids are dissolved in an organic solvent, and by adding a small volume of aqueous phase. Next, the solution is sonicated, and the solvent is removed via rotary evaporator, and the resulting viscous gel is stirred. See Turinek et al., Preparation of sterile liposomes by proliposome-liposome method. Methods Enzymol 2003; 367:111.

In some embodiments, liposomes can be generated using a reverse-phase evaporation method as follows: first, the preparation of encapsulated peptide requires a mixture of a lipid-vesicle-wall-forming composition in organic solvent; and an aqueous mixture of the peptide material to be encapsulated in the vesicle. Vesicle-wall-forming compounds may include any lipid described herein, along with the methods of their preparation. For example, any number of phospholipids or lipid compounds may be used to form the vesicle walls, including and without limitation, phosphatidylcholine (PC), both naturally occurring and synthetically prepared; phosphatidic acid (PA); lysophosphatidylcholine; phosphatidylserine (PS); phosphatidylethanolamine (PE); sphingolipids; phosphatidyglycerol (PG); sphingomyelin, cardiolipin; glycolipids; gangliosides; cerebrosides; and the like, used either singularly or intermixed such as in soybean phospholipids. In addition, other lipids such as steroids, cholesterol, aliphatic amines such as long chain aliphatic amines and carboxylic acids, long chain sulfates and phosphates, dicetyl phosphate, butylated hydroxytoluene, tocophenol, retinol, and isoprenoid compounds may be intermixed with the phospholipid components to confer certain desired and known properties on the formed vesicles. Furthermore, synthetic phospholipids containing either altered aliphatic portions such as hydroxyl groups, branched carbon chains, cycloderivatives, aromatic derivatives, ethers, amides, polyunsaturated derivatives, halogenated derivatives or altered hydrophilic portions containing carbohydrate, glycol, phosphate, phosphonate, quaternary amine, sulfate, sulfonate, carboxy, amine, sulfhydryl, imidazole groups and combinations of such groups can be either substituted or intermixed with the above mentioned phospholipids and used in the process of the disclosure.

It will be appreciated from the above that the chemical composition of the lipid component of the vesicles prepared by the method of the disclosure may be varied greatly without appreciable diminution of percentage capture although the size of the vesicle may be affected by the lipid composition.

In some embodiments, the reverse-phase evaporation method may use a mixture comprising PS and PC; or PG and PC; in a 1:4 molar ratio in each instance. In some embodiments, the PC, PG, PA and PE, may be derived from purified egg yolk, soy lecithin, or commercial sources. In some embodiments, saturated synthetic PC and PG, such as dipalmitoyl may also be used. In yet other embodiments, other amphipathic lipids that may be used, also at 1:4 molar ratios with PC, are gangliosides, globosides, fatty acids, stearylamine, long chain alcohols, and the like.

The liposome wall forming composition may be initially provided dissolved in any inert solvent that can be substantially removed from the lipid or phospholipid compound when desired. Representative of such solvents are a wide variety of eithers, esters, alcohols, ketones, hydrocarbons (aromatic and aliphatic including fluorocarbons), and silicones in which an aqueous phase does not have an appreciable solubility. The solvents may be used either alone or in admixture. For each solvent or mixture of solvents however, the optimal ratio of lipid, aqueous space, and solvent is different and must be determined for each case by trial and error techniques as will be appreciated by those skilled in the art. The term “inert solvent” as used herein means a solvent for the lipid or phospholipid, which will not interfere with or otherwise adversely affect the desired course of the method of the disclosure.

The phospholipid or lipid along with any lipid-soluble additives, may be evaporated from their solvent on to the sides of a suitable reaction vessel. The organic phase, in which the liposomes will be formed, may then be added to the vessel, i.e., an inert organic solvent for the lipids and phospholipids as described above. Next, the solution may be mixed, resulting in dissolution of the lipid component of the vesicles to be formed, previously deposited on the vessel walls.

In some embodiments, the lipid-soluble additives can be cholesterol and/or tocopherols. In some embodiments, the material being encapsulated can be anchored in the lipid membrane for increased stability, e.g., where the peptide to be encapsulated is a highly hydrophobic peptide

In some embodiments, a number of inert organic solvents can be used for forming the organic phase, depending on the following conditions of the method employed. For low temperature conditions, i.e., removal subsequently of the organic phase at relatively low temperatures, diethyl ether may be used, although chloroform, or tetrahydrofuran may also be used. For higher temperature processing, isopropyl ether is a may be used as the inert organic solvent, particularly for preparing lipid vesicles containing saturated phospholipids as the lipid component.

Following dissolution of the phospholipid or lipid to form the organic phase, an aqueous phase is added to obtain a heterogeneous 2-phase mixture. The aqueous phase contains in dissolution/suspension the cargo materials to be encapsulated in the synthetic lipid vesicles. In some embodiments, the aqueous phase is buffered to a pH suitable to maintain stability of the cargo material for encapsulation.

In some embodiments, the ionic strength of the aqueous phase has a bearing on the encapsulation efficiency obtained in the method of the disclosure. As a general rule, the higher the ionic strength of the aqueous phase, the lower the percentage of entrapment. For example, in some embodiments, with 15 mM sodium chloride present, one can encapsulate around 60% of the aqueous phase; while with 500 mM sodium chloride present, only about 20% of the aqueous phase may be encapsulated. Thus, in some embodiments, to maximize the encapsulation of macromolecules, a buffer of low ionic strength (less than 0.3) is may be employed.

The encapsulation efficiency is also dependent to some degree on the concentration of lipid or phospholipid present in the 2-phase system. In some embodiments, the proportion of lipid or phospholipid component is within the range of from about 0.5 mg to about 50 mg/mL of the inert organic solvent. In some embodiments, the ratio of organic phase to aqueous phase is within the range of from about 2:1 to about 20:1 v/v; in other embodiments, about 4:1 v/v to form a water-in-oil emulsion.

An exemplary description of the reverse-phase evaporation method is described in Szoka and Papahadjopoulos, Procedure for preparation of liposomes with large internal aqueous space and high capture by reverse-phase evaporation. Proc Natl Acad Sci USA 1978; 75:4194-8; and Meure et al., Conventional and dense gas techniques for the production of liposomes: A review. AAPS PharmSciTech 2008; 9:798-809, the disclosures of which are incorporated herein by reference in their entireties.

In other embodiments, liposomes can be prepared using a reverse-phase evaporation process as follows: the aqueous material to be encapsulated is added to a mixture of polar lipid in an organic solvent. Then, a homogeneous water-in-oil type of emulsion is formed and the organic solvent is evaporated until a gel is formed. The gel is then converted to a suspension by dispersing the gel-like mixture in an aqueous media. The liposomes generated via this method consist mostly of unilamellar vesicles (large unilamellar vesicles, or LUVs) and some oligolamellar vesicles which are characterized by only a few concentric bilayers with a large internal aqueous space.

An exemplary method of the for making oligolamellar lipid vesicles also known as reverse-phase evaporation vesicles (REVs), is provide in U.S. Pat. No. 4,235,871, the disclosure of which is incorporated herein by reference in its entirety.

### Double Emulsion Evaporation

In some embodiments, double emulsion evaporation can be used to prepare a liposome of the present disclosure.

Briefly, in the double emulsion evaporation method, an aqueous solution comprising a molecule of interest is dispersed in an organic solvent that also contains dissolved lipids; this creates a water-in-oil emulsion that can then be agitated in order to homogenize and create a primary emulsion. Next, the primary emulsion can emulsified from the outer aqueous phase in order to form double emulsion. The creation of the double emulsion is then followed by evaporation of the organic solvent and hardening of the polymer encapsulating the active material. In some embodiments, a chloroform-ether mixture can be used as the solvent.

An exemplary description of double emulsion method is described in Tiwari and Verma, Microencapsulation technique by solvent evaporation method (study of effect of process variables). Int J Pharm Life Sci 2011; 2:998-1005; and Makhmalzadeh et al., Preparation and evaluation of mafenide acetate liposomal formulation as eschar delivery system. Int J Drug Dev Res 2011; 3:129-40; the disclosures of which are incorporated herein by reference in their entireties.

### Solvent Injection of Water-Miscible

In some embodiments, an ether injection method can be used to prepare liposomes of the present disclosure. For example in some embodiments, a lipid containing solution dissolved in diethyl ether, or an ether/methanol mixture, can be slowly injected into an aqueous solution comprising the material to be encapsulated, at a temperature of 55-65° C. (or under reduced pressure). The ether can then be removed under a vacuum in order to generate the formation of liposomes.

In some embodiments, ether injection can be used to prepare liposomes having a single layer, and ranging in size from about 50 nm to about 200 nm.

An exemplary description of the ether injection method is described in Sipai et al., Liposomes: An overview. J Pharm Sci Innov 2012; 1:13-21; and Kumar et al., Development and characterization of liposomal drug delivery system for nimesulide. Int J Pharm Pharm Sci 2010; 2 Suppl 4:87-9; the disclosures of which are incorporated herein by reference in their entireties.

In some embodiments, a fluorocarbon injection method can be used to prepare liposomes of the present disclosure. For example, in some embodiments, the fluorocarbon injection method is performed in a manner similar to the ether injection method, however, instead of ether, Freon is used.

An exemplary description of the fluorocarbon injection method is described in Makhmalzadeh et al., Preparation and evaluation of mafenide acetate liposomal formulation as eschar delivery system. Int J Drug Dev Res 2011; 3:129-40, the disclosure of which is incorporated herein by reference in its entirety.

### Sonication

There are two main sonication techniques: probe/tip sonication and bath sonication. Probe/tip sonication has a high energy input that causes significant heat generation, thus necessitating the use of an ice bath to maintain temperature of the liposomal dispersion in order to prevent lipid degradation. Alternatively, ultrasonic energy can be indirectly imparted to the liposome suspension using a bath sonicator, where temperature is easier to control but energy loss is comparatively high. Sonication generally yields small vesicles (˜10 nm) which spontaneously fuse over time to relieve the stress of high membrane curvature.

In some embodiments, sonication can be used to prepare a liposome of the present disclosure. The use of sonication is particularly useful method for preparing SUVs.

In some embodiments, probe sonication can be used to create a liposome of the present disclosure.

In some embodiments, ultrasonic methods can be used to create a liposome of the present disclosure. For example, in some embodiments, SUVs can be generated using a homogenizer at 50 W, 30 kHz, in an ice bath, and for about 5 to 15 minutes. In another embodiments, MLVs can be sonicated to produce SUVs.

In some embodiments, an exemplary probe sonication method may include the following steps: first, lipids and/or the desired starting materials can be obtained (e.g., lipids may be obtained commercially or generated de novo, e.g., from plant or animal matter). In some embodiments, lipids can be obtained commercially in a dried powder form, or dissolved in chloroform. Alternatively, in some embodiments, the lipids can be dissolved in hexane or ethanol as opposed to chloroform. Next, lipids should be allowed to reach room temperature prior to weighing and/or creating liposomes (note: lipids typically are stored at −20° C.). Next, 25 mg of the lipid powder is weighed using a clean analytical balance, and performed with a clean, ungloved hand (i.e., in order to minimize static).

The lipids should be carefully transferred to a clean 2.0 mL glass vial, to which 2.0 mL of (0.2 um-filtered) buffer (20 mM HEPES, 100 mM NaCl, pH 7.4) is added. The samples are then vortexed in order to mix and hydrate the lipid powder; the process is the same if a dried film is being used. Note: if the solution is being prepared from a chloroform solution, the lipids should be dried to a film under a stream of nitrogen gas.

Next, in order to further homogeneously suspend the lipids, and/or remove large particulates, the mixture can be sonicated. In some embodiments, the mixture may be sonicated with a sonicator such as the Fisherbrand™ Model 120 Sonic Dismembrator (FisherScientific®, 81 Wyman Street, Waltham, MA 02451 USA). In other embodiments, the sonicator can be a probetip sonicator (FisherScientific®, 81 Wyman Street, Waltham, MA 02451 USA) set to 20% duty cycle, with a pulse time of 2 seconds followed by a rest period of 2 seconds for a total sonication time of 2 minutes.

In some embodiments, sonication can be achieved using 1 second pulses in 3 Hz cycles at a power of 150 W. In other embodiments, a 20-kHz low-frequency ultrasonic processor (e.g., Hielscher UP200H, Germany) with an ultrasonic titanium probe (7 mm diameter), set to a pulsed duty cycle of 6 seconds on and 4 seconds off with power delivery 30% for 10 min may be used.

In some embodiments, sonication can be achieved using a Branson Sonifier® SFX 150 (Emerson, 8000 West Florissant Avenue, P.O. Box 4100, St. Louis, MO USA 63136), having a ⅛ inch tip. For example, in some embodiments, a 50 mL sample can be sonicated constantly for 40 minutes at the max setting (150 W, based on the manufacturer's instructions).

Once sonicated, the liposomes may be prepared: here, the cycle in the foregoing step should be repeated 3 additional times for a total of 4 cycles at 2 minutes total sonication time per cycle, resulting in a total preparation time is 8 minutes. Following sonication, the samples can be centrifuged using any standard benchtop microcentrifuge at 10000×g for 3 minutes to remove any residual titanium particles (from the sonicator probe tip) and un-reconstituted lipids. Next, the supernatant is carefully removed and transferred to a clean 2.0 mL Eppendorf tube. In some embodiments, the resulting samples can be stored at 4° C. for up to 24 hours. In some embodiments, an additional centrifugation step can be carried out on samples that have been stored in order to remove any precipitated lipid.

An exemplary method of probe sonication is provided in Lopes et al., Interaction of sodium diclofenac with freeze-dried soya phosphatidylcholine and unilamellar liposomes. Braz J Pharm Sci 2006; 42:497-504; and Hwang et al., Cisplatin encapsulated in phosphatidylethanolamine liposomes enhances the in vitro cytotoxicity and in vivo intratumor drug accumulation against melanomas. J Dermatol Sci 2007; 46:11-20; the disclosures of which are incorporated herein by reference in their entireties.

In some embodiments, a bath sonicator can be used to make liposomes of the present disclosure. Bath sonicators are commercially available, and well known to those having ordinary skill in the art. For example, a bath sonicator that can be used to make liposomes of the present disclosure is the Fisherbrand™ CPXH Series Heated Ultrasonic Cleaning Bath (Product No. 15337402; available from FisherScientific®, 81 Wyman Street, Waltham, MA 02451 USA). In other embodiments, a bath sonicator (Model G112SPIG from Laboratory Supplies Co., Inc., 29 Jefry Lane, Hicksville, NY 11801 USA) can be used.

In some embodiments, a liposome dispersion is placed into a bath sonicator and sonicating for about 5 to 10 minutes above the Tc of the lipid. In some embodiments, bath sonication can be used to keep material sterile (as opposed to probe sonication, or under an inert atmosphere).

Bath sonicators are especially useful for creating liposomes (e.g., SUVs) and thus are the most widely used instrumentation for the preparation of such liposomes. In some embodiments, SUVs can be derived from a large, multilamellar vesicle dispersion. For example, in some embodiments, a test tube containing a suspension of liposome starting materials and the insecticidal peptide to be encapsulated can be placed a bath sonicator, and sonicating for 5 to 10 minutes above the Tc of the lipid. In some embodiments, when using the foregoing technique, the lipid suspension should begin to clarify to yield a slightly hazy transparent solution—this haze is due to light scattering induced by residual large particles remaining in the suspension. In some embodiments, these large particles can be removed by centrifugation in order to provide a clear suspension of SUVs.

In some embodiments, a pen sonicator can be used. For example, in some embodiments, SUVs can be derived from a large, multilamellar vesicle dispersion. For example, in some embodiments, a test tube containing a suspension of liposome starting materials and the insecticidal peptide to be encapsulated can be sonicated using a pen sonicator, and sonicating for 5 to 10 minutes above the Tc of the lipid. Pen sonication techniques can be readily adapted from bath sonication methods, and such techniques are well known in the art.

In some embodiments, the mean size and distribution of the liposomes created via the bath sonication method is a function of composition, concentration, sonication time, temperature, volume, power, sonicator tuning, or a combination thereof.

An exemplary description of bath sonication is described in Jadhav et al., Formulation and evaluation of long circulating liposomal amphotericin B: A scinti-kinetic study using 99mTc in BALB/C mice. Indian J Pharm Sci 2011; 73:57-64; Sipai et al., Liposomes: An overview. J Pharm Sci Innov 2012; 1:13-21; and Hathout et al., Liposomes as an ocular delivery system for acetazolamide: In vitro and in vivo studies. AAPS PharmSciTech 2007; 8:E1-E12; the disclosures of which are incorporated herein by reference in their entireties.

### Extrusion Methods

Lipid extrusion is a technique wherein a lipid suspension is forced through a polycarbonate filter having a defined pore size: this yields particles having a diameter near the pore size of the filter used.

In some embodiments, one or more extrusion methods known to those having ordinary skill in the art may be used to create liposomes of the present disclosure.

In some embodiments, a large, multilamellar vesicle suspensions can be disrupted either by several freeze-thaw cycles, or by prefiltering the suspension through a larger pore size (e.g., 0.2 μm to 1.0 μm); subsequently, the suspension can be extrude through the final pore size. The foregoing steps are performed in order to prevent membrane fouling, and to improve the homogeneity of the size distribution in the final suspension.

In some embodiments, extrusion can be performed using filters with 100 nm in order to yield LUVs having a mean diameter of about 120 nm to about 140 nm. In some embodiments, the mean particle size will depend on lipid composition.

In some embodiments, high-pressure extrusion can be used to make liposomes of the present disclosure. For example, in some embodiments, MLVs that have been prepared by a thin-film hydration method can be repeatedly passed through filters and/or a polycarbonate membranes at 20,000 psi at 4° C., and through a small orifice reducing the liposome size. Here, when the MLVs are pushed through the small orifice, their layers are gradually separated, resulting in only one of the layers remaining; accordingly, this results in a uniform particle size distribution via the decreasing size of the liposomes.

An exemplary description of the high pressure extrusion method is described in Meure et al., Conventional and dense gas techniques for the production of liposomes: A review. AAPS PharmSciTech 2008; 9:798-809, the disclosure of which is incorporated herein by reference in its entirety.

### Injection Methods

In some embodiments, solutions (e.g., ethanol, glycerin, and/or polyglycols) can be used to dissolve lipids, wherein the solution is then injected into water. This results in a dilution and loss of solvency, and the formation of liposomes.

In some embodiments, an ethanol injection method can be used to create liposomes of the present disclosure. For example, in some embodiments, a lipid solution of ethanol can be rapidly injected to a vast excess of a preheated buffer. Here, the concentration of ethanol should be less than or equal to 10-20 v/v %.

In some embodiments, other solvents may be used and mixed with water. For example, in some embodiments, a solvent such as polyhydric alcohols, e.g., glycerol, ethylene glycol, propylene glycol. In yet other embodiments, glycerol esters such as monostearate can be used to make liposomes of the present disclosure.

Exemplary descriptions of injection methods are disclosed in Dua et al., Liposome: Methods of preparation and applications. Int J Pharm Stud Res 2012; 3:14-20; Sipai et al., Liposomes: An overview. J Pharm Sci Innov 2012; 1:13-21; Kumar et al., Development and characterization of liposomal drug delivery system for nimesulide. Int J Pharm Pharm Sci 2010; 2 Suppl 4:87-9; Batzri and Kom, Single bilayer liposomes prepared without sonication. Biochim Biophys Acta 1973; 298:1015-9; and Patil and Jadhav, Novel methods for liposome preparation. Chem Phys Lipids 2014; 177:8-18; the disclosures of which are incorporated herein by reference in their entireties.

### Method for Making Amphoteric Liposomes, SPLVs, MPVs, and FATMLVs

In some embodiments, SPLVs can be prepared as follows: an amphipathic lipid or mixture of lipids is dissolved in an organic solvent (e.g., diethyl ether, fluorinated hydrocarbons and mixtures of fluorinated hydrocarbons and ether). Next, an aqueous phase and the active ingredient to be encapsulated are added to the solution. This biphasic mixture is converted to SPLVs by emulsifying the aqueous material within the solvent while evaporating the solvent.

In some embodiments, evaporation can be accomplished during sonication by any evaporative technique, e.g., evaporation by passing a stream of inert gas over the mixture; heating; or vacuum. Here, the volume of solvent used must exceed the aqueous volume by a sufficient amount so that the aqueous material can be completely emulsified in the mixture.

In some embodiments, a minimum of roughly 3 volumes of solvent to 1 volume of aqueous phase (3:1) may be used. Indeed, the ratio of solvent to aqueous phase can vary to up to 100 or more volumes of solvent to 1 volume aqueous phase. The amount of lipid must be sufficient so as to exceed that amount needed to coat the emulsion droplets (about 40 mg of lipid per mL of aqueous phase). The upper boundary is limited only by the practicality of cost-effectiveness, but SPLVs can be made with 15 g of lipid per mL of aqueous phase.

The foregoing preparation method generates lipid vesicles with different supermolecular organization compared to conventional liposomes. According to the present disclosure, the entire process can be performed at a temperature range of 4° C. to 600° C., regardless of the phase transition temperature of the lipid used. The advantage of this latter point is that heat labile products which have desirable properties, for example, easily denatured proteins, can be incorporated in SPLVs prepared from phospholipid such as distearoylphosphatidylcholine, but can be formed into conventional liposomes only at temperatures above their phase-transition-temperature. This method usually allows more than 20% of the available water soluble material to be encapsulated and more than 40% of the available lipid soluble material to be encapsulated. With MLLVs the entrapment of aqueous phase usually does not exceed 10%.

In some embodiments, liposomes of the present disclosure can also be prepared in the form of: stable plurilamellar vesicles (SPLVs). An exemplary method of preparing SPLVs is provided in U.S. Pat. No. 4,522,803, the disclosure of which is incorporated herein by reference in its entirety.

In some embodiments, liposomes of the present disclosure can also be prepared in the form of monophasic vesicles (MPVs). An exemplary method of preparing monophasic vesicles (MPVs) according to the procedures of U.S. Pat. No. 4,588,578, the disclosure of which is incorporated herein by reference in its entirety.

In some embodiments, liposomes of the present disclosure can also be prepared in the form of freeze and thawed multilamellar vesicles (FATMLVs) according to the procedures U.S. patent application Ser. No. 800,545, the disclosure of which is incorporated herein by reference in its entirety.

### Preparing SUV Liposomes

In some embodiments, liposomes may be prepared by suspending phospholipids in an organic solvent that can then be evaporated to dryness, leaving a waxy deposit of phospholipid on the reaction vessel. Next, an appropriate amount of aqueous phase can be added, the mixture is allowed to “swell,” and the resulting liposomes consist of multilamellar vesicles (MLVs) to be dispersed by mechanical means. In some embodiments, the foregoing method results in a membrane bilayer wherein the hydrophobic (non-polar) “tails” of the lipid orient toward the center of the bilayer, whereas the hydrophilic (polar) “heads” orient toward the aqueous phase. The abovementioned technique can be used to produce small sonicated unilamellar vesicles (SUVs); an exemplary description of the foregoing method is described by Bangham et al., “Diffusion of Univalent Ions Across the Lamellae of Swollen Phospholipids”, J. Mol. Biol. 13:228 (1965); and Papahadjopoulos et al., “Phospholipid Model Membranes I. Structural Characteristics of Hydrated Liquid Crystals”, (1967), Biochim. Biophys. Acta., 135:624-638; the disclosures of which are incorporated herein by reference in their entireties.

Liposome Prepared from Precursors

In some embodiments, liposomes of the present disclosure can be prepared by first forming liposome precursors or micelles, i.e., vesicles containing an aqueous phase surrounded by a monolayer of lipid molecules oriented so that the polar head groups are directed toward the aqueous phase. In some embodiments, liposome precursors can be formed by adding the aqueous solution to be encapsulated to a solution of polar lipid in an organic solvent and sonicating. The liposome precursors are then emulsified in a second aqueous phase in the presence of excess lipid and evaporated. The resultant liposomes, consisting of an aqueous phase encapsulated by a lipid bilayer are dispersed in aqueous phase. An exemplary method of liposome precursor generation is provided in U.S. Pat. No. 4,224,179, the disclosure of which is incorporated herein by reference in its entirety.

Additional exemplary methods of preparing liposomes are provided in, e.g., Szoka et al., Ann. Rev. Biophys. Bioeng. 9:467 (1980), U.S. Pat. Nos. 4,186,183; 4,217,344; 4,235,871; 4,261,975; 4,485,054; 4,501,728; 4,774,085; 4,837,028; 4,235,871; 4,261,975; 4,485,054; 4,501,728; 4,774,085; 4,837,028; 4,946,787; 6,673,364; U.S. Patent Application No. US20170258722A1; PCT Publication No. WO 9117424; Deamer and Bangham, Biochim. Biophys. Acta, 443:629-634 (1976); Fraley, et al., Proc. Natl. Acad. Sci. USA 76:3348-3352 (1979); Hope, et al., Biochim. Biophys. Acta 812:55-65 (1985); Mayer, et al., Biochim. Biophys. Acta 858:161-168 (1986); Williams, et al., Proc. Natl. Acad. Sci. USA 85:242-246 (1988); the text Liposomes, (Marc J. Ostro (ed.), Marcel Dekker, Inc., New York, 1983, Chapter 1); and Hope, et al., Chem. Phys. Lip. 40:89 (1986); the disclosures of which are incorporated herein by reference in their entireties.

### Loading Techniques

It will be recognized that the optimal ratio of protein to lipid in the context of a liposome may differ for different proteins, and this optimal ratio may be readily established for each different protein by methods, such as those described herein, that are well known to those skilled in the art. The optimal protein:lipid ratio for each of the formulations described herein can be readily determined by well-known methods that are routinely used by those of ordinary skill in the art.

In some embodiments, the disclosure provides a liposome comprising, consisting essentially of, or consisting of, a lipid bilayer defining an inner sphere and an outer surface of the liposome, and further comprising an insecticidal protein within the inner sphere. Liposomes of the present disclosure can be loaded with a cargo (e.g., a peptide) using passive or active loading techniques.

In some embodiments, passive loading techniques include mechanical dispersion, solvent dispersion, or detergent removal techniques.

In some embodiments, a liposome can be loaded using a mechanical dispersion technique. For example, in some embodiments, the liposome can be loaded via lipid film hydration; micro emulsification; sonication; French pressure cell; membrane extrusion; and/or dried reconstituted vesicles.

In some embodiments, a liposome can be loaded using a solvent dispersion technique. For example, in some embodiments, the liposome can be loaded using ethanol injection; ether injection; double emulsion; and/or reverse phase evaporation.

In some embodiments, a liposome can be loaded using a detergent removal technique. For example, in some embodiments, a liposome can be loaded via dialysis; column chromatography; and/or dilution.

An exemplary description of liposome loading is provided in U.S. Pat. Nos. 4,522,803; 4,588,578; 4,861,580; 4,897,384; and 5,082,664; the disclosures of which are incorporated herein by reference in their entireties.

### Encapsulation Efficiency (EE)

Two parameters of liposome preparations are functions of vesicle size and lipid concentration: (1) Captured volume, defined as the volume enclosed by a given amount of lipid, is expressed as units of liters entrapped per mole of total lipid (1 mol.⁻¹). The captured volume depends upon the number of lamellae and the radius of the liposomes, which in turn is affected by the lipid composition of the vesicles and the ionic composition of the medium; and (2) Encapsulation efficiency, defined as the fraction of the initial aqueous phase sequestered by the bilayers. See Deamer and Uster, 1983, Liposome Preparation: Methods and Mechanisms, in Liposomes, ed. M. Ostro, Marcel Dekker, Inc. N.Y., pp. 27-51.

Encapsulation efficiency for any liposome is defined as the fraction of aqueous compartment sequestered by bilayers; and is typically expressed as a percentage. In other words, encapsulation efficiency is a measure of the amount of the material to be encapsulated enclosed entirely within the vesicle's internal volume.

In some embodiments, the following criteria may be used to determine definitively that entrapment or encapsulation of the cargo within the aqueous compartment of any liposome has occurred: (a) there must be a clear separation of free from sequestered compound as assayed by gel filtration; (b) there must be no hydrophobic or charge-charge interaction between the outermost vesicle bilayer and the entrapped compound since this may result in a failure to achieve separation of the free compound from the liposomes by molecular sieving, thereby artificially increasing the apparent sequestration or encapsulation efficiency. To eliminate this possibility it must be shown that the water-soluble compound added to a suspension of previously formed liposomes does not co-elute with preformed liposomes; (c) disruption of gel-filtered liposomes by use of detergents or other membrane perturbants must induce a shift in the gel filtration pattern of the sequestered molecule from a position coincident with the liposome peak to one that co-elutes with the free molecule. See Sessa and Weissmann, 1970, J. Biol. Chem. 245:3295.

### Calculating Encapsulation Efficiency

In some embodiments, encapsulation efficiency (EE) can be calculated as follows: a radioactive tracer molecule may be included in the aqueous protein solution, and the percentage of radioactivity found in the liposome fraction can then be compared to the radioactivity found in the remaining fraction. For example, in some embodiments, liposomes may be prepared with phosphatidylcholine and stearylamine, using [H-3]-thymidine as a tracer. Next, separation of liposomes from unincorporated tracer may be accomplished via gel filtration, and the liposome fraction may be compared to the remaining fraction, in order to determine encapsulation efficiency.

### Characterization by Capture Volume

In some embodiments, liposomes can be characterized by captured volume, a measure of the amount of solvent trapped within the vesicles; and encapsulation efficiency (EE), a measure of the amount of the material to be encapsulated enclosed entirely within the vesicle's internal volume. For example, in some embodiments, the captured volume is defined as the concentration of the aqueous fraction inside the vesicle divided by the concentration of lipid in the vesicle, normally expressed as 1/mole lipid. The encapsulation efficiency is defined by the equation:

$$E E = \frac{{C}^{′}}{C} \times \frac{1}{{C}_{L}} \qquad Formula ( V )$$

wherein C′ is the final molar concentration of the molecule to be encapsulated within the lipid vesicle; C is the initial molar concentration of the molecule in its solvent; and CL is the concentration of lipid in the vesicle.

In some embodiments, encapsulation efficiency can be determined based on percent encapsulation, Lipocrit, percent free peptide, or a combination thereof.

“Percent encapsulation” or “% encapsulation” or “percent encapsulation of peptide, or other compound” means the ratio of the amount of peptide to be encapsulated in the final suspension of the liposome manufacturing process to the total amount of insecticidal peptide to be encapsulated used in the first aqueous solution of the process multiplied by 100.

% encapsulation=([Amt. of compound encapsulated]/[Amt. of compound introduced prior to encapsulation])×100

“Lipocrit,” which is defined in analogy to hematocrit, refers to the ratio of the volume occupied by the liposomes to the total suspension volume multiplied by 100. Lipocrit can be calculated as follows:

% Lipocrit=([Volume occupied by the liposomes]/[Total volume of liposome suspension])×100

“Percent free peptide” or “percent free drug” refers to the ratio of the amount of peptide exterior to the liposomes in the final liposome suspension to the total amount of drug in the final suspension (the final product) multiplied by 100. Percent free peptide can be calculated as follows:

Percent free peptide=([Amt. of drug exterior to the liposomes in the final product]/[Amt. of drug in final product])×100

In some embodiments, percent encapsulation of compound can be the ratio of the amount of peptide encapsulated to the amount of peptide introduced prior to encapsulation multiplied by 100. Percent free peptide is the ratio of the drug concentration exterior to the liposomes in the liposome suspension to the total amount of drug in the liposome suspension, multiplied by (100 minus the Lipocrit).

Quantifying Liposome Preparations after Encapsulation and Filtration

In some embodiments, liposomes and solutions containing the same may be quantified in order to determine encapsulation efficiency. For example, in some embodiments, following encapsulation, liposomes may be filtered, e.g., through a 0.45 μm membrane filter to remove insolubles, etc. In yet other embodiments, following encapsulation, liposomes may be mixed with one or more buffers and subsequently filtered. In some embodiments, following encapsulation, liposomes may be ultracentrifuged (e.g., 110,000×g, 1 hour), optionally at a reduced temperature relative to room temperature (e.g., 10° C.).

In some embodiments, the phospholipid content before and after filtration, and the phospholipid content in the supernatant after ultracentrifugation, can be quantified by the enzyme method (see, Practical Clinical Chemistry (enlarged edition), 580 (1982)), using Determiner PL, a reagent for the analysis of phospholipids (KYOWA MEDEX CO., LTD.; 2-1-1 Irifune, Chuo-ku, Tokyo 104-0033, Japan).

In some embodiments, the amount of CRIP before and after filtration, and CRIP in the supernatant after ultracentrifugation, can be quantified by high performance liquid chromatography.

In some embodiments, encapsulation efficiency (EE) can be calculated using the following formula: EE (%)=((A−B)/(C−D))/(E/F)×100, or:

$$EE \% = \frac{\frac{A - B}{C - D}}{\frac{E}{F}} \times 100 \qquad Formula ( VI )$$

wherein:
A: Concentration of CRIP in the filtrate after filtration (mg/ml)
B: Concentration of CRIP in the supernatant after ultracentrifugation (mg/ml)
C: Concentration of the phospholipid in the filtrate after filtration (mg/ml)
D: Concentration of the phospholipid in the ultracentrifuged supernatant (mg/ml)
E: Concentration of CRIP in the suspension before filtration (mg/ml)
F: Concentration of the phospholipid in the suspension before filtration (mg/ml)

In yet other embodiments, encapsulating liposomes preparations may be ultracentrifuged (e.g., 110,000×g, 2 hours) at 10° C. Then, the amount of CRIP before ultracentrifugation, and the amount of CRIP in the supernatant after ultracentrifugation, may be quantified by high performance liquid chromatography. The encapsulation efficiency was calculated by the following formula: EE of CRIP (%)=(B−A)×100/B, or:

$$EE or CRIP \% = B - A \times \frac{100}{B} \qquad Formula ( VII )$$

wherein:
A: Concentration of CRIP in the ultracentrifuged supernatant (mg/ml)
B: Concentration of CRIP in the suspension before ultracentrifugation (mg/ml)

### Other Methods of Determining EE

In alternative embodiments, the encapsulation efficiency can be calculated using the following equation:

[CRIP/lipid (after gel filtration)]/[CRIP/lipid (before gel filtration)]×100%.

In some embodiments, the encapsulation efficiency (EE) and loading efficiency (LE) can calculated based on the obtained peptide amount. For example, the EE can be calculated as follows:

(EE:%)=peptide amount/amount of peptide initially used×100

(LE:%)=([peptide amount/peptide MW]/[initial lipid mol number])×100

In some embodiments, loading and encapsulation efficiencies can be defined and calculated as follows:

$$Loading efficiency , LE ( \% ) = 1 \; 00 \times ( Encapsulated protein / liposome weight )$$

$$Theoretical loading efficiency , TLE ( \% ) = 100 \times ( Protein used for encapsulation / liposome weight )$$

$$Encapsulation efficiency , EE ( \% ) = 100 \times ( Encapsulated protein / Protein used for encapsulation ) = 100 \times LE / TLE$$

Any of the methods described herein, or any combination of methods described herein, can be used to determine the encapsulation efficiency and/or loading efficiency of liposomes of the present disclosure.

### Removing Unencapsulated Peptide

Unencapsulated or “free peptide,” i.e., peptide present in the bulk aqueous phase of the medium, is preferably removed to increase the ratio of liposome-entrapped to free peptide. In some embodiments, the peptide removal process is designed to reduce the final concentration of free peptide to from about less than about 20%, to about less than about 10% of the total peptide present in the composition.

Several methods are available for removing free peptide from a liposome suspension. Sized liposome suspension can be pelleted by high-speed centrifugation, leaving free peptide and very small liposomes in the supernatant. Another method involves concentrating the suspension by ultrafiltration; then resuspending the concentrated liposomes in a peptide-free replacement medium. Alternatively, gel filtration can be used to separate larger liposome particles from solute (free peptide) molecules.

In some embodiments, free peptide may be removed by utilizing an ion-exchange resin capable of binding the peptide in free, but not in liposome-bound, form. In some embodiments, the resin can be based on charge; e.g., a cation-exchanger may be used when the peptide is positively charged at neutral pH.

### Release Rate Kinetics

The release rate kinetics of liposome formulations can be an important consideration, allowing controlled release of the peptide and/or drug from the liposome. In some embodiments, immediate release of the liposome cargo at the target sites may be preferred. However, in yet other embodiments, a delayed release of peptide may be preferred. Release rates depend on both cargo and type of liposome. For example, many drugs have been found to be rapidly released from liposomes after encapsulation; indeed, such rapid release diminishes the beneficial effects of liposome encapsulation.

One technique of employing controlled-release liposome compositions involves the use of synthetic phospholipids, in which the polar moiety of the phosphatidylcholine head group is altered, and thus results in synthetic phospholipids having a decreased rate of phospholipase C hydrolysis which permits the use of such phospholipids as surfactants for controlled-release purposes. An exemplary description of controlled-release liposome compositions is provided in U.S. Pat. No. 4,145,410, the disclosure of which is incorporated herein by reference in its entirety.

In some embodiments, the release of cargo from liposomes can be measured with High-performance liquid chromatography (HPLC). For example, 40 μL of liposomes encapsulating a CRIP may be added to 960 μL of PBS buffer with varying pH values, and then may be mixed at 37° C. for 15 min. Triton X-100 may be used as a control solution because Triton X-100 can break down the liposomes (final concentration: 0.1%). The mixtures may then be added to the inner tubes of ultrafilter Amicon Ultra-4 (MWCO=10 kDa, Millipore), and centrifuged at 10,000×g for 10 min at room temperature. Next, the elutions can be subjected to HPLC to measure the concentration of released cargo (Waters Micromass LCT Premier Mass Spectrometer).

In some embodiments, peptide release rate (unit: %) may be calculated according to the following equation:

Release rate (%)=amount of released peptide/total drug amount×100

In some embodiments, liposome cargo can be modified in order to calculate the liposome release kinetics. For example, the cargo can be a fusion protein comprising the peptide of interest operably linked to a fluorescent peptide.

In some embodiments, a fluorescent molecule can be used to determine the release kinetics of a liposome.

In some embodiments, calcein, a fluorescent molecule, can be used to determine the release rate of a liposome. For example, the release rate of calcein can be determined by the following equation: Release rate of calcein (%)=(Iₓ−I₀)/(I_{T}×1.1−I₀), or:

$$RR ( \% ) = \frac{{I}_{X} - {I}_{o}}{{I}_{T} \times 1 \text{.1} - {I}_{o}} \qquad Formula ( VIII )$$

wherein RR is release rate;
I₀: fluorescence intensity at pH 6.5
Iₓ: fluorescence intensity after addition to buffer at each pH
I_{T}: fluorescence intensity upon addition of 200 μL 1% Triton-X

In some embodiments, the release rate as determined using the equation above, can be used to modify the liposome or its components in order to subsequently modify the release rate. In some embodiments, pH and/or method of preparing the liposomes may influence release rate.

In some embodiments, due to the presence of unencapsulated peptide in liposomes, the normalized release rate of said peptide can be calculated as: 100(MT−Mb)/(100−Mb); wherein Mb is the percent of free drug before dilution with PBS; MT is the percent of free drug determined at different time point after diluted by PBS.

### Characterizing Liposomes

Liposomes can be characterized based on, inter alia, size, lamellarity, charge and/or composition.

In some embodiments, liposomes of the present disclosure can be characterized by their phospholipid contents, e.g., via quantification of the total phosphate in the samples. An exemplary method of characterization based on phosphate is provided by Chen et al., Microdetermination of Phosphorus. Anal. Chem. 1956, 28, 11, 1756-1758, the disclosure of which is incorporated herein by reference in its entirety.

In some embodiments, liposomes can be characterized based on morphology. For example, in some embodiments, liposomes can be characterized by scanning electronic microscopy (SEM), e.g., using a LEICA®, model LEO 440i, and using an acceleration voltage of approximately 5-6 KV. In some embodiments, the crystallinity of lyophilized particles can be evaluated by X-ray diffraction, e.g., using PHILIPS® model XPERT.

In some embodiments, the infrared spectra of the dried samples of liposomes can be evaluated; e.g., in some embodiments, infrared spectra can be recorded using a Boomem MB spectrometer (series Hartmann & Braun; Michelson) with samples were prepared in KBr and infrared spectra collected from 4000 nm to 400 nm.

### Osmotic Behavior

In some embodiments, liposomes can be characterized based on osmotic behavior. For example, in some embodiments, a solution comprising 50 mM glucose, and 2 mM EDTA in 10 mM phosphate buffer (pH 7.4) can be prepared, and mixed with a 0.5 mL volume of dispersed liposomes at various titrations to yield a desired concentration gradient across the lipid bilayer membranes. Next, samples can incubated for 1 hour, followed by measuring the turbidity of the mixture at 450 nm. Here, liposomes respond to an osmotic gradient as ideal osmometers; accordingly, a linear relation can be derived as follows:

$${( 1 / A )}^{1.5} = \{ {V}_{a c t} ( {C}_{i n} / {C}_{o u t} ) + {V}_{dead} \} 1 / k , \\ or : {( \frac{1}{A} )}^{1.5} = ( {V}_{act} \frac{{C}_{i n}}{{C}_{out}} + {V}_{dead} ) \frac{1}{k} \qquad Formula ( IX )$$

wherein A is the absorbance at a given wavelength;
k represents a constant;
V_{act} and V_{dead} denote the osmotically active and inactive volume of liposomes, respectively; and
Cᵢₙ/Cₒᵤₜ is the ratio of solute concentrations in the inner to those in the outer parts of liposomes. Consequently, by plotting (1/A)^{1.5} and Cᵢₙ/Cₒᵤₜ in order to verify via osmotic behavior the constitution of the liposomal structure subsequent to dehydration and rehydration. Exemplary methods of characterizing liposomes and/or their osmotic behavior is provided in Kim et al., Development of dried liposomes containing beta-galactosidase for the digestion of lactose in milk. Int J Pharm. 1999 Jun. 25; 183(2):185-93; and Cabral et al., Preparation and characterization of liposomes entrapping allergenic proteins. Braz. J. Chem. Eng. Vol. 21; No. 2 April/June 2004; pg. 137-144.

### Calorimetry

Liposomes can be characterized by calorimetry. Briefly, calorimetry provides a direct method for measuring changes in thermodynamic properties of biological macromolecules.

In some embodiments differential scanning microcalorimetry (DCS) can be used to characterize liposomes. DCS measures the temperature-dependence of the excess heat capacity of a system pursuant to thermal phase transitions.

An exemplary method of DCS is provided in Biltonen and Lichtenberg, The use of differential scanning calorimetry as a tool to characterize liposome preparations. Chem. Phys. Lipids. 1993, 64 (1-3), pg. 129-142, the disclosure of which is incorporated herein by reference in its entirety.

### Lamellarity

The lamellarity of a liposome refers to its number of lipid bilayers. A liposomes lamellarity can influence said liposomes encapsulation efficiency, and/or release kinetics of its cargo. And, the lamellarity of a liposome can influence the intracellular fate of liposome and its cargo when the liposome fuses and/or is processed in the cell. In some embodiments, liposomes of the present disclosure can be characterized based on their lamellarity.

In some embodiments, small Angle X-ray Scattering (SAXS) can be used to characterize liposomes based on lamellarity. An exemplary method of SAXS is as follows: first, liposome dispersions are added to glass capillaries, the curves are recorded using a one-dimensional position sensitive detector. Next, blank scattering curves are collected from the same capillaries, albeit filled with the liposome suspension solvent. The resulting data is analyzed using Indirect Fourier Transformation—this provides the electron distance distribution “p(r)” as calculated from the scattered intensity in the measured sample. Here, p(r) provides the radial contrast profile of Δ p(r) in electron density relative to the mean value, and can be used to determine the internal structure of the scattering particles.

In some embodiments, ³¹P-nuclear Magnetic Resonance (NMR) can be used to characterize liposomes based on lamellarity. For example, in some embodiments, when using ³¹P-NMR, the external shift reagents that can be use include Mn²⁺, Co²⁺, and Pr³⁺. Briefly, in ³¹P-NMR, a paramagnetic ion interacts with phospholipids on the outer monolayer causing perturbations of the nuclear spin relaxation time. Consequently, reduced signal strength and broadened peaks and in ³¹P-NMR spectrum can be quantified.

In some embodiments, label-free differential interference contrast (DIC) microscopy can be used to characterize liposomes based on lamellarity.

In some embodiments, epifluorescence microscopy can be used to characterize liposomes based on lamellarity.

In some embodiments, cryo-electron microscopy can be used to characterize liposomes based on lamellarity. For example, in some embodiments, cryo-SEM or cryo-TEM can be used.

In some embodiments, electron microscopy can be used to characterize liposomes based on lamellarity.

### Characterizing Liposomes Based on Size

Liposomes can be characterized by their size. Following liposome preparation, the liposomes may be sized to achieve a desired size range and/or relatively narrow distribution of liposome sizes. Several techniques are available for creating liposomes of a desired size, and these techniques are well known to those having ordinary skill in the art.

As used herein, “particle size” or “particle diameter” or “size” or “diameter” are used interchangeably, and refer to the outer diameter of the liposome, i.e., the distance corresponding to the length of the outer diameter of the liposome. If the liposomes are not spherical, the foregoing terms refer to the largest cross-sectional diameter of the liposome.

In some embodiments, light scattering, flow cytometry, electron microscopy, ultracentrifugation, gel filtration, high performance liquid chromatography (HPLC), or a combination thereof, can be used to determine the size or diameter of liposomes.

The size of a liposome can affect its ability to encapsulate the insecticidal protein, and the liposome's targeting ability and delivery efficiency.

In some embodiments, liposome size can be determined in such a manner that a dispersion containing liposome vesicles encapsulating an insecticidal peptide is frozen and fractured, following which carbon is vapor-deposited onto the fractured interfaces and the deposited carbon is observed with an electron microscope (freeze fracture TEM method).

In some embodiments, liposome size can be adjusted by formulation, or control of processing conditions. For example, in some embodiments, increasing the supercritical pressure results in a liposome of a reduced vesicle size.

In some embodiments, liposomes may be separated by size using filtration techniques. For example, in some embodiments, filtration may be conducted using a polycarbonate film to allow the liposome size distribution to fall within a narrower range. In this regard, a liposome of unilamellar vesicles at an average vesicle size of not more than 0.4 m can be efficiently obtained by passing it through an extruder incorporating a filter of 0.1 to 0.5 m pore size.

In some embodiments, the particle size distribution can be monitored by conventional laser-beam particle size discrimination. In addition, the size of the liposomal vesicle can be determined by quasi-electric light scattering (QELS) as described in Bloomfield, Ann. Rev. Biophys. Bioeng. 10:421-450 (1981), the disclosure of which is incorporated herein by reference in its entirety.

In some embodiments, the average liposome diameter of a plurality of liposomes can be reduced by sonication of formed liposomes. In other embodiments, intermittent sonication cycles can be alternated with quasi-elastic light scattering (QELS) assessment to guide efficient liposome synthesis.

An exemplary method of sizing liposomes is provided in U.S. Pat. No. 4,737,323, the disclosure of which is incorporated herein by reference in its entirety.

In some embodiments, liposomes can be sized using an extrusion method.

In some embodiments, liposomes can be sized via extrusion through an asymmetric ceramic filter. Such filters are designed for operation at relatively high pressure, and can be back flushed to prevent clogging. Exemplary methods of sizing liposomes via extrusion are described in U.S. Pat. Nos. 4,737,323; and 4,927,637, the disclosures of which are incorporated herein by reference in their entireties.

### Dynamic Light Scattering (DLS)

In some embodiments, quasi-elastic or dynamic light scattering (DLS) can be used to determine the diameter of a liposome. DLS is the most common analytical technique used for measuring liposomes-especially liposomes that are below 1 μm in size. Evaluation of liposomes via quasi-elastic or DLS provides the mean diameter and distribution of the liposomes. Moreover, DLS can distinguish whether the liposomes are uniformly distributed around one or more particle sizes (unimodal vs. bimodal).

In some embodiments, liposomal size refers to the size as determined by photon correlation spectroscopy (PCS). The average size can be expressed as Z average diameter (ZAD) and the polydispersity index (PDI), as determined using photon correlation spectroscopy according to ISO 22412. ISO 22412:2017 specifies the application of DLS to the measurement of average hydrodynamic particle size and the measurement of the size distribution of mainly submicrometer-sized particles, emulsions, or fine bubbles dispersed in liquids.

In some embodiments, ZAD and PDI are determined on the basis of data obtained by dynamic light scattering (DLS). Briefly, a monochromatic and coherent laser light beam illuminates a representative sample for particle size analysis, dispersed in a liquid at a suitable concentration. The light scattered by the particles at a given angle is recorded by a detector (e.g., an avalanche photodiode) whose output is fed to a correlator. Because the dispersed particles are in continuous Brownian motion, the observed scattered intensity fluctuates along the time axis. Therefore, analysis as a function of time of these intensity fluctuations provides information on the motion of the dispersed particles. In a DLS experiment, the time analysis is carried out with a correlator which constructs the time autocorrelation function of the scattered intensity. The decay rate is linked to the translational diffusion coefficient D of the particles. This decay is interpreted in terms of average particle size and polydispersity index by the so-called cumulants method.

Briefly, for non-interacting spherically shaped particles dispersed in a medium of viscosity i, the diffusion coefficient D is related to the particle hydrodynamic diameter dH by the Stokes-Einstein equation: D=(kT)/(37πηd_{H}), or:

$$D = \frac{k T}{3 π η {d}_{H}} \qquad Formula ( X )$$

wherein:
k is the Boltzmann constant,
T the absolute temperature
η the viscosity of the medium.

The cumulants method is a simple method of analyzing the autocorrelation function generated by a DLS experiment. The foregoing calculation is defined in ISO 13321 and ISO 22412. The first two terms of this moments expansion are used in practice, a mean value for the size (z-average size or z-average mean or z-average diameter), and a width parameter known as the polydispersity index (PDI).

The z-average size is an intensity-based calculated value and should not be confused with or directly compared to a mass or number mean value produced by other methods. The calculation is defined in the ISO standards, so all systems that use this calculation as recommended should give comparable results if the same scattering angle is used.

The z-average size or z-average mean or z-average diameter used in dynamic light scattering is a parameter also known as the cumulants mean. It is the primary and most stable parameter produced by the technique. The z-average mean is commonly used in a quality control setting as it is defined in ISO 13321 and more recently ISO 22412 which defines this mean as the “harmonic intensity averaged particle diameter.”

The z-average size will only be comparable with the size measured by other techniques if the sample is monomodal (i.e., only one peak), spherical, or near-spherical in shape, monodisperse (i.e., very narrow width of distribution), and the sample is prepared in a suitable dispersant, as the z-average mean size can be sensitive to even small changes in the sample (e.g. the presence of a small proportion of aggregates). It should be noted that the z-average is a hydrodynamic parameter and is therefore only applicable to particles in a dispersion or molecules in solution.

Submicron liposomes have an average diameter of less than 1 m. Methods of measuring liposome diameter are well known to the skilled person e.g. dynamic light scattering. For the purpose of description of the present disclosure, the average diameter of the liposomes is expressed as Z-average diameter (ZAD).

Polydispersity Index (PDI) is a number calculated from a simple two parameter fit to the correlation data (the cumulants analysis). The PDI is dimensionless and scaled from 0 to 1. The very small values (e.g., 0.05) correspond to highly monodisperse standards. The closer the values to 1, the broader the size distribution of the particles. The PDI of a liposomal formulation is a measure of the heterogeneity of liposome particles in the formulation.

In some embodiments, the size of a liposome can be measured by dynamic light scattering using a Malvern ZETASIZER® 3000 or a Malvern ZETASIZER® NANO-ZS. See U.S. patent application Ser. No. 11/520,796 (U.S. Patent Publication No. US20070065499A1), the disclosures of which are incorporated by reference herein in their entireties.

Additional exemplary method of the foregoing techniques is provided in U.S. Pat. Nos. 10,695,424, and 10,722,466, the disclosures of which are incorporated herein by reference in their entireties.

In some embodiments, multi-angle light scattering (MALS) to determine the size of liposomes. An exemplary description of MALS used to characterize liposomes is provided in Parot et al., Physical characterization of liposomal drug formulations using multi-detector asymmetrical-flow field flow fractionation. J Control Release. 2020 Apr. 10; 320: 495-510, the disclosure of which is incorporated herein in its entirety.

In some embodiments, one or more of the methods described herein can predictably produce liposomes having a desired size. For example, in some embodiments, sonicating a liposome suspension either by bath or probe sonication produces a progressive size reduction down to small unilamellar vesicles less than about 0.05 microns in diameter.

In some embodiments, homogenization is another method which relies on shearing energy to fragment large liposomes into smaller ones. For example, in some embodiments, a homogenization procedure can be used, wherein multilamellar vesicles are recirculated through a standard emulsion homogenizer until selected liposome sizes, typically between about 0.1 and 0.5 microns, are observed.

In some embodiments, a size range of about 0.05 microns to about 0.20 microns allows the liposome suspension to be sterilized by filtration through a conventional filter, typically a 0.22 micron filter. The filter sterilization method can be carried out on a high through-put basis if the liposomes have been sized down to about 0.05 microns to about 0.20 microns.

### Sizes of Liposomes of the Present Disclosure

In some embodiments, the present disclosure comprises, consists essentially of, or consists of, a liposome that can be of any particle diameter. Here, particle diameter refers to the diameter of a particle (e.g., a liposome) as measured by dynamic light scattering (DLS).

In some embodiments, the mean particle size of a liposome can be determined by dynamic light scattering. In some embodiments, the polydispersity index (PDI), a value indicating the size distribution of the liposomes, can be determined using the same evaluation technique as for the mean particle size, for example, using Beckman Coulter Delsa™ Nano C particle analyzer.

In some embodiments, a liposome of the present disclosure can have a diameter ranging from about 10 nm to about 50,000 nm. Indeed, in some embodiments, a liposome of the present disclosure can have a diameter that can be about 10 nm, about 20 nm, about 25 nm, about 30 nm, about 40 nm, about 50 nm, about 100 nm, about 200 nm, about 300 nm, about 400 nm, about 500 nm, about 600 nm, about 700 nm, about 800 nm, about 900 nm, about 1,000 nm, about 1,100 nm, about 1,200 nm, about 1,300 nm, about 1,400 nm, about 1,500 nm, about 1,600 nm, about 1,700 nm, about 1,800 nm, about 1,900 nm, about 2,000 nm, about 2,100 nm, about 2,200 nm, about 2,300 nm, about 2,400 nm, about 2,500 nm, about 2,600 nm, about 2,700 nm, about 2,800 nm, about 2,900 nm, about 3,000 nm, about 3,100 nm, about 3,200 nm, about 3,300 nm, about 3,400 nm, about 3,500 nm, about 3,600 nm, about 3,700 nm, about 3,800 nm, about 3,900 nm, about 4,000 nm, about 4,100 nm, about 4,200 nm, about 4,300 nm, about 4,400 nm, about 4,500 nm, about 4,600 nm, about 4,700 nm, about 4,800 nm, about 4,900 nm, about 5,000 nm, about 5,100 nm, about 5,200 nm, about 5,300 nm, about 5,400 nm, about 5,500 nm, about 5,600 nm, about 5,700 nm, about 5,800 nm, about 5,900 nm, about 6,000 nm, about 6,100 nm, about 6,200 nm, about 6,300 nm, about 6,400 nm, about 6,500 nm, about 6,600 nm, about 6,700 nm, about 6,800 nm, about 6,900 nm, about 7,000 nm, about 7,100 nm, about 7,200 nm, about 7,300 nm, about 7,400 nm, about 7,500 nm, about 7,600 nm, about 7,700 nm, about 7,800 nm, about 7,900 nm, about 8,000 nm, about 8,100 nm, about 8,200 nm, about 8,300 nm, about 8,400 nm, about 8,500 nm, about 8,600 nm, about 8,700 nm, about 8,800 nm, about 8,900 nm, about 9,000 nm, about 9,100 nm, about 9,200 nm, about 9,300 nm, about 9,400 nm, about 9,500 nm, about 9,600 nm, about 9,700 nm, about 9,800 nm, about 9,900 nm, about 10,000 nm, about 10,100 nm, about 10,200 nm, about 10,300 nm, about 10,400 nm, about 10,500 nm, about 10,600 nm, about 10,700 nm, about 10,800 nm, about 10,900 nm, about 11,000 nm, about 11,100 nm, about 11,200 nm, about 11,300 nm, about 11,400 nm, about 11,500 nm, about 11,600 nm, about 11,700 nm, about 11,800 nm, about 11,900 nm, about 12,000 nm, about 12,100 nm, about 12,200 nm, about 12,300 nm, about 12,400 nm, about 12,500 nm, about 12,600 nm, about 12,700 nm, about 12,800 nm, about 12,900 nm, about 13,000 nm, about 13,100 nm, about 13,200 nm, about 13,300 nm, about 13,400 nm, about 13,500 nm, about 13,600 nm, about 13,700 nm, about 13,800 nm, about 13,900 nm, about 14,000 nm, about 14,100 nm, about 14,200 nm, about 14,300 nm, about 14,400 nm, about 14,500 nm, about 14,600 nm, about 14,700 nm, about 14,800 nm, about 14,900 nm, about 15,000 nm, about 15,100 nm, about 15,200 nm, about 15,300 nm, about 15,400 nm, about 15,500 nm, about 15,600 nm, about 15,700 nm, about 15,800 nm, about 15,900 nm, about 16,000 nm, about 16,100 nm, about 16,200 nm, about 16,300 nm, about 16,400 nm, about 16,500 nm, about 16,600 nm, about 16,700 nm, about 16,800 nm, about 16,900 nm, about 17,000 nm, about 17,100 nm, about 17,200 nm, about 17,300 nm, about 17,400 nm, about 17,500 nm, about 17,600 nm, about 17,700 nm, about 17,800 nm, about 17,900 nm, about 18,000 nm, about 18,100 nm, about 18,200 nm, about 18,300 nm, about 18,400 nm, about 18,500 nm, about 18,600 nm, about 18,700 nm, about 18,800 nm, about 18,900 nm, about 19,000 nm, about 19,100 nm, about 19,200 nm, about 19,300 nm, about 19,400 nm, about 19,500 nm, about 19,600 nm, about 19,700 nm, about 19,800 nm, about 19,900 nm, about 20,000 nm, about 20,100 nm, about 20,200 nm, about 20,300 nm, about 20,400 nm, about 20,500 nm, about 20,600 nm, about 20,700 nm, about 20,800 nm, about 20,900 nm, about 21000 nm, about 21,100 nm, about 21,200 nm, about 21,300 nm, about 21,400 nm, about 21,500 nm, about 21,600 nm, about 21,700 nm, about 21,800 nm, about 21,900 nm, about 22,000 nm, about 22,100 nm, about 22,200 nm, about 22,300 nm, about 22,400 nm, about 22,500 nm, about 22,600 nm, about 22,700 nm, about 22,800 nm, about 22,900 nm, about 23,000 nm, about 23,100 nm, about 23,200 nm, about 23,300 nm, about 23,400 nm, about 23,500 nm, about 23,600 nm, about 23,700 nm, about 23,800 nm, about 23,900 nm, about 24,000 nm, about 24,100 nm, about 24,200 nm, about 24,300 nm, about 24,400 nm, about 24,500 nm, about 24,600 nm, about 24,700 nm, about 24,800 nm, about 24,900 nm, about 25,000 nm, about 25,100 nm, about 25,200 nm, about 25,300 nm, about 25,400 nm, about 25,500 nm, about 25,600 nm, about 25,700 nm, about 25,800 nm, about 25,900 nm, about 26,000 nm, about 26,100 nm, about 26,200 nm, about 26,300 nm, about 26,400 nm, about 26,500 nm, about 26,600 nm, about 26,700 nm, about 26,800 nm, about 26,900 nm, about 27,000 nm, about 27,100 nm, about 27,200 nm, about 27,300 nm, about 27,400 nm, about 27,500 nm, about 27,600 nm, about 27,700 nm, about 27,800 nm, about 27,900 nm, about 28,000 nm, about 28,100 nm, about 28,200 nm, about 28,300 nm, about 28,400 nm, about 28,500 nm, about 28,600 nm, about 28,700 nm, about 28,800 nm, about 28,900 nm, about 29,000 nm, about 29,100 nm, about 29,200 nm, about 29,300 nm, about 29,400 nm, about 29,500 nm, about 29,600 nm, about 29,700 nm, about 29,800 nm, about 29,900 nm, about 30,000 nm, about 30,100 nm, about 30,200 nm, about 30,300 nm, about 30,400 nm, about 30,500 nm, about 30,600 nm, about 30,700 nm, about 30,800 nm, about 30,900 nm, about 31,000 nm, about 31,100 nm, about 31,200 nm, about 31,300 nm, about 31,400 nm, about 31,500 nm, about 31,600 nm, about 31,700 nm, about 31,800 nm, about 31,900 nm, about 32,000 nm, about 32,100 nm, about 32,200 nm, about 32,300 nm, about 32,400 nm, about 32,500 nm, about 32,600 nm, about 32,700 nm, about 32,800 nm, about 32,900 nm, about 33,000 nm, about 33,100 nm, about 33,200 nm, about 33,300 nm, about 33,400 nm, about 33,500 nm, about 33,600 nm, about 33,700 nm, about 33,800 nm, about 33,900 nm, about 34,000 nm, about 34,100 nm, about 34,200 nm, about 34,300 nm, about 34,400 nm, about 34,500 nm, about 34,600 nm, about 34,700 nm, about 34,800 nm, about 34,900 nm, about 35,000 nm, about 35,100 nm, about 35,200 nm, about 35,300 nm, about 35,400 nm, about 35,500 nm, about 35,600 nm, about 35,700 nm, about 35,800 nm, about 35,900 nm, about 36,000 nm, about 36,100 nm, about 36,200 nm, about 36,300 nm, about 36,400 nm, about 36,500 nm, about 36,600 nm, about 36,700 nm, about 36,800 nm, about 36,900 nm, about 37,000 nm, about 37,100 nm, about 37,200 nm, about 37,300 nm, about 37,400 nm, about 37,500 nm, about 37,600 nm, about 37,700 nm, about 37,800 nm, about 37,900 nm, about 38,000 nm, about 38,100 nm, about 38,200 nm, about 38,300 nm, about 38,400 nm, about 38,500 nm, about 38,600 nm, about 38,700 nm, about 38,800 nm, about 38,900 nm, about 39,000 nm, about 39,100 nm, about 39,200 nm, about 39,300 nm, about 39,400 nm, about 39,500 nm, about 39,600 nm, about 39,700 nm, about 39,800 nm, about 39,900 nm, about 40,000 nm, about 40,100 nm, about 40,200 nm, about 40,300 nm, about 40,400 nm, about 40,500 nm, about 40,600 nm, about 40,700 nm, about 40,800 nm, about 40,900 nm, about 41,000 nm, about 41,100 nm, about 41,200 nm, about 41,300 nm, about 41,400 nm, about 41,500 nm, about 41,600 nm, about 41,700 nm, about 41,800 nm, about 41,900 nm, about 42,000 nm, about 42,100 nm, about 42,200 nm, about 42,300 nm, about 42,400 nm, about 42,500 nm, about 42,600 nm, about 42,700 nm, about 42,800 nm, about 42,900 nm, about 43,000 nm, about 43,100 nm, about 43,200 nm, about 43,300 nm, about 43,400 nm, about 43,500 nm, about 43,600 nm, about 43,700 nm, about 43,800 nm, about 43,900 nm, about 44,000 nm, about 44,100 nm, about 44,200 nm, about 44,300 nm, about 44,400 nm, about 44,500 nm, about 44,600 nm, about 44,700 nm, about 44,800 nm, about 44,900 nm, about 45,000 nm, about 45,100 nm, about 45,200 nm, about 45,300 nm, about 45,400 nm, about 45,500 nm, about 45,600 nm, about 45,700 nm, about 45,800 nm, about 45,900 nm, about 46,000 nm, about 46,100 nm, about 46,200 nm, about 46,300 nm, about 46,400 nm, about 46,500 nm, about 46,600 nm, about 46,700 nm, about 46,800 nm, about 46,900 nm, about 47,000 nm, about 47,100 nm, about 47,200 nm, about 47,300 nm, about 47,400 nm, about 47,500 nm, about 47,600 nm, about 47,700 nm, about 47,800 nm, about 47,900 nm, about 48,000 nm, about 48,100 nm, about 48,200 nm, about 48,300 nm, about 48,400 nm, about 48,500 nm, about 48,600 nm, about 48,700 nm, about 48,800 nm, about 48,900 nm, about 49,000 nm, about 49,100 nm, about 49,200 nm, about 49,300 nm, about 49,400 nm, about 49,500 nm, about 49,600 nm, about 49,700 nm, about 49,800 nm, about 49,900, or about 50,000 nm, or more.

In some preferred embodiments, a liposome of the present disclosure can have a diameter of about: 10 nm, 11 nm, 12 nm, 13 nm, 14 nm, 15 nm, 16 nm, 17 nm, 18 nm, 19 nm, 20 nm, 21 nm, 22 nm, 23 nm, 24 nm, 25 nm, 26 nm, 27 nm, 28 nm, 29 nm, 30 nm, 31 nm, 32 nm, 33 nm, 34 nm, 35 nm, 36 nm, 37 nm, 38 nm, 39 nm, 40 nm, 41 nm, 42 nm, 43 nm, 44 nm, 45 nm, 46 nm, 47 nm, 48 nm, 49 nm, 50 nm, 51 nm, 52 nm, 53 nm, 54 nm, 55 nm, 56 nm, 57 nm, 58 nm, 59 nm, 60 nm, 61 nm, 62 nm, 63 nm, 64 nm, 65 nm, 66 nm, 67 nm, 68 nm, 69 nm, 70 nm, 71 nm, 72 nm, 73 nm, 74 nm, 75 nm, 76 nm, 77 nm, 78 nm, 79 nm, 80 nm, 81 nm, 82 nm, 83 nm, 84 nm, 85 nm, 86 nm, 87 nm, 88 nm, 89 nm, 90 nm, 91 nm, 92 nm, 93 nm, 94 nm, 95 nm, 96 nm, 97 nm, 98 nm, 99 nm, 100 nm, 101 nm, 102 nm, 103 nm, 104 nm, 105 nm, 106 nm, 107 nm, 108 nm, 109 nm, 110 nm, 111 nm, 112 nm, 113 nm, 114 nm, 115 nm, 116 nm, 117 nm, 118 nm, 119 nm, 120 nm, 121 nm, 122 nm, 123 nm, 124 nm, 125 nm, 126 nm, 127 nm, 128 nm, 129 nm, 130 nm, 131 nm, 132 nm, 133 nm, 134 nm, 135 nm, 136 nm, 137 nm, 138 nm, 139 nm, 140 nm, 141 nm, 142 nm, 143 nm, 144 nm, 145 nm, 146 nm, 147 nm, 148 nm, 149 nm, 150 nm, 150.1 nm, 150.2 nm, 150.3 nm, 150.4 nm, 150.5 nm, 150.6 nm, 150.7 nm, 150.8 nm, 150.9 nm, 151.0 nm, 151.1 nm, 151.2 nm, 151.3 nm, 151.4 nm, 151.5 nm, 151.6 nm, 151.7 nm, 151.8 nm, 151.9 nm, 152.0 nm, 152.1 nm, 152.2 nm, 152.3 nm, 152.4 nm, 152.5 nm, 152.6 nm, 152.7 nm, 152.8 nm, 152.9 nm, 153.0 nm, 153.1 nm, 153.2 nm, 153.3 nm, 153.4 nm, 153.5 nm, 153.6 nm, 153.7 nm, 153.8 nm, 153.9 nm, 154.0 nm, 154.1 nm, 154.2 nm, 154.3 nm, 154.4 nm, 154.5 nm, 154.6 nm, 154.7 nm, 154.8 nm, 154.9 nm, 155.0 nm, 155.1 nm, 155.2 nm, 155.3 nm, 155.4 nm, 155.5 nm, 155.6 nm, 155.7 nm, 155.8 nm, 155.9 nm, 156.0 nm, 156.1 nm, 156.2 nm, 156.3 nm, 156.4 nm, 156.5 nm, 156.6 nm, 156.7 nm, 156.8 nm, 156.9 nm, 157.0 nm, 157.1 nm, 157.2 nm, 157.3 nm, 157.4 nm, 157.5 nm, 157.6 nm, 157.7 nm, 157.8 nm, 157.9 nm, 158.0 nm, 158.1 nm, 158.2 nm, 158.3 nm, 158.4 nm, 158.5 nm, 158.6 nm, 158.7 nm, 158.8 nm, 158.9 nm, 159.0 nm, 159.1 nm, 159.2 nm, 159.3 nm, 159.4 nm, 159.5 nm, 159.6 nm, 159.7 nm, 159.8 nm, 159.9 nm, 160 nm, 161 nm, 162 nm, 163 nm, 164 nm, 165 nm, 166 nm, 167 nm, 168 nm, 169 nm, 170 nm, 171 nm, 172 nm, 173 nm, 174 nm, 175 nm, 176 nm, 177 nm, 178 nm, 179 nm, 180 nm, 181 nm, 182 nm, 183 nm, 184 nm, 185 nm, 186 nm, 187 nm, 188 nm, 189 nm, 190 nm, 191 nm, 192 nm, 193 nm, 194 nm, 195 nm, 196 nm, 197 nm, 198 nm, 199 nm, 200 nm, 201 nm, 202 nm, 203 nm, 204 nm, 205 nm, 206 nm, 207 nm, 208 nm, 209 nm, 210 nm, 211 nm, 212 nm, 213 nm, 214 nm, 215 nm, 216 nm, 217 nm, 218 nm, 219 nm, 220 nm, 221 nm, 222 nm, 223 nm, 224 nm, 225 nm, 226 nm, 227 nm, 228 nm, 229 nm, 230 nm, 231 nm, 232 nm, 233 nm, 234 nm, 235 nm, 236 nm, 237 nm, 238 nm, 239 nm, 240 nm, 241 nm, 242 nm, 243 nm, 244 nm, 245 nm, 246 nm, 247 nm, 248 nm, 249 nm, 250 nm, 251 nm, 252 nm, 253 nm, 254 nm, 255 nm, 256 nm, 257 nm, 258 nm, 259 nm, 260 nm, 261 nm, 262 nm, 263 nm, 264 nm, 265 nm, 266 nm, 267 nm, 268 nm, 269 nm, 270 nm, 271 nm, 272 nm, 273 nm, 274 nm, 275 nm, 276 nm, 277 nm, 278 nm, 279 nm, 280 nm, 281 nm, 282 nm, 283 nm, 284 nm, 285 nm, 286 nm, 287 nm, 288 nm, 289 nm, 290 nm, 291 nm, 292 nm, 293 nm, 294 nm, 295 nm, 296 nm, 297 nm, 298 nm, 299 nm, 300 nm, 400 nm, or 500 nm.

In other embodiments, the diameter of a liposome can range from about 20 nm to about 1,000 nm; about 100 nm to about 1,500 nm; about 100 nm to about 1,000 nm; about 100 nm to about 700 nm; about 200 nm to about 2,000 nm; about 1,000 nm to about 2,000 nm; or about 750 nm to about 1,500 nm; as measured by dynamic light scattering methods described herein or as known in the art.

In some embodiments, the size of a liposome can be the size required to encapsulate a peptide based on said peptide's atomic mass unit. For example, in some embodiments, a liposome can encapsulate a peptide from about 1,000 Da to about 6,000 Da, or any value in between. In some embodiments, a liposome can encapsulate a peptide is about 2,000 Da to about 5,000 Da. In some embodiments, a liposome can encapsulate a peptide that is about 2,800 Da to about 3,000 Da; 4,000 Da to about 5,000 Da; or 5,000 Da to about 6,000 Da. In some embodiments, a liposome can encapsulate a peptide about 2900 Da, 4570.96 Da, or 5706.25 Da.

A liposome of the present disclosure can have a size contemplated by any of the foregoing diameters.

### Insecticidal Proteins

The present disclosure provides a liposome comprising, consisting essentially of, or consisting of, an insecticidal protein or agriculturally acceptable salt thereof, wherein the liposome encapsulates the insecticidal protein or agriculturally acceptable salt thereof, and wherein the liposome comprises lecithin.

In some embodiments, the liposome of the present disclosure has a lipid bilayer defining an inner sphere and an outer surface of the liposome; and an insecticidal peptide, polypeptide, or protein encapsulated within the inner sphere of the liposome.

Much has been written regarding the possibilities of using liposomes for drug delivery systems. See, e.g., the disclosures in U.S. Pat. Nos. 3,993,754; 4,145,410. The present disclosure contemplates the use of liposomes to deliver one or more insecticidal proteins to a pest.

In a liposome-insecticide delivery system, a bioactive agent such as an insecticidal protein (e.g., a CRIP) is entrapped in the liposome and then administered to the pest or area afflicted thereof. Alternatively, if the insecticidal peptide is lipophilic, it may associate with the lipid bilayer. In the present disclosure, the term “entrapment” and “encapsulated” shall be taken to include both the drug in the aqueous volume of the liposome as well as drug associated with the lipid bilayer.

In some embodiments, the insecticidal protein is encapsulated during liposome formation and then administered to the pest or area to be treated. In some embodiments, the insecticidal protein may be soluble in water or in a non-polar solvent. When preparing liposomes it is advantageous (1) to eliminate the necessity of using organic solvents during the preparation of liposomes; and (2) to maximize the encapsulation efficiency and captured volume so that a greater volume and concentration of the entrapped material can be delivered per dose.

In some embodiments, an insecticidal protein of the present disclosure can be any peptide, amino acid sequence, polypeptide, protein or agriculturally acceptable salt thereof, having insecticidal activity against one or more pests. For example, in some embodiments, an insecticidal protein or agriculturally acceptable salt thereof can be any protein, wherein upon or after exposing a pest to said protein, the pest either: dies stops or slows its movement; stops or slows its feeding; stops or slows its growth; becomes confused (e.g., with regard to navigation, locating food, sleeping behaviors, and/or mating); fails to pupate; fails to find a mate; fails to successfully reproduce; fails to produce offspring; fails to produce fertile offspring; or any combination thereof.

In some embodiments, the insecticidal protein is 25-50 amino acids in length.

In some embodiments, the peptide can be a Cysteine Rich Insecticidal Protein (CRIP).

In some embodiments, the peptide can be an Inhibitor Cystine Knot (ICK) motif protein, or a non-ICK motif protein.

In some embodiments, the insecticidal protein can be derived, isolated, and/or originating from an animal.

In some embodiments, a liposome of the present disclosure encapsulates an insecticidal protein or agriculturally acceptable salt thereof, wherein the insecticidal protein is an arthropod toxin, an amphibian toxin, a reptile toxin, a cnidarian toxin, a mollusk toxin, a fish toxin, or a mammalian toxin.

### Arthropod Insecticidal Proteins

In some embodiments, a liposome of the present disclosure encapsulates an insecticidal protein or agriculturally acceptable salt thereof, wherein the insecticidal protein is an arthropod toxin.

In some embodiments, a liposome of the present disclosure encapsulates an insecticidal protein or agriculturally acceptable salt thereof, wherein the insecticidal protein is an arachnid toxin.

In some embodiments, a liposome of the present disclosure encapsulates an insecticidal protein or agriculturally acceptable salt thereof, wherein the insecticidal protein is a spider toxin or a scorpion toxin.

### Spider Toxins—Generally

In some embodiments, a liposome of the present disclosure encapsulates an insecticidal protein or agriculturally acceptable salt thereof, wherein the insecticidal protein can be derived, isolated, and/or originating from a spider.

In some embodiments, a liposome of the present disclosure encapsulates a spider toxin.

In some embodiments, a liposome of the present disclosure encapsulates an insecticidal protein or agriculturally acceptable salt thereof, wherein the insecticidal protein or agriculturally acceptable salt thereof is: an Agelenopsis aperta toxin, an Agelena orientalis toxin, an Allagelena opulenta toxin, an Ancylometes sp. toxin, an Aphonopelma sp toxin, an Apomastus schleringi toxin, an Atrax formidabilis toxin, an Atrax sp. Illawarra toxin, an Atrax infensus toxin, an Atrax robustus toxin, a Brachypelma albiceps toxin, a Brachypelma smithi toxin, a Calisoga sp. toxin, a Ceratogyrus marshalli toxin, a Chilobrachys jingzhao toxin, a Coremiocnemis valida toxin, a Ctenus ornatus toxin, a Cupiennius salei toxin, a Diguetia canities toxin, an Eratigena agrestis toxin, an Eucratoscelus constrictus toxin, a Grammostola rosea toxin, a Hadronyche formidabilis toxin, a Hadronyche infensa toxin, a Hadronyche venenata toxin, a Hadronyche versuta peptides toxin, a Haplopelma hainanum toxin, a Haplopelma huwenum toxin, a Heriaeus melloteei toxin, a Heteropoda venatoria toxin, a Heteroscodra maculate toxin, a Hololena curta toxin, a Hysterocrates gigas toxin, an Illawara wisharti toxin, a Lasiodora sp toxin, a Latrodectus tredecimguttatus toxin, a Macrothele gigas toxin, a Macrothele raveni toxin, a Missulena bradleyi toxin, a Oxyopes lineatus toxin, a Paraphysa scrofa toxin, a Phoneutria keyserlingi toxin, a Phoneutria nigriventer toxin, a Phoneutria reidyi toxin, a Pireneitega luctuosa toxin, a Plectreurys tristis toxin, a Plesiophrictus guangxiensis toxin, a Psalmopoeus cambridgei toxin, a Segestria florentina toxin, a Stromatopelma calceatum toxin, a Theraphosa blondi, a Thrixopelma pruriens toxin, or a variant thereof.

In some embodiments, a liposome of the present disclosure encapsulates an insecticidal protein or agriculturally acceptable salt thereof, wherein the insecticidal protein or agriculturally acceptable salt thereof is a Hadronyche venenata toxin, an Atrax robustus toxin, an Atrax formidabilis toxin, an Atrax infensus toxin, a Phoneutria nigriventer toxin, or an Eratigena agrestis toxin.

In some embodiments, a liposome of the present disclosure encapsulates an insecticidal protein or agriculturally acceptable salt thereof, wherein the insecticidal protein or agriculturally acceptable salt thereof is a spider toxin peptide or protein isolated from one of the following: Phoneutria nigriventer; Allagelena opulenta; Cupiennius salei; Plectreurys tristis; Coremiocnemis valida; Haplopelma huwenum; Agelena orientalis; Allagelena opulenta; Segestria florentina; Apomastus schlingeri; Phoneutria keyserlingi; Macrothele gigas; Macrothele raveni; Missulena bradleyi; Pireneitega luctuosa; Phoneutria reidyi; Illawara wisharti; Eucratoscelus constrictus; Agelenopsis aperta; Hololena curta; Oxyopes lineatus; Brachypelma albiceps; or Brachypelma smithi.

In some embodiments, a liposome of the present disclosure encapsulates an insecticidal protein or agriculturally acceptable salt thereof, selected from any of the following spider peptides, polypeptides, and/or toxins: U+2-ACTX-Hv1a; Γ-CNTX-Pn1a; U13-ctenitoxin-Pn1a, U13-ctenitoxin-Pn1b, U13-ctenitoxin-Pn1c, U1-agatoxin-Aop1a, U1-ctenitoxin-Cs1a, U1-nemetoxin-Csp1a, U1-nemetoxin-Csp1b, U1-nemetoxin-Csp1c, U1-plectoxin-Pt1a, U1-plectoxin-Pt1b, U1-plectoxin-Pt1c, U1-plectoxin-Pt1d, U1-plectoxin-Pt1f, U1-theraphotoxin-Cv1a, U1-theraphotoxin-Hh1a_1, U1-theraphotoxin-Hh1a_2, U1-theraphotoxin-Hh1a_3, U1-theraphotoxin-Hh1b, U1-theraphotoxin-Hh1c_1, U1-theraphotoxin-Hh1c_2, U1-theraphotoxin-Hh1d, U1-theraphotoxin-Hh1e, U1-theraphotoxin-Hh1f_1, U1-theraphotoxin-Hh1f_2, U1-theraphotoxin-Hh1f 3, U1-theraphotoxin-Hh1f_4, U1-theraphotoxin-Hh1g, U2-agatoxin-Ao1a, U2-agatoxin-Aop1a, U2-ctenitoxin-Cs1a, U2-ctenitoxin-Pn1a, U2-cyrtautoxin-As1a, U2-segestritoxin-Sf1a, U2-segestritoxin-Sf1b, U2-segestritoxin-Sf1c, U2-segestritoxin-Sf1d, U2-segestritoxin-Sf1e, U2-segestritoxin-Sf1f, U2-segestritoxin-Sf1g, U2-segestritoxin-Sf1h, U2-theraphotoxin-Hh1a, U3-cyrtautoxin-As1a, U3-plectoxin-Pt1a, U5-ctenitoxin-Pn1a, U7-ctenitoxin-Pk1a, β-hexatoxin-Mg1a, β-hexatoxin-Mr1a, Γ-ctenitoxin-Pn1a, δ-actinopoditoxin-Mb1a, δ-Amaurobitoxin-Pl1a, δ-Amaurobitoxin-Pl1b, δ-Amaurobitoxin-Pl1c, δ-Amaurobitoxin-Pl1d, δ-ctenitoxin-Asp2e, δ-ctenitoxin-Pn1a_1, δ-ctenitoxin-Pn1a 2, δ-ctenitoxin-Pn1b, δ-ctenitoxin-Pn2a, δ-ctenitoxin-Pn2b, δ-ctenitoxin-Pn2cδ-ctenitoxin-Pr2d, δ-hexatoxin-Ar1a, δ-hexatoxin-Hv1a, δ-hexatoxin-Hv1b, δ-hexatoxin-Iw1a, δ-hexatoxin-Mg1a, δ-hexatoxin-Mg1b, κ-hexatoxin-KHf1a, κ-hexatoxin-Hva, κ-hexatoxin-Hvb, κ-hexatoxin-Hvc_1, κ-hexatoxin-Hv1c 2, κ-hexatoxin-Hv1c_3, κ-hexatoxin-Hvc_4, κ-hexatoxin-H1vd, κ-hexatoxin-Hv1e, κ-theraphotoxin-Ec2a, κ-theraphotoxin-Ec2b, μ-agatoxin-Aa1a, μ-agatoxin-Aa1b, μ-agatoxin-Aa1c, μ-agatoxin-Aa1d, μ-agatoxin-Aa1e, μ-agatoxin-Aa1f, μ-agatoxin-Hc1a, μ-agatoxin-He1b, μ-agatoxin-Hc1c, ω-hexatoxin-Mg1a, ω-hexatoxin-Mg1b, ω-hexatoxin-Mg1c, ω-hexatoxin-Mg2a, ω-theraphotoxin-Hh1a, ω-actinopoditoxin-Mb1a, ω-agatoxin-Aa4a, ω-agatoxin-Aa4b, ω-agatoxin-Aa4c, ω-hexatoxin-Ar1a_1, ω-hexatoxin-Ar1a_3, ω-hexatoxin-Ar1b1, ω-hexatoxin-Ar1d1, ω-hexatoxin-Ar1d_4, ω-hexatoxin-Arle_1 ω-hexatoxin-Ar1f, ω-hexatoxin-Ar1g_1, ω-hexatoxin-Ar1h, ω-hexatoxin-Ar2a, ω-hexatoxin-Ar2b, ω-hexatoxin-Ar2c, ω-hexatoxin-Ar2d, ω-hexatoxin-Ar2e_1, ω-hexatoxin-Ar2e_2, ω-atracotoxin-Asp2a, ω-hexatoxin-Asp2b, ω-hexatoxin-Hf1a, ω-hexatoxin-Hi1a_1, ω-hexatoxin-Hi1a_2, ω-hexatoxin-Hila 3, ω-hexatoxin-Hilb 1, ω-hexatoxin-Hilb 10, ω-hexatoxin-Hi1b_2, ω-hexatoxin-Hilb 5, ω-hexatoxin-Hilb 8, ω-hexatoxin-Hic_1, ω-hexatoxin-Hi1c 2, ω-hexatoxin-Hv1a, ω-hexatoxin-Hv1b, ω-hexatoxin-Hv1c, ω-hexatoxin-Hv1d, ω-hexatoxin-Hv1e, ω-hexatoxin-Hv1f, ω-hexatoxin-Hv1g_, ω-hexatoxin-Hv1g_5ω-hexatoxin-Hv1g_6ω-hexatoxin-Hv2a, ω-hexatoxin-Hv2b_1, ω-hexatoxin-Hv2b_2, ω-hexatoxin-Hv2b_3, ω-hexatoxin-Hv2b_4, ω-hexatoxin-Hv2b_5, ω-hexatoxin-Hv2b_6, ω-hexatoxin-Hv2b_7, ω-hexatoxin-Hv2c, ω-hexatoxin-Hv2d_1, ω-hexatoxin-Hv2d_2, ω-hexatoxin-Hv2d_3, ω-hexatoxin-Hv2e, ω-hexatoxin-Hv2f, ω-hexatoxin-Hv2g, ω-hexatoxin-Hv2h_1, ω-hexatoxin-Hv2h_2, ω-hexatoxin-Hv2i, ω-hexatoxin-Hv2j_1, ω-hexatoxin-Hv2j_2, ω-hexatoxin-Hv2k, ω-hexatoxin-Hv21, ω-hexatoxin-Hv2m 1, ω-hexatoxin-Hv2m 2, ω-hexatoxin-Hv2m 3, ω-hexatoxin-Hv2n, ω-hexatoxin-Hv2o, ω-hexatoxin-Hvn1a, ω-hexatoxin-Hvnlb 1, ω-hexatoxin-Hvn1b_2, ω-hexatoxin-Hvn1b_3, ω-hexatoxin-Hvn1b_4, ω-hexatoxin-Hvn1b_6, ω-hexatoxin-Iw2a, ω-oxotoxin-Ol1b, ω-plectoxin-Pt1a, ω-theraphotoxin-Asp1a, ω-theraphotoxin-Asp1f, ω-theraphotoxin-Asp1g, ω-theraphotoxin-Ba1a, ω-theraphotoxin-Ba1b, ω-theraphotoxin-Bs1a, ω-theraphotoxin-Bs2a, or ω-theraphotoxin-Hh2a.

In some embodiments, a liposome of the present disclosure encapsulates an insecticidal protein or agriculturally acceptable salt thereof having an amino acid sequence that is at least 50% identical, at least 55% identical, at least 60% identical, at least 65% identical, at least 70% identical, at least 75% identical, at least 80% identical, at least 81% identical, at least 82% identical, at least 83% identical, at least 84% identical, at least 85% identical, at least 86% identical, at least 87% identical, at least 88% identical, at least 89% identical, at least 90% identical, at least 91% identical, at least 92% identical, at least 93% identical, at least 94% identical, at least 95% identical, at least 96% identical, at least 97% identical, at least 98% identical, at least 99% identical, at least 99.5% identical, at least 99.6% identical, at least 99.7% identical, at least 99.8% identical, at least 99.9% identical, or 100% identical to an amino acid sequence set forth in any one of SEQ ID NOs: 9-187.

### Hexathelidae Family Spiders

In some embodiments, a liposome of the present disclosure encapsulates a spider toxin, wherein the spider toxin can be derived from the Hexathelidae family of spiders. The Hexathelidae family of spiders previously contained the Atracidae, Macrothelidae, and Porrhothelidae families of spiders; however, molecular phylogenetics has revealed that Hexathelidae was not monophyletic; accordingly, the genera Atracidae, Macrothelidae and Porrhothelidae were split off into new families. See Hedin et al., Phylogenomic reclassification of the world's most venomous spiders (Mygalomorphae, Atracinae), with implications for venom evolution. Sci Rep. 2018; 8: 1636.

In some embodiments, the spider toxin can be derived from the Atracidae family of spiders.

In some embodiments, the spider toxin can be derived from the Macrothelidae family of spiders.

In some embodiments, the spider toxin can be derived from the Porrhothelidae family of spiders.

In some embodiments, the spider toxin can be an ACTX peptide. ACTX peptides are a family of insecticidal ICK peptides that have been isolated from spiders belonging to the Atracinae family. ACTX peptides are positive allosteric modulators of the nicotinic acetylcholine receptor, and may also be a dual antagonist to insect voltage-gated Ca²⁺ channels and voltage-gated K⁺ channels. See Chambers et al., Insecticidal spider toxins are high affinity positive allosteric modulators of the nicotinic acetylcholine receptor. FEBS Lett. 2019 June; 593(12):1336-1350; and Windley et al., Lethal effects of an insecticidal spider venom peptide involve positive allosteric modulation of insect nicotinic acetylcholine receptors. Neuropharmacology. 2017 December; 127:224-242, the disclosures of which are incorporated herein by reference in their entireties.

Accordingly, in some embodiments, a composition of the present disclosure comprises, consists essentially of, or consists of, one or more polypeptides derived, isolated, and/or originating from a spider (e.g., a spider toxin), and a liposome.

In some embodiments, the insecticidal protein can be a Shiva family toxin.

In some embodiments, the insecticidal protein can be isolated from the species: Hadronyche versuta (also known as the Blue Mountain funnel web spider), Hadronyche venenata, Atrax robustus, Atrax formidabilis, or Atrax infensus.

In some embodiments, the insecticidal protein can be one or more atracotoxin (ACTX) peptides described in U.S. patent application Ser. No. 16/865,287, filed on May 1, 2020, the disclosure of which is incorporated herein by reference in its entirety.

In a related embodiment, the one or more ACTX peptides can include one or more U-ACTX peptides, Omega-ACTX peptides, and/or Kappa-ACTX peptides.

In some embodiments, a composition of the present disclosure comprises, consists essentially of, or consists of: (1) a liposome; and (2) one or more of the following ACTX peptides: U-ACTX-Hv1a, U+2-ACTX-Hv1a, rU-ACTX-Hv1a, rU-ACTX-Hv1b, rκ-ACTX-Hv1c, o-ACTX-Hv1a, and/or co-ACTX-Hv1a+2.

Exemplary ACTX peptides include:

U+2-ACTX-Hv1a, having the amino acid sequence:

(SEQ ID NO: 1)
“GSQYCVPVDQPCSLNTQPCCDDATCTQERNENGHTVYYCRA”;

Omega-ACTX-Hv1a, having the amino acid sequence:

(SEQ ID NO: 2)
“QYCVPVDQPCSLNTQPCCDDATCTQERNENGHTVYYCRA”;

(SEQ ID NO: 3)
“SPTCIPSGQPCPYNENCCSQSCTFKENENGNTVKRCD”;

Omega-ACTX-Hv1a+2, having the amino acid sequence:

(SEQ ID NO: 4)
“GSSPTCIPSGQPCPYNENCCSQSCTFKENENGNTVKRCD”;

Kappa-hexatoxin-Hv1c+2, having the amino acid sequence:

(SEQ ID NO: 5)
“GSAICTGADRPCAACCPCCPGTSCKAESNGVSYCRKDEP”;

and

Kappa-hexatoxin-Hv1c, having the amino acid sequence:

(SEQ ID NO: 8)
“AICTGADRPCAACCPCCPGTSCKAESNGVSYCRKDEP”.

In some embodiments, a composition of the present disclosure comprises, consists essentially of, or consists of: (1) a liposome; and (2) any one or more of the aforementioned exemplary ACTX peptides.

In some embodiments, a composition of the present disclosure comprises, consists essentially of, or consists of: (1) a liposome; and (2) one or more U-ACTX peptides, Omega-ACTX peptides, and/or Kappa-ACTX peptides.

In some embodiments, a liposome of the present disclosure encapsulates a Shiva family toxin having an amino acid sequence that is at least 50% identical, at least 55% identical, at least 60% identical, at least 65% identical, at least 70% identical, at least 75% identical, at least 80% identical, at least 81% identical, at least 82% identical, at least 83% identical, at least 84% identical, at least 85% identical, at least 86% identical, at least 87% identical, at least 88% identical, at least 89% identical, at least 90% identical, at least 91% identical, at least 92% identical, at least 93% identical, at least 94% identical, at least 95% identical, at least 96% identical, at least 97% identical, at least 98% identical, at least 99% identical, at least 99.5% identical, at least 99.6% identical, at least 99.7% identical, at least 99.8% identical, at least 99.9% identical, or 100% identical to an amino acid sequence set forth in any one of SEQ ID NOs: 1-5, 8.

### Phoneutria Spider Toxins

In some embodiments, a liposome of the present disclosure encapsulates a spider toxin, wherein the spider toxin can be isolated or derived from a spider belonging to the Phoneutria genus.

In some embodiments, a liposome of the present disclosure encapsulates a Γ-CNTX-Pn1a or 7-CNTX-Pn1a toxin. The Γ-CNTX-Pn1a peptide is an insecticidal neurotoxin derived from the Brazilian armed spider, Phoneutria nigriventer. Γ-CNTX-Pn1a targets the N-methyl-D-aspartate (NMDA)-subtype of ionotropic glutamate receptor (GRIN), and sodium channels. An exemplary wild-type full length Γ-CNTX-Pn1a peptide has an amino acid sequence of: MKVAIVFLSLLVLAFASESIEENREEFPVEESARCADINGACKSDCDCCGDSVTCDCY WSDSCKCRESNFKIGMAIRKKFC (SEQ ID NO: 161) (NCBI Accession No. P59367). A recombinant mature Γ-CNTX-Pn1a peptide is provided, having an amino acid sequence of “GSCADINGACKSDCDCCGDSVTCDCYWSDSCKCRESNFKIGMAIRKKFC” (SEQ ID NO: 188).

In some embodiments, a liposome of the present disclosure encapsulates a Γ-CNTX-Pn1a peptide having an amino acid sequence that is at least 50%, at least 55%, at least 60%, at least 65%, at least 70%, at least 75%, at least 80%, at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, at least 99.5%, at least 99.6%, at least 99.7%, at least 99.8%, at least 99.9%, or 100% amino acid sequence identity to SEQ ID NO: 188.

### Eratigena Spider Toxins

In some embodiments, a liposome of the present disclosure encapsulates a spider toxin or agriculturally acceptable salt thereof, wherein the spider toxin can be isolated or derived from a spider belonging to the Eratigena genus.

“Hobo spiders” (Eratigena agrestis, formerly Tegenaria agrestis) are venomous spiders that are members of the Agelenidae family of spiders, or funnel web weavers. See Ingale A, Antigenic epitopes prediction and MHC binder of a paralytic insecticidal toxin (ITX-1) of Tegenaria agrestis (hobo spider). 4 Aug. 2010 Volume 2010:2 pp 97-103. The venom of Hobo spiders has been implicated as possessing insecticidal activity. See Johnson et al., Novel insecticidal peptides from Tegenaria agrestis spider venom may have a direct effect on the insect central nervous system. Arch Insect Biochem Physiol. 1998; 38(1):19-31; Klint et al., Production of Recombinant Disulfide-Rich Venom Peptides for Structural and Functional Analysis via Expression in the Periplasm of E. coli. PLoS One. 2013; 8(5): e63865.

The Hobo spider-along with several other spiders in the Agelenidae family, produce venom containing agatoxins-which exhibit insecticidal activity. Agatoxins are a chemically diverse group of toxins that can induce various insecticidal effects depending on the target species; .e.g., agatoxins cause slow-onset spastic paralysis in coleopterans, lepidopterans, and dipterans; increase the rate of neuron firing in the central nervous system (CNS) of houseflies (Musca domestica); and are lethal to other insects (e.g., the blowfly, Lucilia cuprina). Accordingly, agatoxins are implicated in targeting the CNS. See Undheim et al., Weaponization of a hormone: convergent recruitment of hyperglycemic hormone into the venom of arthropod predators. Structure 23: 1283-1292, and Johnson et al., Novel insecticidal peptides from Tegenaria agrestis spider venom may have a direct effect on the insect central nervous system. Arch. Insect Biochem. Physiol. 38:19-31(1998).

Two types of agatoxins include U1-agatoxin-Ta1a and U1-agatoxin-Ta1b, which are both members of the helical arthropod-neuropeptide-derived (HAND) toxins family. In addition to spiders, these toxins can also be found in the venom of centipedes. The agatoxins are evolutionary offshoots of an ancient ecdysozoan hormone family, i.e., the ion transport peptide/crustacean hyperglycemic hormone (ITP/CHH) family. See Undheim et al., Weaponization of a hormone: convergent recruitment of hyperglycemic hormone into the venom of arthropod predators. Structure 23: 1283-1292, and Johnson et al., Novel insecticidal peptides from Tegenaria agrestis spider venom may have a direct effect on the insect central nervous system. Arch. Insect Biochem. Physiol. 38:19-31(1998).

The Hobo-spider-derived U1-agatoxin-Ta1b toxin has a full amino acid sequence of “MKLQLMICLVLLPCFFCEPDEICRARMTNKEFTYKSNVCNNCGDQVAACEAECFRN DVYTACHEAQKG” (SEQ ID NO: 189) which includes a signal peptide from amino acid positions 1-17, and the mature toxin from positions 18-68. Id. The protein comprises four tightly packed α-helices, with no β-strands present, and the molecular mass of the mature toxin is 5700.39 Daltons (Da). Id.

An exemplary mature wild-type U1-agatoxin-Ta1b polypeptide from Eratigena agrestis is provided having the amino acid sequence:

(SEQ ID NO: 190)
“EPDEICRARMTNKEFTYKSNVCNNCG
DQVAACEAECFRNDVYTACHEAQKG”.

During protein processing, the mature wild-type U1-agatoxin-Talb toxin undergoes an excision event of the C-terminal glycine, yielding the following amino acid sequence: EPDEICRARMTNKEFTYKSNVCNNCGDQVAACEAECFRNDVYTACHEAQK (SEQ ID NO: 191). A subsequent post-translational event result in the mature wild-type U1-agatoxin-Talb toxin having a C-terminal amidation.

U1-agatoxin-Talb Variant Polypeptides (TVPs) are mutants or variants that differ from the wild-type U1-agatoxin-Talb (SEQ ID NO: 190) in some way, e.g., in some embodiments, this variance can be an amino acid substitution, deletion, or addition; or a change to the polynucleotide encoding the wild-type U1-agatoxin-Talb resulting in an amino acid substitution, deletion, or addition. The result of this variation is a non-naturally occurring polypeptide and/or polynucleotide sequence encoding the same that possesses enhanced insecticidal activity against one or more insect species relative to the wild-type U1-agatoxin-Talb.

In some embodiments, a liposome of the present disclosure encapsulates a spider toxin or agriculturally acceptable salt thereof, wherein the spider toxin is an Eratigena agrestis toxin, or a variant thereof.

In some embodiments, a liposome of the present disclosure encapsulates a spider toxin or agriculturally acceptable salt thereof, wherein the spider toxin is a wild-type U1-agatoxin-Talb protein.

In some embodiments, a liposome of the present disclosure encapsulates a spider toxin or agriculturally acceptable salt thereof, wherein the spider toxin is a U1-agatoxin-Talb Variant Polypeptide (TVP).

In some embodiments, a liposome of the present disclosure encapsulates a TVP having an amino acid sequence that is at least 50% identical, at least 55% identical, at least 60% identical, at least 65% identical, at least 70% identical, at least 75% identical, at least 80% identical, at least 81% identical, at least 82% identical, at least 83% identical, at least 84% identical, at least 85% identical, at least 86% identical, at least 87% identical, at least 88% identical, at least 89% identical, at least 90% identical, at least 91% identical, at least 92% identical, at least 93% identical, at least 94% identical, at least 95% identical, at least 96% identical, at least 97% identical, at least 98% identical, at least 99% identical, at least 99.5% identical, at least 99.6% identical, at least 99.7% identical, at least 99.8% identical, at least 99.9% identical, or 100% identical to an amino acid sequence set forth in any one of SEQ ID NOs: 192-244.

Exemplary TVPs, and methods of making and using the same, are described in International Patent Application No. PCT/US2021/028254, entitled “Proteolytically stable ul-agatoxin-ta1b variant polypeptides for pest control,” the disclosure of which is incorporated herein by reference in its entirety.

### Diguetia Spider Toxins

The American Desert Spider (Diguetia canities), also known as “the desert bush spider,” is a species of coneweb spider found in desert and semi-desert habitats in the United States. Diguetia canities produces toxins that have been shown to have an insecticidal effect, while having no effect on mammals. See Bende et al., A distinct sodium channel voltage-sensor locus determines insect selectivity of the spider toxin Dc1a. Nat Commun. 2014 Jul. 11; 5: 4350.

One of the toxins that Diguetia canities produces is, inter alia, Mu-diguetoxin-Dc1a, (also known as μ-DGTX-Dc1a, or simply “Dc1a”). An exemplary wild-type Mu-diguetoxin-Dc1a polypeptide sequence from Diguetia canities is provided herein, having the amino acid sequence of SEQ ID NO:600 (NCBI Accession No. P49126.1).

The wild-type Dc1a polypeptide exemplified in SEQ ID NO:1 includes a signal peptide region and a propeptide region. Following polypeptide processing, the mature wild-type Dc1a polypeptide possesses an amino acid sequence of “AKDGDVEGPAGCKKYDVECDSGECCQKQYLWYKWRPLDCRCLKSGFFSSKCVCR DV” (SEQ ID NO:601). Dc1a possesses an inhibitor cystine knot (ICK) motif, along with a three-strand beta-sheet that is derived from an extended N-terminal segment, and large inter-cystine loop between residues C25 and C39. Dc1a has disulfide bond connectivity between cysteines at C12 and C25; C19 and C39; C24 and C53; and C41 and C51.

Mu-diguetoxin-Dc1a Variant Polypeptides (DVPs), or pharmaceutically acceptable salts thereof, are mutants or variants that differ from the wild-type mature Mu-diguetoxin-Dc1a (SEQ ID NO:601), e.g., in some embodiments, this variance can be an amino acid substitution, amino acid deletion/insertion, or a change to the polynucleotide encoding the wild-type Mu-diguetoxin-Dc1a. The result of this variation is a non-naturally occurring polypeptide and/or polynucleotide sequence encoding the same that possesses insecticidal activity against one or more insect species relative to the wild-type Mu-diguetoxin-Dc1a.

In some embodiments, a liposome of the present disclosure encapsulates a DVP having an amino acid sequence that is at least 50% identical, at least 55% identical, at least 60% identical, at least 65% identical, at least 70% identical, at least 75% identical, at least 80% identical, at least 81% identical, at least 82% identical, at least 83% identical, at least 84% identical, at least 85% identical, at least 86% identical, at least 87% identical, at least 88% identical, at least 89% identical, at least 90% identical, at least 91% identical, at least 92% identical, at least 93% identical, at least 94% identical, at least 95% identical, at least 96% identical, at least 97% identical, at least 98% identical, at least 99% identical, at least 99.5% identical, at least 99.6% identical, at least 99.7% identical, at least 99.8% identical, at least 99.9% identical, or 100% identical to the amino acid sequence according to Formula (a): A-X₁-D-G-D-V-E-G-P-A-G-C-K-K-Y-D-X₂-E-C-X₃-X₄-G-E-C-C-Q-K-Q-Y-L-X₅-X₆-K-W-R-X₇-L-X₈-C-R-X₉-X₁₀-K-S-G-F-F-S-S-K-X₁₁-X₁₂-C-R-D-V, wherein the polypeptide comprises at least one amino acid substitution relative to the wild-type sequence of the diguetoxin as set forth in SEQ ID NO:2, and wherein X₁ is K or L; X₂ is V, A, or E; X₃ is D, Y, or A; X₄ is S or A; X₅ is W, A, F; X₆ is Y, A, S, H, or K; X₇ is P or A; X₈ is D, A, K, S, T or M; X₉ is C, G, T, A, S, M, or V; X₁₀ is L, A, N, V, S, E, I, or Q; X₁₁ is C, F, A, T, S, M, or V; and X₁₂ is V, A, or T; or an agriculturally acceptable salt thereof.

In some embodiments, a liposome of the present disclosure encapsulates a DVP having an amino acid sequence that is at least 50% identical, at least 55% identical, at least 60% identical, at least 65% identical, at least 70% identical, at least 75% identical, at least 80% identical, at least 81% identical, at least 82% identical, at least 83% identical, at least 84% identical, at least 85% identical, at least 86% identical, at least 87% identical, at least 88% identical, at least 89% identical, at least 90% identical, at least 91% identical, at least 92% identical, at least 93% identical, at least 94% identical, at least 95% identical, at least 96% identical, at least 97% identical, at least 98% identical, at least 99% identical, at least 99.5% identical, at least 99.6% identical, at least 99.7% identical, at least 99.8% identical, at least 99.9% identical, or 100% identical to an amino acid sequence as set forth in any one of SEQ ID NOs: 602-701, or an agriculturally acceptable salt thereof.

Exemplary DVPs, and methods of making and using the same, are described in International Patent Application No. PCT/PCT/US21/52259, entitled “Mu-Diguetoxin-Dc1a Variant Polypeptides for Pest Control,” the disclosure of which is incorporated herein by reference in its entirety.

### Scorpion Toxins-Generally

In some embodiments, a liposome of the present disclosure encapsulates an insecticidal protein or agriculturally acceptable salt thereof, wherein the insecticidal protein can be derived, isolated, and/or originating from a scorpion.

In some embodiments, a liposome of the present disclosure encapsulates a scorpion toxin or agriculturally acceptable salt thereof.

In some embodiments, a liposome of the present disclosure encapsulates a scorpion toxin or agriculturally acceptable salt thereof selected from: an Androctonus australis toxin, an Androctonus mauretanicus mauretanicus toxin, an Anuroctonus phaiodactylus toxin, a Bothus martensii Karsch toxin, a Bothus occitanus tunetanus toxin, a Buthacus arenicola toxin, a Buthotus judaicus toxin, a Buthus eupeus toxin, a Buthus martensii toxin, a Buthus occitanus mardochei toxin, a Buthus occitanus tunetanus toxin, a Buthus sindicus toxin, a Centruroides elegans toxin, a Centruroides exilicauda toxin, a Centruroides gracilis toxin, a Centruroides limbatus toxin, a Centruroides limpidus limpidus toxin, a Centruroides margaritatus toxin, a Centruroides noxius toxin, a Centruroides sculpturatus toxin, a Centruroides suffusus suffuses toxin, a Hadrurus gertschi toxin, a Hemiscorpius lepturus toxin, a Heterometrus spinfer toxin, a Hottentotta judaica toxin, a Leiurus quinquestriatus toxin, a Mesobuthus eupeus toxin, a Mesobuthus martensii toxin, a Mesobuthus tamulus toxin, an Odonthobuthus doriae toxin, an Orthochirus scrobiculosus toxin, a Pandinus imperator toxin, a Parabuthus granulatus toxin, a Parabuthus transvaalicus toxin, a Parabuthus villosus toxin, a Scorpio maurus toxin, a Tityus cambridgei toxin, a Tityus costatus toxin, a Tityus discrepans toxin, a Tityus serrulatus toxin, a Tityus trivittatus toxin, or a Tityus zulianus toxin.

In some embodiments, a liposome of the present disclosure encapsulates a scorpion toxin or agriculturally acceptable salt thereof selected from the following: Imperatoxin-A (IpTxa), Potassium channel toxin alpha-KTx 10.2 (Cobatoxin-2), Potassium channel toxin alpha-KTx 11.1 (Parabutoxin-1), Potassium channel toxin alpha-KTx 11.2 (Parabutoxin-2), Potassium channel toxin alpha-KTx 11.3 (Parabutoxin-10), Potassium channel toxin alpha-KTx 12.1 (Butantoxin), Potassium channel toxin alpha-KTx 12.2 (Butantoxin), Potassium channel toxin alpha-KTx 12.3 (Butantoxin-like peptide), Potassium channel toxin alpha-KTx 15.1 (Peptide Aa1), Potassium channel toxin alpha-KTx 15.3 (Toxin AmmTX3), Potassium channel toxin alpha-KTx 15.6 (Discrepin), Potassium channel toxin alpha-KTx 16.1 (Tamulotoxin), Potassium channel toxin alpha-KTx 19.1 (Neurotoxin BmBKTx1), Potassium channel toxin alpha-KTx 1.3 (Iberiotoxin), Potassium channel toxin alpha-KTx 1.4 (Limbatotoxin), Potassium channel toxin alpha-KTx 1.7 (Lqh 15-1), Potassium channel toxin alpha-KTx 1.9 (Hongotoxin-2), Potassium channel toxin alpha-KTx 1.10 (Parabutoxin-3), Potassium channel toxin alpha-KTx 1.11 (Slotoxin), Potassium channel toxin alpha-KTx 1.13 (Charybdotoxin c), Potassium channel toxin alpha-KTx 2.1 (Noxiustoxin), Potassium channel toxin alpha-KTx 2.2 (Margatoxin), Potassium channel toxin alpha-KTx 2.3 (CllTx1), Potassium channel toxin alpha-KTx 2.4 (Noxiustoxin-2), Potassium channel toxin alpha-KTx 2.5 (Hongotoxin-1), Potassium channel toxin alpha-KTx 2.6 (Hongotoxin-3), Potassium channel toxin alpha-KTx 2.7 (CllTx2), Potassium channel toxin alpha-KTx 2.8 (Toxin Ce1), Potassium channel toxin alpha-KTx 2.9 (Toxin Ce2), Potassium channel toxin alpha-KTx 2.10 (Toxin Ce3), Potassium channel toxin alpha-KTx 2.11 (Toxin Ce4), Potassium channel toxin alpha-KTx 2.12 (Toxin Ce5), Potassium channel toxin alpha-KTx 3.1 (Kaliotoxin-1), Potassium channel toxin alpha-KTx 3.2 (Agitoxin-2), Potassium channel toxin alpha-KTx 3.3 (Agitoxin-3), Potassium channel toxin alpha-KTx 3.4 (Agitoxin-1), Potassium channel toxin alpha-KTx 3.7 (OsK-1), Potassium channel toxin alpha-KTx 3.8 (Charybdotoxin-like peptide Bs 6), Potassium channel toxin alpha-KTx 3.9 (Kaliotoxin-3), Potassium channel toxin alpha-KTx 4.1 (Tityustoxin K-alpha), Potassium channel toxin alpha-KTx 4.3 (Toxin TdK1), Potassium channel toxin alpha-KTx 4.4 (Toxin Tc30), Potassium channel toxin alpha-KTx 5.1 (Leiurotoxin-1), Potassium channel toxin alpha-KTx 5.2 (Leiurotoxin I-like toxin P05), Potassium channel toxin alpha-KTx 5.4 (Tamapin), Potassium channel toxin alpha-KTx 5.5 (Tamapin-2), Potassium channel toxin alpha-KTx 6.1 (Potassium channel-blocking toxin 1), Potassium channel toxin alpha-KTx 6.2 (Maurotoxin), Potassium channel toxin alpha-KTx 6.3 (Neurotoxin HsTX1), Potassium channel toxin alpha-KTx 6.12 (Anuroctoxin), Potassium channel toxin alpha-KTx 6.13 (Spinoxin), Potassium channel toxin alpha-KTx 6.14 (HgeTx1), Potassium channel toxin alpha-KTx 7.2 (Toxin PiTX-K-beta), Potassium channel toxin gamma-KTx 1.2 (Ergtoxin-like protein 1), Potassium channel toxin gamma-KTx 1.3 (Ergtoxin-like protein 1), Potassium channel toxin gamma-KTx 1.4 (Ergtoxin-like protein 1), Potassium channel toxin gamma-KTx 1.5 (Ergtoxin-like protein 1), Potassium channel toxin gamma-KTx 1.6 (Ergtoxin-like protein 1), Potassium channel toxin gamma-KTx 4.2 (Ergtoxin-like protein 5), Insectotoxin-I1. Small toxin (Peptide I), Insectotoxin-I3 (BeI3), Insectotoxin-I4 (BeI4), Insectotoxin-I5A, Neurotoxin 8 (Neurotoxin VIII), Probable toxin Lqh 8/6, Neurotoxin 9 (Neurotoxin IX), Maurocalcin (MCa), Chlorotoxin-like peptide Bs 14 (Bs14), Chlorotoxin (CTX), Neurotoxin P2, Insectotoxin-I5 (BeI5), Potassium channel toxin alpha-KTx 6.15 (Hemitoxin), Toxin GaTx1, AahIT1, Phaiodotoxin, BaIT2, BotITI, BotIT2, BmK M1, BmK-M2, BmK-M4, BmK-M7, BmK IT-AP, Bom3, Bom4, BjaIT, Bj-xtrIT, BjIT2, LqhaIT, Lqhbl, LqhIT2, LqhdprIT3a, Lgh-xtrIT, Lqh3, Lqh6, Lqh7, LqqIT1, LqqIT2, Lqq3, OD1, Ts1, or Tz1.

In some embodiments, a liposome of the present disclosure encapsulates a scorpion toxin or agriculturally acceptable salt thereof having an amino acid sequence that is at least 50% identical, at least 55% identical, at least 60% identical, at least 65% identical, at least 70% identical, at least 75% identical, at least 80% identical, at least 81% identical, at least 82% identical, at least 83% identical, at least 84% identical, at least 85% identical, at least 86% identical, at least 87% identical, at least 88% identical, at least 89% identical, at least 90% identical, at least 91% identical, at least 92% identical, at least 93% identical, at least 94% identical, at least 95% identical, at least 96% identical, at least 97% identical, at least 98% identical, at least 99% identical, at least 99.5% identical, at least 99.6% identical, at least 99.7% identical, at least 99.8% identical, at least 99.9% identical, or 100% identical to an amino acid sequence set forth in any one of SEQ ID NOs: 245-348.

In some embodiments, a liposome of the present disclosure encapsulates an imperatoxin or agriculturally acceptable salt thereof. Imperatoxins are peptide toxins derived from the venom of the African scorpion (Pandinus imperator).

In some embodiments, a liposome of the present disclosure encapsulates an imperatoxin, wherein the imperatoxin is Imperatoxin A (IpTx-a), or a variant thereof. In some embodiments, the IpTx-a has an amino acid sequence of

(SEQ ID NO: 246)
GDCLPHLKRCKADNDCCGKKCKRRGTNAEKRCR.

In some embodiments, a liposome of the present disclosure encapsulates an AaIT1 toxin. The protein toxin, AalT1, is a sodium channel site 4 toxin from North African desert scorpion (Androctonus australis). An exemplary AaIT1 toxin is a peptide having the amino acid sequence according to SEQ ID NO: 245 (NCBI accession No. P01497.2). AaIT1 is a site 4 toxin, which forces the insect sodium channel to open by lowering the activation reaction energy barrier.

In some embodiments, a liposome of the present disclosure encapsulates a scorpion peptide having an amino acid sequence that is at least 50% identical, at least 55% identical, at least 60% identical, at least 65% identical, at least 70% identical, at least 75% identical, at least 80% identical, at least 81% identical, at least 82% identical, at least 83% identical, at least 84% identical, at least 85% identical, at least 86% identical, at least 87% identical, at least 88% identical, at least 89% identical, at least 90% identical, at least 91% identical, at least 92% identical, at least 93% identical, at least 94% identical, at least 95% identical, at least 96% identical, at least 97% identical, at least 98% identical, at least 99% identical, at least 99.5% identical, at least 99.6% identical, at least 99.7% identical, at least 99.8% identical, at least 99.9% identical, or 100% identical to an amino acid sequence set forth in any one of SEQ ID NOs: 245 or 246.

### Cnidarian Insecticidal Proteins

In some embodiments, a liposome of the present disclosure encapsulates an insecticidal protein or agriculturally acceptable salt thereof, wherein the insecticidal protein can be derived, isolated, and/or originating from a cnidarian.

For example, in some embodiments, an insecticidal protein can be a coral toxin, a sea pen toxin, a sea anemone toxin, a jellyfish toxin, a hydroid toxin, or a variant thereof.

In some embodiments, a liposome of the present disclosure encapsulates a cnidarian toxin or agriculturally acceptable salt thereof.

In some embodiments, a liposome of the present disclosure encapsulates a sea anemone toxin or agriculturally acceptable salt thereof.

In some embodiments, a liposome of the present disclosure encapsulates an Anemonia viridis toxin, an Actinia equina toxin, an Anemonia erythraea toxin, an Anemonia sulcata toxin, an Anthopleura elegantissima toxin, an Anthopleura fuscoviridis toxin, an Anthopleura xanthogrammica toxin, a Bunodosoma caissarum toxin, a Bunodosoma cangicum toxin, a Bunodosoma granulifera toxin, a Heteractis crispa toxin, a Parasicyonis actinostoloides toxin, a Radianthus paumotensis toxin, or a Stoichactis helianthus toxin.

In some embodiments, a liposome of the present disclosure encapsulates a wild-type insecticidal protein isolated from a sea anemone. For example, in some embodiments, the sea anemone can be Actinia equina; Anemonia erythraea; Anemonia sulcata; Anemonia viridis; Anthopleura elegantissima; Anthopleura fuscoviridis; Anthopleura xanthogrammica; Bunodosoma caissarum; Bunodosoma cangicum; Bunodosoma granulifera; Heteractis crispa; Parasicyonis actinostoloides; Radianthus paumotensis; or Stoichactis helianthus. In yet other embodiments, the sea anemone toxin can be Av2; an Av3; or a variant thereof.

In some embodiments, a liposome of the present disclosure encapsulates one of the following sea anemone toxins: Toxin AETX-1 (AETX I), Toxin APETx1, Toxin APETx2, Antihypertensive protein BDS-1 (Blood depressing substance I), Antihypertensive protein BDS-2 (Blood depressing substance II), Neurotoxin Bg-2 (Bg II), Neurotoxin Bg-3 (Bg III), Toxin APE 1-1, Toxin APE 1-2, Neurotoxin-1 (Toxin ATX-I), Neurotoxin-1 (Neurotoxin I), Neurotoxin 1 (Toxin RTX-I), Neurotoxin 1 (Toxin SUP—I), Toxin APE 2-1, Toxin APE 2-2, Neurotoxin-2 (Toxin ATX-II), (aka AV2) Neurotoxin-2 (Toxin AFT-II), Neurotoxin 2 (Toxin RTX-II), Neurotoxin 2 (Neurotoxin II), Neurotoxin 3 homolog (Neurotoxin III homolog), Neurotoxin 3 (Toxin RTX-III), Neurotoxin 3 (Neurotoxin-III), Neurotoxin 4 (Toxin RTX-IV), Neurotoxin-5 (Toxin ATX-V), Neurotoxin 5 (Toxin RTX-V), Anthopleurin-A (Toxin AP-A), Anthopleurin-B (Toxin AP-B), Anthopleurin-C(Toxin AP-C), Potassium channel toxin Aek, Potassium channel toxin Bgk, Major neurotoxin BcIII, Neurotoxin BcIV, Cangitoxin (CGTX), Potassium channel toxin ShK, Toxin PCR1 (PCR1-2), Toxin PCR2 (PCR2-5), Toxin PCR3 (PCR2-1), Toxin PCR4 (PCR2-10), Toxin PCR6 (PCR3-7), Cangitoxin-2 (Cangitoxin II), or Cangitoxin-3 (Cangitoxin III).

In some embodiments, a liposome of the present disclosure encapsulates a sea anemone peptide or agriculturally acceptable salt thereof having an amino acid sequence that is at least 50% identical, at least 55% identical, at least 60% identical, at least 65% identical, at least 70% identical, at least 75% identical, at least 80% identical, at least 81% identical, at least 82% identical, at least 83% identical, at least 84% identical, at least 85% identical, at least 86% identical, at least 87% identical, at least 88% identical, at least 89% identical, at least 90% identical, at least 91% identical, at least 92% identical, at least 93% identical, at least 94% identical, at least 95% identical, at least 96% identical, at least 97% identical, at least 98% identical, at least 99% identical, at least 99.5% identical, at least 99.6% identical, at least 99.7% identical, at least 99.8% identical, at least 99.9% identical, or 100% identical to an amino acid sequence set forth in any one of SEQ ID NOs: 349-389.

In some embodiments, a liposome of the present disclosure encapsulates a polypeptide derived from the sea anemone, Anemonia viridis, which possesses a variety of toxins that it uses to defend itself. One of the toxins derived from Anemonia viridis is the neurotoxin “Av3.” Av3 is a type III sea anemone toxin that inhibits the inactivation of voltage-gated sodium (Na⁺) channels at receptor site 3, resulting in contractile paralysis. The binding of an Av3 toxin to site 3 results in the inactivated state of the sodium channel to become destabilized, which in turn causes the channel to remain in the open position (see Blumenthal et al., Voltage-gated sodium channel toxins: poisons, probes, and future promise. Cell Biochem Biophys. 2003; 38(2):215-38). Av3 shows high selectivity for crustacean and insect sodium channels, and low selectivity for mammalian sodium channels (see Moran et al., Sea anemone toxins affecting voltage-gated sodium channels—molecular and evolutionary features, Toxicon. 2009 Dec. 15; 54(8): 1089-1101). An exemplary Av3 polypeptide from Anemonia viridis is provided having the amino acid sequence of RSCCPCYWGGCPWGQNCYPEGCSGPKV (SEQ ID NO: 6; NCBI Accession No. P01535.1).

In some embodiments, a liposome of the present disclosure encapsulates an Av3 variant polypeptide (AVP). In some embodiments, AVPs can have the following amino acid variations relative to SEQ ID NO: 6: for example, an N-terminal amino acid substitution of R1K relative to SEQ ID NO: 6, changing the polypeptide sequence from the wild-type

(SEQ ID NO: 390)
“RSCCPCYWGGCPWGQNCYPEGCSGPKV”
to
“KSCCPCYWGGCPWGQNCYPEGCSGPKV”.

In some embodiments, a liposome of the present disclosure encapsulates an AVP wherein the AVP has a C-terminal amino acid that is deleted relative to SEQ ID NO: 6, changing the polypeptide sequence from the wild-type

(SEQ ID NO: 391)
“RSCCPCYWGGCPWGQNCYPEGCSGPKV”
to
“RSCCPCYWGGCPWGQNCYPEGCSGPK”

In some embodiments, a liposome of the present disclosure encapsulates an AVP, wherein the AVP has an N-terminal mutation and a C-terminal mutation, wherein the N-terminal amino acid can have a substitution of R1K relative to SEQ ID NO: 6, and the C-terminal amino acid can be deleted relative to SEQ ID NO: 6, changing the polypeptide sequence from the wild-type “RSCCPCYWGGCPWGQNCYPEGCSGPKV” to “KSCCPCYWGGCPWGQNCYPEGCSGPK” (SEQ ID NO: 7).

In some embodiments, an illustrative Av3 peptide or variant thereof is described in the Applicant's PCT application (Application No. PCT/US19/51093) filed Sep. 13, 2019, entitled “Av3 Mutant Insecticidal Polypeptides and Methods for Producing and Using Same,” the disclosure of which, and the disclosure of Av3 peptides or variants thereof, are described and are incorporated by reference herein in its entirety.

In some embodiments, a liposome of the present disclosure encapsulates a sea anemone peptide or agriculturally acceptable salt thereof having an amino acid sequence that is at least 50% identical, at least 55% identical, at least 60% identical, at least 65% identical, at least 70% identical, at least 75% identical, at least 80% identical, at least 81% identical, at least 82% identical, at least 83% identical, at least 84% identical, at least 85% identical, at least 86% identical, at least 87% identical, at least 88% identical, at least 89% identical, at least 90% identical, at least 91% identical, at least 92% identical, at least 93% identical, at least 94% identical, at least 95% identical, at least 96% identical, at least 97% identical, at least 98% identical, at least 99% identical, at least 99.5% identical, at least 99.6% identical, at least 99.7% identical, at least 99.8% identical, at least 99.9% identical, or 100% identical to an amino acid sequence set forth in any one of SEQ ID NOs: 7, 390, or 391.

In some embodiments, a liposome of the present disclosure encapsulates an Av3b mutant polypeptide (AMP) or agriculturally acceptable salt thereof having an amino acid sequence that is at least 50% identical, at least 55% identical, at least 60% identical, at least 65% identical, at least 70% identical, at least 75% identical, at least 80% identical, at least 81% identical, at least 82% identical, at least 83% identical, at least 84% identical, at least 85% identical, at least 86% identical, at least 87% identical, at least 88% identical, at least 89% identical, at least 90% identical, at least 91% identical, at least 92% identical, at least 93% identical, at least 94% identical, at least 95% identical, at least 96% identical, at least 97% identical, at least 98% identical, at least 99% identical, at least 99.5% identical, at least 99.6% identical, at least 99.7% identical, at least 99.8% identical, at least 99.9% identical, or 100% identical to an amino acid sequence set forth in any one of SEQ ID NOs: 430-599.

### Mollusk Insecticidal Proteins

In some embodiments, a liposome of the present disclosure encapsulates an insecticidal protein or agriculturally acceptable salt thereof, wherein the insecticidal protein can be derived, isolated, and/or originating from a mollusk.

In some embodiments, a liposome of the present disclosure encapsulates a mollusk toxin or agriculturally acceptable salt thereof.

In some embodiments, a liposome of the present disclosure encapsulates an insecticidal protein or agriculturally acceptable salt thereof, wherein the insecticidal protein can be derived, isolated, and/or originating from a species belonging to the Conus genus.

In some embodiments, a liposome of the present disclosure encapsulates a cone shell toxin (also known as a “conotoxin”) or agriculturally acceptable salt thereof.

Conotoxins are toxins isolated from cone shells; these toxins act by interfering with neuronal communication. Examples of conotoxins include the α-, ω-, μ-, δ-, and κ-conotoxins. Briefly, the α-conotoxins (and αA-δφ-conotoxins) target nicotinic ligand gated channels; ω-conotoxins target voltage-gated calcium channels; μ-conotoxins target the voltage-gated sodium channels; δ-conotoxins target the voltage-gated sodium channel; and κ-conotoxins target the voltage-gated potassium channel.

In some embodiments, a liposome of the present disclosure encapsulates a protein isolated from organisms belonging to the Conus genus, wherein the peptide isolated is a conotoxin.

In some embodiments, a liposome of the present disclosure encapsulates a Conus amadis toxin, a Conus catus toxin, a Conus ermineus toxin, a Conus geographus toxin, a Conus gloriamaris toxin, a Conus kinoshitai toxin, a Conus magus toxin, a Conus marmoreus toxin, a Conus purpurascens toxin, a Conus stercusmuscarum toxin, a Conus striatus toxin, a Conus textile toxin, a Conus tulipa toxin, or a Striated cone toxin.

In some embodiments, a liposome of the present disclosure encapsulates a sea anemone peptide or agriculturally acceptable salt thereof having an amino acid sequence that is at least 50% identical, at least 55% identical, at least 60% identical, at least 65% identical, at least 70% identical, at least 75% identical, at least 80% identical, at least 81% identical, at least 82% identical, at least 83% identical, at least 84% identical, at least 85% identical, at least 86% identical, at least 87% identical, at least 88% identical, at least 89% identical, at least 90% identical, at least 91% identical, at least 92% identical, at least 93% identical, at least 94% identical, at least 95% identical, at least 96% identical, at least 97% identical, at least 98% identical, at least 99% identical, at least 99.5% identical, at least 99.6% identical, at least 99.7% identical, at least 99.8% identical, at least 99.9% identical, or 100% identical to an amino acid sequence set forth in any one of SEQ ID NOs: 392-429.

### Other Insecticidal Proteins

The present disclosure contemplates a wide variety of insecticidal proteins that can be encapsulated by a liposome of the present disclosure, e.g., without limitation, an insecticidal protein that is derived, isolated, and/or originating from: a bee, a wasp, a centipede, a crustacean; a reptile, e.g., a snake or a lizard; an amphibian, e.g., a frog or a salamander; a hydrozoan, a cephalopod, an octopus, a squid, a cuttlefish, a fish, or a mammal.

In some embodiments, a liposome of the present disclosure encapsulates a snake venom, or toxin therefrom.

### Modified-Insecticidal Proteins

Modified-insecticidal proteins are any protein, peptide, polypeptide, amino acid sequence, configuration, or arrangement, consisting of: (1) at least one insecticidal protein, or two or more insecticidal protein; and (2) additional non-insecticidal protein peptides, polypeptides, or proteins that, e.g., in some embodiments, have the ability to do the following: increase the mortality and/or inhibit the growth of insects when the insects are exposed to a modified-insecticidal protein, relative to an insecticidal protein alone; increase the expression of said modified-insecticidal protein, e.g., in a host cell or an expression system; and/or affect the post-translational processing of the modified-insecticidal protein.

In some embodiments, a liposome of the present disclosure encapsulates a modified-insecticidal protein, wherein the modified-insecticidal protein can be a polymer comprising two or more insecticidal proteins described herein. In some embodiments, a modified-insecticidal protein can be a polymer comprising two or more insecticidal proteins, wherein the insecticidal proteins are operably linked via a linker peptide, e.g., a cleavable and/or non-cleavable linker.

In some embodiments, a liposome of the present disclosure encapsulates a modified-insecticidal protein, wherein the modified-insecticidal protein comprises one or more insecticidal proteins operably linked with one or more additional non-insecticidal proteins such as a stabilizing domain (STA); an endoplasmic reticulum signaling protein (ERSP); an insect cleavable or insect non-cleavable linker (L); and/or any other combination thereof.

In some embodiments, a liposome of the present disclosure encapsulates a modified-insecticidal protein, wherein the modified-insecticidal protein can be a non-naturally occurring protein comprising (1) a wild-type insecticidal protein; and (2) additional peptides, polypeptides, or proteins, e.g., an ERSP; a linker; a STA; a UBI; or a histidine tag or similar marker.

In some embodiments, a liposome of the present disclosure encapsulates a modified-insecticidal protein, wherein the modified-insecticidal protein can be a non-naturally occurring protein comprising (1) a wild-type insecticidal protein; and (2) a non-naturally occurring insecticidal protein.

In some embodiments, a liposome of the present disclosure encapsulates a modified-insecticidal protein, wherein the modified-insecticidal protein can be a non-naturally occurring protein comprising (1) a wild-type insecticidal protein; and (2) a non-naturally occurring insecticidal protein; and (3) additional peptides, polypeptides, or proteins, e.g., an ERSP; a linker; a STA; a UBI; or a histidine tag or similar marker.

In some embodiments, a liposome of the present disclosure encapsulates a modified-insecticidal protein, wherein the modified-insecticidal protein can comprise any of the insecticidal protein described herein.

In some embodiments, a liposome of the present disclosure encapsulates a modified-insecticidal protein, wherein the modified-insecticidal protein can comprise a one or more insecticidal proteins as disclosed herein. In some embodiments, the modified-insecticidal protein can comprise an insecticidal protein homopolymer, e.g., two or more insecticidal protein monomers that are the same insecticidal protein. In some embodiments, the modified-insecticidal protein can comprise an insecticidal protein heteropolymer, e.g., two or more insecticidal protein monomers, wherein the insecticidal protein monomers are different.

In some embodiments, a liposome of the present disclosure encapsulates a modified-insecticidal protein, wherein the modified-insecticidal protein can comprise a fused protein comprising two or more insecticidal protein separated by a cleavable or non-cleavable linker, wherein the amino acid sequence of each insecticidal protein may be the same or different.

In some embodiments, a liposome of the present disclosure encapsulates a modified-insecticidal protein, wherein the modified-insecticidal protein can comprise a fused protein comprising two or more insecticidal proteins separated by a cleavable or non-cleavable linker, wherein the amino acid sequence of each insecticidal protein may be the same or different, wherein the linker is cleavable inside the gut or hemolymph of an insect.

In some embodiments, a liposome of the present disclosure encapsulates a modified-insecticidal protein, wherein the modified-insecticidal protein can comprise a fused protein comprising two or more insecticidal protein separated by a cleavable or non-cleavable linker, wherein the amino acid sequence of each insecticidal protein may be the same or different, wherein the linker is cleavable inside the gut of a mammal.

Exemplary methods for the generation and use of cleavable and non-cleavable linkers can be found in U.S. patent application Ser. No. 15/727,277; and PCT Application No. PCT/US2013/030042, the disclosure of which are incorporated by reference herein in their entirety.

In some embodiments, a composition of the present disclosure comprises, consists essentially of, or consists of: a liposome and two or more insecticidal proteins.

In some embodiments, a composition of the present disclosure comprises, consists essentially of, or consists of: a liposome and two or more insecticidal proteins, wherein the insecticidal proteins are the same.

In some embodiments, a composition of the present disclosure comprises, consists essentially of, or consists of: a liposome and two or more insecticidal proteins, wherein the insecticidal proteins are the different.

In some embodiments, a composition of the present disclosure comprises, consists essentially of, or consists of: a liposome and two or more insecticidal proteins, wherein the insecticidal proteins are encapsulated by the liposome.

In some embodiments, a composition of the present disclosure comprises, consists essentially of, or consists of: a liposome and two or more insecticidal proteins, wherein the insecticidal proteins are not encapsulated by the liposome.

In some embodiments, a composition, mixture, or combination of the present disclosure can comprise, consist essentially of, or consist of, an insecticidal protein and a lipid molecule, and/or one or more additional components in any useful ratio. Exemplary ratios include from a (w/w) ratio of from about 100:1 to about 1:100 (w/w); from about 1:10 to about 1:100 (w/w); from about 1:10 to about 1:50 (w/w); from about 1:15 to about 1:25 (w/w) of insecticidal protein:total lipid ratio, where the total lipid ratio is the weight of the combination of one or more lipid molecules (e.g., cationic, anionic, or neutral lipids) and one or more components (e.g., sterol derivatives, PEG-lipid conjugates, polyamide-lipid conjugates, gangliosides, antioxidants, surfactants, amphiphilic agents, or salts).

In some embodiments, a composition, mixture, or combination of the present disclosure can comprise, consist essentially of, or consist of, an insecticidal protein and a lipid molecule, and/or one or more additional components in a ratio of 1:1 (w/w) of insecticidal protein:total lipid ratio, where the total lipid ratio is the weight of the combination of one or more lipid molecules (e.g., cationic, anionic, or neutral lipids) and one or more components (e.g., sterol derivatives, PEG-lipid conjugates, polyamide-lipid conjugates, gangliosides, antioxidants, surfactants, amphiphilic agents, or salts).

In some embodiments, the present disclosure comprises, consists essentially of, or consists of, an insecticidal protein, wherein the insecticidal protein is a fused protein comprising two or more insecticidal proteins separated by a cleavable or non-cleavable linker, and wherein the amino acid sequence of each insecticidal protein may be the same or different.

In some embodiments, the linker can be cleavable inside the gut or hemolymph of an insect.

Any of the foregoing insecticidal proteins, i.e., any one of the peptides, polypeptides, proteins, insecticides, insecticidal proteins, spider toxins, and/or CRIPs described herein, can be used as a cargo for any one of the liposomes as described herein. In some embodiments, the liposome can encapsulate (e.g., in the aqueous center or in the lipid bilayer) and/or otherwise bind (e.g., on the surface) any one or more of the insecticidal proteins described herein.

### Methods for Producing Insecticidal Proteins

Methods of producing proteins are well known in the art, and there are a variety of techniques available. For example, in some embodiments, the insecticidal proteins of the present disclosure can be produced using recombinant methods, or chemically synthesized.

In some embodiments, an insecticidal protein of the present disclosure can be created using any known method for producing a protein. For example, in some embodiments, and without limitation, an insecticidal protein can be created using a recombinant expression system, such as yeast expression system or a bacterial expression system. However, those having ordinary skill in the art will recognize that other methods of protein production are available.

Exemplary methods of producing the insecticidal proteins disclosed herein are described in International Patent Publication No. WO2021222814, the disclosure of which is incorporated herein by reference in its entirety.

### Isolating and Mutating Wild-Type Insecticidal Proteins

In some embodiments, an insecticidal protein of the present disclosure can be obtained directly from the source (e.g., isolating said insecticidal protein from an animal). Mutant insecticidal protein can be generated by creating a mutation in the wild-type insecticidal protein polynucleotide sequence; inserting that insecticidal protein encoding polynucleotide sequence into the appropriate vector; transforming a host organism in such a way that the polynucleotide encoding the insecticidal protein is expressed; culturing the host organism to generate the desired amount of insecticidal protein; and then purifying the insecticidal protein from in and/or around host organism.

In some embodiments, wild-type insecticidal proteins can be isolated from the venom glands of spiders, e.g., from Hadronyche versuta (also known as the Blue Mountain funnel web spider), Hadronyche venenata, Atrax robustus, Atrax formidabilis, or Atrax infensus, using any of the techniques known to those having ordinary skill in the art.

An exemplary description of isolating proteins from venom is disclosed in U.S. Pat. No. 5,688,764, the disclosure of which is incorporated herein by reference in its entirety.

A wild-type polynucleotide sequence encoding an insecticidal protein can be obtained by screening a genomic library using primer probes directed to the insecticidal protein polynucleotide sequence. Alternatively, wild-type polynucleotide sequences encoding an insecticidal protein can be chemically synthesized. For example, a wild-type polynucleotide sequence encoding an insecticidal protein can be generated using the oligonucleotide synthesis methods such as the phosphoramidite; triester, phosphite, or H-Phosphonate methods (see Engels, J. W. and Uhlmann, E. (1989), Gene Synthesis [New Synthetic Methods (77)]. Angew. Chem. Int. Ed. Engl., 28: 716-734, the disclosure of which is incorporated herein by reference in its entirety).

### Chemically Synthesizing Polynucleotides Encoding Insecticidal Proteins

In some embodiments, the polynucleotide sequence encoding the insecticidal protein can be chemically synthesized using commercially available polynucleotide synthesis services such as those offered by Genewiz® (e.g., TurboGENE™; PriorityGENE; and FragmentGENE), or Sigma-Aldrich® (e.g., Custom DNA and RNA Oligos Design and Order Custom DNA Oligos). Exemplary method for generating DNA and or custom chemically synthesized polynucleotides are well known in the art, and are illustratively provided in U.S. Pat. No. 5,736,135, Ser. No. 08/389,615, filed on Feb. 13, 1995, the disclosure of which is incorporated herein by reference in its entirety. See also Agarwal, et al., Chemical synthesis of polynucleotides. Angew Chem Int Ed Engl. 1972 June; 11(6):451-9; Ohtsuka et al., Recent developments in the chemical synthesis of polynucleotides. Nucleic Acids Res. 1982 Nov. 11; 10(21): 6553-6570; Sondek & Shortle. A general strategy for random insertion and substitution mutagenesis: substoichiometric coupling of trinucleotide phosphoramidites. Proc Natl Acad Sci USA. 1992 Apr. 15; 89(8): 3581-3585; Beaucage S. L., et al., Advances in the Synthesis of Oligonucleotides by the Phosphoramidite Approach. Tetrahedron, Elsevier Science Publishers, Amsterdam, NL, vol. 48, No. 12, 1992, pp. 2223-2311; Agrawal (1993) Protocols for Oligonucleotides and Analogs: Synthesis and Properties; Methods in Molecular Biology Vol. 20, the disclosure of which is incorporated herein by reference in its entirety.

Producing a mutation in wild-type polynucleotide sequence operable to encode an insecticidal protein can be achieved by various means that are well known to those having ordinary skill in the art. Methods of mutagenesis include Kunkel's method; cassette mutagenesis; PCR site-directed mutagenesis; the “perfect murder” technique (delitto perfetto); direct gene deletion and site-specific mutagenesis with PCR and one recyclable marker; direct gene deletion and site-specific mutagenesis with PCR and one recyclable marker using long homologous regions; transplacement “pop-in pop-out” method; and CRISPR-Cas 9. Exemplary methods of site-directed mutagenesis can be found in Ruvkun & Ausubel, A general method for site-directed mutagenesis in prokaryotes. Nature. 1981 Jan. 1; 289(5793):85-8; Wallace et al., Oligonucleotide directed mutagenesis of the human beta-globin gene: a general method for producing specific point mutations in cloned DNA. Nucleic Acids Res. 1981 Aug. 11; 9(15):3647-56; Dalbadie-McFarland et al., Oligonucleotide-directed mutagenesis as a general and powerful method for studies of protein function. Proc Natl Acad Sci USA. 1982 November; 79(21):6409-13; Bachman. Site-directed mutagenesis. Methods Enzymol. 2013; 529:241-8; Carey et al., PCR-mediated site-directed mutagenesis. Cold Spring Harb Protoc. 2013 Aug. 1; 2013(8):738-42; and Cong et al., Multiplex genome engineering using CRISPR/Cas systems. Science. 2013 Feb. 15; 339(6121):819-23, the disclosures of all of the aforementioned references are incorporated herein by reference in their entireties.

Chemically synthesizing polynucleotides allows for a DNA sequence to be generated that is tailored to produce a desired polypeptide based on the arrangement of nucleotides within said sequence (i.e., the arrangement of cytosine [C], guanine [G], adenine [A] or thymine [T] molecules); the mRNA sequence that is transcribed from the chemically synthesized DNA polynucleotide can be translated to a sequence of amino acids, each amino acid corresponding to a codon in the mRNA sequence. Accordingly, the amino acid composition of a polypeptide chain that is translated from an mRNA sequence can be altered by changing the underlying codon that determines which of the 20 amino acids will be added to the growing polypeptide; thus, mutations in the DNA such as insertions, substitutions, deletions, and frameshifts may cause amino acid insertions, substitutions, or deletions, depending on the underlying codon.

In some embodiments, a polynucleotide can be chemically synthesized, wherein said polynucleotide harbors one or more mutations. In some embodiments, an mRNA can be created from the template DNA sequence. In yet other embodiments, the mRNA can be cloned and transformed into a competent cell.

### Recombinant Expression, Vectors and Transformation

Obtaining an insecticidal protein from a chemically synthesized DNA polynucleotide sequence and/or a wild-type DNA polynucleotide sequence that has been altered via mutagenesis can be achieved by cloning the DNA sequence into an appropriate vector. There are a variety of expression vectors available, host organisms, and cloning strategies known to those having ordinary skill in the art. For example, the vector can be a plasmid, which can introduce a heterologous gene and/or expression cassette into yeast cells to be transcribed and translated. The term “vector” is used to refer to a carrier nucleic acid molecule into which a nucleic acid sequence can be inserted for introduction into a cell where it can be replicated. A vector may contain “vector elements” such as an origin of replication (ORI); a gene that confers antibiotic resistance to allow for selection; multiple cloning sites; a promoter region; a selection marker for non-bacterial transfection; and a primer binding site. A nucleic acid sequence can be “exogenous,” which means that it is foreign to the cell into which the vector is being introduced or that the sequence is homologous to a sequence in the cell but in a position within the host cell nucleic acid in which the sequence is ordinarily not found. Vectors include plasmids, cosmids, viruses (bacteriophage, animal viruses, and plant viruses), and artificial chromosomes (e.g., YACs). One of skill in the art would be well equipped to construct a vector through standard recombinant techniques, which are described in Sambrook et al., 1989 and Ausubel et al., 1996, both incorporated herein by reference in their entireties. In addition to encoding an insecticidal protein polynucleotide, a vector may encode a targeting molecule. A targeting molecule is one that directs the desired nucleic acid to a particular tissue, cell, or other location.

In some embodiments, a polynucleotide operable to encode an insecticidal protein can be transformed into a host cell.

In some embodiments, a polynucleotide operable to encode an insecticidal protein can be cloned into a vector, and transformed into a host cell.

In some embodiments, a insecticidal protein ORF can be transformed into a host cell.

In addition to a polynucleotide sequence operable to encode an insecticidal protein, additional DNA segments known as regulatory elements can be cloned into a vector that allow for enhanced expression of the foreign DNA or transgene; examples of such additional DNA segments include (1) promoters, terminators, and/or enhancer elements; (2) an appropriate mRNA stabilizing polyadenylation signal; (3) an internal ribosome entry site (IRES); (4) introns; and (5) post-transcriptional regulatory elements. The combination of a DNA segment of interest (e.g., insecticidal protein) with any one of the foregoing cis-acting elements is called an “expression cassette.”

In some embodiments, an expression cassette or insecticidal protein expression cassette can contain one or more polynucleotide sequences operable to encode an insecticidal protein.

In some embodiments, an expression cassette or can contain one or more polynucleotide sequence operable to encode an insecticidal protein, and one or more additional regulatory elements such as: (1) promoters, terminators, and/or enhancer elements; (2) an appropriate mRNA stabilizing polyadenylation signal; (3) an internal ribosome entry site (IRES); (4) introns; and (5) post-transcriptional regulatory elements.

In some embodiments, a single expression cassette can contain one or more of the aforementioned regulatory elements, and a polynucleotide operable to express an insecticidal protein. For example, in some embodiments, an expression cassette can comprise a polynucleotide operable to express an insecticidal protein, and an α-MF signal; Kex2 site; LAC4 terminator; ADN1 promoter; and an acetamidase (amdS) selection marker—flanked by LAC4 promoters on the 5′-end and 3′-end.

In some embodiments, there can be numerous expression cassettes cloned into a vector. For example, in some embodiments, there can be a first expression cassette comprising a polynucleotide operable to express an insecticidal protein. In alternative embodiments, there are two expression cassettes operable to encode an insecticidal protein (i.e., a double expression cassette). In other embodiments, there are three expression cassettes operable to encode an insecticidal protein (i.e., a triple expression cassette).

In some embodiments, a double expression cassette can be generated by subcloning a second expression cassette into a vector containing a first expression cassette.

In some embodiments, a triple expression cassette can be generated by subcloning a third expression cassette into a vector containing a first and a second expression cassette.

In some embodiments, a polynucleotide can be cloned into a vector using a variety of cloning strategies, and commercial cloning kits and materials readily available to those having ordinary skill in the art. For example, the polynucleotide can be cloned into a vector using such strategies as the SnapFast; Gateway; TOPO; Gibson; LIC; InFusionHD; or Electra strategies.

There are numerous commercially available vectors that can be used to produce insecticidal proteins. For example, a polynucleotide can be generated using polymerase chain reaction (PCR), and combined with a pCR™II-TOPO vector, or a PCRm2.1-TOPO® vector (commercially available as the TOPO® TA Cloning® Kit from Invitrogen) for 5 minutes at room temperature; the TOPO® reaction can then be transformed into competent cells, which can subsequently be selected based on color change (see Janke et al., A versatile toolbox for PCR-based tagging of yeast genes: new fluorescent proteins, more markers and promoter substitution cassettes. Yeast. 2004 August; 21(11):947-62; see also, Adams et al. Methods in Yeast Genetics. Cold Spring Harbor, NY, 1997, the disclosure of which is incorporated herein by reference in its entirety).

In some embodiments, a polynucleotide encoding an insecticidal protein can be cloned into a vector such as a plasmid, cosmid, virus (bacteriophage, animal viruses, and plant viruses), and/or artificial chromosome (e.g., YACs).

In some embodiments, a polynucleotide encoding an insecticidal protein can be inserted into a vector, for example, a plasmid vector using E. coli as a host, by performing the following: digesting about 2 to 5 μg of vector DNA using the restriction enzymes necessary to allow the DNA segment of interest to be inserted, followed by overnight incubation to accomplish complete digestion (alkaline phosphatase may be used to dephosphorylate the 5′-end in order to avoid self-ligation/recircularization); gel purify the digested vector. Next, amplify the DNA segment of interest, for example, a polynucleotide encoding an insecticidal protein, via PCR, and remove any excess enzymes, primers, unincorporated dNTPs, short-failed PCR products, and/or salts from the PCR reaction using techniques known to those having ordinary skill in the art (e.g., by using a PCR clean-up kit). Ligate the DNA segment of interest to the vector by creating a mixture comprising: about 20 ng of vector; about 100 to 1,000 ng or DNA segment of interest; 2 μL 10× buffer (i.e., 30 mM Tris-HCl 4 mM MgCl₂, 26 μM NAD, 1 mM DTT, 50 μg/ml BSA, pH 8, stored at 25° C.); 1 L T4 DNA ligase; all brought to a total volume of 20 μL by adding H₂O. The ligation reaction mixture can then be incubated at room temperature for 2 hours, or at 16° C. for an overnight incubation. The ligation reaction (i.e., about 1 μL) can then be transformed to competent cell, for example, by using electroporation or chemical methods, and a colony PCR can then be performed to identify vectors containing the DNA segment of interest.

In some embodiments a polynucleotide encoding an insecticidal protein, along with other DNA segments together composing an expression cassette can be designed for secretion from host yeast cells. An illustrative method of designing an expression cassette is as follows: the cassette can begin with a signal peptide sequence, followed by a DNA sequence encoding a Kex2 cleavage site (Lysine-Arginine), and subsequently followed by the polynucleotide transgene, with the addition of glycine-serine codons at the 5′-end, and finally a stop codon at the 3′-end. All these elements will then be expressed to a fusion peptide in yeast cells as a single open reading frame (ORF). An α-mating factor (αMF) signal sequence is most frequently used to facilitate metabolic processing of the recombinant insecticidal peptides through the endogenous secretion pathway of the recombinant yeast, i.e. the expressed fusion peptide will typically enter the Endoplasmic Reticulum, wherein the α-mating factor signal sequence is removed by signal peptidase activity, and then the resulting pro-insecticidal peptide will be trafficked to the Golgi Apparatus, in which the Lysine-Arginine dipeptide mentioned above is completely removed by Kex2 endoprotease, after which the mature, polypeptide (i.e., an insecticidal protein), is secreted out of the cells.

In some embodiments, polypeptide expression levels in recombinant yeast cells can be enhanced by optimizing the codons based on the specific host yeast species. Naturally occurring frequencies of codons observed in endogenous open reading frames of a given host organism need not necessarily be optimized for high efficiency expression. Furthermore, different yeast species (for example, Kluyveromyces lactis, Pichia pastoris, Saccharomyces cerevisiae, etc.) have different optimal codons for high efficiency expression. Hence, codon optimization should be considered for the expression cassette, including the sequence elements encoding the signal sequence, the Kex2 cleavage site and the an insecticidal protein, because they are initially translated as one fusion peptide in the recombinant yeast cells.

In some embodiments, a codon-optimized expression cassette can be ligated into a yeast-specific expression vectors for yeast expression. There are many expression vectors available for yeast expression, including episomal vectors and integrative vectors, and they are usually designed for specific yeast strains. One should carefully choose the appropriate expression vector in view of the specific yeast expression system which will be used for the peptide production. In some embodiments, integrative vectors can be used, which integrate into chromosomes of the transformed yeast cells and remain stable through cycles of cell division and proliferation. The integrative DNA sequences are homologous to targeted genomic DNA loci in the transformed yeast species, and such integrative sequences include pLAC4, 25S rDNA, pAOX1, and TRP2, etc. The locations of insecticidal peptide transgenes can be adjacent to the integrative DNA sequence (Insertion vectors) or within the integrative DNA sequence (replacement vectors).

In some embodiments, the expression vectors or cloning vectors can contain E. coli elements for DNA preparation in E. coli, for example, E. coli replication origin, antibiotic selection marker, etc. In some embodiments, vectors can contain an array of the sequence elements needed for expression of the transgene of interest, for example, transcriptional promoters, terminators, yeast selection markers, integrative DNA sequences homologous to host yeast DNA, etc. There are many suitable yeast promoters available, including natural and engineered promoters, for example, yeast promoters such as pLAC4, pAOX1, pUPP, pADH1, pTEF, pGal1, etc., and others, can be used in some embodiments.

In some embodiments, selection methods such as acetamide prototrophy selection; zeocin-resistance selection; geneticin-resistance selection; nourseothricin-resistance selection; uracil deficiency selection; and/or other selection methods may be used. For example, in some embodiments, the Aspergillus nidulans amdS gene can be used as selectable marker. Exemplary methods for the use of selectable markers can be found in U.S. Pat. No. 6,548,285 (filed Apr. 3, 1997); U.S. Pat. No. 6,165,715 (filed Jun. 22, 1998); and 6,110,707 (filed Jan. 17, 1997), the disclosures of which are incorporated herein by reference in its entirety.

In some embodiments, a polynucleotide encoding an insecticidal protein can be inserted into a pKLAC1 vector. The pKLAC1 is commercially available from New England Biolabs® Inc., (item no. (NEB #E1000). The pKLAC1 is designed to accomplish high-level expression of recombinant protein (e.g., insecticidal protein) in the yeast Kluyveromyces lactis. The pKLAC1 plasmid can be ordered alone, or as part of a K. lactis Protein Expression Kit. The pKLAC1 plasmid can be linearized using the SacII or BstXI restriction enzymes, and possesses a MCS downstream of an aMF secretion signal. The aMF secretion signal directs recombinant proteins to the secretory pathway, which is then subsequently cleaved via Kex2 resulting in peptide of interest, for example, an insecticidal protein. Kex2 is a calcium-dependent serine protease, which is involved in activating proproteins of the secretory pathway, and is commercially available (PeproTech®; item no. 450-45).

In some embodiments, a polynucleotide encoding an insecticidal protein can be inserted into a pLB102 plasmid, or subcloned into a pLB102 plasmid subsequent to selection of yeast colonies transformed with pKLAC1 plasmids ligated with polynucleotide encoding an insecticidal protein. Yeast, for example K. lactis, transformed with a pKLAC1 plasmids ligated with polynucleotide encoding an insecticidal protein can be selected based on acetamidase (amdS), which allows transformed yeast cells to grow in YCB medium containing acetamide as its only nitrogen source. Once positive yeast colonies transformed with a pKLAC1 plasmids ligated with polynucleotide encoding an insecticidal protein are identified.

In some embodiments, a polynucleotide encoding an insecticidal protein can be inserted into other commercially available plasmids and/or vectors that are readily available to those having skill in the art, e.g., plasmids are available from Addgene (a non-profit plasmid repository); GenScript®; Takara®; Qiagen®; and Promega™.

In some embodiments, a yeast cell transformed with one or more expression cassettes can produce an insecticidal protein in a yeast culture with a yield of: at least 70 mg/L, at least 80 mg/L, at least 90 mg/L, at least 100 mg/L, at least 110 mg/L, at least 120 mg/L, at least 130 mg/L, at least 140 mg/L, at least 150 mg/L, at least 160 mg/L, at least 170 mg/L, at least 180 mg/L, at least 190 mg/L 200 mg/L, at least 500 mg/L, at least 750 mg/L, at least 1,000 mg/L, at least 1,250 mg/L, at least 1,500 mg/L, at least 1,750 mg/L, at least 2,000 mg/L, at least 2,500 mg/L, at least 3,000 mg/L, at least 3,500 mg/L, at least 4,000 mg/L, at least 4,500 mg/L, at least 5,000 mg/L, at least 5,500 mg/L, at least at least 6,000 mg/L, at least 6,500 mg/L, at least 7,000 mg/L, at least 7,500 mg/L, at least 8,000 mg/L, at least 8,500 mg/L, at least 9,000 mg/L, at least 9,500 mg/L, at least 10,000 mg/L, at least 11,000 mg/L, at least 12,000 mg/L, at least 12,500 mg/L, at least 13,000 mg/L, at least 14,000 mg/L, at least 15,000 mg/L, at least 16,000 mg/L, at least 17,000 mg/L, at least 17,500 mg/L, at least 18,000 mg/L, at least 19,000 mg/L, at least 20,000 mg/L, at least 25,000 mg/L, at least 30,000 mg/L, at least 40,000 mg/L, at least 50,000 mg/L, at least 60,000 mg/L, at least 70,000 mg/L, at least 80,000 mg/L, at least 90,000 mg/L, or at least 100,000 mg/L of insecticidal protein per liter of medium.

In some embodiments, a culture of K. lactis transformed with one or more expressions cassettes, can produce an insecticidal protein in a yeast culture with a yield of: at least 70 mg/L, at least 80 mg/L, at least 90 mg/L, at least 100 mg/L, at least 110 mg/L, at least 120 mg/L, at least 130 mg/L, at least 140 mg/L, at least 150 mg/L, at least 160 mg/L, at least 170 mg/L, at least 180 mg/L, at least 190 mg/L, at least 200 mg/L, at least 500 mg/L, at least 750 mg/L, at least 1,000 mg/L, at least 1,250 mg/L, at least 1,500 mg/L, at least 1,750 mg/L, at least 2,000 mg/L, at least 2,500 mg/L, at least 3,000 mg/L, at least 3,500 mg/L, at least 4,000 mg/L, at least 4,500 mg/L, at least 5,000 mg/L, at least 5,500 mg/L, at least at least 6,000 mg/L, at least 6,500 mg/L, at least 7,000 mg/L, at least 7,500 mg/L, at least 8,000 mg/L, at least 8,500 mg/L, at least 9,000 mg/L, at least 9,500 mg/L, at least 10,000 mg/L, at least 11,000 mg/L, at least 12,000 mg/L, at least 12,500 mg/L, at least 13,000 mg/L, at least 14,000 mg/L, at least 15,000 mg/L, at least 16,000 mg/L, at least 17,000 mg/L, at least 17,500 mg/L, at least 18,000 mg/L, at least 19,000 mg/L, at least 20,000 mg/L, at least 25,000 mg/L, at least 30,000 mg/L, at least 40,000 mg/L, at least 50,000 mg/L, at least 60,000 mg/L, at least 70,000 mg/L, at least 80,000 mg/L, at least 90,000 mg/L, or at least 100,000 mg/L of insecticidal protein per liter of growth medium containing: (1) MSM media recipe: 2 g/L sodium citrate dihydrate; 1 g/L calcium sulfate dihydrate (0.79 g/L anhydrous calcium sulfate); 42.9 g/L potassium phosphate monobasic; 5.17 g/L ammonium sulfate; 14.33 g/L potassium sulfate; 11.7 g/L magnesium sulfate heptahydrate; 2 mL/L PTM1trace salt solution; 0.4 ppm biotin (from 500×, 200 ppm stock); 1-2% pure glycerol or other carbon source. (2) PTM1 trace salts solution: Cupric sulfate-5H₂O 6.0 g; Sodium iodide 0.08 g; Manganese sulfate-H₂O 3.0 g; Sodium molybdate-2H₂O 0.2 g; Boric Acid 0.02 g; Cobalt chloride 0.5 g; Zinc chloride 20.0 g; Ferrous sulfate-7H₂O 65.0 g; Biotin 0.2 g; Sulfuric Acid 5.0 ml; add Water to a final volume of 1 liter. An illustrative composition for K. lactis defined medium (DMSor) is as follows: 11.83 g/L KH₂PO₄, 2.299 g/L K₂HIPO₄, 20 g/L of a fermentable sugar, e.g., galactose, maltose, latotriose, sucrose, fructose or glucose and/or a sugar alcohol, for example, erythritol, hydrogenated starch hydrolysates, isomalt, lactitol, maltitol, mannitol, and xylitol, 1 g/L MgSO₄.7H₂O, 10 g/L (NH₄)SO₄, 0.33 g/L CaCl₂·2H₂O, 1 g/L NaCl, 1 g/L KCl, 5 mg/L CuSO₄·5H₂O, 30 mg/L MnSO₄·H₂O, 10 mg/L, ZnCl₂, 1 mg/L KI, 2 mg/L COCl₂·6H₂O, 8 mg/L Na₂MoO₄·2H₂O, 0.4 mg/L H₃BO₃, 15 mg/L FeCl₃·6H₂O, 0.8 mg/L biotin, 20 mg/L Ca-pantothenate, 15 mg/L thiamine, 16 mg/L myo-inositol, 10 mg/L nicotinic acid, and 4 mg/L pyridoxine; a selection marker, and culturing under conditions that enable optimum expression.

In some embodiments, one or more expression cassettes comprising a polynucleotide operable to express an insecticidal protein can be inserted into a vector, resulting in a yield of about 100 mg/L of insecticidal protein (supernatant of yeast fermentation broth). For example, in some embodiments, two expression cassettes comprising a polynucleotide operable to express an insecticidal protein can be inserted into a vector, for example a pKS022 plasmid, resulting in a yield of about 2 g/L of insecticidal protein (supernatant of yeast fermentation broth). Alternatively, in some embodiments, three expression cassettes comprising a polynucleotide operable to express an insecticidal protein can be inserted into a vector, for example a pLB103bT plasmid.

In some embodiments, multiple expression cassettes can be transfected into yeast in order to enable integration of one or more copies of the optimized transgene into the K. lactis genome. An exemplary method of introducing multiple expression cassettes into a K. lactis genome is as follows: an expression cassette DNA sequence is synthesized, comprising an intact LAC4 promoter element, a codon-optimized ORF element and a pLAC4 terminator element; the intact expression cassette is ligated into the pLB103b vector between Sal I and Kpn I restriction sites, downstream of the pLAC4 terminator of pLB10V5, resulting in the double transgene expression vector, pKS022; the double transgene vectors, pKS022, are then linearized using Sac II restriction endonuclease and transformed into YCT306 strain of K. lactis by electroporation. The resulting yeast colonies are then grown on YCB agar plate supplemented with 5 mM acetamide, which only the acetamidase-expressing cells could use efficiently as a metabolic source of nitrogen. To evaluate the yeast colonies, about 100 to 400 colonies can be picked from the pKS022 yeast plates. Inoculates from the colonies are each cultured in 2.2 mL of the defined K. lactis media with 2% sugar alcohol added as a carbon source. Cultures are incubated at 23.5° C., with shaking at 280 rpm, for six days, at which point cell densities in the cultures will reach their maximum levels as indicated by light absorbance at 600 nm (OD600). Cells are then removed from the cultures by centrifugation at 4,000 rpm for 10 minutes, and the resulting supernatants (conditioned media) are filtered through 0.2 μM membranes for HPLC yield analysis.

### Chemically Synthesizing Insecticidal Proteins

Peptide synthesis or the chemical synthesis or peptides and/or polypeptides can be used to generate insecticidal proteins: these methods can be performed by those having ordinary skill in the art, and/or through the use of commercial vendors (e.g., GenScript®; Piscataway, New Jersey). For example, in some embodiments, chemical peptide synthesis can be achieved using Liquid phase peptide synthesis (LPPS), or solid phase peptide synthesis (SPPS).

In some embodiments, peptide synthesis can generally be achieved by using a strategy wherein the coupling the carboxyl group of a subsequent amino acid to the N-terminus of a preceding amino acid generates the nascent polypeptide chain—a process that is opposite to the type of polypeptide synthesis that occurs in nature.

Peptide deprotection is an important first step in the chemical synthesis of polypeptides. Peptide deprotection is the process in which the reactive groups of amino acids are blocked through the use of chemicals in order to prevent said amino acid's functional group from taking part in an unwanted or non-specific reaction or side reaction; in other words, the amino acids are “protected” from taking part in these undesirable reactions.

Prior to synthesizing the peptide chain, the amino acids must be “deprotected” to allow the chain to form (i.e., amino acids to bind). Chemicals used to protect the N-termini include 9-fluorenylmethoxycarbonyl (Fmoc), and tert-butoxycarbonyl (Boc), each of which can be removed via the use of a mild base (e.g., piperidine) and a moderately strong acid (e.g., trifluoracetic acid (TFA)), respectively.

The C-terminus protectant required is dependent on the type of chemical peptide synthesis strategy used: e.g., LPPS requires protection of the C-terminal amino acid, whereas SPPS does not owing to the solid support which acts as the protecting group. Side chain amino acids require the use of several different protecting groups that vary based on the individual peptide sequence and N-terminal protection strategy; typically, however, the protecting group used for side chain amino acids are based on the tert-butyl (tBu) or benzyl (Bzl) protecting groups.

Amino acid coupling is the next step in a peptide synthesis procedure. To effectuate amino acid coupling, the incoming amino acid's C-terminal carboxylic acid must be activated: this can be accomplished using carbodiimides such as diisopropylcarbodiimide (DIC), or dicyclohexylcarbodiimide (DCC), which react with the incoming amino acid's carboxyl group to form an O-acylisourea intermediate. The O-acylisourea intermediate is subsequently displaced via nucleophilic attack via the primary amino group on the N-terminus of the growing peptide chain. The reactive intermediate generated by carbodiimides can result in the racemization of amino acids. To avoid racemization of the amino acids, reagents such as 1-hydroxybenzotriazole (HOBt) are added in order to react with the O-acylisourea intermediate. Other couple agents that may be used include 2-(1H-benzotriazol-1-yl)-1,1,3,3-tetramethyluronium hexafluorophosphate (HBTU), and benzotriazol-1-yl-oxy-tris(dimethylamino)phosphonium hexafluorophosphate (BOP), with the additional activating bases. Finally, following amino acid deprotection and coupling,

At the end of the synthesis process, removal of the protecting groups from the polypeptide must occur—a process that usually occurs through acidolysis. Determining which reagent is required for peptide cleavage is a function of the protection scheme used and overall synthesis method. For example, in some embodiments, hydrogen bromide (HBr); hydrogen fluoride (HF); or trifluoromethane sulfonic acid (TFMSA) can be used to cleave Bzl and Boc groups. Alternatively, in other embodiments, a less strong acid such as TFA can effectuate acidolysis of tBut and Fmoc groups. Finally, peptides can be purified based on the peptide's physiochemical characteristics (e.g., charge, size, hydrophobicity, etc.). Techniques that can be used to purify peptides include Purification techniques include Reverse-phase chromatography (RPC); Size-exclusion chromatography; Partition chromatography; High-performance liquid chromatography (HPLC); and Ion exchange chromatography (IEC).

Exemplary methods of peptide synthesis can be found in Anderson G. W. and McGregor A. C. (1957) T-butyloxycarbonylamino acids and their use in peptide synthesis. Journal of the American Chemical Society. 79, 6180-3; Carpino L. A. (1957) Oxidative reactions of hydrazines. Iv. Elimination of nitrogen from 1, 1-disubstituted-2-arenesulfonhydrazides 1-4. Journal of the American Chemical Society. 79, 4427-31; McKay F. C. and Albertson N. F. (1957) New amine-masking groups for peptide synthesis. Journal of the American Chemical Society. 79, 4686-90; Merrifield R. B. (1963) Solid phase peptide synthesis. I. The synthesis of a tetrapeptide. Journal of the American Chemical Society. 85, 2149-54; Carpino L. A. and Han G. Y. (1972) 9-fluorenylmethoxycarbonyl amino-protecting group. The Journal of Organic Chemistry. 37, 3404-9; and A Lloyd-Williams P. et al. (1997) Chemical approaches to the synthesis of peptides and proteins. Boca Raton: CRC Press. 278; U.S. Pat. No. 3,714,140 (filed Mar. 16, 1971); U.S. Pat. No. 4,411,994 (filed Jun. 8, 1978); U.S. Pat. No. 7,785,832 (filed Jan. 20, 2006); U.S. Pat. No. 8,314,208 (filed Feb. 10, 2006); and 10,442,834 (filed Oct. 2, 2015); and United States Patent Application 2005/0165215 (filed Dec. 23, 2004), the disclosures of which are incorporated herein by reference in their entirety.

Additional exemplary methods of generating polynucleotides, peptides, and insecticidal proteins, can be found in U.S. Patent Application Publication No. 20150148288 A1, the disclosure of which is incorporated herein by reference in its entirety.

Any of the methods described herein can be used to generate any of the insecticidal proteins or modified-insecticidal proteins as described herein.

### Cell Culture

Cell culture techniques and transformation methods are well known in the art. In some embodiments, a host cell can be transformed using the following methods: electroporation; cell squeezing; microinjection; impalefection; the use of hydrostatic pressure; sonoporation; optical transfection; continuous infusion; lipofection; through the use of viruses such as adenovirus, adeno-associated virus, lentivirus, herpes simplex virus, and retrovirus; the chemical phosphate method; endocytosis via DEAE-dextran or polyethylenimine (PEI); protoplast fusion; hydrodynamic deliver; magnetofection; nucleoinfection; and/or others. Exemplary methods regarding transfection and/or transformation techniques can be found in Makrides (2003), Gene Transfer and Expression in Mammalian Cells, Elvesier; Wong, TK & Neumann, E. Electric field mediated gene transfer. Biochem. Biophys. Res. Commun. 107, 584-587 (1982); Potter & Heller, Transfection by Electroporation. Curr Protoc Mol Biol. 2003 May; CHAPTER: Unit-9.3; Kim & Eberwine, Mammalian cell transfection: the present and the future. Anal Bioanal Chem. 2010 August; 397(8): 3173-3178, each of these references are incorporated herein by reference in their entireties.

### Agriculturally Acceptable Salts

In some embodiments, agriculturally acceptable salts, hydrates, solvates, and crystal forms of the insecticidal protein described herein can be utilized.

As used herein, the terms “agriculturally acceptable salts,” and “veterinarily acceptable salts” and “pharmaceutically acceptable salts” are used interchangeably.

In some embodiments, an agriculturally acceptable salt of the present disclosure possesses the desired pharmacological activity of the parent compound. Such salts include: acid addition salts, formed with inorganic acids; acid addition salts formed with organic acids; or salts formed when an acidic proton present in the parent compound is replaced by a metal ion, e.g., an alkali metal ion, aluminum ion; or coordinates with an organic base such as ethanolamine, and the like.

In some embodiments, agriculturally acceptable salts include conventional toxic or non-toxic salts. For example, in some embodiments, convention non-toxic salts include those such as fumarate, phosphate, citrate, chlorydrate, and the like. In some embodiments, the agriculturally acceptable salts of the present disclosure can be synthesized from a parent compound by conventional chemical methods. In some embodiments, such salts can be prepared by reacting the free acid or base forms of these compounds with a stoichiometric amount of the appropriate base or acid in water or in an organic solvent, or in a mixture of the two. In some embodiments, non-aqueous media like ether, ethyl acetate, ethanol, isopropanol, or acetonitrile are preferred. Lists of suitable salts are found in Remington's Pharmaceutical Sciences, 17th ed., Mack Publishing Company, Easton, Pa., 1985, p. 1418, the disclosure of which is incorporated herein by reference in its entirety.

In some embodiments, an agriculturally acceptable salt can be one of the following: hydrochloride; sodium; sulfate; acetate; phosphate or diphosphate; chloride; potassium; maleate; calcium; citrate; mesylate; nitrate; tartrate; aluminum; or gluconate.

In some embodiments, a list of agriculturally acceptable acids that can be used to form salts can be: glycolic acid; hippuric acid; hydrobromic acid; hydrochloric acid; isobutyric acid; lactic acid (DL); lactobionic acid; lauric acid; maleic acid; malic acid (−L); malonic acid; mandelic acid (DL); methanesulfonic acid; naphthalene-1,5-disulfonic acid; naphthalene-2-sulfonic acid; nicotinic acid; nitric acid; oleic acid; oxalic acid; palmitic acid; pamoic acid; phosphoric acid; proprionic acid; pyroglutamic acid (−L); salicylic acid; sebacic acid; stearic acid; succinic acid; sulfuric acid; tartaric acid (+L); thiocyanic acid; toluenesulfonic acid (p); undecylenic acid; a 1-hydroxy-2-naphthoic acid; 2,2-dichloroacetic acid; 2-hydroxyethanesulfonic acid; 2-oxoglutaric acid; 4-acetamidobenzoic acid; 4-aminosalicylic acid; acetic acid; adipic acid; ascorbic acid (L); aspartic acid (L); benzenesulfonic acid; benzoic acid; camphoric acid (+); camphor-O-sulfonic acid (+); capric acid (decanoic acid); caproic acid (hexanoic acid); caprylic acid (octanoic acid); carbonic acid; cinnamic acid; citric acid; cyclamic acid; dodecylsulfuric acid; ethane-1,2-disulfonic acid; ethanesulfonic acid; formic acid; fumaric acid; galactaric acid; gentisic acid; glucoheptonic acid (D); gluconic acid (D); glucuronic acid (D); glutamic acid; glutaric acid; or glycerophosphoric acid.

In some embodiments, agriculturally acceptable salt can be any organic or inorganic addition salt.

In some embodiments, the salt may use an inorganic acid and an organic acid as a free acid. The inorganic acid may be hydrochloric acid, bromic acid, nitric acid, sulfuric acid, perchloric acid, phosphoric acid, etc. The organic acid may be citric acid, acetic acid, lactic acid, maleic acid, fumaric acid, gluconic acid, methane sulfonic acid, gluconic acid, succinic acid, tartaric acid, galacturonic acid, embonic acid, glutamic acid, aspartic acid, oxalic acid, (D) or (L) malic acid, maleic acid, methane sulfonic acid, ethane sulfonic acid, 4-toluene sulfonic acid, salicylic acid, citric acid, benzoic acid, malonic acid, etc.

In some embodiments, the salts include alkali metal salts (sodium salts, potassium salts, etc.) and alkaline earth metal salts (calcium salts, magnesium salts, etc.). For example, the acid addition salt may include acetate, aspartate, benzoate, besylate, bicarbonate/carbonate, bisulfate/sulfate, borate, camsylate, citrate, edisilate, esylate, formate, fumarate, gluceptate, gluconate, glucuronate, hexafluorophosphate, hibenzate, hydrochloride/chloride, hydrobromide/bromide, hydroiodide/iodide, isethionate, lactate, malate, maleate, malonate, mesylate, methyl sulfate, naphthalate, 2-napsylate, nicotinate, nitrate, orotate, oxalate, palmitate, pamoate, phosphate/hydrogen phosphate/dihydrogen phosphate, saccharate, stearate, succinate, tartrate, tosylate, trifluoroacetate, aluminum, arginine, benzathine, calcium, choline, diethylamine, diolamine, glycine, lysine, magnesium, meglumine, olamine, potassium, sodium, tromethamine, zinc salt, etc., and among them, hydrochloride or trifluoroacetate may be used.

In yet other embodiments, the agriculturally acceptable salt can be a salt with an acid such as acetic acid, propionic acid, butyric acid, formic acid, trifluoroacetic acid, maleic acid, tartaric acid, citric acid, stearic acid, succinic acid, ethylsuccinic acid, lactobionic acid, gluconic acid, glucoheptonic acid, benzoic acid, methanesulfonic acid, ethanesulfonic acid, 2-hydroxyethanesulfonic acid, benzenesulfonic acid, p-toluenesulfonic acid, laurylsulfuric acid, malic acid, aspartic acid, glutaminic acid, adipic acid, cysteine, N-acetylcysteine, hydrochloric acid, hydrobromic acid, phosphoric acid, sulfuric acid, hydroiodic acid, nicotinic acid, oxalic acid, picric acid, thiocyanic acid, undecanoic acid, polyacrylate or carboxyvinyl polymer.

In some embodiments, the agriculturally acceptable salt can be prepared from either inorganic or organic bases. Salts derived from inorganic bases include, but are not limited to, the sodium, potassium, lithium, ammonium, calcium, magnesium, ferrous, zinc, copper, manganous, aluminum, ferric, manganic salts, and the like. Preferred inorganic salts are the ammonium, sodium, potassium, calcium, and magnesium salts. Salts derived from organic bases include, but are not limited to, salts of primary, secondary, and tertiary amines, substituted amines including naturally-occurring substituted amines, and cyclic amines, including isopropylamine, trimethylamine, diethylamine, triethylamine, tripropylamine, ethanolamine, 2-dimethylaminoethanol, tromethamine, lysine, arginine, histidine, caffeine, procaine, hydrabamine, choline, betaine, ethylenediamine, glucosamine, N-alkylglucamines, theobromine, purines, piperazine, piperidine, N-ethylpiperidine, and the like. Preferred organic bases are isopropylamine, diethylamine, ethanolamine, piperidine, tromethamine, and choline.

In some embodiments, agriculturally acceptable salt refers to those salts which are, within the scope of sound medical judgment, suitable for use in contact with the tissues of humans and lower animals without undue toxicity, irritation, allergic response and the like, and are commensurate with a reasonable benefit/risk ratio. Agriculturally acceptable salts are well known in the art. For example, S. M. Berge, et al. describe agriculturally acceptable salts in detail in J. Pharmaceutical Sciences, 66: 1-19 (1977), the disclosure of which is incorporated herein by reference in its entirety.

In some embodiments, the salts of the present disclosure can be prepared in situ during the final isolation and purification of the compounds of the disclosure, or separately by reacting the free base function with a suitable organic acid. Examples of agriculturally acceptable, nontoxic acid addition salts are salts of an amino group formed with inorganic acids such as hydrochloric acid, hydrobromic acid, phosphoric acid, sulfuric acid and perchloric acid or with organic acids such as acetic acid, oxalic acid, maleic acid, tartaric acid, citric acid, succinic acid or malonic acid or by using other methods used in the art such as ion exchange. Other agriculturally acceptable salts include adipate, alginate, ascorbate, aspartate, benzenesulfonate, benzoate, bisulfate, borate, butyrate, camphorate, camphorsulfonate, citrate, cyclopentanepropionate, digluconate, dodecylsulfate, ethanesulfonate, formate, fumarate, glucoheptonate, glycerophosphate, gluconate, hemisulfate, heptanoate, hexanoate, hydroiodide, 2-hydroxy-ethanesulfonate, lactobionate, lactate, laurate, lauryl sulfate, malate, maleate, malonate, methanesulfonate, 2-naphthalenesulfonate, nicotinate, nitrate, oleate, oxalate, palmitate, pamoate, pectinate, persulfate, 3-phenylpropionate, phosphate, picrate, pivalate, propionate, stearate, succinate, sulfate, tartrate, thiocyanate, p-toluenesulfonate, undecanoate, valerate salts, and the like. Representative alkali or alkaline earth metal salts include sodium, lithium, potassium, calcium, magnesium, and the like. Further agriculturally acceptable salts include, when appropriate, nontoxic ammonium, quaternary ammonium, and amine cations formed using counterions such as halide, hydroxide, carboxylate, sulfate, phosphate, nitrate, lower alkyl sulfonate and aryl sulfonate.

Exemplary descriptions of pharmaceutically acceptable salts is provided in P. H. Stahl and C. G. Wermuth, (editors), Handbook of Pharmaceutical Salts: Properties, Selection and Use, John Wiley & Sons, August 23, (2002), the disclosure of which is incorporated herein by reference in its entirety.

### Compositions, Combinations, and Mixtures

As used herein, “v/v” or “% v/v” or “v/v %” or “volume per volume” refers to the volume concentration of a solution (“v/v” stands for volume per volume). Here, v/v can be used when both components of a solution are liquids. For example, when 50 mL of ingredient X is diluted with 50 mL of water, there will be 50 mL of ingredient X in a total volume of 100 mL; therefore, this can be expressed as “ingredient X 50% v/v.” Percent volume per volume (% v/v) is calculated as follows: (volume of solute (mL)/volume of solution (100 mL)); e.g., % v/v=mL of solute/100 mL of solution.

As used herein, “w/w” or “% w/w” or “w/w %” or “wt %” or “weight per weight” refers to the weight concentration of a solution, i.e., percent weight in weight (“w/w” stands for weight per weight). Here, w/w expresses the number of grams (g) of a constituent in 100 g of solution or mixture. For example, a mixture consisting of 30 g of ingredient X, and 70 g of water would be expressed as “ingredient X 30% w/w.” Percent weight per weight (% w/w) is calculated as follows: (weight of solute (g)/weight of solution (g))×100; or (mass of solute (g)/mass of solution (g))×100.

As used herein, “w/v” or “% w/v” or “w/v %” or “weight per volume” refers to the mass concentration of a solution, i.e., percent weight in volume (“w/v” stands for weight per volume). Here, w/v expresses the number of grams (g) of a constituent in 100 mL of solution. For example, if 1 g of ingredient X is used to make up a total volume of 100 mL, then a “1% w/v solution of ingredient X” has been made. Percent weight per volume (% w/v) is calculated as follows: (Mass of solute (g)/Volume of solution (mL))×100.

Any of the liposome components that are described herein can be used to create a liposome composition of the present disclosure, wherein said composition comprises at least one liposome and at least one insecticidal protein encapsulated therein.

In some embodiments, a liposome composition comprises, consists essentially of, or consists of: an insecticidal protein or agriculturally acceptable salt thereof, and at least one excipient.

In some embodiments, a liposome composition comprises, consists essentially of, or consists of: an insecticidal protein or agriculturally acceptable salt thereof, and at least one excipient, wherein the liposome encapsulates the insecticidal protein or agriculturally acceptable salt thereof.

In some embodiments, a liposome composition comprises, consists essentially of, or consists of: an insecticidal protein or agriculturally acceptable salt thereof, and at least one excipient, wherein the liposome encapsulates the insecticidal protein or agriculturally acceptable salt thereof; and wherein the liposome comprises lecithin.

In some embodiments, the composition can comprise a liposome and at least two insecticidal proteins, wherein the insecticidal proteins are different.

In some embodiments, the composition comprises at least one liposome and at least one insecticidal protein, which may be the same or different from the insecticidal protein entrapped in the liposomes described herein.

Any of the liposome combinations, mixtures or combinations described herein (e.g., a liposome and an insecticidal protein, or an agriculturally acceptable salt thereof) can be used to control pests, their growth, and/or the damage caused by their actions, especially their damage to plants.

Compositions comprising a liposome and an insecticidal protein or an agriculturally acceptable salt thereof, for example, agrochemical compositions, can include, but are not limited to, additional aerosols and/or aerosolized products, e.g., sprays, fumigants, powders, dusts, and/or gases; seed dressings; oral preparations (e.g., insect food, etc.).

The compositions of the present disclosure may be formulated as a powder, dust, pellet, granule, spray, emulsion, colloid, solution, or the like. In some embodiments, the insecticidal protein may be prepared by such conventional means as desiccation, lyophilization, homogenization, extraction, filtration, centrifugation, sedimentation, or concentration of a culture of cells comprising the insecticidal protein. In all such compositions that contain at least one such liposome-encapsulated insecticidal protein, the liposome-encapsulated insecticidal protein may be present in a concentration of from about 1% to about 99% by weight.

In some embodiments, a composition of the present disclosure comprises, consists essentially of, or consists of: a liposome comprising an insecticidal protein or agriculturally acceptable salt thereof, and at least one excipient; wherein the liposome encapsulates the insecticidal protein or agriculturally acceptable salt thereof, and wherein the liposome comprises lecithin; and wherein the composition is formulated as an agricultural composition, or a veterinary composition.

In some embodiments, a composition of the present disclosure comprises, consists essentially of, or consists of: a liposome comprising an insecticidal protein or agriculturally acceptable salt thereof, and at least one excipient; wherein the liposome encapsulates the insecticidal protein or agriculturally acceptable salt thereof, and wherein the liposome comprises lecithin; and wherein the composition is formulated a solution, an emulsion, a powder, a dust, a pellet, a granule, a spray, or a colloid.

In some embodiments, the compositions described herein may be made by formulating either the liposome and insecticidal protein, or agriculturally acceptable salt thereof, with the desired agriculturally-acceptable carrier. The compositions may be formulated prior to administration in an appropriate means such as lyophilized, freeze-dried, desiccated, or in an aqueous carrier, medium or suitable diluent, such as saline and/or other buffer. In some embodiments, the formulated compositions may be in the form of a dust or granular material, or a suspension in oil (vegetable or mineral), or water or oil/water emulsions, or as a wettable powder, or in combination with any other carrier material suitable for agricultural application. Suitable agricultural carriers can be solid or liquid and are well known in the art. In some embodiments, the formulations may be mixed with one or more solid or liquid adjuvants and prepared by various means, e.g., by homogeneously mixing, blending and/or grinding the pesticidal composition with suitable adjuvants using conventional formulation techniques. Suitable formulations and application methods are described in U.S. Pat. No. 6,468,523, the disclosure of which is incorporated by reference herein in its entirety.

In some embodiments, a composition can comprise, consist essentially of, or consist of, a liposome and an insecticidal protein.

In some embodiments, a composition can comprise, consist essentially of, or consist of, a liposome, an insecticidal protein, and an excipient.

In some embodiments, a composition can comprise, consist essentially of, or consist of: a liposome; and a CRIP, or an agriculturally acceptable salt thereof.

In some embodiments, a composition can comprise, consist essentially of, or consist of: a liposome; a CRIP, or an agriculturally acceptable salt thereof, and an excipient.

In some embodiments, a composition of the present disclosure can comprise, consist essentially of, or consist of: a liposome comprising an insecticidal protein or agriculturally acceptable salt thereof, and at least one excipient; wherein the liposome encapsulates the insecticidal protein or agriculturally acceptable salt thereof, and wherein the liposome comprises lecithin.

In some embodiments, a composition of the present disclosure can comprise, consist essentially of, or consist of: a liposome comprising an insecticidal protein or agriculturally acceptable salt thereof, and at least one excipient; wherein the liposome encapsulates the insecticidal protein or agriculturally acceptable salt thereof, wherein the liposome comprises lecithin, wherein the lecithin is a natural lecithin, a semi-synthetic lecithin, or a synthetic lecithin.

In some embodiments, a composition of the present disclosure can comprise, consist essentially of, or consist of: a liposome comprising an insecticidal protein or agriculturally acceptable salt thereof, and at least one excipient; wherein the liposome encapsulates the insecticidal protein or agriculturally acceptable salt thereof, wherein the liposome comprises lecithin, wherein the lecithin is a plant lecithin, or an animal lecithin.

In some embodiments, a composition of the present disclosure can comprise, consist essentially of, or consist of: a liposome comprising an insecticidal protein or agriculturally acceptable salt thereof, and at least one excipient; wherein the liposome encapsulates the insecticidal protein or agriculturally acceptable salt thereof, and wherein the liposome comprises plant lecithin, wherein the plant lecithin is a soy lecithin.

In some embodiments, a composition of the present disclosure can comprise, consist essentially of, or consist of: a liposome comprising an insecticidal protein or agriculturally acceptable salt thereof, and at least one excipient; wherein the liposome encapsulates the insecticidal protein or agriculturally acceptable salt thereof, wherein the liposome comprises soy lecithin, wherein the soy lecithin is a hydrogenated soy lecithin.

In some embodiments, a composition of the present disclosure can comprise, consist essentially of, or consist of: a liposome comprising an insecticidal protein or agriculturally acceptable salt thereof, and at least one excipient; wherein the liposome encapsulates the insecticidal protein or agriculturally acceptable salt thereof, wherein the liposome comprises lecithin; and wherein the liposome has an average diameter of about 10-200 nm.

In some embodiments, a composition of the present disclosure can comprise, consist essentially of, or consist of: a liposome comprising an insecticidal protein or agriculturally acceptable salt thereof, and at least one excipient; wherein the liposome encapsulates the insecticidal protein or agriculturally acceptable salt thereof, wherein the liposome comprises lecithin; and wherein the liposome has an average diameter of about 15-150 nm.

In some embodiments, a composition of the present disclosure can comprise, consist essentially of, or consist of: a liposome comprising an insecticidal protein or agriculturally acceptable salt thereof, and at least one excipient; wherein the liposome encapsulates the insecticidal protein or agriculturally acceptable salt thereof, wherein the liposome comprises lecithin; and wherein the liposome has an average diameter of about 20-100 nm.

In some embodiments, a composition of the present disclosure can comprise, consist essentially of, or consist of: a liposome comprising an insecticidal protein or agriculturally acceptable salt thereof, and at least one excipient; wherein the liposome encapsulates the insecticidal protein or agriculturally acceptable salt thereof, wherein the liposome comprises lecithin; wherein the encapsulated insecticidal protein or agriculturally acceptable salt thereof has a greater bioavailability when ingested by a pest when compared to an equivalent amount of the insecticidal protein or agriculturally acceptable salt thereof when not encapsulated in the liposome and is ingested by the pest.

In some embodiments, a composition of the present disclosure can comprise, consist essentially of, or consist of: a liposome comprising an insecticidal protein or agriculturally acceptable salt thereof, and at least one excipient; wherein the liposome encapsulates the insecticidal protein or agriculturally acceptable salt thereof, wherein the liposome comprises lecithin; wherein the encapsulated insecticidal protein or agriculturally acceptable salt thereof has a greater bioavailability when ingested by a pest when compared to an equivalent amount of the insecticidal protein or agriculturally acceptable salt thereof when not encapsulated in the liposome and is ingested by the pest; wherein the greater bioavailability is a greater oral bioavailability.

In some embodiments, a composition of the present disclosure can comprise, consist essentially of, or consist of: a liposome comprising an insecticidal protein or agriculturally acceptable salt thereof, and at least one excipient; wherein the liposome encapsulates the insecticidal protein or agriculturally acceptable salt thereof, wherein the liposome comprises lecithin; wherein the insecticidal protein or agriculturally acceptable salt thereof is about 25-50 amino acids in length.

In some embodiments, a composition of the present disclosure can comprise, consist essentially of, or consist of: a liposome comprising an insecticidal protein or agriculturally acceptable salt thereof, and at least one excipient; wherein the liposome encapsulates the insecticidal protein or agriculturally acceptable salt thereof, wherein the liposome comprises lecithin; wherein the insecticidal protein or agriculturally acceptable salt thereof is a cysteine-rich insecticidal protein (CRIP).

In some embodiments, a composition of the present disclosure can comprise, consist essentially of, or consist of: a liposome comprising an insecticidal protein or agriculturally acceptable salt thereof, and at least one excipient; wherein the liposome encapsulates the insecticidal protein or agriculturally acceptable salt thereof, wherein the liposome comprises lecithin; wherein the insecticidal protein or agriculturally acceptable salt thereof, is an arthropod toxin, an amphibian toxin, a reptile toxin, a cnidarian toxin, a mollusk toxin, a fish toxin, a mammalian toxin, or a variant thereof.

In some embodiments, a composition of the present disclosure can comprise, consist essentially of, or consist of: a liposome comprising an insecticidal protein or agriculturally acceptable salt thereof, and at least one excipient; wherein the liposome encapsulates the insecticidal protein or agriculturally acceptable salt thereof, wherein the liposome comprises lecithin; wherein the insecticidal protein or agriculturally acceptable salt thereof is an arachnid toxin.

In some embodiments, a composition of the present disclosure can comprise, consist essentially of, or consist of: a liposome comprising an insecticidal protein or agriculturally acceptable salt thereof, and at least one excipient; wherein the liposome encapsulates the insecticidal protein or agriculturally acceptable salt thereof, wherein the liposome comprises lecithin; wherein the insecticidal protein or agriculturally acceptable salt thereof is a spider toxin or a scorpion toxin.

In some embodiments, a composition of the present disclosure can comprise, consist essentially of, or consist of: a liposome comprising an insecticidal protein or agriculturally acceptable salt thereof, and at least one excipient; wherein the liposome encapsulates the insecticidal protein or agriculturally acceptable salt thereof, wherein the liposome comprises lecithin; wherein the insecticidal protein or agriculturally acceptable salt thereof is an Agelenopsis aperta toxin, an Agelena orientalis toxin, an Allagelena opulenta toxin, an Ancylometes sp. toxin, an Aphonopelma sp toxin, an Apomastus schleringi toxin, an Atrax formidabilis toxin, an Atrax sp. Illawarra toxin, an Atrax infensus toxin, an Atrax robustus toxin, a Brachypelma albiceps toxin, a Brachypelma smithi toxin, a Calisoga sp. toxin, a Ceratogyrus marshalli toxin, a Chilobrachys jingzhao toxin, a Coremiocnemis valida toxin, a Ctenus ornatus toxin, a Cupiennius salei toxin, a Diguetia canities toxin, an Eratigena agrestis toxin, an Eucratoscelus constrictus toxin, a Grammostola rosea toxin, a Hadronyche formidabilis toxin, a Hadronyche infensa toxin, a Hadronyche venenata toxin, a Hadronyche versuta peptides toxin, a Haplopelma hainanum toxin, a Haplopelma huwenum toxin, a Heriaeus melloteei toxin, a Heteropoda venatoria toxin, a Heteroscodra maculate toxin, a Hololena curta toxin, a Hysterocrates gigas toxin, an Illawara wisharti toxin, a Lasiodora sp toxin, a Latrodectus tredecimguttatus toxin, a Macrothele gigas toxin, a Macrothele raveni toxin, a Missulena bradleyi toxin, a Oxyopes lineatus toxin, a Paraphysa scrofa toxin, a Phoneutria keyserlingi toxin, a Phoneutria nigriventer toxin, a Phoneutria reidyi toxin, a Pireneitega luctuosa toxin, a Plectreurys tristis toxin, a Plesiophrictus guangxiensis toxin, a Psalmopoeus cambridgei toxin, a Segestria florentina toxin, a Stromatopelma calceatum toxin, a Theraphosa blondi, or a Thrixopelma pruriens toxin.

In some embodiments, a composition of the present disclosure can comprise, consist essentially of, or consist of: a liposome comprising an insecticidal protein or agriculturally acceptable salt thereof, and at least one excipient; wherein the liposome encapsulates the insecticidal protein or agriculturally acceptable salt thereof, wherein the liposome comprises lecithin; wherein the insecticidal protein or agriculturally acceptable salt thereof is a Hadronyche venenata toxin, an Atrax robustus toxin, an Atrax formidabilis toxin, an Atrax infensus toxin, a Phoneutria nigriventer toxin, or an Eratigena agrestis toxin.

In some embodiments, a composition of the present disclosure can comprise, consist essentially of, or consist of: a liposome comprising an insecticidal protein or agriculturally acceptable salt thereof, and at least one excipient; wherein the liposome encapsulates the insecticidal protein or agriculturally acceptable salt thereof, wherein the liposome comprises lecithin; wherein the insecticidal protein or agriculturally acceptable salt thereof is a spider toxin having an amino acid sequence that is at least 50% identical, at least 55% identical, at least 60% identical, at least 65% identical, at least 70% identical, at least 75% identical, at least 80% identical, at least 81% identical, at least 82% identical, at least 83% identical, at least 84% identical, at least 85% identical, at least 86% identical, at least 87% identical, at least 88% identical, at least 89% identical, at least 90% identical, at least 91% identical, at least 92% identical, at least 93% identical, at least 94% identical, at least 95% identical, at least 96% identical, at least 97% identical, at least 98% identical, at least 99% identical, at least 99.5% identical, at least 99.6% identical, at least 99.7% identical, at least 99.8% identical, at least 99.9% identical, or 100% identical to an amino acid sequence set forth in any one of SEQ ID NO: 1-5, 8, 9-244, 600-701.

In some embodiments, a composition of the present disclosure can comprise, consist essentially of, or consist of: a liposome comprising an insecticidal protein or agriculturally acceptable salt thereof, and at least one excipient; wherein the liposome encapsulates the insecticidal protein or agriculturally acceptable salt thereof, wherein the liposome comprises lecithin; wherein the insecticidal protein or agriculturally acceptable salt thereof is an Androctonus australis toxin, an Androctonus mauretanicus mauretanicus toxin, an Anuroctonus phaiodactylus toxin, a Bothus martensii Karsch toxin, a Bothus occitanus tunetanus toxin, a Buthacus arenicola toxin, a Buthotus judaicus toxin, a Buthus eupeus toxin, a Buthus martensii toxin, a Buthus occitanus mardochei toxin, a Buthus occitanus tunetanus toxin, a Buthus sindicus toxin, a Centruroides elegans toxin, a Centruroides exilicauda toxin, a Centruroides gracilis toxin, a Centruroides limbatus toxin, a Centruroides limpidus limpidus toxin, a Centruroides margaritatus toxin, a Centruroides noxius toxin, a Centruroides sculpturatus toxin, a Centruroides suffusus suffuses toxin, a Hadrurus gertschi toxin, a Hemiscorpius lepturus toxin, a Heterometrus spinfer toxin, a Hottentotta judaica toxin, a Leiurus quinquestriatus toxin, a Mesobuthus eupeus toxin, a Mesobuthus martensii toxin, a Mesobuthus tamulus toxin, an Odonthobuthus doriae toxin, an Orthochirus scrobiculosus toxin, a Pandinus imperator toxin, a Parabuthus granulatus toxin, a Parabuthus transvaalicus toxin, a Parabuthus villosus toxin, a Scorpio maurus toxin, a Tityus cambridgei toxin, a Tityus costatus toxin, a Tityus discrepans toxin, a Tityus serrulatus toxin, a Tityus trivittatus toxin, or a Tityus zulianus toxin.

In some embodiments, a composition of the present disclosure can comprise, consist essentially of, or consist of: a liposome comprising an insecticidal protein or agriculturally acceptable salt thereof, and at least one excipient; wherein the liposome encapsulates the insecticidal protein or agriculturally acceptable salt thereof, wherein the liposome comprises lecithin; wherein the insecticidal protein or agriculturally acceptable salt thereof is a Pandinus imperator toxin.

In some embodiments, a composition of the present disclosure can comprise, consist essentially of, or consist of: a liposome comprising an insecticidal protein or agriculturally acceptable salt thereof, and at least one excipient; wherein the liposome encapsulates the insecticidal protein or agriculturally acceptable salt thereof, wherein the liposome comprises lecithin; wherein the insecticidal protein or agriculturally acceptable salt thereof is a scorpion toxin having an amino acid sequence that is at least 50% identical, at least 55% identical, at least 60% identical, at least 65% identical, at least 70% identical, at least 75% identical, at least 80% identical, at least 81% identical, at least 82% identical, at least 83% identical, at least 84% identical, at least 85% identical, at least 86% identical, at least 87% identical, at least 88% identical, at least 89% identical, at least 90% identical, at least 91% identical, at least 92% identical, at least 93% identical, at least 94% identical, at least 95% identical, at least 96% identical, at least 97% identical, at least 98% identical, at least 99% identical, at least 99.5% identical, at least 99.6% identical, at least 99.7% identical, at least 99.8% identical, at least 99.9% identical, or 100% identical to an amino acid sequence set forth in any one of SEQ ID NO: 245-348.

In some embodiments, a composition of the present disclosure can comprise, consist essentially of, or consist of: a liposome comprising an insecticidal protein or agriculturally acceptable salt thereof, and at least one excipient; wherein the liposome encapsulates the insecticidal protein or agriculturally acceptable salt thereof, wherein the liposome comprises lecithin; wherein the insecticidal protein or agriculturally acceptable salt thereof is an Anemonia viridis toxin, an Actinia equina toxin, an Anemonia erythraea toxin, an Anemonia sulcata toxin, an Anthopleura elegantissima toxin, an Anthopleura fuscoviridis toxin, an Anthopleura xanthogrammica toxin, a Bunodosoma caissarum toxin, a Bunodosoma cangicum toxin, a Bunodosoma granulifera toxin, a Heteractis crispa toxin, a Parasicyonis actinostoloides toxin, a Radianthus paumotensis toxin, or a Stoichactis helianthus toxin.

In some embodiments, a composition of the present disclosure can comprise, consist essentially of, or consist of: a liposome comprising an insecticidal protein or agriculturally acceptable salt thereof, and at least one excipient; wherein the liposome encapsulates the insecticidal protein or agriculturally acceptable salt thereof, wherein the liposome comprises lecithin; wherein the insecticidal protein or agriculturally acceptable salt thereof is an Anemonia viridis toxin.

In some embodiments, a composition of the present disclosure can comprise, consist essentially of, or consist of: a liposome comprising an insecticidal protein or agriculturally acceptable salt thereof, and at least one excipient; wherein the liposome encapsulates the insecticidal protein or agriculturally acceptable salt thereof, wherein the liposome comprises lecithin; wherein the insecticidal protein or agriculturally acceptable salt thereof is a cnidarian toxin having an amino acid sequence that is at least 50% identical, at least 55% identical, at least 60% identical, at least 65% identical, at least 70% identical, at least 75% identical, at least 80% identical, at least 81% identical, at least 82% identical, at least 83% identical, at least 84% identical, at least 85% identical, at least 86% identical, at least 87% identical, at least 88% identical, at least 89% identical, at least 90% identical, at least 91% identical, at least 92% identical, at least 93% identical, at least 94% identical, at least 95% identical, at least 96% identical, at least 97% identical, at least 98% identical, at least 99% identical, at least 99.5% identical, at least 99.6% identical, at least 99.7% identical, at least 99.8% identical, at least 99.9% identical, or 100% identical to an amino acid sequence set forth in any one of SEQ ID NO: 6, 7, 349-389, or 430-599.

In some embodiments, a composition of the present disclosure can comprise, consist essentially of, or consist of: a liposome comprising an insecticidal protein or agriculturally acceptable salt thereof, and at least one excipient; wherein the liposome encapsulates the insecticidal protein or agriculturally acceptable salt thereof, wherein the liposome comprises lecithin; wherein the insecticidal protein or agriculturally acceptable salt thereof is a Conus amadis toxin, a Conus catus toxin, a Conus ermineus toxin, a Conus geographus toxin, a Conus gloriamaris toxin, a Conus kinoshitai toxin, a Conus magus toxin, a Conus marmoreus toxin, a Conus purpurascens toxin, a Conus stercusmuscarum toxin, a Conus striatus toxin, a Conus textile toxin, a Conus tulipa toxin, or a Striated cone toxin.

In some embodiments, a composition of the present disclosure can comprise, consist essentially of, or consist of: a liposome comprising an insecticidal protein or agriculturally acceptable salt thereof, and at least one excipient; wherein the liposome encapsulates the insecticidal protein or agriculturally acceptable salt thereof, wherein the liposome comprises lecithin; wherein the insecticidal protein or agriculturally acceptable salt thereof is a mollusk toxin having an amino acid sequence that is at least 50% identical, at least 55% identical, at least 60% identical, at least 65% identical, at least 70% identical, at least 75% identical, at least 80% identical, at least 81% identical, at least 82% identical, at least 83% identical, at least 84% identical, at least 85% identical, at least 86% identical, at least 87% identical, at least 88% identical, at least 89% identical, at least 90% identical, at least 91% identical, at least 92% identical, at least 93% identical, at least 94% identical, at least 95% identical, at least 96% identical, at least 97% identical, at least 98% identical, at least 99% identical, at least 99.5% identical, at least 99.6% identical, at least 99.7% identical, at least 99.8% identical, at least 99.9% identical, or 100% identical to an amino acid sequence set forth in any one of SEQ ID NO: 392-429.

### Liposome Formulations

According to some embodiments, an exemplary method for the preparation of the liposomes may include various modifications to finely adjust the components of the composition, as well as the ratio between the components, so as to obtain the most effective composition. The modifications may include, for example, such parameters as, but not limited to: the specific lipids used for the formation of the lipid composition, the ratio between the lipids of the lipid compositions, the identity of the insecticidal protein to be encapsulated, the ratio between the insecticidal protein and the lipid composition, the pH at which reactions are performed, the temperatures at which reactions are performed, the conditions at which the reactions are formed, the time length of various steps, and the like, or any combination thereof.

In some embodiments, a liposome composition of the disclosure comprises, consists essentially of, or consists of, about 0.001 wt %, 0.01 wt %, 0.1 wt %, 1.0 wt %, 2 wt %, 3 wt %, 4 wt %, 5 wt %, 6 wt %, 7 wt %, 8 wt %, 9 wt %, 10 wt %, 15 wt %, 20 wt %, (or any range between about 0.001 and 20) or more of an insecticidal protein. For example, in some embodiments, a liposome composition can comprise about 0.001 wt % to about 0.01 wt %; about 0.01 wt % to about 0.1 wt %; about 0.1 wt % to about 1 wt %; about 1 wt % to about 5 wt %; about 5 wt % to about 10 wt %; or about 10 wt % to about 20 wt % of an insecticidal protein.

In some embodiments, a liposome composition can comprise, consist essentially of, or consist of, about 2 wt %, 3 wt %, 4 wt %, 5 wt %, 7 wt %, 10 wt %, 12 wt 15 wt %, 16 wt %, 17 wt %, 18 wt % (or any range between about 2 wt % and 18 wt %) or more lipid phase; and about 82 wt %, 83 wt %, 84 wt %, 85 wt %, 88 wt %, 90 wt %, 93 wt %, 95 wt %, 96 wt %, 97 wt %, 98 wt % (or any range between about 82 wt % and 98 wt %) aqueous phase.

In some embodiments, the lipid phase may comprise, consist essentially of, or consist of, about 2 wt % 5 wt %, 10 wt %, 15 wt %, 20 wt %, 30 wt %, 40 wt %, 50 wt %, 60 wt %, 70 wt %, 75 wt % or 80 wt % phospholipids, for example about 25 wt % to about 44 wt % phospholipids.

In some embodiments, a liposome composition of the present disclosure can be loaded with any of the following amounts of insecticidal protein: from about 1,000 μg/mL to about 100,000 μg/mL, or any value in between.

In some embodiments, a liposome composition of the present disclosure can be loaded with any of the following amounts of insecticidal protein: from about 1,000 μg/mL to about 50,000 μg/mL, or any value in between.

In some embodiments, a liposome composition of the present disclosure can be loaded with any of the following amounts of insecticidal protein: at least 1,000 μg/mL, at least 1,250 μg/mL, at least 1,500 μg/mL, at least 1,750 μg/mL, at least 2,000 μg/mL, at least 2,500 μg/mL, at least 3,000 μg/mL, at least 3,500 μg/mL, at least 4,000 μg/mL, at least 4,500 μg/mL, at least 5,000 μg/mL, at least 5,500 μg/mL, at least at least 6,000 μg/mL, at least 6,500 μg/mL, at least 7,000 μg/mL, at least 7,500 μg/mL, at least 8,000 μg/mL, at least 8,500 μg/mL, at least 9,000 μg/mL, at least 9,500 μg/mL, at least 10,000 μg/mL, at least 11,000 μg/mL, at least 12,000 μg/mL, at least 12,500 μg/mL, at least 13,000 μg/mL, at least 14,000 μg/mL, at least 15,000 μg/mL, at least 16,000 μg/mL, at least 17,000 μg/mL, at least 17,500 μg/mL, at least 18,000 μg/mL, at least 19,000 μg/mL, at least 20,000 μg/mL, at least 25,000 μg/mL, at least 30,000 μg/mL, at least 40,000 μg/mL, at least 50,000 μg/mL, at least 60,000 μg/mL, at least 70,000 μg/mL, at least 80,000 μg/mL, at least 90,000 μg/mL, or at least 100,000 μg/mL of insecticidal protein.

In some embodiments, a liposome composition of the present disclosure can be loaded with about: 0.001 μg/mL, 0.01 μg/mL, 0.1 μg/mL, 1.0 μg/mL, 2 μg/mL, 3 μg/mL, 4 μg/mL, 5 μg/mL, 6 μg/mL, 7 μg/mL, 8 μg/mL, 9 μg/mL, 10 μg/mL, 11 μg/mL, 12 μg/mL, 13 μg/mL, 14 μg/mL, 15 μg/mL, 16 μg/mL, 17 μg/mL, 18 μg/mL, 19 μg/mL, 20 μg/mL, 21 μg/mL, 22 μg/mL, 23 μg/mL, 24 μg/mL, 25 μg/mL, 26 μg/mL, 27 μg/mL, 28 μg/mL, 29 μg/mL, 30 μg/mL, 31 μg/mL, 32 μg/mL, 33 μg/mL, 34 μg/mL, 35 μg/mL, 36 μg/mL, 37 μg/mL, 38 μg/mL, 39 μg/mL, 40 μg/mL, 41 μg/mL, 42 μg/mL, 43 μg/mL, 44 μg/mL, 45 g/mL, 46 μg/mL, 47 μg/mL, 48 μg/mL, 49 μg/mL, 50 μg/mL, 51 μg/mL, 52 μg/mL, 53 μg/mL, 54 μg/mL, 55 μg/mL, 56 μg/mL, 57 μg/mL, 58 μg/mL, 59 μg/mL, 60 μg/mL, 62 μg/mL, 62 μg/mL, 63 μg/mL, 64 μg/mL, 65 μg/mL, 66 μg/mL, 67 μg/mL, 68 μg/mL, 69 μg/mL, 70 μg/mL, 71 μg/mL, 72 μg/mL, 73 μg/mL, 74 μg/mL, 75 μg/mL, 76 μg/mL, 77 μg/mL, 78 μg/mL, 79 μg/mL, 80 μg/mL, 81 μg/mL, 82 μg/mL, 83 μg/mL, 84 μg/mL, 85 μg/mL, 86 μg/mL, 87 μg/mL, 88 μg/mL, 89 μg/mL, 90 μg/mL, 91 μg/mL, 92 μg/mL, 93 μg/mL, 94 μg/mL, 95 μg/mL, 96 μg/mL, 97 μg/mL, 98 μg/mL, 99 μg/mL, 100 μg/mL, 101 μg/mL, 102 μg/mL, 103 μg/mL, 104 μg/mL, 105 μg/mL, 106 μg/mL, 107 μg/mL, 108 μg/mL, 109 μg/mL, 110 μg/mL, 111 μg/mL, 112 μg/mL, 113 μg/mL, 114 μg/mL, 115 μg/mL, 116 μg/mL, 117 μg/mL, 118 μg/mL, 119 μg/mL, 120 μg/mL, 121 μg/mL, 122 μg/mL, 123 μg/mL, 124 μg/mL, 125 μg/mL, 126 μg/mL, 127 μg/mL, 128 μg/mL, 129 μg/mL, 130 μg/mL, 131 μg/mL, 132 μg/mL, 133 μg/mL, 134 μg/mL, 135 μg/mL, 136 μg/mL, 137 μg/mL, 138 μg/mL, 139 μg/mL, 140 μg/mL, 141 μg/mL, 142 μg/mL, 143 μg/mL, 144 μg/mL, 145 μg/mL, 146 μg/mL, 147 μg/mL, 148 μg/mL, 149 μg/mL, 150 μg/mL, 151 μg/mL, 152 μg/mL, 153 μg/mL, 154 μg/mL, 155 μg/mL, 156 μg/mL, 157 μg/mL, 158 μg/mL, 159 μg/mL, 160 μg/mL, 161 μg/mL, 162 μg/mL, 163 μg/mL, 164 μg/mL, 165 μg/mL, 166 μg/mL, 167 μg/mL, 168 μg/mL, 169 μg/mL, 170 μg/mL, 171 μg/mL, 172 μg/mL, 173 μg/mL, 174 μg/mL, 175 μg/mL, 176 μg/mL, 177 μg/mL, 178 μg/mL, 179 μg/mL, 180 μg/mL, 181 μg/mL, 182 μg/mL, 183 μg/mL, 184 μg/mL, 185 μg/mL, 186 μg/mL, 187 μg/mL, 188 μg/mL, 189 μg/mL, 190 μg/mL, 191 μg/mL, 192 μg/mL, 193 μg/mL, 194 μg/mL, 195 μg/mL, 196 μg/mL, 197 μg/mL, 198 μg/mL, 199 μg/mL, 200 μg/mL, 201 μg/mL, 202 μg/mL, 203 μg/mL, 204 μg/mL, 205 μg/mL, 206 μg/mL, 207 μg/mL, 208 μg/mL, 209 μg/mL, 210 μg/mL, 211 μg/mL, 212 μg/mL, 213 μg/mL, 214 μg/mL, 215 μg/mL, 216 μg/mL, 217 μg/mL, 218 μg/mL, 219 μg/mL, 220 μg/mL, 221 μg/mL, 222 μg/mL, 223 μg/mL, 224 μg/mL, 225 μg/mL, 226 μg/mL, 227 μg/mL, 228 μg/mL, 229 μg/mL, 230 μg/mL, 231 μg/mL, 232 μg/mL, 233 μg/mL, 234 μg/mL, 235 μg/mL, 236 μg/mL, 237 μg/mL, 238 μg/mL, 239 μg/mL, 240 μg/mL, 241 μg/mL, 242 μg/mL, 243 μg/mL, 244 μg/mL, 245 μg/mL, 246 μg/mL, 247 μg/mL, 248 μg/mL, 249 μg/mL, 250 μg/mL, 251 μg/mL, 252 μg/mL, 253 μg/mL, 254 μg/mL, 255 μg/mL, 256 μg/mL, 257 μg/mL, 258 μg/mL, 259 μg/mL, 260 μg/mL, 261 μg/mL, 262 μg/mL, 263 μg/mL, 264 μg/mL, 265 μg/mL, 266 μg/mL, 267 μg/mL, 268 μg/mL, 269 μg/mL, 270 μg/mL, 271 μg/mL, 272 μg/mL, 273 μg/mL, 274 μg/mL, 275 μg/mL, 276 μg/mL, 277 μg/mL, 278 μg/mL, 279 μg/mL, 280 μg/mL, 281 μg/mL, 282 μg/mL, 283 μg/mL, 284 μg/mL, 285 μg/mL, 286 μg/mL, 287 μg/mL, 288 μg/mL, 289 μg/mL, 290 μg/mL, 291 μg/mL, 292 μg/mL, 293 μg/mL, 294 μg/mL, 295 μg/mL, 296 μg/mL, 297 μg/mL, 298 μg/mL, 299 μg/mL, 300 μg/mL, 301 μg/mL, 302 μg/mL, 303 μg/mL, 304 μg/mL, 305 μg/mL, 306 μg/mL, 307 μg/mL, 308 μg/mL, 309 μg/mL, 310 μg/mL, 311 μg/mL, 312 μg/mL, 313 μg/mL, 314 μg/mL, 315 μg/mL, 316 μg/mL, 317 μg/mL, 318 μg/mL, 319 μg/mL, 320 μg/mL, 321 μg/mL, 322 μg/mL, 323 μg/mL, 324 μg/mL, 325 μg/mL, 326 μg/mL, 327 μg/mL, 328 μg/mL, 329 μg/mL, 330 μg/mL, 331 μg/mL, 332 μg/mL, 333 μg/mL, 334 μg/mL, 335 μg/mL, 336 μg/mL, 337 μg/mL, 338 μg/mL, 339 μg/mL, 340 μg/mL, 341 μg/mL, 342 μg/mL, 343 μg/mL, 344 μg/mL, 345 μg/mL, 346 μg/mL, 347 μg/mL, 348 μg/mL, 349 μg/mL, 350 μg/mL, 351 μg/mL, 352 μg/mL, 353 μg/mL, 354 μg/mL, 355 μg/mL, 356 μg/mL, 357 μg/mL, 358 μg/mL, 359 μg/mL, 360 μg/mL, 361 μg/mL, 362 μg/mL, 363 μg/mL, 364 μg/mL, 365 μg/mL, 366 μg/mL, 367 μg/mL, 368 μg/mL, 369 μg/mL, 370 μg/mL, 371 μg/mL, 372 μg/mL, 373 μg/mL, 374 μg/mL, 375 μg/mL, 376 μg/mL, 377 μg/mL, 378 μg/mL, 379 μg/mL, 380 μg/mL, 381 μg/mL, 382 μg/mL, 383 μg/mL, 384 μg/mL, 385 μg/mL, 386 μg/mL, 387 μg/mL, 388 μg/mL, 389 μg/mL, 390 μg/mL, 391 μg/mL, 392 μg/mL, 393 μg/mL, 394 μg/mL, 395 μg/mL, 396 μg/mL, 397 μg/mL, 398 μg/mL, 399 μg/mL, 400 μg/mL, 401 μg/mL, 402 μg/mL, 403 μg/mL, 404 μg/mL, 405 μg/mL, 406 μg/mL, 407 μg/mL, 408 μg/mL, 409 μg/mL, 410 μg/mL, 411 μg/mL, 412 μg/mL, 413 μg/mL, 414 μg/mL, 415 μg/mL, 416 μg/mL, 417 μg/mL, 418 μg/mL, 419 μg/mL, 420 μg/mL, 421 μg/mL, 422 μg/mL, 423 μg/mL, 424 μg/mL, 425 μg/mL, 426 μg/mL, 427 μg/mL, 428 μg/mL, 429 μg/mL, 430 μg/mL, 431 μg/mL, 432 μg/mL, 433 μg/mL, 434 μg/mL, 435 μg/mL, 436 μg/mL, 437 μg/mL, 438 μg/mL, 439 μg/mL, 440 μg/mL, 441 μg/mL, 442 μg/mL, 443 μg/mL, 444 μg/mL, 445 μg/mL, 446 μg/mL, 447 μg/mL, 448 μg/mL, 449 μg/mL, 450 μg/mL, 451 μg/mL, 452 μg/mL, 453 μg/mL, 454 μg/mL, 455 μg/mL, 456 μg/mL, 457 μg/mL, 458 μg/mL, 459 μg/mL, 460 μg/mL, 461 μg/mL, 462 μg/mL, 463 μg/mL, 464 μg/mL, 465 μg/mL, 466 μg/mL, 467 μg/mL, 468 μg/mL, 469 μg/mL, 470 μg/mL, 471 μg/mL, 472 μg/mL, 473 μg/mL, 474 μg/mL, 475 μg/mL, 476 μg/mL, 477 μg/mL, 478 μg/mL, 479 μg/mL, 480 μg/mL, 481 μg/mL, 482 μg/mL, 483 μg/mL, 484 μg/mL, 485 μg/mL, 486 μg/mL, 487 μg/mL, 488 μg/mL, 489 μg/mL, 490 μg/mL, 491 μg/mL, 492 μg/mL, 493 μg/mL, 494 μg/mL, 495 μg/mL, 496 μg/mL, 497 μg/mL, 498 μg/mL, 499 μg/mL, 500 μg/mL, 1000 μg/mL, 1100 μg/mL, 1200 μg/mL, 1300 μg/mL, 1400 μg/mL, 1500 μg/mL, 1600 μg/mL, 1700 μg/mL, 1800 μg/mL, 1900 μg/mL, 2000 μg/mL, 2100 μg/mL, 2200 μg/mL, 2300 μg/mL, 2400 μg/mL, 2500 μg/mL, 2600 μg/mL, 2700 μg/mL, 2800 μg/mL, 2900 μg/mL, 3000 μg/mL, 3100 μg/mL, 3200 μg/mL, 3300 μg/mL, 3400 μg/mL, 3500 μg/mL, 3600 μg/mL, 3700 μg/mL, 3800 μg/mL, 3900 μg/mL, 4000 μg/mL, 4100 μg/mL, 4200 μg/mL, 4300 μg/mL, 4400 μg/mL, 4500 μg/mL, 4600 μg/mL, 4700 μg/mL, 4800 μg/mL, 4900 μg/mL, 5000 μg/mL, 5100 μg/mL, 5200 μg/mL, 5300 μg/mL, 5400 μg/mL, 5500 μg/mL, 5600 μg/mL, 5700 μg/mL, 5800 μg/mL, 5900 μg/mL, 6000 μg/mL, 6100 μg/mL, 6200 μg/mL, 6300 μg/mL, 6400 μg/mL, 6500 μg/mL, 6600 μg/mL, 6700 μg/mL, 6800 μg/mL, 6900 μg/mL, 7000 μg/mL, 7100 μg/mL, 7200 μg/mL, 7300 μg/mL, 7400 μg/mL, 7500 μg/mL, 7600 μg/mL, 7700 μg/mL, 7800 μg/mL, 7900 μg/mL, 8000 μg/mL, 8100 μg/mL, 8200 μg/mL, 8300 μg/mL, 8400 μg/mL, 8500 μg/mL, 8600 μg/mL, 8700 μg/mL, 8800 μg/mL, 8900 μg/mL, 9000 μg/mL, 9100 μg/mL, 9200 μg/mL, 9300 μg/mL, 9400 μg/mL, 9500 μg/mL, 9600 μg/mL, 9700 μg/mL, 9800 μg/mL, 9900 μg/mL, 10000 μg/mL, 10100 μg/mL, 10200 μg/mL, 10300 μg/mL, 10400 μg/mL, 10500 μg/mL, 10600 μg/mL, 10700 μg/mL, 10800 μg/mL, 10900 μg/mL, 11000 μg/mL, 11100 μg/mL, 11200 μg/mL, 11300 μg/mL, 11400 μg/mL, 11500 μg/mL, 11600 μg/mL, 11700 μg/mL, 11800 μg/mL, 11900 μg/mL, 12000 μg/mL, 12100 μg/mL, 12200 μg/mL, 12300 μg/mL, 12400 μg/mL, 12500 μg/mL, 12600 μg/mL, 12700 μg/mL, 12800 μg/mL, 12900 μg/mL, 13000 μg/mL, 13100 μg/mL, 13200 μg/mL, 13300 μg/mL, 13400 μg/mL, 13500 μg/mL, 13600 μg/mL, 13700 μg/mL, 13800 μg/mL, 13900 μg/mL, 14000 μg/mL, 14100 μg/mL, 14200 μg/mL, 14300 μg/mL, 14400 μg/mL, 14500 μg/mL, 14600 μg/mL, 14700 μg/mL, 14800 μg/mL, 14900 μg/mL, 15000 μg/mL, 15100 μg/mL, 15200 μg/mL, 15300 μg/mL, 15400 μg/mL, 15500 μg/mL, 15600 μg/mL, 15700 μg/mL, 15800 μg/mL, 15900 μg/mL, 16000 μg/mL, 16100 μg/mL, 16200 μg/mL, 16300 μg/mL, 16400 μg/mL, 16500 μg/mL, 16600 μg/mL, 16700 μg/mL, 16800 μg/mL, 16900 μg/mL, 17000 μg/mL, 17100 μg/mL, 17200 μg/mL, 17300 μg/mL, 17400 μg/mL, 17500 μg/mL, 17600 μg/mL, 17700 μg/mL, 17800 μg/mL, 17900 μg/mL, 18000 μg/mL, 18100 μg/mL, 18200 μg/mL, 18300 μg/mL, 18400 μg/mL, 18500 μg/mL, 18600 μg/mL, 18700 μg/mL, 18800 μg/mL, 18900 μg/mL, 19000 μg/mL, 19100 μg/mL, 19200 μg/mL, 19300 μg/mL, 19400 μg/mL, 19500 μg/mL, 19600 μg/mL, 19700 μg/mL, 19800 μg/mL, 19900 μg/mL, 20000 μg/mL, 20100 μg/mL, 20200 μg/mL, 20300 μg/mL, 20400 μg/mL, 20500 μg/mL, 20600 μg/mL, 20700 μg/mL, 20800 μg/mL, 20900 μg/mL, 21000 μg/mL, 21100 μg/mL, 21200 μg/mL, 21300 μg/mL, 21400 μg/mL, 21500 μg/mL, 21600 μg/mL, 21700 μg/mL, 21800 μg/mL, 21900 μg/mL, 22000 μg/mL, 22100 μg/mL, 22200 μg/mL, 22300 μg/mL, 22400 μg/mL, 22500 μg/mL, 22600 μg/mL, 22700 μg/mL, 22800 μg/mL, 22900 μg/mL, 23000 μg/mL, 23100 μg/mL, 23200 μg/mL, 23300 μg/mL, 23400 μg/mL, 23500 μg/mL, 23600 μg/mL, 23700 μg/mL, 23800 μg/mL, 23900 μg/mL, 24000 μg/mL, 24100 μg/mL, 24200 μg/mL, 24300 μg/mL, 24400 μg/mL, 24500 μg/mL, 24600 μg/mL, 24700 μg/mL, 24800 μg/mL, 24900 μg/mL, 25000 μg/mL, 25100 μg/mL, 25200 μg/mL, 25300 μg/mL, 25400 μg/mL, 25500 μg/mL, 25600 μg/mL, 25700 μg/mL, 25800 μg/mL, 25900 μg/mL, 26000 μg/mL, 26100 μg/mL, 26200 μg/mL, 26300 μg/mL, 26400 μg/mL, 26500 μg/mL, 26600 μg/mL, 26700 μg/mL, 26800 μg/mL, 26900 μg/mL, 27000 μg/mL, 27100 μg/mL, 27200 μg/mL, 27300 μg/mL, 27400 μg/mL, 27500 μg/mL, 27600 μg/mL, 27700 μg/mL, 27800 μg/mL, 27900 μg/mL, 28000 μg/mL, 28100 μg/mL, 28200 μg/mL, 28300 μg/mL, 28400 μg/mL, 28500 μg/mL, 28600 μg/mL, 28700 μg/mL, 28800 μg/mL, 28900 μg/mL, 29000 μg/mL, 29100 μg/mL, 29200 μg/mL, 29300 μg/mL, 29400 μg/mL, 29500 μg/mL, 29600 μg/mL, 29700 μg/mL, 29800 μg/mL, 29900 μg/mL, 30000 μg/mL, 30100 μg/mL, 30200 μg/mL, 30300 μg/mL, 30400 μg/mL, 30500 μg/mL, 30600 μg/mL, 30700 μg/mL, 30800 μg/mL, 30900 μg/mL, 31000 μg/mL, 31100 μg/mL, 31200 μg/mL, 31300 μg/mL, 31400 μg/mL, 31500 μg/mL, 31600 μg/mL, 31700 μg/mL, 31800 μg/mL, 31900 μg/mL, 32000 μg/mL, 32100 μg/mL, 32200 μg/mL, 32300 μg/mL, 32400 μg/mL, 32500 μg/mL, 32600 μg/mL, 32700 μg/mL, 32800 μg/mL, 32900 μg/mL, 33000 μg/mL, 33100 μg/mL, 33200 μg/mL, 33300 μg/mL, 33400 μg/mL, 33500 μg/mL, 33600 μg/mL, 33700 μg/mL, 33800 μg/mL, 33900 μg/mL, 34000 μg/mL, 34100 μg/mL, 34200 μg/mL, 34300 μg/mL, 34400 μg/mL, 34500 μg/mL, 34600 μg/mL, 34700 μg/mL, 34800 μg/mL, 34900 μg/mL, 35000 μg/mL, 35100 μg/mL, 35200 μg/mL, 35300 μg/mL, 35400 μg/mL, 35500 μg/mL, 35600 μg/mL, 35700 μg/mL, 35800 μg/mL, 35900 μg/mL, 36000 μg/mL, 36100 μg/mL, 36200 μg/mL, 36300 μg/mL, 36400 μg/mL, 36500 μg/mL, 36600 μg/mL, 36700 μg/mL, 36800 μg/mL, 36900 μg/mL, 37000 μg/mL, 37000 μg/mL, 37025 μg/mL, 37050 μg/mL, 37075 μg/mL, 37100 μg/mL, 37125 μg/mL, 37150 μg/mL, 37175 μg/mL, 37200 μg/mL, 37225 μg/mL, 37250 μg/mL, 37275 μg/mL, 37300 μg/mL, 37325 μg/mL, 37350 μg/mL, 37375 μg/mL, 37400 μg/mL, 37405 μg/mL, 37410 μg/mL, 37415 μg/mL, 37420 μg/mL, 37425 μg/mL, 37430 μg/mL, 37435 μg/mL, 37440 μg/mL, 37445 μg/mL, 37450 μg/mL, 37455 μg/mL, 37460 μg/mL, 37465 μg/mL, 37470 μg/mL, 37475 μg/mL, 37480 μg/mL, 37485 μg/mL, 37490 μg/mL, 37490 μg/mL, 37491 μg/mL, 37492 μg/mL, 37493 μg/mL, 37494 μg/mL, 37495 μg/mL, 37496 μg/mL, 37497 μg/mL, 37498 μg/mL, 37499 μg/mL, 37500 μg/mL, 37501 μg/mL, 37502 μg/mL, 37503 μg/mL, 37504 μg/mL, 37505 μg/mL, 37506 μg/mL, 37507 μg/mL, 37508 μg/mL, 37509 μg/mL, 37510 μg/mL, 37511 μg/mL, 37512 μg/mL, 37513 μg/mL, 37514 μg/mL, 37515 μg/mL, 37516 μg/mL, 37517 μg/mL, 37518 μg/mL, 37519 μg/mL, 37520 μg/mL, 37521 μg/mL, 37522 μg/mL, 37523 μg/mL, 37524 μg/mL, 37525 μg/mL, 37526 μg/mL, 37527 μg/mL, 37528 μg/mL, 37529 μg/mL, 37530 μg/mL, 37531 μg/mL, 37532 μg/mL, 37533 μg/mL, 37534 μg/mL, 37535 μg/mL, 37536 μg/mL, 37537 μg/mL, 37538 μg/mL, 37539 μg/mL, 37540 μg/mL, 37541 μg/mL, 37542 μg/mL, 37543 μg/mL, 37544 μg/mL, 37545 μg/mL, 37546 μg/mL, 37547 μg/mL, 37548 μg/mL, 37549 μg/mL, 37550 μg/mL, 37551 μg/mL, 37552 μg/mL, 37553 μg/mL, 37554 μg/mL, 37555 μg/mL, 37556 μg/mL, 37557 μg/mL, 37558 μg/mL, 37559 μg/mL, 37560 μg/mL, 37561 μg/mL, 37562 μg/mL, 37563 μg/mL, 37564 μg/mL, 37565 μg/mL, 37566 μg/mL, 37567 μg/mL, 37568 μg/mL, 37569 μg/mL, 37570 μg/mL, 37571 μg/mL, 37572 μg/mL, 37573 μg/mL, 37574 μg/mL, 37575 μg/mL, 37576 μg/mL, 37577 μg/mL, 37578 μg/mL, 37579 μg/mL, 37580 μg/mL, 37581 μg/mL, 37582 μg/mL, 37583 μg/mL, 37584 μg/mL, 37585 μg/mL, 37586 μg/mL, 37587 μg/mL, 37588 μg/mL, 37589 μg/mL, 37590 μg/mL, 37591 μg/mL, 37592 μg/mL, 37593 μg/mL, 37594 μg/mL, 37595 μg/mL, 37596 μg/mL, 37597 μg/mL, 37598 μg/mL, 37599 μg/mL, 37600 μg/mL, 37600 μg/mL, 37625 μg/mL, 37650 μg/mL, 37675 μg/mL, 37700 μg/mL, 37725 μg/mL, 37750 μg/mL, 37775 μg/mL, 37800 μg/mL, 37825 μg/mL, 37850 μg/mL, 37875 μg/mL, 37900 μg/mL, 37925 μg/mL, 37950 μg/mL, 37975 μg/mL, 38000 μg/mL, 38100 μg/mL, 38200 μg/mL, 38300 μg/mL, 38400 μg/mL, 38500 μg/mL, 38600 μg/mL, 38700 μg/mL, 38800 μg/mL, 38900 μg/mL, 39000 μg/mL, 39100 μg/mL, 39200 μg/mL, 39300 μg/mL, 39400 μg/mL, 39500 μg/mL, 39600 μg/mL, 39700 μg/mL, 39800 μg/mL, 39900 μg/mL, 40000 μg/mL, 40100 μg/mL, 40200 μg/mL, 40300 μg/mL, 40400 μg/mL, 40500 μg/mL, 40600 μg/mL, 40700 μg/mL, 40800 μg/mL, 40900 μg/mL, 41000 μg/mL, 41100 μg/mL, 41200 μg/mL, 41300 μg/mL, 41400 μg/mL, 41500 μg/mL, 41600 μg/mL, 41700 μg/mL, 41800 μg/mL, 41900 μg/mL, 42000 μg/mL, 42100 μg/mL, 42200 μg/mL, 42300 μg/mL, 42400 μg/mL, 42500 μg/mL, 42600 μg/mL, 42700 μg/mL, 42800 μg/mL, 42900 μg/mL, 43000 μg/mL, 43100 μg/mL, 43200 μg/mL, 43300 μg/mL, 43400 μg/mL, 43500 μg/mL, 43600 μg/mL, 43700 μg/mL, 43800 μg/mL, 43900 μg/mL, 44000 μg/mL, 44100 μg/mL, 44200 μg/mL, 44300 μg/mL, 44400 μg/mL, 44500 μg/mL, 44600 μg/mL, 44700 μg/mL, 44800 μg/mL, 44900 μg/mL, 45000 μg/mL, 45100 μg/mL, 45200 μg/mL, 45300 μg/mL, 45400 μg/mL, 45500 μg/mL, 45600 μg/mL, 45700 μg/mL, 45800 μg/mL, 45900 μg/mL, 46000 μg/mL, 46100 μg/mL, 46200 μg/mL, 46300 μg/mL, 46400 μg/mL, 46500 μg/mL, 46600 μg/mL, 46700 μg/mL, 46800 μg/mL, 46900 μg/mL, 47000 μg/mL, 47100 μg/mL, 47200 μg/mL, 47300 μg/mL, 47400 μg/mL, 47500 μg/mL, 47600 μg/mL, 47700 μg/mL, 47800 μg/mL, 47900 μg/mL, 48000 μg/mL, 48100 μg/mL, 48200 μg/mL, 48300 μg/mL, 48400 μg/mL, 48500 μg/mL, 48600 μg/mL, 48700 μg/mL, 48800 μg/mL, 48900 μg/mL, 49000 μg/mL, 49100 μg/mL, 49200 μg/mL, 49300 μg/mL, 49400 μg/mL, 49500 μg/mL, 49600 μg/mL, 49700 μg/mL, 49800 μg/mL, 49900 μg/mL, 50000 μg/mL, or more of an insecticidal protein, or any value in between.

In some embodiments, the lipid phase may optionally comprise, consist essentially of, or consist of, one or more additional agents such as thickeners, gelling agents, preservatives, stabilizers, wetting agents, pH buffering agents, emulsifiers, stearylamine, phosphatidic acid, dicetyl phosphate, sterols, cholesterol, cholesterol stearate, lanolin extracts, hydroxypropylmethycellulose, carboxymethycellulose, sodium acetate, sorbitan monolaurate, triethanolamine oleate, and sorbitol. In some embodiments, an additional agent may be present at about 0.01, 0.1, 1, 2, 5, 7, 10, 12, or 15 wt % of the lipid phase.

In some embodiments, a liposome composition can also include one or more additives to improve the biological performance of the composition (for example by improving wetting, retention or distribution on surfaces; resistance to rain on treated surfaces; or uptake or mobility of a liposome formulation). Such additives include, but are not limited to, surface active agents, spray additives based on oils, for example certain mineral oils or natural plant oils (such as soy bean and rape seed oil), and blends of these with other bio-enhancing adjuvants (ingredients which may aid or modify the action of a liposome formulation).

In some embodiments, the present disclosure comprises, consists essentially of, or consists of, a liposome composition formulated into one of the following, without limitation: dustable powders (DP); soluble powders (SP); water soluble granules (SG); water dispersible granules (WG); wettable powders (WP); granules (GR) (slow or fast release); soluble concentrates (SL); oil miscible liquids (OL); ultra-low volume liquids (UL); emulsifiable concentrates (EC); dispersible concentrates (DC); emulsions (both oil in water (EW) and water in oil (EO)); micro-emulsions (ME); suspension concentrates (SC); aerosols; fogging/smoke formulations; capsule suspensions (CS) and seed treatment formulations. The formulation type chosen in any instance will depend upon the particular purpose envisaged and the physical, chemical and biological properties of the liposome formulation.

### Dustable Powders (DP)

In some embodiments, dustable powders (DP) may be prepared by mixing a liposome formulation with one or more solid diluents (for example natural clays, kaolin, pyrophyllite, bentonite, alumina, montmorillonite, kieselguhr, chalk, diatomaceous earths, calcium phosphates, calcium and magnesium carbonates, sulfur, lime, flours, talc and other organic and inorganic solid carriers) and mechanically grinding the mixture to a fine powder.

In some embodiments, a DP liposome composition may contain an amount of liposome-encapsulated insecticidal protein ranging from about 0.005 wt % to about 99 wt %.

### Soluble Powders (SP)

In some embodiments, soluble powders (SP) may be prepared by mixing a liposome formulation with one or more water-soluble inorganic salts (such as sodium bicarbonate, sodium carbonate or magnesium sulfate) or one or more water-soluble organic solids (such as a polysaccharide) and, optionally, one or more wetting agents, one or more dispersing agents or a mixture of said agents to improve water dispersibility/solubility. The mixture is then ground to a fine powder. Similar compositions may also be granulated to form water soluble granules (SG).

In some embodiments, a SP liposome composition may contain an amount of liposome-encapsulated insecticidal protein ranging from about 0.005 wt % to about 99 wt %.

### Wettable Powders (WP)

In some embodiments, wettable powders (WP) may be prepared by mixing a liposome formulation with one or more solid diluents or carriers, one or more wetting agents and, preferably, one or more dispersing agents and, optionally, one or more suspending agents to facilitate the dispersion in liquids. The mixture is then ground to a fine powder. Similar compositions may also be granulated to form water dispersible granules (WG).

In some embodiments, a WP liposome composition may contain an amount of liposome-encapsulated insecticidal protein ranging from about 0.005 wt % to about 99 wt %.

### Granules (GR)

In some embodiments, granules (GR) may be formed either by granulating a mixture of a liposome formulation and one or more powdered solid diluents or carriers, or from pre-formed blank granules by absorbing a liposome formulation (or a solution thereof, in a suitable agent) in a porous granular material (such as pumice, attapulgite clays, fuller's earth, kieselguhr, diatomaceous earths or ground corn cobs) or by adsorbing a liposome formulation (or a solution thereof, in a suitable agent) on to a hard core material (such as sands, silicates, mineral carbonates, sulfates or phosphates) and drying if necessary. Agents which are commonly used to aid absorption or adsorption include solvents (such as aliphatic and aromatic petroleum solvents, alcohols, ethers, ketones and esters) and sticking agents (such as polyvinyl acetates, polyvinyl alcohols, dextrins, sugars and vegetable oils). One or more other additives may also be included in granules (for example an emulsifying agent, wetting agent or dispersing agent).

In some embodiments, a GR liposome composition may contain an amount of liposome-encapsulated insecticidal protein ranging from about 0.005 wt % to about 99 wt %.

### Dispersible Concentrates (DC)

In some embodiments, dispersible Concentrates (DC) may be prepared by dissolving a liposome formulation in water or an organic solvent, such as a ketone, alcohol or glycol ether. These solutions may contain a surface active agent (for example to improve water dilution or prevent crystallization in a spray tank).

In some embodiments, a DC liposome composition may contain an amount of liposome-encapsulated insecticidal protein ranging from about 0.005 wt % to about 99 wt %.

### Emulsifiable Concentrates (EC)

In some embodiments, emulsifiable concentrates (EC) or oil-in-water emulsions (EW) may be prepared by dissolving a liposome formulation in an organic solvent (optionally containing one or more wetting agents, one or more emulsifying agents or a mixture of said agents). Suitable organic solvents for use in ECs include aromatic hydrocarbons (such as alkylbenzenes or alkylnaphthalenes, exemplified by SOLVESSO®100, SOLVESSO® 150 and SOLVESSO® 200; SOLVESSO®), ketones (such as cyclohexanone or methylcyclohexanone) and alcohols (such as benzyl alcohol, furfuryl alcohol or butanol), N-alkylpyrrolidones (such as N-methylpyrrolidone or N-octylpyrrolidone), dimethyl amides of fatty acids (such as C5-C10 fatty acid dimethylamide) and chlorinated hydrocarbons. An EC product may spontaneously emulsify on addition to water, to produce an emulsion with sufficient stability to allow spray application through appropriate equipment. Preparation of an EC involves obtaining a liposome formulation either as a liquid (if it is not a liquid at ambient temperature, it may be melted at a reasonable temperature, typically below 700° C.) or in solution (by dissolving it in an appropriate solvent) and then emulsifying the resultant liquid or solution into water containing one or more SFAs, under high shear, to produce an emulsion. Suitable solvents for use in EWs include vegetable oils, chlorinated hydrocarbons (such as chlorobenzenes), aromatic solvents (such as alkylbenzenes or alkylnaphthalenes) and other appropriate organic solvents which have a low solubility in water.

In some embodiments, an EC liposome composition may contain an amount of liposome-encapsulated insecticidal protein ranging from about 0.005 wt % to about 99 wt %.

### Microemulsions (ME)

In some embodiments, microemulsions (ME) may be prepared by mixing water with a blend of one or more solvents with one or more SFAs, to produce spontaneously a thermodynamically stable isotropic liquid formulation. A liposome formulation is present initially in either the water or the solvent/SFA blend. Suitable solvents for use in MEs include those hereinbefore described for use in ECs or in EWs. An ME may be either an oil-in-water or a water-in-oil system (which system is present may be determined by conductivity measurements) and may be suitable for mixing water-soluble and oil-soluble pesticides in the same formulation. An ME is suitable for dilution into water, either remaining as a microemulsion or forming a conventional oil-in-water emulsion.

In some embodiments, an ME liposome composition may contain an amount of liposome-encapsulated insecticidal protein ranging from about 0.005 wt % to about 99 wt %.

### Suspension Concentrates (SC)

In some embodiments, a suspension concentrates (SC) may comprise aqueous or non-aqueous suspensions of finely divided insoluble solid particles of a liposome formulation. SCs may be prepared by ball or bead milling the solid liposome formulation in a suitable medium, optionally with one or more dispersing agents, to produce a fine particle suspension of the compound. One or more wetting agents may be included in the composition and a suspending agent may be included to reduce the rate at which the particles settle. Alternatively, a liposome formulation may be dry milled and added to water, containing agents hereinbefore described, to produce the desired end product.

In some embodiments, an SC liposome composition may contain an amount of liposome-encapsulated insecticidal protein ranging from about 0.005 wt % to about 99 wt %.

### Aerosol Formulations

In some embodiments, aerosol formulations comprise a liposome formulation and a suitable propellant (for example n-butane). A liposome formulation may also be dissolved or dispersed in a suitable medium (for example water or a water miscible liquid, such as n-propanol) to provide compositions for use in non-pressurized, hand-actuated spray pumps.

A liposome formulation may be mixed in the dry state with a pyrotechnic mixture to form a composition suitable for generating, in an enclosed space, a smoke containing the compound.

In some embodiments, an aerosol formulation may contain an amount of liposome-encapsulated insecticidal protein ranging from about 0.005 wt % to about 99 wt %.

### Capsule Suspensions (CS)

In some embodiments, capsule suspensions (CS) may be prepared in a manner similar to the preparation of EW formulations but with an additional polymerization stage such that an aqueous dispersion of oil droplets is obtained, in which each oil droplet is encapsulated by a polymeric shell and contains a liposome formulation and, optionally, a carrier or diluent therefor. The polymeric shell may be produced by either an interfacial polycondensation reaction or by a coacervation procedure. The compositions may provide for controlled release of the liposome formulation and they may be used for seed treatment. A liposome formulation may also be formulated in a biodegradable polymeric matrix to provide a slow, controlled release of the compound.

In some embodiments, a CS liposome composition may contain an amount of liposome-encapsulated insecticidal protein ranging from about 0.005 wt % to about 99 wt %.

### Seed Treatments

In some embodiments, a liposome formulation may also be formulated for use as a seed treatment, for example as a powder composition, including a powder for dry seed treatment (DS), a water soluble powder (SS) or a water dispersible powder for slurry treatment (WS), or as a liquid composition, including a flowable concentrate (FS), a solution (LS) or a capsule suspension (CS). The preparations of DS, SS, WS, FS and LS compositions are very similar to those of, respectively, DP, SP, WP, SC and DC compositions described above. Compositions for treating seed may include an agent for assisting the adhesion of the composition to the seed (for example a mineral oil or a film-forming barrier). In a seed treatment a liposomal composition can be applied in an amount of about 0.0001, 0.001, 0.01, 0.1, 1.0, 5, 10, 100, 1,000, 5,000, 10,000 g per 100 kg of seeds. For example from about 0.001 g to about 10 kg per 100 kg of seeds.

### Sprayable Compositions

Examples of spray products of the present disclosure can include field sprayable formulations for agricultural usage and indoor sprays for use in interior spaces in a residential or commercial space. In some embodiments, residual sprays or space sprays comprising a liposome and an insecticidal protein, or an agriculturally acceptable salt thereof, can be used to reduce or eliminate insect pests in an interior space.

Surface spraying indoors (SSI) is the technique of applying a variable volume sprayable volume of an insecticide onto indoor surfaces where vectors rest, such as on walls, windows, floors and ceilings. The primary goal of variable volume sprayable volume is to reduce the lifespan of the insect pest, (for example, a fly, a flea, a tick, or a mosquito vector) and thereby reduce or interrupt disease transmission. The secondary impact is to reduce the density of insect pests within the treatment area. SSI can be used as a method for the control of insect pest vector diseases, such as Lyme disease, Salmonella, Chikungunya virus, Zika virus, and malaria, and can also be used in the management of parasites carried by insect vectors, such as Leishmaniasis and Chagas disease. Many mosquito vectors that harbor Zika virus, Chikungunya virus, and malaria include endophilic mosquito vectors, resting inside houses after taking a blood meal. These mosquitoes are particularly susceptible to control through surface spraying indoors (SSI) with a sprayable composition comprising a liposome and an insecticidal protein, or an agriculturally acceptable salt thereof, and an excipient. As its name implies, SSI involves applying the composition onto the walls and other surfaces of a house with a residual insecticide.

In one embodiment, the composition comprising a liposome and an insecticidal protein, or an agriculturally acceptable salt thereof, and at least one excipient, will knock down insect pests that come in contact with these surfaces. SSI does not directly prevent people from being bitten by mosquitoes. Rather, it usually controls insect pests after they have blood fed, if they come to rest on the sprayed surface. SSI thus prevents transmission of infection to other persons. To be effective, SSI must be applied to a very high proportion of households in an area (usually greater than 40-80 percent). Therefore, sprays in accordance with the disclosure having good residual efficacy and acceptable odor are particularly suited as a component of integrated insect pest vector management or control solutions.

In contrast to SSI, which requires that the active insecticidal protein be bound to surfaces of dwellings, such as walls or ceilings, as with a paint, for example, space spray products of the disclosure rely on the production of a large number of small insecticidal droplets intended to be distributed through a volume of air over a given period of time. When these droplets impact on a target insect pest, they deliver a knockdown effective dose of the insecticidal protein effective to control the insect pest. The traditional methods for generating a space-spray include thermal fogging (whereby a dense cloud of a composition comprising a liposome and an insecticidal protein, or an agriculturally acceptable salt thereof is produced giving the appearance of a thick fog) and Ultra Low Volume (ULV), whereby droplets are produced by a cold, mechanical aerosol-generating machine. Ready-to-use aerosols such as aerosol cans may also be used.

Because large areas can be treated at any one time, the foregoing method is a very effective way to rapidly reduce the population of flying insect pests in a specific area. And, because there is very limited residual activity from the application, it must be repeated at intervals of 5-7 days in order to be fully effective. This method can be particularly effective in epidemic situations where rapid reduction in insect pest numbers is required. As such, it can be used in urban dengue control campaigns.

Effective space-spraying is generally dependent upon the following specific principles. Target insects are usually flying through the spray cloud (or are sometimes impacted whilst resting on exposed surfaces). The efficiency of contact between the spray droplets and target insects is therefore crucial. This is achieved by ensuring that spray droplets remain airborne for the optimum period of time and that they contain the right dose of insecticide. These two issues are largely addressed through optimizing the droplet size. If droplets are too big they drop to the ground too quickly and don't penetrate vegetation or other obstacles encountered during application (limiting the effective area of application). If one of these big droplets impacts an individual insect then it is also “overkill,” because a high dose will be delivered per individual insect. If droplets are too small then they may either not deposit on a target insect (no impaction) due to aerodynamics or they can be carried upwards into the atmosphere by convection currents. The optimum size of droplets for space-spray application are droplets with a Volume Median Diameter (VMD) of 10-25 microns.

In some embodiments, a sprayable liposome composition may contain an amount of liposome-encapsulated insecticidal protein ranging from about 0.005 wt % to about 99 wt %.

### Foams

The active compositions of the present disclosure comprising a liposome and an insecticidal protein, or an agriculturally acceptable salt thereof, and at least one excipient, may be made available in a spray product as an aerosol-based application, including aerosolized foam applications. Pressurized cans are the typical vehicle for the formation of aerosols. An aerosol propellant that is compatible with the liposome composition used. Preferably, a liquefied-gas type propellant is used.

Suitable propellants include compressed air, carbon dioxide, butane and nitrogen. The concentration of the propellant in the active compound composition is from about 5 percent to about 40 percent by weight of the pyridine composition, preferably from about 15 percent to about 30 percent by weight of the comprising a liposome and an insecticidal protein, or an agriculturally acceptable salt thereof, and an excipient.

In one embodiment, formulations comprising a liposome and an insecticidal protein, or an agriculturally acceptable salt thereof can also include one or more foaming agents. Foaming agents that can be used include sodium laureth sulfate, cocamide DEA, and cocamidopropyl betaine. Preferably, the sodium laureth sulfate, cocamide DEA and cocamidopropyl are used in combination. The concentration of the foaming agent(s) in the active compound composition is from about 10 percent to about 25 percent by weight, more preferably 15 percent to 20 percent by weight of the composition.

When such formulations are used in an aerosol application not containing foaming agents, the active compositions of the present disclosure can be used without the need for mixing directly prior to use. However, aerosol formulations containing the foaming agents do require mixing (i.e., shaking) immediately prior to use. In addition, if the formulations containing foaming agents are used for an extended time, they may require additional mixing at periodic intervals during use.

In some embodiments, an aerosolized foam liposome composition may contain an amount of liposome-encapsulated insecticidal protein ranging from about 0.005 wt % to about 99 wt %.

### Burning Formulations

In some embodiments, a dwelling area may also be treated with an liposome composition of the present disclosure by using a burning formulation, such as a candle, a smoke coil or a piece of incense containing the composition. For example, the composition may be formulated into household products such as “heated” air fresheners in which insecticidal compositions are released upon heating, e.g., electrically, or by burning. The active compound compositions of the present disclosure comprising a liposome and an insecticidal protein, or an agriculturally acceptable salt thereof may be made available in a spray product as an aerosol, a mosquito coil, and/or a vaporizer or fogger.

In some embodiments, a burning formulation liposome composition may contain an amount of liposome-encapsulated insecticidal protein ranging from about 0.005 wt % to about 99 wt %.

### Fabric Treatments

In some embodiments, fabrics and garments may be made containing a pesticidal effective composition comprising a liposome and an insecticidal protein, or an agriculturally acceptable salt thereof, and an excipient. In some embodiments, the concentration of the liposome and insecticidal protein in the polymeric material, fiber, yarn, weave, net, or substrate described herein, can be varied within a relatively wide concentration range from, for example, 0.05 to 15 percent by weight, preferably 0.2 to 10 percent by weight, more preferably 0.4 to 8 percent by weight, especially 0.5 to 5, such as 1 to 3, percent by weight.

Similarly, the concentration of the composition comprising a liposome and an insecticidal protein, or an agriculturally acceptable salt thereof, and an excipient (whether for treating surfaces or for coating a fiber, yarn, net, weave) can be varied within a relatively wide concentration range from, for example 0.1 to 70 percent by weight, such as 0.5 to 50 percent by weight, preferably 1 to 40 percent by weight, more preferably 5 to 30 percent by weight, especially 10 to 20 percent by weight.

The concentration of the insecticidal protein may be chosen according to the field of application such that the requirements concerning knockdown efficacy, durability and toxicity are met. Adapting the properties of the material can also be accomplished and so custom-tailored textile fabrics are obtainable in this way.

Accordingly, an effective amount of a liposome and an insecticidal protein, or an agriculturally acceptable salt thereof can depend on the specific use pattern, the insect pest against which control is most desired and the environment in which the liposome composition will be used. Therefore, an effective amount of a liposome and an insecticidal protein, or an agriculturally acceptable salt thereof is sufficient that control of an insect pest is achieved.

In some embodiments, a fabric treated with a liposome composition may contain an amount of liposome-encapsulated insecticidal protein ranging from about 0.005 wt % to about 99 wt %.

### Surface-Treatment Compositions

In some embodiments, the present disclosure provides compositions or formulations comprising: a liposome and an insecticidal protein, or an agriculturally acceptable salt thereof; or a liposome and an insecticidal protein, or an agriculturally acceptable salt thereof, and an excipient; suitable for coating walls, floors and ceilings inside of buildings, and for coating a substrate or non-living material. The inventive compositions comprising a liposome and an insecticidal protein, or an agriculturally acceptable salt thereof, and an excipient, can be prepared using known techniques for the purpose in mind. Preparations of compositions comprising a liposome and an insecticidal protein, could be so formulated to also contain a binder to facilitate the binding of the compound to the surface or other substrate. Agents useful for binding are known in the art and tend to be polymeric in form. The type of binder suitable for a compositions to be applied to a wall surface having particular porosities and/or binding characteristics would be different compared to a fiber, yarn, weave or net-thus, a skilled person, based on known teachings, would select a suitable binder based on the desired surface and/or substrate.

Typical binders are poly vinyl alcohol, modified starch, poly vinyl acrylate, polyacrylic, polyvinyl acetate co polymer, polyurethane, and modified vegetable oils. Suitable binders can include latex dispersions derived from a wide variety of polymers and co-polymers and combinations thereof. Suitable latexes for use as binders in the inventive compositions comprise polymers and copolymers of styrene, alkyl styrenes, isoprene, butadiene, acrylonitrile lower alkyl acrylates, vinyl chloride, vinylidene chloride, vinyl esters of lower carboxylic acids and alpha, beta-ethylenically unsaturated carboxylic acids, including polymers containing three or more different monomer species copolymerized therein, as well as post-dispersed suspensions of silicones or polyurethanes. Also suitable may be a polytetrafluoroethylene (PTFE) polymer for binding the active ingredient to other surfaces.

In some embodiments, a surface treated with a liposome composition may contain an amount of liposome-encapsulated insecticidal protein ranging from about 0.005 wt % to about 99 wt %.

### Dispersants

In some exemplary embodiments, an insecticidal formulation according to the present disclosure may consist of a liposome and an insecticidal protein, or an agriculturally acceptable salt thereof, and an excipient, diluent or carrier (e.g., such as water), a polymeric binder, and/or additional components such as a dispersing agent, a polymerizing agent, an emulsifying agent, a thickener, an alcohol, a fragrance, or any other inert excipients used in the preparation of sprayable insecticides known in the art.

In some embodiments, a composition comprising a liposome and an insecticidal protein, or an agriculturally acceptable salt thereof, and an excipient, can be prepared in a number of different forms or formulation types, such as suspensions or capsules suspensions. And a person skilled in the art can prepare the relevant composition based on the properties of the particular liposome/insecticidal protein combination, its uses, and also its application type. For example, the liposome and insecticidal protein combination used in the methods, embodiments, and other aspects of the present disclosure, may be encapsulated in a suspension or capsule suspension formulation. An encapsulated liposome and insecticidal protein combination can provide improved wash-fastness, and also a longer period of activity. The formulation can be organic based or aqueous based, preferably aqueous based.

In some embodiments, a dispersant liposome composition may contain an amount of insecticidal peptide ranging from about 0.005 wt % to about 99 wt %.

### Microencapsulation

Microencapsulated liposome and insecticidal protein combinations suitable for use in the compositions and methods according to the present disclosure may be prepared with any suitable technique known in the art. For example, various processes for microencapsulating material have been previously developed. These processes can be divided into three categories: physical methods, phase separation, and interfacial reaction. In the physical methods category, microcapsule wall material and core particles are physically brought together and the wall material flows around the core particle to form the microcapsule. In the phase separation category, microcapsules are formed by emulsifying or dispersing the core material in an immiscible continuous phase in which the wall material is dissolved and caused to physically separate from the continuous phase, such as by coacervation, and deposit around the core particles. In the interfacial reaction category, microcapsules are formed by emulsifying or dispersing the core material in an immiscible continuous phase and then an interfacial polymerization reaction is caused to take place at the surface of the core particles. The concentration of the liposome and insecticidal protein combination present in the microcapsules can vary from 0.1 to 60% by weight of the microcapsule.

### Formulations, Dispersants, Kits, and the Ingredients Thereof

The formulation used in the compositions (comprising a liposome and an insecticidal protein, or an agriculturally acceptable salt thereof, and optionally an excipient), methods, embodiments and other aspects according to the present disclosure, may be formed by mixing all ingredients together with water, and optionally using suitable mixing and/or dispersing aggregates. In general, such a formulation is formed at a temperature of from 10 to 70° C., preferably 15 to 50° C., more preferably 20 to 40° C. Generally, a formulation comprising one or more of (A), (B), (C), and/or (D) is possible, wherein it is possible to use: a liposome and an insecticidal protein, or an agriculturally acceptable salt thereof (as a pesticidal liposome and insecticidal protein combination) (A); solid polymer (B); optional additional additives (D); and to disperse them in the aqueous component (C). If a binder is present in a composition of the present disclosure (comprising a liposome and an insecticidal protein, or an agriculturally acceptable salt thereof, and an excipient), it is preferred to use dispersions of the polymeric binder (B) in water as well as aqueous formulations of the liposome and insecticidal protein combination (A) in water which have been separately prepared before. Such separate formulations may contain additional additives for stabilizing (A) and/or (B) in the respective formulations and are commercially available. In a second process step, such raw formulations and optionally additional water (component (C)) are added. Also, combinations of the abovementioned ingredients based on the foregoing scheme are likewise possible, e.g., using a pre-formed dispersion of (A) and/or (B) and mixing it with solid (A) and/or (B). A dispersion of the polymeric binder (B) may be a pre-manufactured dispersion already made by a chemicals manufacturer.

Moreover, it is also within the scope of the present disclosure to use “hand-made” dispersions, i.e., dispersions made in small-scale by an end-user. Such dispersions may be made by providing a mixture of about 20 percent of the binder (B) in water, heating the mixture to temperature of 90° C. to 100° C. and intensively stirring the mixture for several hours. It is possible to manufacture the formulation as a final product so that it can be readily used by the end-user for the process according to the present disclosure. And, it is of course similarly possible to manufacture a concentrate, which may be diluted by the end-user with additional water (C) to the desired concentration for use.

In an embodiment, a composition (comprising a liposome and an insecticidal protein, or an agriculturally acceptable salt thereof, and an excipient) suitable for SSI application or a coating formulation (comprising a liposome and an insecticidal protein, or an agriculturally acceptable salt thereof, and an excipient), contains the active ingredient and a carrier, such as water, and may also one or more co-formulants selected from a dispersant, a wetter, an anti-freeze, a thickener, a preservative, an emulsifier and a binder or sticker.

Furthermore, it may be possible to ship the formulation to the end-user as a kit comprising at least a first component comprising a liposome and an insecticidal protein, or an agriculturally acceptable salt thereof (A); and a second component comprising at least one polymeric binder (B). Further additives (D) may be a third separate component of the kit, or may be already mixed with components (A) and/or (B). The end-user may prepare the formulation for use by just adding water (C) to the components of the kit and mixing. The components of the kit may also be formulations in water. Of course it is possible to combine an aqueous formulation of one of the components with a dry formulation of the other component(s). As an example, the kit can consist of one formulation of a liposome and an insecticidal protein, or an agriculturally acceptable salt thereof (A) and optionally water (C); and a second, separate formulation of at least one polymeric binder (B), water as component (C) and optionally components (D).

The concentrations of the components (A), (B), (C) and optionally (D) will be selected by the skilled artisan depending of the technique to be used for coating/treating. In general, the amount of a liposome and an insecticidal protein, or an agriculturally acceptable salt thereof (A) may be up to 50, preferably 1 to 50, such as 10 to 40, especially 15 to 30, percent by weight, based on weight of the composition. The amount of polymeric binder (B) may be in the range of 0.01 to 30, preferably 0.5 to 15, more preferably 1 to 10, especially 1 to 5, percent by weight, based on weight of the composition. If present, in general the amount of additional components (D) is from 0.1 to 20, preferably 0.5 to 15, percent by weight, based on weight of the composition. If present, suitable amounts of pigments and/or dyestuffs and/or fragrances are in general 0.01 to 5, preferably 0.1 to 3, more preferably 0.2 to 2, percent by weight, based on weight of the composition. A typical formulation ready for use comprises 0.1 to 40, preferably 1 to 30, percent of components (A), (B), and optionally (D), the residual amount being water (C). A typical concentration of a concentrate to be diluted by the end-user may comprise 5 to 70, preferably 10 to 60, percent of components (A), (B), and optionally (D), the residual amount being water (C).

In some embodiments, the components of the liposome composition may be provided separately to be mixed by the end user. For example, in some embodiments, the components required to generate liposomes may be provided with insecticidal peptides, e.g., in the form of a combination.

### Storing Liposomes

After formation and loading of liposomes with one or more insecticidal proteins, the liposomes can be stored according to any one of several methods known in the art.

Proper storage helps liposomes maintain their physical properties and characteristics. And, proper storage can maintain the desired liposome size, and preclude degradation of liposomal constituents. One concern with storage is permeabilization of the membrane, which can lead to leakage of encapsulated material (e.g., an insecticidal protein). Additionally, hydrolytic degradation can also present stability concerns.

In some embodiments, liposomes comprising lipids having ester-linked hydrocarbon chains should be kept refrigerated, as they are susceptible to temperature changes and subsequent hydrolysis.

While liposomes can be frozen, depending on the type of liposome and intended use, an alternative to freezing should be considered; this is because freezing has the potential to rupture or fracture the vesicles, which in turn could lead to a loss of encapsulated content and/or a change in size distribution.

In some embodiments, cryoprotectants can be used for storage of liposomes. For example, in some embodiments, cryoprotectants such as dextrose, sucrose, and trehalose can be used in order to increase stability and preclude hydrolysis.

In some embodiments, liposomes and/or their cargo may experience oxidation upon and/or during storage. Thus, in some embodiments, the addition of small amounts of antioxidants during processing can be used.

In some embodiments, SUVs can be stored above their transition temperature for no longer than around 24 hours.

In other embodiments, LUVs can be stored for longer than 24 hours if stored at 4-8° C. when not in use.

In some embodiments, liposome degradation can occur immediately, and lipid hydrolysis can result in monoacyl derivatives, which have the potential to act as detergents. Accordingly, after around 5-7 days at 4-8° C., the encapsulated contents of the liposome will begin to leak-thus indicating hydrolytic degradation of the lipid.

In some embodiments, liposomes can be stored for longer than 5 to 7 days. For example, in some embodiments, liposomes can stored for 1-2 months with minimal hydrolytic degradation; however, one having ordinary skill will be aware that membrane structure of the liposome may be affected.

In some embodiments, liposomes can be stored for 1-year or longer. For example in some embodiments, liposomes can be stored in 02-free atmosphere, which resists lipid degradation. An exemplary method of long term liposome storage is provided in Hernández-Caselles et al., Stability of liposomes on long term storage. J Pharm Pharmacol. 1990 June; 42(6):397-400, the disclosure of which is incorporated herein by reference in its entirety.

In some embodiments, liposomes can be freeze-dried or lyophilized.

In some embodiments, a liposome can be reconstituted upon contact with water or another liquid. In some embodiments, additional components can be added to the lyophilized or reconstituted liposomes.

For example, in some embodiments, the additional components can include, but are not limited to: water, fertilizer, pesticides, herbicides, weed killers, cryoprotectants, surfactants, detergents, soaps, dormant oils, polymers, and/or time-release or biodegradable carrier formulations that permit long-term dosing of a target area following a single application of the formulation. In some embodiments, one or more of these additional compounds can be prepared, if desired, together with further agriculturally acceptable carriers, surfactants or application-promoting adjuvants customarily employed in the art of formulation. Suitable carriers and adjuvants can be solid or liquid and correspond to the substances ordinarily employed in formulation technology, e.g. natural or regenerated mineral substances, solvents, dispersants, wetting agents, tackifiers, binders or fertilizers. Likewise, the formulations may be prepared into edible “baits” or fashioned into pest “traps” to permit feeding or ingestion by a target pest of the pesticidal formulation.

An exemplary method of preparing liposomes for storage can be found in U.S. Pat. Nos. 4,311,712; 4,962,022; 5,962,015; and U.S. Patent Application No. 20180116209 A1; the disclosures of which are incorporated herein by reference in their entireties.

### Illustrative Liposome Preparations and Compositions

The present disclosure contemplates combinations, mixtures, compositions, and products, that comprise, consist essentially of, consist of, or otherwise contain, one or more liposomes and one or more insecticidal proteins as described herein.

In some embodiments, the illustrative composition comprises, consists essentially of, or consists of: (1) a liposome; and (2) an insecticidal protein, or an agriculturally acceptable salt thereof.

In some embodiments, the illustrative composition comprises, consists essentially of, or consists of: (1) a liposome; (2) an insecticidal protein, or an agriculturally acceptable salt thereof, and (3) at least one excipient (e.g., any of the excipients described herein).

In some embodiments, the combinations, mixtures, or compositions of the present disclosure comprises, consists essentially of, or consists of: (1) a liposome; an insecticidal protein, or an agriculturally acceptable salt thereof, and (2) one or more excipients (e.g., any of the excipients described herein); wherein either of the foregoing (1) or (2) can be used concomitantly, or sequentially.

In some embodiments, an illustrative composition of the present disclosure comprises, consists essentially of, or consists of: (1) a liposome; and (2) a Cysteine Rich Insecticidal Protein (CRIP), or an agriculturally acceptable salt thereof.

In some embodiments, an illustrative composition of the present disclosure comprises, consists essentially of, or consists of: (1) a liposome; and (2) an Inhibitor Cystine Knot (ICK) motif protein, or a non-ICK motif protein.

In some embodiments, an illustrative composition of the present disclosure comprises, consists essentially of, or consists of: (1) a liposome; and (2) an insecticidal protein can be derived, isolated, and/or originating from a spider.

In some embodiments, an illustrative composition of the present disclosure comprises, consists essentially of, or consists of: (1) a liposome; and (2) an insecticidal protein can be derived, isolated, and/or originating from a sea anemone.

In some embodiments, an illustrative composition of the present disclosure comprises, consists essentially of, or consists of: (1) a liposome; and (2) a spider toxin.

In some embodiments, an illustrative composition of the present disclosure comprises, consists essentially of, or consists of: (1) a liposome; and (2) a sea anemone toxin.

In some embodiments, an illustrative composition of the present disclosure comprises, consists essentially of, or consists of: (1) a liposome; and (2) an insecticidal protein that is isolated from Hadronyche versuta (also known as the Blue Mountain funnel web spider), Hadronyche venenata, Atrax robustus, Atrax formidabilis, or Atrax infensus.

In some embodiments, an illustrative composition of the present disclosure comprises, consists essentially of, or consists of: (1) a liposome; and (2) an insecticidal protein that is isolated from Anemonia viridis.

In some embodiments, an illustrative composition of the present disclosure comprises, consists essentially of, or consists of: (1) a liposome; and (2) a Shiga family toxin.

In some embodiments, an illustrative composition of the present disclosure comprises, consists essentially of, or consists of: (1) a liposome; and (2) an ACTX peptide that is encapsulated in the liposome.

In some embodiments, an illustrative composition of the present disclosure comprises, consists essentially of, or consists of: (1) a liposome; and (2) one or more of the following ACTX peptides encapsulated in the liposome: U-ACTX-Hv1a, U+2-ACTX-Hv1a, rU-ACTX-Hv1a, rU-ACTX-Hv1b, rκ-ACTX-Hv1c, ω-ACTX-Hv1a, and/or ω-ACTX-Hv1a+2.

In some embodiments, an illustrative composition of the present disclosure comprises, consists essentially of, or consists of: (1) a liposome; and (2) a U+2-ACTX-Hv1a, having the amino acid sequence

(SEQ ID NO: 1)
“GSQYCVPVDQPCSLNTQPCCDDATCTQERNENGHTVYYCRA”,

encapsulated in the liposome.

In some embodiments, an illustrative composition of the present disclosure comprises, consists essentially of, or consists of: (1) a liposome; and (2) a U-ACTX-Hv1a, having the amino acid sequence

(SEQ ID NO: 2)
“QYCVPVDQPCSLNTQPCCDDATCTQERNENGHTVYYCRA”

encapsulated in the liposome.

In some embodiments, an illustrative composition of the present disclosure comprises, consists essentially of, or consists of: (1) a liposome; and (2) an Omega-ACTX-Hv1a, having the amino acid sequence “SPTCIPSGQPCPYNENCCSQSCTFKENENGNTVKRCD” (SEQ ID NO: 3) encapsulated in the liposome.

In some embodiments, an illustrative composition of the present disclosure comprises, consists essentially of, or consists of: (1) a liposome; and (2) an Omega-ACTX-Hv1a+2, having the amino acid sequence

(SEQ ID NO: 4)
“GSSPTCIPSGQPCPYNENCCSQSCTFKENENGNTVKRCD”

encapsulated in the liposome.

In some embodiments, an illustrative composition of the present disclosure comprises, consists essentially of, or consists of: (1) a liposome; and (2) a Kappa-hexatoxin-Hv1c+2, having the amino acid sequence

(SEQ ID NO: 5)
“GSAICTGADRPCAACCPCCPGTSCKAESNGVSYCRKDEP”

encapsulated in the liposome.

In some embodiments, an illustrative composition of the present disclosure comprises, consists essentially of, or consists of: (1) a liposome; and (2) a Kappa-hexatoxin-Hv1c+2, having the amino acid sequence “AICTGADRPCAACCPCCPGTSCKAESNGVSYCRKDEP” (SEQ ID NO: 8) encapsulated in the liposome.

In some embodiments, an illustrative composition of the present disclosure comprises, consists essentially of, or consists of: (1) a liposome; and (2) an Av3 toxin, having the amino acid sequence “RSCCPCYWGGCPWGQNCYPEGCSGPKV” (SEQ ID NO: 6) encapsulated in the liposome.

In some embodiments, an illustrative composition of the present disclosure comprises, consists essentially of, or consists of: (1) a liposome; and (2) an Av3b variant toxin, having the amino acid sequence “KSCCPCYWGGCPWGQNCYPEGCSGPK” (SEQ ID NO: 7) encapsulated in the liposome.

In some embodiments, an illustrative composition of the present disclosure comprises, consists essentially of, or consists of: (1) a liposome; and (2) one or more insecticidal proteins having an amino acid sequence that is at least 50% identical, at least 55% identical, at least 60% identical, at least 65% identical, at least 70% identical, at least 75% identical, at least 80% identical, at least 81% identical, at least 82% identical, at least 83% identical, at least 84% identical, at least 85% identical, at least 86% identical, at least 87% identical, at least 88% identical, at least 89% identical, at least 90% identical, at least 91% identical, at least 92% identical, at least 93% identical, at least 94% identical, at least 95% identical, at least 96% identical, at least 97% identical, at least 98% identical, at least 99% identical, at least 99.5% identical, at least 99.6% identical, at least 99.7% identical, at least 99.8% identical, at least 99.9% identical, or 100% identical to an amino acid sequence set forth in SEQ ID NOs: 1-8, wherein said insecticidal protein is encapsulated in the liposome.

Any of the combinations, mixtures, compositions, formulations, or products, utilizing a liposome and an insecticidal protein (as described herein), can be used to control pests, their growth, and/or the damage caused by their actions, especially their damage to plants.

Compositions comprising a liposome, an insecticidal protein, or an agriculturally acceptable salt thereof, and at least one excipient, can include agrochemical compositions. For example, in some embodiments, agrochemical compositions can include, but is not limited to, aerosols and/or aerosolized products (e.g., sprays, fumigants, powders, dusts, and/or gases); seed dressings; or oral preparations (e.g., insect food, etc.), as described herein.

In some embodiments, the active ingredients of the present disclosure can be applied in the form of compositions and can be applied to the crop area or plant to be treated, simultaneously or in succession, with other non-active compounds. These non-active compounds can be fertilizers, weed killers, cryoprotectants, surfactants, detergents, soaps, dormant oils, polymers, and/or time-release or biodegradable carrier formulations that permit long-term dosing of a target area following a single application of the formulation. One or more of these non-active compounds can be prepared, if desired, together with further agriculturally acceptable carriers, surfactants or application-promoting adjuvants customarily employed in the art of formulation. Suitable carriers and adjuvants can be solid or liquid and correspond to the substances ordinarily employed in formulation technology, e.g. natural or regenerated mineral substances, solvents, dispersants, wetting agents, tackifiers, binders or fertilizers. Likewise, the formulations may be prepared into edible “baits” or fashioned into pest “traps” to permit feeding or ingestion by a target pest of the pesticidal formulation.

Methods of applying an active ingredient of the present disclosure or an agrochemical composition of the present disclosure that comprises, consists essentially of, or consists of: a liposome comprising an insecticidal protein or agriculturally acceptable salt thereof, wherein the liposome encapsulates the insecticidal protein or agriculturally acceptable salt thereof, and at least one excipient, as produced by the methods described herein of the present disclosure, include leaf application, seed coating, and/or soil application. In some embodiments, the number of applications and the rate of application depend on the intensity of infestation by the corresponding pest.

The composition comprising a liposome, an insecticidal protein or an agriculturally acceptable salt thereof, and at least one excipient may be formulated as a powder, dust, pellet, granule, spray, emulsion, colloid, solution, or such like, and may be prepared by such conventional means as described herein. In all such compositions that contain at least one such liposome-encapsulated insecticidal protein, the liposome-encapsulated insecticidal protein may be present in a concentration of from about 1% to about 99% by weight.

In some embodiments, combinations, mixtures, or compositions comprising, consisting essentially of, or consisting of, a liposome and an insecticidal protein (or an agriculturally acceptable salt thereof) may be prophylactically applied to an environmental area to prevent infestation by a susceptible pest, for example, a lepidopteran and/or coleopteran pest, which may be killed or reduced in numbers in a given area by the methods of the disclosure. In some embodiments, the pest ingests, or comes into contact with, a pesticidally-effective amount of the polypeptide.

Any of the foregoing formulations and methods of making the same can be prepared using any of the liposomes as described herein, and any of the insecticidal proteins as described herein. For example, any of the formulations or compositions described above can be used for any type of liposome and/or size of liposome (e.g., SUV, LUV, GUV, OLV, MLV, MVV, SPLV, MPV, FATMLV, amphoteric liposomes; or conventional liposomes; fusogenic liposomes; pH sensitive liposomes; cationic liposomes; thermosensitive liposomes; or immune liposomes); and any insecticidal protein as described herein (e.g., a CRIP).

In some embodiments, liposomes in a composition of the present disclosure can be multilamellar.

In some embodiments, liposomes of the present disclosure can be dumbbell in shape or dumbbell-shaped. Shape changes in liposomes is discussed in Kas et al., Shape transitions and shape stability of giant phospholipid vesicles in pure water induced by area-to-volume changes. Biophys J. 1991 October; 60(4): 825-844, the disclosure of which is incorporated herein by reference in its entirety.

In some embodiments, a liposome composition of the present disclosure can comprise, consist essentially of, or consist of: vesicles having one type of lamellarity. For example, in some embodiments, a liposome preparation of the present disclosure can comprise, consist essentially of, or consist of, vesicles wherein all the vesicles are, e.g., unilamellar. In other embodiments, a liposome preparation of the present disclosure can comprise, consist essentially of, or consist of, vesicles wherein all the vesicles are, e.g., multilamellar.

In some embodiments, a liposome composition of the present disclosure can comprise, consist essentially of, or consist of, vesicles having one or more lamellarities. For example, in some embodiments, a liposome composition of the present disclosure can comprise, consist essentially of, or consist of, vesicles that are, e.g., unilamellar and multilamellar.

In some embodiments a liposome composition of the present disclosure can comprise, consist essentially of, or consist of: a plurality of vesicles having two or more lamellarities, wherein the lamellarities of the vesicles are selected from are any lamellarity described herein.

In some embodiments, a liposome preparation comprises, consists essentially of, or consists of: a liposome comprising an insecticidal protein or agriculturally acceptable salt thereof, wherein the liposome encapsulates the insecticidal protein or agriculturally acceptable salt thereof.

In some embodiments, a liposome preparation comprises, consists essentially of, or consists of: a liposome comprising an insecticidal protein or agriculturally acceptable salt thereof, wherein the liposome encapsulates the insecticidal protein or agriculturally acceptable salt thereof; and wherein the liposome comprises lecithin.

In some embodiments, liposomes of the present disclosure can comprise, consist essentially of, or consist of, a unilamellar vesicle having a diameter of less than 100 nm.

In some embodiments, liposomes of the present disclosure can comprise, consist essentially of, or consist of, a unilamellar vesicle having a diameter greater than 100 nm.

In some embodiments, liposomes of the present disclosure can comprise, consist essentially of, or consist of, a vesicle, e.g., a unilamellar or a multilamellar vesicle, wherein said vesicle has a diameter of: 10 nm; 11 nm; 12 nm; 13 nm; 14 nm; 15 nm; 16 nm; 17 nm; 18 nm; 19 nm; 20 nm; 21 nm; 22 nm; 23 nm; 24 nm; 25 nm; 26 nm; 27 nm; 28 nm; 29 nm; 30 nm; 31 nm; 32 nm; 33 nm; 34 nm; 35 nm; 36 nm; 37 nm; 38 nm; 39 nm; 40 nm; 41 nm; 42 nm; 43 nm; 44 nm; 45 nm; 46 nm; 47 nm; 48 nm; 49 nm; 50 nm; 51 nm; 52 nm; 53 nm; 54 nm; 55 nm; 56 nm; 57 nm; 58 nm; 59 nm; 60 nm; 61 nm; 62 nm; 63 nm; 64 nm; 65 nm; 66 nm; 67 nm; 68 nm; 69 nm; 70 nm; 71 nm; 72 nm; 73 nm; 74 nm; 75 nm; 76 nm; 77 nm; 78 nm; 79 nm; 80 nm; 81 nm; 82 nm; 83 nm; 84 nm; 85 nm; 86 nm; 87 nm; 88 nm; 89 nm; 90 nm; 91 nm; 92 nm; 93 nm; 94 nm; 95 nm; 96 nm; 97 nm; 98 nm; 99 nm; 100 nm; 101 nm; 102 nm; 103 nm; 104 nm; 105 nm; 106 nm; 107 nm; 108 nm; 109 nm; 110 nm; 111 nm; 112 nm; 113 nm; 114 nm; 115 nm; 116 nm; 117 nm; 118 nm; 119 nm; 120 nm; 121 nm; 122 nm; 123 nm; 124 nm; 125 nm; 126 nm; 127 nm; 128 nm; 129 nm; 130 nm; 131 nm; 132 nm; 133 nm; 134 nm; 135 nm; 136 nm; 137 nm; 138 nm; 139 nm; 140 nm; 141 nm; 142 nm; 143 nm; 144 nm; 145 nm; 146 nm; 147 nm; 148 nm; 149 nm; 150 nm; 151 nm; 152 nm; 153 nm; 154 nm; 154 nm; 154.01 nm; 154.02 nm; 154.03 nm; 154.04 nm; 154.05 nm; 154.06 nm; 154.07 nm; 154.08 nm; 154.09 nm; 154.1 nm; 154.11 nm; 154.12 nm; 154.13 nm; 154.14 nm; 154.15 nm; 154.16 nm; 154.17 nm; 154.18 nm; 154.19 nm; 154.2 nm; 154.21 nm; 154.22 nm; 154.23 nm; 154.24 nm; 154.25 nm; 154.26 nm; 154.27 nm; 154.28 nm; 154.29 nm; 154.3 nm; 154.31 nm; 154.32 nm; 154.33 nm; 154.34 nm; 154.35 nm; 154.36 nm; 154.37 nm; 154.38 nm; 154.39 nm; 154.4 nm; 154.41 nm; 154.42 nm; 154.43 nm; 154.44 nm; 154.45 nm; 154.46 nm; 154.47 nm; 154.48 nm; 154.49 nm; 154.5 nm; 154.51 nm; 154.52 nm; 154.53 nm; 154.54 nm; 154.55 nm; 154.56 nm; 154.57 nm; 154.58 nm; 154.59 nm; 154.6 nm; 154.61 nm; 154.62 nm; 154.63 nm; 154.64 nm; 154.65 nm; 154.66 nm; 154.67 nm; 154.68 nm; 154.69 nm; 154.7 nm; 154.71 nm; 154.72 nm; 154.73 nm; 154.74 nm; 154.75 nm; 154.76 nm; 154.77 nm; 154.78 nm; 154.79 nm; 154.8 nm; 154.81 nm; 154.82 nm; 154.83 nm; 154.84 nm; 154.85 nm; 154.86 nm; 154.87 nm; 154.88 nm; 154.89 nm; 154.9 nm; 154.91 nm; 154.92 nm; 154.93 nm; 154.94 nm; 154.95 nm; 154.96 nm; 154.97 nm; 154.98 nm; 154.99 nm; 155 nm; 155.01 nm; 155.02 nm; 155.03 nm; 155.04 nm; 155.05 nm; 155.06 nm; 155.07 nm; 155.08 nm; 155.09 nm; 155.1 nm; 155.11 nm; 155.12 nm; 155.13 nm; 155.14 nm; 155.15 nm; 155.16 nm; 155.17 nm; 155.18 nm; 155.19 nm; 155.2 nm; 155.21 nm; 155.22 nm; 155.23 nm; 155.24 nm; 155.25 nm; 155.26 nm; 155.27 nm; 155.28 nm; 155.29 nm; 155.3 nm; 155.31 nm; 155.32 nm; 155.33 nm; 155.34 nm; 155.35 nm; 155.36 nm; 155.37 nm; 155.38 nm; 155.39 nm; 155.4 nm; 155.41 nm; 155.42 nm; 155.43 nm; 155.44 nm; 155.45 nm; 155.46 nm; 155.47 nm; 155.48 nm; 155.49 nm; 155.5 nm; 155.51 nm; 155.52 nm; 155.53 nm; 155.54 nm; 155.55 nm; 155.56 nm; 155.57 nm; 155.58 nm; 155.59 nm; 155.6 nm; 155.61 nm; 155.62 nm; 155.63 nm; 155.64 nm; 155.65 nm; 155.66 nm; 155.67 nm; 155.68 nm; 155.69 nm; 155.7 nm; 155.71 nm; 155.72 nm; 155.73 nm; 155.74 nm; 155.75 nm; 155.76 nm; 155.77 nm; 155.78 nm; 155.79 nm; 155.8 nm; 155.81 nm; 155.82 nm; 155.83 nm; 155.84 nm; 155.85 nm; 155.86 nm; 155.87 nm; 155.88 nm; 155.89 nm; 155.9 nm; 155.91 nm; 155.92 nm; 155.93 nm; 155.94 nm; 155.95 nm; 155.96 nm; 155.97 nm; 155.98 nm; 155.99 nm; 156 nm; 157 nm; 158 nm; 159 nm; 160 nm; 161 nm; 162 nm; 163 nm; 164 nm; 165 nm; 166 nm; 167 nm; 168 nm; 169 nm; 170 nm; 171 nm; 172 nm; 173 nm; 174 nm; 175 nm; 176 nm; 177 nm; 178 nm; 179 nm; 180 nm; 181 nm; 182 nm; 183 nm; 184 nm; 185 nm; 186 nm; 187 nm; 188 nm; 189 nm; 190 nm; 191 nm; 192 nm; 193 nm; 194 nm; 195 nm; 196 nm; 197 nm; 198 nm; 199 nm; 200 nm; 201 nm; 202 nm; 203 nm; 204 nm; 205 nm; 206 nm; 207 nm; 208 nm; 209 nm; 210 nm; 211 nm; 212 nm; 213 nm; 214 nm; 215 nm; 216 nm; 217 nm; 218 nm; 219 nm; 220 nm; 221 nm; 222 nm; 223 nm; 224 nm; 225 nm; 226 nm; 227 nm; 228 nm; 229 nm; 230 nm; 231 nm; 232 nm; 233 nm; 234 nm; 235 nm; 236 nm; 237 nm; 238 nm; 239 nm; 240 nm; 241 nm; 242 nm; 243 nm; 244 nm; 245 nm; 246 nm; 247 nm; 248 nm; 249 nm; 250 nm; 251 nm; 252 nm; 253 nm; 254 nm; 255 nm; 256 nm; 257 nm; 258 nm; 259 nm; 260 nm; 261 nm; 262 nm; 263 nm; 264 nm; 265 nm; 266 nm; 267 nm; 268 nm; 269 nm; 270 nm; 271 nm; 272 nm; 273 nm; 274 nm; 275 nm; 276 nm; 277 nm; 278 nm; 279 nm; 280 nm; 281 nm; 282 nm; 283 nm; 284 nm; 285 nm; 286 nm; 287 nm; 288 nm; 289 nm; 290 nm; 291 nm; 292 nm; 293 nm; 294 nm; 295 nm; 296 nm; 297 nm; 298 nm; 299 nm; 300 nm; 301 nm; 302 nm; 303 nm; 304 nm; 305 nm; 306 nm; 307 nm; 308 nm; 309 nm; 310 nm; 311 nm; 312 nm; 313 nm; 314 nm; 315 nm; 316 nm; 317 nm; 318 nm; 319 nm; 320 nm; 321 nm; 322 nm; 323 nm; 324 nm; 325 nm; 326 nm; 327 nm; 328 nm; 329 nm; 330 nm; 331 nm; 332 nm; 333 nm; 334 nm; 335 nm; 336 nm; 337 nm; 338 nm; 339 nm; 340 nm; 341 nm; 342 nm; 343 nm; 344 nm; 345 nm; 346 nm; 347 nm; 348 nm; 349 nm; 350 nm; 351 nm; 352 nm; 353 nm; 354 nm; 355 nm; 356 nm; 357 nm; 358 nm; 359 nm; 360 nm; 361 nm; 362 nm; 363 nm; 364 nm; 365 nm; 366 nm; 367 nm; 368 nm; 369 nm; 370 nm; 371 nm; 372 nm; 373 nm; 374 nm; 375 nm; 376 nm; 377 nm; 378 nm; 379 nm; 380 nm; 381 nm; 382 nm; 383 nm; 384 nm; 385 nm; 386 nm; 387 nm; 388 nm; 389 nm; 390 nm; 391 nm; 392 nm; 393 nm; 394 nm; 395 nm; 396 nm; 397 nm; 398 nm; 399 nm; 400 nm; 401 nm; 402 nm; 403 nm; 404 nm; 405 nm; 406 nm; 407 nm; 408 nm; 409 nm; 410 nm; 411 nm; 412 nm; 413 nm; 414 nm; 415 nm; 416 nm; 417 nm; 418 nm; 419 nm; 420 nm; 421 nm; 422 nm; 423 nm; 424 nm; 425 nm; 426 nm; 427 nm; 428 nm; 429 nm; 430 nm; 431 nm; 432 nm; 433 nm; 434 nm; 435 nm; 436 nm; 437 nm; 438 nm; 439 nm; 440 nm; 441 nm; 442 nm; 443 nm; 444 nm; 445 nm; 446 nm; 447 nm; 448 nm; 449 nm; 450 nm; 451 nm; 452 nm; 453 nm; 454 nm; 455 nm; 456 nm; 457 nm; 458 nm; 459 nm; 460 nm; 461 nm; 462 nm; 463 nm; 464 nm; 465 nm; 466 nm; 467 nm; 468 nm; 469 nm; 470 nm; 471 nm; 472 nm; 473 nm; 474 nm; 475 nm; 476 nm; 477 nm; 478 nm; 479 nm; 480 nm; 481 nm; 482 nm; 483 nm; 484 nm; 485 nm; 486 nm; 487 nm; 488 nm; 489 nm; 490 nm; 491 nm; 492 nm; 493 nm; 494 nm; 495 nm; 496 nm; 497 nm; 498 nm; 499 nm; or 500 nm, or any value in between.

In some embodiments, liposomes of the present disclosure can comprise, consist essentially of, or consist of, a unilamellar vesicle having a diameter of 20-100 nm.

In some embodiments, liposomes of the present disclosure can comprise, consist essentially of, or consist of, a unilamellar vesicle having a diameter of 20-50 nm.

In some embodiments, liposomes of the present disclosure can comprise, consist essentially of, or consist of, a unilamellar vesicle having a diameter of 50-100 nm.

In some embodiments, liposomes of the present disclosure can comprise, consist essentially of, or consist of, a unilamellar vesicle having a diameter of from about 30 nm to about 90 nm.

In some embodiments, liposomes of the present disclosure can comprise, consist essentially of, or consist of, a unilamellar vesicle having a diameter of from about 30 nm to about 90 nm.

In some embodiments, liposomes of the present disclosure can comprise, consist essentially of, or consist of, a unilamellar vesicle having a diameter of about 39.5 nm.

In some embodiments, liposomes of the present disclosure can comprise, consist essentially of, or consist of, a unilamellar vesicle having a diameter of about 85.6 nm.

In some embodiments, liposomes of the present disclosure can comprise, consist essentially of, or consist of, a multilamellar vesicle having a diameter of from about 50 nm to about 200 nm.

In some embodiments, liposomes of the present disclosure can comprise, consist essentially of, or consist of, a multilamellar vesicle having a diameter of from about 100 nm to about 200 nm.

In some embodiments, liposomes of the present disclosure can comprise, consist essentially of, or consist of, a multilamellar vesicle having a diameter of from about 117 nm to about 137 nm.

In some embodiments, liposomes of the present disclosure can comprise, consist essentially of, or consist of, a multilamellar vesicle having a diameter of about 117.9 nm.

In some embodiments, liposomes of the present disclosure can comprise, consist essentially of, or consist of, a multilamellar vesicle having a diameter of about 136.5 nm to about 136.9 nm.

In some embodiments a liposome preparation of the present disclosure can comprise, consist essentially of, or consist of, a plurality of vesicles, wherein the vesicles are the same size.

In some embodiments a liposome preparation of the present disclosure can comprise, consist essentially of, or consist of, a plurality of vesicles, wherein the vesicles are of a different same size from one another.

In some embodiments a liposome preparation of the present disclosure can comprise, consist essentially of, or consist of, a plurality of vesicles, wherein the vesicles are one or more sizes selected from are any size described herein.

In some embodiments a liposome preparation of the present disclosure can comprise, consist essentially of, or consist of, a plurality of vesicles, wherein the vesicles are 20-50 nm; 50-100 nm; greater than 100 nm; or any combination thereof.

In some embodiments a liposome preparation of the present disclosure can comprise, consist essentially of, or consist of, a plurality of vesicles, wherein the vesicles are 20-50 nm; 50-100 nm; and greater than 100 nm.

In some embodiments a liposome preparation of the present disclosure can comprise, consist essentially of, or consist of, a plurality of vesicles, wherein the vesicles are from about 40-60% vesicles having a diameter of 20-50 nm; 40-50% vesicles having a diameter of 50-100 nm; and 1-2% vesicles having diameter of >100 nm.

In some embodiments a liposome preparation of the present disclosure can comprise, consist essentially of, or consist of, a plurality of vesicles, wherein the vesicles are from about 40-60% unilamellar vesicles having a diameter of 20-50 nm; 40-50% unilamellar vesicles having a diameter of 50-100 nm; and 1-2% unilamellar vesicles having diameter of >100 nm.

In some embodiments a liposome preparation of the present disclosure can comprise, consist essentially of, or consist of, a plurality of vesicles, wherein the vesicles are 57.89% unilamellar vesicles having a diameter of 20-50 nm; 41.52% unilamellar vesicles having a diameter of 50-100 nm; and 0.59% unilamellar vesicles having diameter of >100 nm.

In some embodiments a liposome preparation of the present disclosure can comprise, consist essentially of, or consist of, a plurality of vesicles, wherein the vesicles have an average diameter of from about 10 nm to about 1000; from about 20 nm to about 1000; from about 30 nm to about 1000; from about 40 nm to about 1000; from about 50 nm to about 1000; from about 60 nm to about 1000; from about 70 nm to about 1000; from about 80 nm to about 1000; from about 90 nm to about 1000; from about 100 nm to about 1000; from about 110 nm to about 1000; from about 120 nm to about 1000; from about 130 nm to about 1000; from about 140 nm to about 1000; from about 150 nm to about 1000; from about 160 nm to about 1000; from about 170 nm to about 1000; from about 180 nm to about 1000; from about 190 nm to about 1000; from about 200 nm to about 1000; from about 210 nm to about 1000; from about 220 nm to about 1000; from about 230 nm to about 1000; from about 240 nm to about 1000; from about 250 nm to about 1000; from about 260 nm to about 1000; from about 270 nm to about 1000; from about 280 nm to about 1000; from about 290 nm to about 1000; from about 300 nm to about 1000; from about 310 nm to about 1000; from about 320 nm to about 1000; from about 330 nm to about 1000; from about 340 nm to about 1000; from about 350 nm to about 1000; from about 360 nm to about 1000; from about 370 nm to about 1000; from about 380 nm to about 1000; from about 390 nm to about 1000; from about 400 nm to about 1000; from about 410 nm to about 1000; from about 420 nm to about 1000; from about 430 nm to about 1000; from about 440 nm to about 1000; from about 450 nm to about 1000; from about 460 nm to about 1000; from about 470 nm to about 1000; from about 480 nm to about 1000; from about 490 nm to about 1000; from about 500 nm to about 1000; from about 510 nm to about 1000; from about 520 nm to about 1000; from about 530 nm to about 1000; from about 540 nm to about 1000; from about 550 nm to about 1000; from about 560 nm to about 1000; from about 570 nm to about 1000; from about 580 nm to about 1000; from about 590 nm to about 1000; from about 600 nm to about 1000; from about 610 nm to about 1000; from about 620 nm to about 1000; from about 630 nm to about 1000; from about 640 nm to about 1000; from about 650 nm to about 1000; from about 660 nm to about 1000; from about 670 nm to about 1000; from about 680 nm to about 1000; from about 690 nm to about 1000; from about 700 nm to about 1000; from about 710 nm to about 1000; from about 720 nm to about 1000; from about 730 nm to about 1000; from about 740 nm to about 1000; from about 750 nm to about 1000; from about 760 nm to about 1000; from about 770 nm to about 1000; from about 780 nm to about 1000; from about 790 nm to about 1000; from about 800 nm to about 1000; from about 810 nm to about 1000; from about 820 nm to about 1000; from about 830 nm to about 1000; from about 840 nm to about 1000; from about 850 nm to about 1000; from about 860 nm to about 1000; from about 870 nm to about 1000; from about 880 nm to about 1000; from about 890 nm to about 1000; from about 900 nm to about 1000; from about 910 nm to about 1000; from about 920 nm to about 1000; from about 930 nm to about 1000; from about 940 nm to about 1000; from about 950 nm to about 1000; from about 960 nm to about 1000; from about 970 nm to about 1000; from about 980 nm to about 1000; or from about 990 nm to about 1000, or any value in between.

In some embodiments a liposome preparation of the present disclosure can comprise, consist essentially of, or consist of, a plurality of vesicles, wherein the vesicles have an average diameter of: about 100 nm; about 101 nm; about 102 nm; about 103 nm; about 104 nm; about 105 nm; about 106 nm; about 107 nm; about 108 nm; about 109 nm; about 110 nm; about 111 nm; about 112 nm; about 113 nm; about 114 nm; about 115 nm; about 116 nm; about 117 nm; about 118 nm; about 119 nm; about 120 nm; about 121 nm; about 122 nm; about 123 nm; about 124 nm; about 125 nm; about 126 nm; about 127 nm; about 128 nm; about 129 nm; about 130 nm; about 131 nm; about 132 nm; about 133 nm; about 134 nm; about 135 nm; about 136 nm; about 137 nm; about 138 nm; about 139 nm; about 140 nm; about 141 nm; about 142 nm; about 143 nm; about 144 nm; about 145 nm; about 146 nm; about 147 nm; about 148 nm; about 149 nm; about 150 nm; about 151 nm; about 152 nm; about 153 nm; about 154 nm; about 155 nm; about 156 nm; about 157 nm; about 158 nm; about 159 nm; about 160 nm; about 161 nm; about 162 nm; about 163 nm; about 164 nm; about 165 nm; about 166 nm; about 167 nm; about 168 nm; about 169 nm; about 170 nm; about 171 nm; about 172 nm; about 173 nm; about 174 nm; about 175 nm; about 176 nm; about 177 nm; about 178 nm; about 179 nm; about 180 nm; about 181 nm; about 182 nm; about 183 nm; about 184 nm; about 185 nm; about 186 nm; about 187 nm; about 188 nm; about 189 nm; about 190 nm; about 191 nm; about 192 nm; about 193 nm; about 194 nm; about 195 nm; about 196 nm; about 197 nm; about 198 nm; about 199 nm; or about 200 nm.

In some embodiments a liposome preparation of the present disclosure can comprise, consist essentially of, or consist of, a plurality of vesicles, wherein the vesicles have an average diameter of about 155.2 nm.

In some embodiments, a liposome preparation of the present disclosure can comprise, consist essentially of, or consist of, a soy lecithin content of from about 20-50%.

In some embodiments, a liposome preparation of the present disclosure can comprise, consist essentially of, or consist of, a soy lecithin content of from about 20-40%.

In some embodiments, a liposome preparation of the present disclosure can comprise, consist essentially of, or consist of, a soy lecithin content of from about 20-30%.

In some embodiments, a liposome preparation of the present disclosure can comprise, consist essentially of, or consist of, a soy lecithin content of about 20%; 20.1%; 20.2%; 20.3%; 20.4%; 20.5%; 20.6%; 20.7%; 20.8%; 20.9%; 21%; 21.1%; 21.2%; 21.3%; 21.4%; 21.5%; 21.6%; 21.7%; 21.8%; 21.9%; 22%; 22.1%; 22.2%; 22.3%; 22.4%; 22.5%; 22.6%; 22.7%; 22.8%; 22.9%; 23%; 23.1%; 23.2%; 23.3%; 23.4%; 23.5%; 23.6%; 23.7%; 23.8%; 23.9%; 24%; 24.1%; 24.2%; 24.3%; 24.4%; 24.5%; 24.6%; 24.7%; 24.8%; 24.9%; 25%; 25.1%; 25.2%; 25.3%; 25.4%; 25.5%; 25.6%; 25.7%; 25.8%; 25.9%; 26%; 26.1%; 26.2%; 26.3%; 26.4%; 26.5%; 26.6%; 26.7%; 26.8%; 26.9%; 27%; 27.1%; 27.2%; 27.3%; 27.4%; 27.5%; 27.6%; 27.7%; 27.8%; 27.9%; 28%; 28.1%; 28.2%; 28.3%; 28.4%; 28.5%; 28.6%; 28.7%; 28.8%; 28.9%; 29%; 29.1%; 29.2%; 29.3%; 29.4%; 29.5%; 29.6%; 29.7%; 29.8%; 29.9%; or about 30%.

In some embodiments, a liposome preparation of the present disclosure can comprise, consist essentially of, or consist of, a soy lecithin content of about 27.01%; 27.02%; 27.03%; 27.04%; 27.05%; 27.06%; 27.07%; 27.08%; 27.09%; 27.1%; 27.11%; 27.12%; 27.13%; 27.14%; 27.15%; 27.16%; 27.17%; 27.18%; 27.19%; 27.2%; 27.21%; 27.22%; 27.23%; 27.24%; 27.25%; 27.26%; 27.27%; 27.28%; 27.29%; 27.3%; 27.31%; 27.32%; 27.33%; 27.34%; 27.35%; 27.36%; 27.37%; 27.38%; 27.39%; 27.4%; 27.41%; 27.42%; 27.43%; 27.44%; 27.45%; 27.46%; 27.47%; 27.48%; 27.49%; 27.5%; 27.51%; 27.52%; 27.53%; 27.54%; 27.55%; 27.56%; 27.57%; 27.58%; 27.59%; 27.6%; 27.61%; 27.62%; 27.63%; 27.64%; 27.65%; 27.66%; 27.67%; 27.68%; 27.69%; 27.7%; 27.71%; 27.72%; 27.73%; 27.74%; 27.75%; 27.76%; 27.77%; 27.78%; 27.79%; 27.8%; 27.81%; 27.82%; 27.83%; 27.84%; 27.85%; 27.86%; 27.87%; 27.88%; 27.89%; 27.9%; 27.91%; 27.92%; 27.93%; 27.94%; 27.95%; 27.96%; 27.97%; 27.98%; 27.99%; or 28%.

In some embodiments, a liposome preparation of the present disclosure can comprise, consist essentially of, or consist of, a soy lecithin content of 27.5%.

In some embodiments, a liposome preparation of the present disclosure can be used to combat a pest selected from, and/or protect a plant from, a pest belonging to the following order: Lepidoptera, Diptera, or Coleoptera.

In some embodiments, a liposome preparation of the present disclosure can be used to combat a pest selected from, and/or protect a plant from, a pest belonging to the following family: Noctuidae, Muscidae, or Scarabaeidae.

In some embodiments, a liposome preparation of the present disclosure can be used to combat and/or protect a plant from Helicoverpa zea (common name: corn earworm, CEW).

In some embodiments, a liposome preparation of the present disclosure can be used to combat and/or protect a plant from Musca domestica.

In some embodiments, a liposome preparation of the present disclosure can be used to combat and/or protect a plant from Popillia japonica.

Any of the foregoing liposomes, liposome preparations, liposome formulations, or liposome compositions comprising: a liposome comprising an insecticidal protein or agriculturally acceptable salt thereof, wherein the liposome encapsulates the insecticidal protein or agriculturally acceptable salt thereof, and optionally comprising one or more excipients; can be can be applied to: (1) a pest, a locus of the pest, a food supply of the pest, a habitat of the pest, or a breeding ground of the pest; (2) a plant, a seed, a plant part, a locus of a plant, or an environment of a plant that is susceptible to an attack by the pest (e.g., crop area or plant to be treated); (3) an animal, a locus of an animal, or an environment of an animal susceptible to an attack by the pest; or (4) a combination thereof, simultaneously or in succession, with other compounds. For example, in some embodiments, these compounds can be fertilizers, weed killers, cryoprotectants, surfactants, detergents, pesticidal soaps, dormant oils, polymers, and/or time-release or biodegradable carrier formulations that permit long-term dosing of a target area following a single application of the formulation. The other compounds can also be selective herbicides, chemical insecticides, virucides, microbicides, amoebicides, pesticides, fungicides, bacteriocides, nematocides, molluscicides or mixtures of several of these preparations, if desired, together with further agriculturally acceptable carriers, surfactants or application-promoting adjuvants customarily employed in the art of formulation. In some embodiments, suitable carriers and adjuvants can be solid or liquid, and correspond to the substances ordinarily employed in formulation technology, e.g. natural or regenerated mineral substances, solvents, dispersants, wetting agents, tackifiers, binders or fertilizers. Likewise, any of the foregoing mixtures, compositions, or formulations may be prepared into edible “baits” or fashioned into pest “traps” to permit feeding or ingestion by a target pest of the pesticidal formulation.

### Methods of Using the Present Disclosure

### Methods for Protecting Plants, Plant Parts, and Seeds

In some embodiments, the present disclosure provides a method of combating, controlling, or inhibiting a pest comprising, applying a pesticidally effective amount of: (1) a liposome comprising an insecticidal protein or agriculturally acceptable salt thereof, wherein the liposome encapsulates the insecticidal protein or agriculturally acceptable salt thereof, and/or (2) a liposome comprising an insecticidal protein or agriculturally acceptable salt thereof, and at least one excipient, wherein the liposome encapsulates the insecticidal protein or agriculturally acceptable salt thereof; to the pest, a locus of the pest, a food supply of the pest, a habitat of the pest, or a breeding ground of the pest; a plant, a seed, a plant part, a locus of a plant, or an environment of a plant that is susceptible to an attack by the pest; an animal, a locus of an animal, or an environment of an animal susceptible to an attack by the pest; or a combination thereof.

In some embodiments, the present disclosure provides a method of protecting a plant comprising, applying a pesticidally effective amount of: (1) a liposome comprising an insecticidal protein or agriculturally acceptable salt thereof, wherein the liposome encapsulates the insecticidal protein or agriculturally acceptable salt thereof, and/or (2) a liposome comprising an insecticidal protein or agriculturally acceptable salt thereof, and at least one excipient, wherein the liposome encapsulates the insecticidal protein or agriculturally acceptable salt thereof, to the pest, a locus of the pest, a food supply of the pest, a habitat of the pest, or a breeding ground of the pest; a plant, a seed, a plant part, a locus of a plant, or an environment of a plant that is susceptible to an attack by the pest; or a combination thereof.

In some embodiments, the present disclosure provides a method for controlling an invertebrate pest in agronomic and/or nonagronomic applications, comprising contacting the invertebrate pest or its environment, a solid surface, including a plant surface or part thereof, with a biologically effective amount of a composition comprising, consisting essentially of, or consisting of: (1) a liposome comprising an insecticidal protein or agriculturally acceptable salt thereof, wherein the liposome encapsulates the insecticidal protein or agriculturally acceptable salt thereof; and/or (2) a liposome comprising an insecticidal protein or agriculturally acceptable salt thereof, and at least one excipient, wherein the liposome encapsulates the insecticidal protein or agriculturally acceptable salt thereof.

In some embodiments, the present disclosure provides a method for controlling an invertebrate pest in agronomic and/or nonagronomic applications, comprising contacting the invertebrate pest or its environment, a solid surface, including a plant surface or part thereof, with a biologically effective amount of a composition comprising, consisting essentially of, or consisting of: (1) a liposome comprising an insecticidal protein or agriculturally acceptable salt thereof, wherein the liposome encapsulates the insecticidal protein or agriculturally acceptable salt thereof; and/or (2) a liposome comprising an insecticidal protein or agriculturally acceptable salt thereof, and at least one excipient, wherein the liposome encapsulates the insecticidal protein or agriculturally acceptable salt thereof.

Examples of suitable combinations, mixtures, and compositions of the present disclosure comprising, consisting essentially of, or consisting of: (1) a liposome; (2) an insecticidal protein; and (3) optionally an excipient; include without limitation: combinations, mixtures, and compositions formulated with inactive ingredients to be delivered in the form of: a liquid solution, an emulsion, a powder, a granule, a nanoparticle, a microparticle, or a combination thereof.

In some embodiments, one or more of: (1) a liposome comprising an insecticidal protein or agriculturally acceptable salt thereof, wherein the liposome encapsulates the insecticidal protein or agriculturally acceptable salt thereof, and/or (2) a liposome comprising an insecticidal protein or agriculturally acceptable salt thereof, and at least one excipient, wherein the liposome encapsulates the insecticidal protein or agriculturally acceptable salt thereof, can be formulated with one or more inactive ingredients to be delivered in the form of: a solution, an emulsion, a powder, a dust, a pellet, a granule, a spray, or a colloid.

In some embodiments, to achieve contact with a combination, compound, mixture, or composition of the present disclosure, to protect a field crop from invertebrate pests, the composition is typically applied to the seed of the crop before planting, to the foliage (e.g., leaves, stems, flowers, fruits) of crop plants, or to the soil or other growth medium before or after the crop is planted.

One embodiment of a method of contact is by spraying. Alternatively, a granular composition comprising a liposome and an insecticidal protein, or an agriculturally acceptable salt thereof, and optionally an excipient, can be applied to the plant foliage or the soil. Compounds of this disclosure can also be effectively delivered through plant uptake by contacting the plant with a composition comprising a compound of this disclosure applied as a soil drench of a liquid formulation, a granular formulation to the soil, a nursery box treatment or a dip of transplants. Of note is a composition of the present disclosure in the form of a soil drench liquid formulation. Also of note is a method for controlling an invertebrate pest comprising contacting the invertebrate pest or its environment with a biologically effective amount of a liposome and an insecticidal protein. Of further note, in some illustrative embodiments, the illustrative method contemplates a soil environment, wherein the composition is applied to the soil as a soil drench formulation. Of further note is that a liposome, and an insecticidal protein, or an agriculturally acceptable salt thereof, is also effective by localized application to the locus of infestation. Other methods of contact include application of a compound or a composition of the disclosure by direct and residual sprays, aerial sprays, gels, seed coatings, microencapsulations, systemic uptake, baits, ear tags, boluses, foggers, fumigants, aerosols, dusts and many others. One embodiment of a method of contact is a dimensionally stable fertilizer granule, stick or tablet comprising a compound or composition of the disclosure. The combinations, mixtures, and compositions of this disclosure can also be impregnated into materials for fabricating invertebrate control devices (e.g., insect netting, application onto clothing, application into candle formulations and the like).

In some embodiments, a liposome and an insecticidal protein, or an agriculturally acceptable salt thereof, is also useful in seed treatments for protecting seeds from invertebrate pests. In the context of the present disclosure and claims, treating a seed means contacting the seed with a biologically effective amount of a liposome and an insecticidal protein, or an agriculturally acceptable salt thereof, that are typically formulated as a composition of the disclosure. This seed treatment protects the seed from invertebrate soil pests and generally can also protect roots and other plant parts in contact with the soil of the seedling developing from the germinating seed. The seed treatment may also provide protection of foliage by translocation of the insecticidal protein within the developing plant. Seed treatments can be applied to all types of seeds, including those from which plants genetically transformed to express specialized traits will germinate.

One method of seed treatment is by spraying or dusting the seed with a liposome and an insecticidal protein, or an agriculturally acceptable salt thereof, (i.e. as a formulated composition or a mixture comprising a composition of a liposome and an insecticidal protein, or an agriculturally acceptable salt thereof, and optionally an excipient) before sowing the seeds. Compositions formulated for seed treatment generally consist of a liposome and an insecticidal protein, or an agriculturally acceptable salt thereof, and a film former or adhesive agent. Therefore, typically, a seed coating composition of the present disclosure consists of a biologically effective amount of a liposome and an insecticidal protein, or an agriculturally acceptable salt thereof, and a film former or adhesive agent. Seed can be coated by spraying a flowable suspension concentrate directly into a tumbling bed of seeds and then drying the seeds. Alternatively, other formulation types such as wetted powders, solutions, suspoemulsions, emulsifiable concentrates and emulsions in water can be sprayed on the seed. This process is particularly useful for applying film coatings on seeds. Various coating machines and processes are available to one skilled in the art. Suitable processes include those listed in P. Kosters et al., Seed Treatment: Progress and Prospects, 1994 BCPC Monograph No. 57, and references listed therein, the disclosures of which are incorporated herein by reference in their entireties.

The treated seed typically comprises a liposome and an insecticidal protein, or an agriculturally acceptable salt thereof, in an amount ranging from about 0.01 g to 1 kg per 100 kg of seed (i.e. from about 0.00001 to 1% by weight of the seed before treatment). A flowable suspension formulated for seed treatment typically comprises from about 0.5 to about 70% of the active ingredient, from about 0.5 to about 30% of a film-forming adhesive, from about 0.5 to about 20% of a dispersing agent, from 0 to about 5% of a thickener, from 0 to about 5% of a pigment and/or dye, from 0 to about 2% of an antifoaming agent, from 0 to about 1% of a preservative, and from 0 to about 75% of a volatile liquid diluent.

### Methods of Using Liposomes and Compositions Thereof

In some embodiments, the present disclosure provides a method of using a composition comprising, consisting essentially of, or consisting of: 1) a liposome comprising an insecticidal protein or agriculturally acceptable salt thereof, wherein the liposome encapsulates the insecticidal protein or agriculturally acceptable salt thereof, and/or (2) a liposome comprising an insecticidal protein or agriculturally acceptable salt thereof, and at least one excipient, wherein the liposome encapsulates the insecticidal protein or agriculturally acceptable salt thereof, to control pests.

In some embodiments, the present disclosure provides a method of using a composition comprising, consisting essentially of, or consisting of: 1) a liposome comprising an insecticidal protein or agriculturally acceptable salt thereof, wherein the liposome encapsulates the insecticidal protein or agriculturally acceptable salt thereof, and/or (2) a liposome comprising an insecticidal protein or agriculturally acceptable salt thereof, and at least one excipient, wherein the liposome encapsulates the insecticidal protein or agriculturally acceptable salt thereof, to control insects.

In some embodiments, the present disclosure provides a method of using a composition comprising, consisting essentially of, or consisting of: (1) a liposome comprising an insecticidal protein or agriculturally acceptable salt thereof, wherein the liposome encapsulates the insecticidal protein or agriculturally acceptable salt thereof, and/or (2) a liposome comprising an insecticidal protein or agriculturally acceptable salt thereof, and at least one excipient, wherein the liposome encapsulates the insecticidal protein or agriculturally acceptable salt thereof, to control a pest, wherein the insecticidal protein is a CRIP, or an agriculturally acceptable salt thereof, and wherein said method comprises, preparing the composition, and then applying said composition to the pest, a locus of the pest, a food supply of the pest, a habitat of the pest, or a breeding ground of the pest; a plant, a seed, a plant part, a locus of a plant, or an environment of a plant that is susceptible to an attack by the pest; an animal, a locus of an animal, or an environment of an animal susceptible to an attack by the pest; or a combination thereof.

In some embodiments, the present disclosure provides a method of using a composition of the present disclosure to combat, control, and/or inhibit a pest comprising: applying a pesticidally effective amount of: (1) a liposome comprising an insecticidal protein or agriculturally acceptable salt thereof, wherein the liposome encapsulates the insecticidal protein or agriculturally acceptable salt thereof; and/or (2) a liposome comprising an insecticidal protein or agriculturally acceptable salt thereof, and at least one excipient, wherein the liposome encapsulates the insecticidal protein or agriculturally acceptable salt thereof; to the pest, a locus of the pest, a food supply of the pest, a habitat of the pest, or a breeding ground of the pest; a plant, a seed, a plant part, a locus of a plant, or an environment of a plant that is susceptible to an attack by the pest; an animal, a locus of an animal, or an environment of an animal susceptible to an attack by the pest; or a combination thereof, wherein the pest is an insect selected from the group consisting of: Achema Sphinx Moth (Hornworm) (Eumorpha achemon); Alfalfa Caterpillar (Colias eurytheme); Almond Moth (Caudra cautella); Amorbia Moth (Amorbia humerosana); Armyworm (Spodoptera spp., e.g. exigua, frugiperda, littoralis, Pseudaletia unipuncta); Artichoke Plume Moth (Platyptilia carduidactyla); Azalea Caterpillar (Datana major); Bagworm (Thyridopteryx); ephemeraeformis); Banana Moth (Hypercompe scribonia); Banana Skipper (Erionota thrax); Blackheaded Budworm (Acleris gloverana); California Oakworm (Phryganidia californica); Spring Cankerworm (Paleacrita merriccata); Cherry Fruitworm (Grapholita packardi); China Mark Moth (Nymphula stagnata); Citrus Cutworm (Xylomyges curialis); Codling Moth (Cydia pomonella); Cranberry Fruitworm (Acrobasis vaccinii); Cross-striped Cabbageworm (Evergestis rimosalis); Cutworm (Noctuid species, Agrotis ipsilon); Douglas Fir Tussock Moth (Orgyia pseudotsugata); Ello Moth (Hornworm) (Erinnyis ello); Elm Spanworm (Ennomos subsignaria); European Grapevine Moth (Lobesia botrana); European Skipper (Thymelicus lineola; Essex Skipper; Fall Webworm (Melissopus latiferreanus)); Filbert Leafroller (Archips rosanus)); Fruittree Leafroller (Archips argyrospilia)); Grape Berry Moth (Paralobesia viteana)); Grape Leafroller (Platynota stultana)); Grapeleaf Skeletonizer (Harrisina americana) (ground only); Green Cloverworm (Plathypena scabra)); Greenstriped Mapleworm (Dryocampa rubicunda)); Gummosos-Batrachedra comosae (Hodges); Gypsy Moth (Lymantria dispar); Hemlock Looper (Lambdina fiscellaria); Hornworm (Manduca spp.); Imported Cabbageworm (Pieris rapae); Jo Moth (Automeris io); Jack Pine Budworm (Choristoneura pinus); Light Brown Apple Moth (Epiphyas postvittana); Melonworm (Diaphania hyalinata); Mimosa Webworm (Homadaula anisocentra); Obliquebanded Leafroller (Choristoneura rosaceana); Oleander Moth (Syntomeida epilais); Omnivorous Leafroller (Playnota stultana); Omnivorous Looper (Sabulodes aegrotata); Orangedog (Papilio cresphontes); Orange Tortrix (Argyrotaenia citrana); Oriental Fruit Moth (Grapholita molesta); Peach Twig Borer (Anarsia lineatella); Pine Butterfly (Neophasia menapia); Podworm; Redbanded Leafroller (Argyrotaenia velutinana); Redhumped Caterpillar (Schizura concinna); Rindworm Complex; Saddleback Caterpillar (Sibine stimulea); Saddle Prominent Caterpillar (Heterocampa guttivitta); Saltmarsh Caterpillar (Estigmene acrea); Sod Webworm (Crambus spp.); Spanworm (Ennomos subsignaria); Fall Cankerworm (Alsophila pometaria); Spruce Budworm (Choristoneura fumiferana); Tent Caterpillar (Various Lasiocampidae); Thecla-Thecla basilides (Geyr) (Thecla basilides); Tobacco Hornworm (Manduca sexta); Tobacco Moth (Ephestia elutella); Tufted Apple Budmoth (Platynota idaeusalis); Twig Borer (Anarsia lineatella); Variegated Cutworm (Peridroma saucia); Variegated Leafroller (Platynota flavedana); Velvetbean Caterpillar (Anticarsia gemmatalis); Walnut Caterpillar (Datana integerrima); Webworm (Hyphantria cunea); Western Tussock Moth (Orgyia vetusta); southern Cornstalk Borer (Diatraea crambidoides); Corn Earworm; Sweet potato weevil; Pepper weevil; Citrus root weevil; Strawberry root weevil; Pecan weevil); Filbert weevil; Ricewater weevil; Alfalfa weevil; Clover weevil; Tea shot-hole borer; Root weevil; Sugarcane beetle; Coffee berry borer; Annual blue grass weevil (Listronotus maculicollis); Asiatic garden beetle (Maladera castanea); European chafer (Rhizotroqus majalis); Green June beetle (Cotinis nitida); Japanese beetle (Popilla japonica); May or June beetle (Phyllophaga sp.); Northern masked chafer (Cyclocephala borealis); Oriental beetle (Anomala orientalis); Southern masked chafer (Cyclocephala lurida); Billbug (Curculionoidea); Aedes aegypti; Busseola fusca; Chilo suppressalis; Culex pipiens; Culex quinquefasciatus; Diabrotica virgifera; Diatraea saccharalis; Helicoverpa armigera; Helicoverpa zea; Heliothis virescens; Leptinotarsa decemlineata; Ostrinia furnacalis; Ostrinia nubilalis; Pectinophora gossypiella; Plodia interpunctella; Plutella xylostella; Pseudoplusia includens; Spodoptera exigua; Spodoptera frugiperda; Spodoptera littoralis; Trichoplusia ni; and/or Xanthogaleruca luteola.

In some embodiments, the present disclosure provides a method of using a composition of the present disclosure to combat, control, and/or inhibit a pest comprising: applying a pesticidally effective amount of: (1) a liposome comprising an insecticidal protein or agriculturally acceptable salt thereof, wherein the liposome encapsulates the insecticidal protein or agriculturally acceptable salt thereof; and/or (2) a liposome comprising an insecticidal protein or agriculturally acceptable salt thereof, and at least one excipient, wherein the liposome encapsulates the insecticidal protein or agriculturally acceptable salt thereof; to the pest, a locus of the pest, a food supply of the pest, a habitat of the pest, or a breeding ground of the pest; a plant, a seed, a plant part, a locus of a plant, or an environment of a plant that is susceptible to an attack by the pest; an animal, a locus of an animal, or an environment of an animal susceptible to an attack by the pest; or a combination thereof, wherein the pest is an insect selected from the group consisting of: Eumorpha achemon; Colias eurytheme; Caudra cautella; Amorbia humerosana; Pseudaletia unipuncta; Platyptilia carduidactyla; Datana major; Thyridopteryx ephemeraeformis; Hypercompe scribonia; Erionota thrax; Acleris gloverana; Phryganidia ca/fornica; Paleacrita merriccata; Grapholita packardi; Nymphula stagnata; Xylomyges curialis; Cydia pomonella; Acrobasis vaccinii; Evergestis rimosalis; Noctuid species; Agrotis ipsilon; Orgyia pseudotsugata; Erinnyis ello; Ennomos subsignaria; Lobesia botrana; Thymelicus lineola; Melissopus latiferreanus; Archips rosanus; Archips argyrospilia; Paralobesia viteana); Platynota stultana; Harrisina americana; Plathypena scabra; Dryocampa rubicunda; Batrachedra comosae; Lymantria dispar; Lambdina fiscellaria; Manduca quinquemaculata; Manduca sexta; Pieris rapae; Automeris io; Choristoneura pinus; Epiphyas postvittana; Diaphania hyalinata; Homadaula anisocentra; Choristoneura rosaceana; Syntomeida epilais; Playnota stultana; Sabulodes aegrotata; Papilio cresphontes; Argyrotaenia citrana; Grapholita molesta; Anarsia lineatella; Neophasia menapia; Argyrotaenia velutinana; Schizura concinna; Sibine stimulea; Heterocampa guttivitta; Estigmene acrea; Crambus sp.; Ennomos subsignaria; Alsophila pometaria; Choristoneurafumiferana; Lasiocampidae sp.; Thecla basilides; Ephestia elutella; Platynota idaeusalis; Anarsia lineatella; Peridroma saucia; Platynota flavedana; Anticarsia gemmatalis; Datana integerrima; Hyphantria cunea; Orgyia vetusta; Southern Diatraea crambidoides; Cylas formicarius; Anthonomus eugenii; Diaprepes abbreviatus; Otiorhynchus ovatus; Curculio caryae; Curculio occidentis; Lissorhoptrus oryzophilus; Hypera postica; Hypera zoilus; Euwallaceafornicatus; Euetheola humilis; Hypothenemus hampei; Listronotus maculicollis; Maladera castanea; Rhizotroqus maja/is; Cotinis nitida; Popilia japonica; Phyllophaga sp.; Cyclocephala borealis; Anomala orientalis; Cyclocephala lurida; Sphenophorus parvulus; Sphenophorus apicalis; Sphenophorus cariosus; Sphenophorus inaequalis; Sphenophorus minimus; Aedes aegypti; Busseolafusca; Chilo suppressalis; Culex pipiens; Culex quinquefasciatus; Diabrotica virgifera; Diatraea saccharalis; Helicoverpa armigera; Helicoverpa zea; He/iothis virescens; Leptinotarsa decemlineata; Ostrinia furnacalis; Ostrinia nubilalis; Pectinophora gossypiella; Plodia interpunctella; Plutella xylostella; Pseudoplusia includens; Spodoptera exigua; Spodoptera frugiperda; Spodoptera littoralis; Trichoplusia ni; and Xanthogaleruca luteola.

In some embodiments, the present disclosure provides a method of using a composition of the present disclosure to combat, control, and/or inhibit a pest comprising: applying a pesticidally effective amount of: (1) a liposome comprising an insecticidal protein or agriculturally acceptable salt thereof, wherein the liposome encapsulates the insecticidal protein or agriculturally acceptable salt thereof; and/or (2) a liposome comprising an insecticidal protein or agriculturally acceptable salt thereof, and at least one excipient, wherein the liposome encapsulates the insecticidal protein or agriculturally acceptable salt thereof; to the pest, a locus of the pest, a food supply of the pest, a habitat of the pest, or a breeding ground of the pest; a plant, a seed, a plant part, a locus of a plant, or an environment of a plant that is susceptible to an attack by the pest; an animal, a locus of an animal, or an environment of an animal susceptible to an attack by the pest; or a combination thereof, wherein the pest is an insect selected from the group consisting of: Aedes aegypti; Busseola fusca; Chilo suppressalis; Culex pipiens; Culex quinquefasciatus; Diabrotica virgifera; Diatraea saccharalis; Helicoverpa armigera; Helicoverpa zea; Heliothis virescens; Leptinotarsa decemlineata; Ostrinia furnacalis; Ostrinia nubilalis; Pectinophora gossypiella; Plodia interpunctella; Plutella xylostella; Pseudoplusia includens; Spodoptera exigua; Spodoptera frugiperda; Spodoptera littoralis; Trichoplusia ni; and Xanthogaleruca luteola.

### Crops and Pests

Specific crop pests and insects that may be controlled by the methods of the present disclosure include the following: Dictyoptera (cockroaches); Isoptera (termites); Orthoptera (locusts, grasshoppers and crickets); Diptera (house flies, mosquito, tsetse fly, crane-flies and fruit flies); Hymenoptera (ants, wasps, bees, saw-flies, ichneumon flies and gall-wasps); Anoplura (biting and sucking lice); Siphonaptera (fleas); and Hemiptera (bugs and aphids), as well as arachnids such as Acari (ticks and mites), and the parasites that each of these organisms harbor.

“Pest” includes, but is not limited to: insects, fungi, bacteria, nematodes, mites, ticks, and the like.

Insect pests include, but are not limited to, insects selected from the orders Coleoptera, Diptera, Hymenoptera, Lepidoptera, Mallophaga, Homoptera, Hemiptera, Orthroptera, Thysanoptera, Dermaptera, Isoptera, Anoplura, Siphonaptera, Trichoptera, and the like. More particularly, insect pests include Coleoptera, Lepidoptera, and Diptera.

Insects of suitable agricultural, household and/or medical/veterinary importance for treatment with the insecticidal polypeptides include, but are not limited to, members of the following classes and orders:

The order Coleoptera includes the suborders Adephaga and Polyphaga. Suborder Adephaga includes the superfamilies Caraboidea and Gyrinoidea. Suborder Polyphaga includes the superfamilies Hydrophiloidea, Staphylinoidea, Cantharoidea, Cleroidea, Elateroidea, Dascilloidea, Dryopoidea, Byrrhoidea, Cucujoidea, Meloidea, Mordelloidea, Tenebrionoidea, Bostrichoidea, Scarabaeoidea, Cerambycoidea, Chrysomeloidea, and Curculionoidea. Superfamily Caraboidea includes the families Cicindelidae, Carabidae, and Dytiscidae. Superfamily Gyrinoidea includes the family Gyrinidae. Superfamily Hydrophiloidea includes the family Hydrophilidae. Superfamily Staphylinoidea includes the families Silphidae and Staphylinidae. Superfamily Cantharoidea includes the families Cantharidae and Lampyridae. Superfamily Cleroidea includes the families Cleridae and Dermestidae. Superfamily Elateroidea includes the families Elateridae and Buprestidae. Superfamily Cucujoidea includes the family Coccinellidae. Superfamily Meloidea includes the family Meloidae. Superfamily Tenebrionoidea includes the family Tenebrionidae. Superfamily Scarabaeoidea includes the families Passalidae and Scarabaeidae. Superfamily Cerambycoidea includes the family Cerambycidae. Superfamily Chrysomeloidea includes the family Chrysomelidae. Superfamily Curculionoidea includes the families Curculionidae and Scolytidae.

Examples of Coleoptera include, but are not limited to: the American bean weevil Acanthoscelides obtectus, the leaf beetle Agelastica alni, click beetles (Agriotes lineatus, Agriotes obscurus, Agriotes bicolor), the grain beetle Ahasverus advena, the summer schafer Amphimallon solstitialis, the furniture beetle Anobium punctatum, Anthonomus spp. (weevils), the Pygmy mangold beetle Atomaria linearis, carpet beetles (Anthrenus spp., Attagenus spp.), the cowpea weevil Callosobruchus maculates, the fried fruit beetle Carpophilus hemipterus, the cabbage seedpod weevil Ceutorhynchus assimilis, the rape winter stem weevil Ceutorhynchus picitarsis, the wireworms Conoderus vespertinus and Conoderus falli, the banana weevil Cosmopolites sordidus, the New Zealand grass grub Costelytra zealandica, the June beetle Cotinis nitida, the sunflower stem weevil Cylindrocopturus adspersus, the larder beetle Dermestes lardarius, the corn rootworms Diabrotica virgifera, Diabrotica virgifera virgifera, and Diabrotica barberi, the Mexican bean beetle Epilachna varivestis, the old house borer Hylotropes bajulus, the lucerne weevil Hypera postica, the shiny spider beetle Gibbium psylloides, the cigarette beetle Lasioderma serricorne, the Colorado potato beetle Leptinotarsa decemlineata, Lyctus beetles (Lyctus spp.), the pollen beetle Meligethes aeneus, the common cockshafer Melolontha melolontha, the American spider beetle Mezium americanum, the golden spider beetle Niptus hololeucus, the grain beetles Oryzaephilus surinamensis and Oryzaephilus mercator, the black vine weevil Otiorhynchus sulcatus, the mustard beetle Phaedon cochleariae, the crucifer flea beetle Phyllotreta cruciferae, the striped flea beetle Phyllotreta striolata, the cabbage steam flea beetle Psylliodes chrysocephala, Ptinus spp. (spider beetles), the lesser grain borer Rhizopertha dominica, the pea and been weevil Sitona lineatus, the rice and granary beetles Sitophilus oryzae and Sitophilus granaries, the red sunflower seed weevil Smicronyx fulvus, the drugstore beetle Stegobium paniceum, the yellow mealworm beetle Tenebrio molitor, the flour beetles Tribolium castaneum and Tribolium confusum, warehouse and cabinet beetles (Trogoderma spp.), and the sunflower beetle Zygogramma exclamationis.

Examples of Dermaptera (earwigs) include, but are not limited to: the European earwig, Forficula auricularia, and the striped earwig, Labidura riparia.

Examples of Dictvontera include, but are not limited to: the oriental cockroach, Blatta orientalis, the German cockroach, Blatella germanica, the Madeira cockroach, Leucophaea maderae, the American cockroach, Periplaneta americana, and the smokybrown cockroach Periplaneta fuliginosa.

Examples of Diplonoda include, but are not limited to: the spotted snake millipede Blaniulus guttulatus, the flat-back millipede Brachydesmus superus, and the greenhouse millipede Oxidus gracilis.

The order Diptera includes the Suborders Nematocera, Brachycera, and Cyclorrhapha. Suborder Nematocera includes the families Tipulidae, Psychodidae, Culicidae, Ceratopogonidae, Chironomidae, Simuliidae, Bibionidae, and Cecidomyiidae. Suborder Brachycera includes the families Stratiomyidae, Tabanidae, Therevidae, Asilidae, Mydidae, Bombyliidae, and Dolichopodidae. Suborder Cyclorrhapha includes the Divisions Aschiza and Aschiza. Division Aschiza includes the families Phoridae, Syrphidae, and Conopidae. Division Aschiza includes the Sections Acalyptratae and Calyptratae. Section Acalyptratae includes the families Otitidae, Tephritidae, Agromyzidae, and Drosophilidae. Section Calyptratae includes the families Hippoboscidae, Oestridae, Tachinidae, Anthomyiidae, Muscidae, Calliphoridae, and Sarcophagidae.

Examples of Diptera include, but are not limited to: the house fly (Musca domestica), the African tumbu fly (Cordylobia anthropophaga), biting midges (Culicoides spp.), bee louse (Braula spp.), the beet fly Pegomyia betae, blackflies (Cnephia spp., Eusimulium spp., Simulium spp.), bot flies (Cuterebra spp., Gastrophilus spp., Oestrus spp.), craneflies (Tipula spp.), eye gnats (Hippelates spp.), filth-breeding flies (Calliphora spp., Fannia spp., Hermetia spp., Lucilia spp., Musca spp., Muscina spp., Phaenicia spp., Phormia spp.), flesh flies (Sarcophaga spp., Wohlfahrtia spp.); the flit fly Oscinella frit, fruitflies (Dacus spp., Drosophila spp.), head and canon flies (Hydrotea spp.), the hessian fly Mayetiola destructor, horn and buffalo flies (Haematobia spp.), horse and deer flies (Chrysops spp., Haematopota spp., Tabanus spp.), louse flies (Lipoptena spp., Lynchia spp., and Pseudolynchia spp.), medflies (Ceratitus spp.), mosquitoes (Aedes spp., Anopheles spp., Culex spp., Psorophora spp.), sandflies (Phlebotomus spp., Lutzomyia spp.), screw-worm flies (Chtysomya bezziana and Cochlomyia hominivorax), sheep keds (Melophagus spp.); stable flies (Stomoxys spp.), tsetse flies (Glossina spp.), and warble flies (Hypoderma spp.).

Examples of Isontera (termites) include, but are not limited to: species from the familes Hodotennitidae, Kalotermitidae, Mastotermitidae, Rhinotennitidae, Serritermitidae, Termitidae, and Termopsidae.

Examples of Heteroptera include, but are not limited to: the bed bug Cimex lectularius, the cotton stainer Dysdercus intermedius, the Sunn pest Eurygaster integriceps, the tarnished plant bug Lygus lineolaris, the green stink bug Nezara antennata, the southern green stink bug Nezara viridula, and the triatomid bugs Panstrogylus megistus, Rhodnius ecuadoriensis, Rhodnius pallescans, Rhodnius prolixus, Rhodnius robustus, Triatoma dimidiata, Triatoma infestans, and Triatoma sordida.

Examples of Homoptera include, but are not limited to: the California red scale Aonidiella aurantii, the black bean aphid Aphis fabae, the cotton or melon aphid Aphis gossypii, the green apple aphid Aphis pomi, the Citrus Spiny Whitefly Aleurocanthus spiniferus, the Oleander Scale Aspidiotus hederae, the sweet potato whitefly Bemesia tabaci, the cabbage aphid Brevicoryne brassicae, the pear psylla Cacopsylla pyricola, the currant aphid Cryptomyzus ribis, the grape phylloxera Daktulosphaira vitifoliae, the citrus psylla Diaphorina citri, the potato leafhopper Empoasca fabae, the bean leafhopper Empoasca solana, the vine leafhopper Empoasca vitis, the woolly aphid Eriosoma lanigerum, the European fruit scale Eulecanium corni, the mealy plum aphid Hyalopterus arundinis, the small brown planthopper Laodelphax striatellus, the potato aphid Macrosiphum euphorbiae, the green peach aphid Myzus persicae, the green rice leafhopper Nephotettix cinticeps, the brown planthopper Nilaparvata lugens, gall-forming aphids (Pemphigus spp.), the hop aphid Phorodon humuli, the bird-cherry aphid Rhopalosiphum padi, the black scale Saissetia oleae, the greenbug Schizaphis graminum, the grain aphid Sitobion avenae, and the greenhouse whitefly Trialeurodes vaporariorum.

Examples of Isopoda include, but are not limited to: the common pillbug Armadillidium vulgare and the common woodlouse Oniscus asellus.

The order Lepidoptera includes the families Papilionidae, Pieridae, Lycaenidae, Nymphalidae, Danaidae, Satyridae, Hesperiidae, Sphingidae, Saturniidae, Geometridae, Arctiidae, Noctuidae, Lymantriidae, Sesiidae, and Tineidae.

Examples of Lepidoptera include, but are not limited to: Adoxophyes orana (summer fruit tortrix moth), Agrotis ipsolon (black cutworm), Archips podana (fruit tree tortrix moth), Bucculatrix pyrivorella (pear leafminer), Bucculatrix thurberiella (cotton leaf perforator), Bupalus piniarius (pine looper), Carpocapsa pomonella (codling moth), Chilo suppressalis (striped rice borer), Choristoneura fumiferana (eastern spruce budworm), Cochylis hospes (banded sunflower moth), Diatraea grandiosella (southwestern corn borer), Earls insulana (Egyptian bollworm), Euphestia kuehniella (Mediterranean flour moth), Eupoecilia ambiguella (European grape berry moth), Euproctis chrysorrhoea (brown-tail moth), Euproctis subflava (oriental tussock moth), Galleria mellonella (greater wax moth), Helicoverpa armigera (cotton bollworm), Helicoverpa zea (cotton bollworm), Heliothis virescens (tobacco budworm), Hofmannophila pseudopretella (brown house moth), Homeosoma electellum (sunflower moth), Homona magnanima (oriental tea tree tortrix moth), Lithocolletis blancardella (spotted tentiform leafminer), Lymantria dispar (gypsy moth), Malacosoma neustria (tent caterpillar), Mamestra brassicae (cabbage armyworm), Mamestra configurata (Bertha armyworm), the hornworms Manduca sexta and Manuduca quinquemaculata, Operophtera brumata (winter moth), Ostrinia nubilalis (European corn borer), Panolis flammea (pine beauty moth), Pectinophora gossypiella (pink bollworm), Phyllocnistis citrella (citrus leafminer), Pieris brassicae (cabbage white butterfly), Plutella xylostella (diamondback moth), Rachiplusia ni (soybean looper), Spilosoma virginica (yellow bear moth), Spodoptera exigua (beet armyworm), Spodoptera frugiperda (fall armyworm), Spodoptera littoralis (cotton leafworin), Spodoptera litura (common cutworm), Spodoptera praefica (yellowstriped armyworm), Sylepta derogata (cotton leaf roller), Tineola bisselliella (webbing clothes moth), Tineola pellionella (case-making clothes moth), Tortrix viridana (European oak leafroller), Trichoplusia ni (cabbage looper), and Yponomeuta padella (small ermine moth).

Examples of Orthoptera include, but are not limited to: the common cricket Acheta domesticus, tree locusts (Anacridium spp.), the migratory locust Locusta migratoria, the twostriped grasshopper Melanoplus bivittatus, the differential grasshopper Melanoplus dfferentialis, the redlegged grasshopper Melanoplus femurrubrum, the migratory grasshopper Melanoplus sanguinipes, the northern mole cricket Neocurtilla hexadectyla, the red locust Nomadacris septemfasciata, the shortwinged mole cricket Scapteriscus abbreviatus, the southern mole cricket Scapteriscus borellii, the tawny mole cricket Scapteriscus vicinus, and the desert locust Schistocerca gregaria.

Examples of Phthiraptera include, but are not limited to: the cattle biting louse Bovicola bovis, biting lice (Damalinia spp.), the cat louse Felicola subrostrata, the shortnosed cattle louse Haematopinus eloysternus, the tail-switch louse Haematopinus quadriperiussus, the hog louse Haematopinus suis, the face louse Linognathus ovillus, the foot louse Linognathus pedalis, the dog sucking louse Linognathus setosus, the long-nosed cattle louse Linognathus vituli, the chicken body louse Menacanthus stramineus, the poultry shaft louse Menopon gallinae, the human body louse Pediculus humanus, the pubic louse Phthirus pubis, the little blue cattle louse Solenopotes capillatus, and the dog biting louse Trichodectes canis.

Examples of Psocoptera include, but are not limited to: the booklice Liposcelis bostrychophila, Liposcelis decolor, Liposcelis entomophila, and Trogium pulsatorium. Examples of Siphonaptera include, but are not limited to: the bird flea Ceratophyllus gallinae, the dog flea Ctenocephalides canis, the cat flea Ctenocephalides fells, the humanflea Pulex irritans, and the oriental rat flea Xenopsylla cheopis.

Examples of Symphyla include, but are not limited to: the garden symphylan Scutigerella immaculate.

Examples of Thysanura include, but are not limited to: the gray silverfish Ctenolepisma longicaudata, the four-lined silverfish Ctenolepisma quadriseriata, the common silverfish Lepisma saccharina, and the firebrat Thennobia domestica;

Examples of Thysanoptera include, but are not limited to: the tobacco thrips Frankliniella fusca, the flower thrips Frankliniella intonsa, the western flower thrips Frankliniella occidentalis, the cotton bud thrips Frankliniella schultzei, the banded greenhouse thrips Hercinothrips femoralis, the soybean thrips Neohydatothrips variabilis, Kelly's citrus thrips Pezothrips kellyanus, the avocado thrips Scirtothrips perseae, the melon thrips, Thrips palmi, and the onion thrips, Thrips tabaci.

Examples of Nematodes include, but are not limited to: parasitic nematodes such as root-knot, cyst, and lesion nematodes, including Heterodera spp., Meloidogyne spp., and Globodera spp.; particularly members of the cyst nematodes, including, but not limited to: Heterodera glycines (soybean cyst nematode); Heterodera schachtii (beet cyst nematode); Heterodera avenae (cereal cyst nematode); and Globodera rostochiensis and Globodera pailida (potato cyst nematodes). Lesion nematodes include, but are not limited to: Pratylenchus spp.

Other insect species susceptible to the present disclosure include: athropod pests that cause public and animal health concerns, for example, mosquitos for example, mosquitoes from the genera Aedes, Anopheles and Culex, from ticks, flea, and flies etc.

In one embodiment, a composition that comprises, consists essentially of, or consists of, a liposome and an insecticidal protein, or an agriculturally acceptable salt thereof, can be employed to treat ectoparasites. Ectoparasites include, but are not limited to: fleas, ticks, mange, mites, mosquitoes, nuisance and biting flies, lice, and combinations comprising one or more of the foregoing ectoparasites. The term “fleas” includes the usual or accidental species of parasitic flea of the order Siphonaptera, and in particular the species Ctenocephalides, in particular C. fells and C. cams, rat fleas (Xenopsylla cheopis) and human fleas (Pulex irritans).

The present disclosure may be used to control, inhibit, and/or kill insect pests of major crops, e.g., in some embodiments, the major crops and corresponding insect pest include, but are not limited to: Maize: Ostrinia nubilalis, European corn borer; Agrotis ipsilon, black cutworm; Helicoverpa zea, corn earworm; Spodoptera frugiperda, fall armyworm; Diatraea grandiosella, southwestern corn borer; Elasmopalpus lignosellus, lesser cornstalk borer; Diatraea saccharalis, surgarcane borer; Diabrotica virgifera, western corn rootworm; Diabrotica longicornis barberi, northern corn rootworm; Diabrotica undecimpunctata howardi, southern corn rootworm; Melanotus spp., wireworms; Cyclocephala borealis, northern masked chafer (white grub); Cyclocephala immaculata, southern masked chafer (white grub); Popillia japonica, Japanese beetle; Chaetocnema pulicaria, corn flea beetle; Sphenophorus maidis, maize billbug; Rhopalosiphum maidis, corn leaf aphid; Anuraphis maidiradicis, corn root aphid; Blissus leucopterus leucopterus, chinch bug; Melanoplus femurrubrum, redlegged grasshopper; Melanoplus sanguinipes, migratory grasshopper; Hylemya platura, seedcorn maggot; Agromyza parvicornis, corn blot leafminer; Anaphothrips obscrurus, grass thrips; Solenopsis milesta, thief ant; Tetranychus urticae, twospotted spider mite; Sorghum: Chilo partellusz, Sorghum borer; Spodoptera frugiperda, fall armyworm; Helicoverpa zea, corn earworm; Elasmopalpus lignosellus, lesser cornstalk borer; Feltia subterranea, granulate cutworm; Phyllophaga crinita, white grub; Eleodes, Conoderus, and Aeolus spp., wireworms; Oulema melanopus, cereal leaf beetle; Chaetocnema pulicaria, corn flea beetle; Sphenophorus maidis, maize billbug; Rhopalosiphum maidis, corn leaf aphid; Sipha flava, yellow sugarcane aphid; Blissus leucopterus leucopterus, chinch bug; Contarinia sorghicola, Sorghum midge; Tetranychus cinnabarinus, carmine spider mite; Tetranychus urticae, twospotted spider mite; Wheat: Pseudaletia unipunctata, army worm; Spodoptera frugiperda, fall armyworm; Elasmopalpus lignosellus, lesser cornstalk borer; Agrotis orthogonia, western cutworm; Elasmopalpus lignosellus, lesser cornstalk borer; Oulema melanopus, cereal leaf beetle; Hypera punctata, clover leaf weevil; Diabrotica undecimpunctata howardi, southern corn rootworm; Russian wheat aphid; Schizaphis graminum, greenbug; Macrosiphum avenae, English grain aphid; Melanoplus femurrubrum, redlegged grasshopper; Melanoplus differentialis, differential grasshopper; Melanoplus sanguinipes, migratory grasshopper; Mayetiola destructor, Hessian fly; Sitodiplosis mosellana, wheat midge; Meromyza americana, wheat stem maggot; Hylemya coarctata, wheat bulb fly; Frankliniella fusca, tobacco thrips; Cephus cinctus, wheat stem sawfly; Aceria tulipae, wheat curl mite; Sunflower: Suleima helianthana, sunflower bud moth; Homoeosoma electellum, sunflower moth; Zygogramma exclamationis, sunflower beetle; Bothyrus gibbosus, carrot beetle; Neolasioptera murtfeldtiana, sunflower seed midge; Cotton: Heliothis virescens, cotton budworm; Helicoverpa zea, cotton bollworm; Spodoptera exigua, beet armyworm; Pectinophora gossypiella, pink bollworm; Anthonomus grandis, boll weevil; Aphis gossypii, cotton aphid; Pseudatomoscelis seriatus, cotton fleahopper; Trialeurodes abutilonea, banded winged whitefly; Lygus lineolaris, tarnished plant bug; Melanoplus femurrubrum, redlegged grasshopper; Melanoplus differentialis, differential grasshopper; Thrips tabaci, onion thrips; Franklinkiella fusca, tobacco thrips; Tetranychus cinnabarinus, carmine spider mite; Tetranychus urticae, twospotted spider mite; Rice: Diatraea saccharalis, sugarcane borer; Spodoptera frugiperda, fall armyworm; Helicoverpa zea, corn earworm; Colaspis brunnea, grape colaspis; Lissorhoptrus oryzophilus, rice water weevil; Sitophilus oryzae, rice weevil; Nephotettix nigropictus, rice leafhopper; Blissus leucopterus, chinch bug; Acrosternum hilare, green stink bug; Soybean: Pseudoplusia includens, soybean looper; Anticarsia gemmatalis, velvet bean caterpillar; Plathypena scabra, green clover worm; Ostrinia nubilalis, European corn borer; Agrotis ipsilon, black cutworm; Spodoptera exigua, beet armyworm; Heliothis virescens, cotton budworm; Helicoverpa zea, cotton bollworm; Epilachna varivestis, Mexican bean beetle; Myzus persicae, green peach aphid; Empoasca fabae, potato leafhopper; Acrosternum hilare, green stink bug; Melanoplus femurrubrum, redlegged grasshopper; Melanoplus differentialis, differential grasshopper; Hylemya platura, seedcorn maggot; Sericothrips variabilis, soybean thrips; Thrips tabaci, onion thrips; Tetranychus turkestani, strawberry spider mite; Tetranychus urticae, twospotted spider mite; Barley: Ostrinia nubilalis, European corn borer; Agrotis ipsilon, black cutworm; Schizaphis graminum, greenbug; Blissus leucopterus leucopterus, chinch bug; Acrosternum hilare, green stink bug; Euschistus servus, brown stink bug; Delia platura, seedcorn maggot; Mayetiola destructor, Hessian fly; Petrobia latens, brown wheat mite; Oil Seed Rape: Brevicoryne brassicae, cabbage aphid; Phyllotreta cruciferae, Flea beetle; Mamestra configurata, Bertha armyworm; Plutella xylostella, Diamond-back moth; Delia ssp., Root maggots.

In some embodiments, a composition of the present disclosure comprising, consisting essentially of, or consisting of, a liposome and an insecticidal protein, or an agriculturally acceptable salt thereof, can be employed to treat any one or more of the foregoing insects.

The insects that are susceptible to present disclosure include but are not limited to the following: familes such as: Blattaria, Coleoptera, Collembola, Diptera, Echinostomida, Hemiptera, Hymenoptera, Isoptera, Lepidoptera, Neuroptera, Orthoptera, Rhabditida, Siphonoptera, and Thysanoptera. Genus Species are indicated as follows: Actebia fennica, Agrotis ipsilon, A. segetum, Anticarsia gemmatalis, Argyrotaenia citrana, Artogeia rapae, Bombyx mori, Busseola fusca, Cacyreus marshall, Chilo suppressalis, Christoneura fumiferana, C. occidentalis, C. pinus pinus, C. rosacena, Cnaphalocrocis medinalis, Conopomorpha cramerella, Ctenopsuestis obliquana, Cydia pomonella, Danaus plexippus, Diatraea saccharallis, D. grandiosella, Earias vittella, Elasmolpalpus lignoselius, Eldana saccharina, Ephestia kuehniella, Epinotia aporema, Epiphyas postvittana, Galleria mellonella, Genus-Species, Helicoverpa zea, H. punctigera, H. armigera, Heliothis virescens, Hyphantria cunea, Lambdina fiscellaria, Leguminivora glycinivorella, Lobesia botrana, Lymantria dispar, Malacosoma disstria, Mamestra brassicae, M configurata, Manduca sexta, Marasmia patnalis, Maruca vitrata, Orgyia leucostigma, Ostrinia nubilalis, O. furnacalis, Pandemis pyrusana, Pectinophora gossypiella, Perileucoptera coffeella, Phthorimaea opercullela, Pianotortrix octo, Piatynota stultana, Pieris brassicae, Plodia interpunctala, Plutella xylostella, Pseudoplusia includens, Rachiplusia nu, Sciropophaga incertulas, Sesamia calamistis, Spilosoma virginica, Spodoptera exigua, Spodoptera frugiperda, Spodoptera littoralis, Spodoptera exempta, Spodoptera litura, Tecia solanivora, Thaumetopoea pityocampa, Trichoplusia ni, Wiseana cervinata, Wiseana copularis, Wiseana jocosa, Blattaria blattella, Collembola xenylla, Collembola folsomia, Folsomia candida, Echinostomida fasciola, Hemiptera oncopeltrus, Hemiptera bemisia, Hemiptera macrosiphum, Hemiptera rhopalosiphum, Hemiptera myzus, Hymenoptera diprion, Hymenoptera apis, Hymenoptera Macrocentrus, Hymenoptera Meteorus, Hymenoptera Nasonia, Hymenoptera Solenopsis, Isopoda porcellio, Isoptera reticulitermes, Orthoptera Achta, Prostigmata tetranychus, Rhabitida acrobeloides, Rhabitida caenorhabditis, Rhabitida distolabrellus, Rhabitida panagrellus, Rhabitida pristionchus, Rhabitida pratylenchus, Rhabitida ancylostoma, Rhabitida nippostrongylus, Rhabitida panagrellus, Rhabitida haemonchus, Rhabitida meloidogyne, and Siphonaptera ctenocephalides.

The present disclosure provides methods for protecting a plant and/or crops from a pest. In some embodiments, the plant and/or crop may be any plant and/or crop species, including, but not limited to, monocots and dicots. In some embodiments, the liposome composition of the present disclosure may be used to protect, e.g., alfalfa, cotton, tomato, maize, wheat, corn, sweet corn, lucerne, soybean, Sorghum, field pea, linseed, safflower, rapeseed, oil seed rape, rice, soybean, barley, sunflower, trees (including coniferous and deciduous), flowers (including those grown commercially and in greenhouses), field lupins, switchgrass, sugarcane, potatoes, tomatoes, tobacco, crucifers, peppers, sugarbeet, barley, and oilseed rape, Brassica sp., rye, millet, peanuts, sweet potato, cassaya, coffee, coconut, pineapple, citrus trees, cocoa, tea, banana, avocado, fig, guava, mango, olive, papaya, cashew, macadamia, almond, oats, vegetables, ornamentals, and conifers.

In some embodiments, the compositions, mixtures, and/or methods of the present disclosure can be applied to the locus of an insect and/or pest selected from the group consisting of: Loopers; Omnivorous Leafroller; Hornworms; Imported Cabbageworm; Diamondback Moth; Green Cloverworm; Webworm; Saltmarsh Caterpillar; Armyworms; Cutworms; Cross-Striped Cabbageworm; Podworms; Velvetbean Caterpillar; Soybean Looper; Tomato Fruitworm; Variegated Cutworm; Melonworms; Rindworm complex; Fruittree Leafroller; Citrus Cutworm; Heliothis; Orangedog; Citrus Cutworm; Redhumped Caterpillar; Tent Caterpillars; Fall Webworm; Walnut Caterpillar; Cankerworms; Gypsy Moth; Variegated Leafroller; Redbanded Leafroller; Tufted Apple Budmoth; Oriental Fruit Moth); Filbert Leafroller; Obliquebanded Leafroller; Codling Moth; Twig Borer; Grapeleaf Skeletonizer; Grape Leafroller; Achema Sphinx Moth (Hornworm); Orange Tortrix; Tobacco Budworm); Grape Berry Moth; Spanworm; Alfalfa Caterpillar; Cotton Bollworm; Head Moth; Amorbia Moth; Omnivorous Looper; Ello Moth (Hornworm); Jo Moth; Oleander Moth; Azalea Caterpillar; Hornworm; Leafrollers; Banana Skipper; Batrachedra comosae (Hodges); Thecla Moth; Artichoke Plume Moth; Thistle Butterfly; Bagworm; Spring & Fall Cankerworm; Elm Spanworm; California Oakworm; Pine Butterfly; Spruce Budworms; Saddle Prominent Caterpillar; Douglas Fir Tussock Moth; Western Tussock Moth; Blackheaded Budworm; Mimosa Webworm; Jack Pine Budworm; Saddleback Caterpillar; Greenstriped Mapleworm; or Hemlock Looper.

In some embodiments, the compositions, mixtures, and/or methods of the present disclosure can be applied to the locus of an insect and/or pest selected from the group consisting of: Achema Sphinx Moth (Hornworm) (Eumorpha achemon); Alfalfa Caterpillar (Coilas eurytheme); Almond Moth (Caudra cautella); Amorbia Moth (Amorbia humerosana); Armyworm (Spodoptera spp., e.g. exigua, frugiperda, littoralis, Pseudaletia unipuncta); Artichoke Plume Moth (Platyptilia carduidactyla); Azalea Caterpillar (Datana major); Bagworm (Thyridopteryx); ephemeraeformis); Banana Moth (Hypercompe scribonia); Banana Skipper (Erionota thrax); Blackheaded Budworm (Acleris gloverana); California Oakworm (Phryganidia californica); Spring Cankerworm (Paleacrita merriccata); Cherry Fruitworm (Grapholita packardi); China Mark Moth (Nymphula stagnata); Citrus Cutworm (Xylomyges curialis); Codling Moth (Cydia pomonella); Cranberry Fruitworm (Acrobasis vaccinii); Cross-striped Cabbageworm (Evergestis rimosalis); Cutworm (Noctuid species, Agrotis ipsilon); Douglas Fir Tussock Moth (Orgyia pseudotsugata); Ello Moth (Hornworm) (Erinnyis ello); Elm Spanworm (Ennomos subsignaria); European Grapevine Moth (Lobesia botrana); European Skipper (Thymelicus lineola) (Essex Skipper); Fall Webworm (Melissopus latiferreanus); Filbert Leafroller (Archips rosanus); Fruittree Leafroller (Archips argyrospilia); Grape Berry Moth (Paralobesia viteana); Grape Leafroller (Platynota stultana); Grapeleaf Skeletonizer (Harrisina americana) (ground only); Green Cloverworm (Plathypena scabra); Greenstriped Mapleworm (Dryocampa rubicunda); Gummosos-Batrachedra Comosae (Hodges); Gypsy Moth (Lymantria dispar); Hemlock Looper (Lambdina fiscellaria); Hornworm (Manduca spp.); Imported Cabbageworm (Pieris rapae); Jo Moth (Automeris io); Jack Pine Budworm (Choristoneura pinus); Light Brown Apple Moth (Epiphyas postvittana); Melonworm (Diaphania hyalinata); Mimosa Webworm (Homadaula anisocentra); Obliquebanded Leafroller (Choristoneura rosaceana); Oleander Moth (Syntomeida epilais); Omnivorous Leafroller (Playnota stultana); Omnivorous Looper (Sabulodes aegrotata); Orangedog (Papilio cresphontes); Orange Tortrix (Argyrotaenia citrana); Oriental Fruit Moth (Grapholita molesta); Peach Twig Borer (Anarsia lineatella); Pine Butterfly (Neophasia menapia); Redbanded Leafroller (Argyrotaenia velutinana); Redhumped Caterpillar (Schizura concinna); Rindworm Complex (Various Leps.); Saddleback Caterpillar (Sibine stimulea); Saddle Prominent Caterpillar (Heterocampa guttivitta); Saltmarsh Caterpillar (Estigmene acrea); Sod Webworm (Crambus spp.); Spanworm (Ennomos subsignaria); Fall Cankerworm (Alsophila pometaria); Spruce Budworm (Choristoneura fumiferana); Tent Caterpillar (Various Lasiocampidae); Thecla-Thecla basilides (Geyr) (Thecla basilides); Tobacco Hornworm (Manduca sexta); Tobacco Moth (Ephestia elutella); Tufted Apple Budmoth (Platynota idaeusalis); Twig Borer (Anarsia lineatella); Variegated Cutworm (Peridroma saucia); Variegated Leafroller (Platynota flavedana); Velvetbean Caterpillar (Anticarsia gemmatalis); Walnut Caterpillar (Datana integerrima); Webworm (Hyphantria cunea); Western Tussock Moth (Orgyia vetusta); Southern Cornstalk Borer (Diatraea crambidoides); Corn Earworm; Sweet potato weevil; Pepper weevil; Citrus root weevil; Strawberry root weevil; Pecan weevil); Filbert weevil; Ricewater weevil; Alfalfa weevil; Clover weevil; Tea shot-hole borer; Root weevil; Sugarcane beetle; Coffee berry borer; Annual blue grass weevil (Listronotus maculicollis); Asiatic garden beetle (Maladera castanea); European chafer (Rhizotroqus majalis); Green June beetle (Cotinis nitida); Japanese beetle (Popillia japonica); May or June beetle (Phyllophaga sp.); Northern masked chafer (Cyclocephala borealis); Oriental beetle (Anomala orientalis); Southern masked chafer (Cyclocephala lurida); Billbug (Curculionoidea); Aedes aegypti; Busseolafusca; Chilo suppressalis; Culex pipiens; Culex quinquefasciatus; Diabrotica virgifera; Diatraea saccharalis; Helicoverpa armigera; Helicoverpa zea; Heliothis virescens; Leptinotarsa decemlineata; Ostrinia furnacalis; Ostrinia nubilalis; Pectinophora gossypiella; Plodia interpunctella; Plutella xylostella; Pseudoplusia includens; Spodoptera exigua; Spodoptera frugiperda; Spodoptera littoralis; Trichoplusia ni; and/or Xanthogaleruca luteola.

In some embodiments, the compositions, mixtures, and/or methods of the present disclosure can be applied to the locus of an adult beetle selected from the group consisting of: Asiatic garden beetle (Maladera castanea); Gold spotted oak borer (Agrilus coxalis auroguttatus); Green June beetle (Cotinis nitida); Japanese beetle (Popillia japonica); May or June beetle (Phyllophaga sp.); Oriental beetle (Anomala orientalis); and/or Soap berry-borer (Agrilus prionurus).

In some embodiments, the compositions, mixtures, and/or methods of the present disclosure can be applied to the locus of an insect and/or pest that is a larvae (annual white grub) selected from the group consisting of: Annual blue grass weevil (Listronotus maculicollis); Asiatic garden beetle (Maladera castanea); European chafer (Rhizotroqus majalis); Green June beetle (Cotinis nitida); Japanese beetle (Popillia japonica); May or June beetle (Phyllophaga sp.); Northern masked chafer (Cyclocephala borealis); Oriental beetle (Anomala orientalis); Southern masked chafer (Cyclocephala lurida); and Billbug (Curculionoidea).

### Illustrative Embodiments

In some embodiments, a liposome of the present disclosure comprises, consists essentially of, or consists of: a liposome comprising an insecticidal protein or agriculturally acceptable salt thereof, wherein the liposome encapsulates the insecticidal protein or agriculturally acceptable salt thereof; and wherein the liposome comprises lecithin.

In some embodiments, a liposome of the present disclosure comprises, consists essentially of, or consists of: a liposome comprising an insecticidal protein or agriculturally acceptable salt thereof, wherein the liposome encapsulates the insecticidal protein or agriculturally acceptable salt thereof; and wherein the liposome comprises lecithin, wherein the lecithin is a natural lecithin, a semi-synthetic lecithin, or a synthetic lecithin.

In some embodiments, a liposome of the present disclosure comprises lecithin, wherein the lecithin is a plant lecithin, or an animal lecithin.

In some embodiments, a liposome of the present disclosure comprises plant lecithin, wherein the plant lecithin is a soy lecithin.

In some embodiments, a liposome of the present disclosure comprises soy lecithin, wherein the soy lecithin is a hydrogenated soy lecithin.

In some embodiments, a liposome of the present disclosure has an average diameter of about 10-200 nm.

In some embodiments, a liposome of the present disclosure has an average diameter of about 15-150 nm.

In some embodiments, a liposome of the present disclosure has an average diameter of about 20-100 nm.

In some embodiments, a liposome of the present disclosure comprises, consists essentially of, or consists of: an insecticidal protein or agriculturally acceptable salt thereof, wherein the liposome encapsulates the insecticidal protein or agriculturally acceptable salt thereof; and wherein the liposome comprises lecithin, and wherein the encapsulated insecticidal protein or agriculturally acceptable salt thereof has a greater bioavailability when ingested by a pest when compared to an equivalent amount of the insecticidal protein or agriculturally acceptable salt thereof when not encapsulated in the liposome and is ingested by the pest.

In some embodiments, a liposome of the present disclosure comprises, consists essentially of, or consists of: an insecticidal protein or agriculturally acceptable salt thereof, wherein the liposome encapsulates the insecticidal protein or agriculturally acceptable salt thereof; wherein the encapsulated insecticidal protein or agriculturally acceptable salt thereof has a greater bioavailability when ingested by a pest when compared to an equivalent amount of the insecticidal protein or agriculturally acceptable salt thereof when not encapsulated in the liposome and is ingested by the pest.

In some embodiments, the greater bioavailability is a greater oral bioavailability.

In some embodiments, a liposome of the present disclosure comprises, consists essentially of, or consists of: an insecticidal protein or agriculturally acceptable salt thereof, wherein the liposome encapsulates the insecticidal protein or agriculturally acceptable salt thereof; wherein the encapsulated insecticidal protein or agriculturally acceptable salt thereof has a greater bioavailability when ingested by a pest when compared to an equivalent amount of the insecticidal protein or agriculturally acceptable salt thereof when not encapsulated in the liposome and is ingested by the pest; wherein the pest is in an insect pest.

In some embodiments, the insect pest is a lepidopteran pest, or a coleopteran pest.

In some embodiments, a liposome of the present disclosure comprises, consists essentially of, or consists of: an insecticidal protein or agriculturally acceptable salt thereof, wherein the liposome encapsulates the insecticidal protein or agriculturally acceptable salt thereof; wherein the insecticidal protein or agriculturally acceptable salt thereof is about 25-50 amino acids in length.

In some embodiments, a liposome of the present disclosure encapsulates an insecticidal protein or agriculturally acceptable salt thereof, wherein the insecticidal protein is a cysteine-rich insecticidal protein (CRIP).

In some embodiments, a liposome of the present disclosure encapsulates an arthropod toxin, an amphibian toxin, a reptile toxin, a cnidarian toxin, a mollusk toxin, a fish toxin, a mammalian toxin, or a variant thereof.

In some embodiments, a liposome of the present disclosure encapsulates an arthropod toxin, wherein the arthropod toxin is an arachnid toxin.

In some embodiments, a liposome of the present disclosure encapsulates an arachnid toxin, wherein the arachnid toxin is a spider toxin or a scorpion toxin.

In some embodiments, a liposome of the present disclosure encapsulates a spider toxin, wherein the spider toxin is an Agelenopsis aperta toxin, an Agelena orientalis toxin, an Allagelena opulenta toxin, an Ancylometes sp. toxin, an Aphonopelma sp toxin, an Apomastus schleringi toxin, an Atrax formidabilis toxin, an Atrax sp. Illawarra toxin, an Atrax infensus toxin, an Atrax robustus toxin, a Brachypelma albiceps toxin, a Brachypelma smithi toxin, a Calisoga sp. toxin, a Ceratogyrus marshalli toxin, a Chilobrachys jingzhao toxin, a Coremiocnemis valida toxin, a Ctenus ornatus toxin, a Cupiennius salei toxin, a Diguetia canities toxin, an Eratigena agrestis toxin, an Eucratoscelus constrictus toxin, a Grammostola rosea toxin, a Hadronyche formidabilis toxin, a Hadronyche infensa toxin, a Hadronyche venenata toxin, a Hadronyche versuta peptides toxin, a Haplopelma hainanum toxin, a Haplopelma huwenum toxin, a Heriaeus melloteei toxin, a Heteropoda venatoria toxin, a Heteroscodra maculate toxin, a Hololena curta toxin, a Hysterocrates gigas toxin, an Illawara wisharti toxin, a Lasiodora sp toxin, a Latrodectus tredecimguttatus toxin, a Macrothele gigas toxin, a Macrothele raveni toxin, a Missulena bradleyi toxin, a Oxyopes lineatus toxin, a Paraphysa scrofa toxin, a Phoneutria keyserlingi toxin, a Phoneutria nigriventer toxin, a Phoneutria reidyi toxin, a Pireneitega luctuosa toxin, a Plectreurys tristis toxin, a Plesiophrictus guangxiensis toxin, a Psalmopoeus cambridgei toxin, a Segestria florentina toxin, a Stromatopelma calceatum toxin, a Theraphosa blondi, or a Thrixopelma pruriens toxin.

In some embodiments, a liposome of the present disclosure encapsulates a spider toxin, wherein the spider toxin is a Hadronyche venenata toxin, an Atrax robustus toxin, an Atrax formidabilis toxin, an Atrax infensus toxin, a Phoneutria nigriventer toxin, or an Eratigena agrestis toxin.

In some embodiments, a liposome of the present disclosure encapsulates a spider toxin, wherein the spider toxin has an amino acid sequence that is at least 80%, 85%, 90%, or at least 95% identical to an amino sequence set forth in any one of SEQ ID NO: 1-5, 8, 9-244, 600-701.

In some embodiments, a liposome of the present disclosure encapsulates a scorpion toxin, wherein the scorpion toxin is an Androctonus australis toxin, an Androctonus mauretanicus mauretanicus toxin, an Anuroctonus phaiodactylus toxin, a Bothus martensii Karsch toxin, a Bothus occitanus tunetanus toxin, a Buthacus arenicola toxin, a Buthotus judaicus toxin, a Buthus eupeus toxin, a Buthus martensii toxin, a Buthus occitanus mardochei toxin, a Buthus occitanus tunetanus toxin, a Buthus sindicus toxin, a Centruroides elegans toxin, a Centruroides exilicauda toxin, a Centruroides gracilis toxin, a Centruroides limbatus toxin, a Centruroides limpidus limpidus toxin, a Centruroides margaritatus toxin, a Centruroides noxius toxin, a Centruroides sculpturatus toxin, a Centruroides suffusus suffuses toxin, a Hadrurus gertschi toxin, a Hemiscorpius lepturus toxin, a Heterometrus spinfer toxin, a Hottentotta judaica toxin, a Leiurus quinquestriatus toxin, a Mesobuthus eupeus toxin, a Mesobuthus martensii toxin, a Mesobuthus tamulus toxin, an Odonthobuthus doriae toxin, an Orthochirus scrobiculosus toxin, a Pandinus imperator toxin, a Parabuthus granulatus toxin, a Parabuthus transvaalicus toxin, a Parabuthus villosus toxin, a Scorpio maurus toxin, a Tityus cambridgei toxin, a Tityus costatus toxin, a Tityus discrepans toxin, a Tityus serrulatus toxin, a Tityus trivittatus toxin, or a Tityus zulianus toxin.

In some embodiments, a liposome of the present disclosure encapsulates a scorpion toxin, wherein the scorpion toxin is a Pandinus imperator toxin.

In some embodiments, a liposome of the present disclosure encapsulates a scorpion toxin, wherein the scorpion toxin has an amino acid sequence that is at least 80%, 85%, 90%, or at least 95% identical to an amino sequence set forth in SEQ ID NO: 245-348.

In some embodiments, a liposome of the present disclosure encapsulates a cnidarian, wherein the cnidarian toxin is an Anemonia viridis toxin, an Actinia equina toxin, an Anemonia erythraea toxin, an Anemonia sulcata toxin, an Anthopleura elegantissima toxin, an Anthopleura fuscoviridis toxin, an Anthopleura xanthogrammica toxin, a Bunodosoma caissarum toxin, a Bunodosoma cangicum toxin, a Bunodosoma granulifera toxin, a Heteractis crispa toxin, a Parasicyonis actinostoloides toxin, a Radianthus paumotensis toxin, or a Stoichactis helianthus toxin.

In some embodiments, a liposome of the present disclosure encapsulates a cnidarian, wherein the cnidarian toxin is an Anemonia viridis toxin.

In some embodiments, a liposome of the present disclosure encapsulates a cnidarian, wherein the cnidarian toxin has an amino acid sequence that is at least 80%, 85%, 90%, or at least 95% identical to an amino sequence set forth in SEQ ID NO: 6, 7, 349-389, or 430-599.

In some embodiments, a liposome of the present disclosure encapsulates a mollusk, wherein the mollusk toxin is a Conus amadis toxin, a Conus catus toxin, a Conus ermineus toxin, a Conus geographus toxin, a Conus gloriamaris toxin, a Conus kinoshitai toxin, a Conus magus toxin, a Conus marmoreus toxin, a Conus purpurascens toxin, a Conus stercusmuscarum toxin, a Conus striatus toxin, a Conus textile toxin, a Conus tulipa toxin, or a Striated cone toxin.

In some embodiments, a liposome of the present disclosure encapsulates a mollusk toxin, wherein the mollusk toxin has an amino acid sequence that is at least 80%, 85%, 90%, or at least 95% identical to an amino sequence set forth in SEQ ID NO: 392-429.

In some embodiments, the present disclosure provides a composition comprising, consisting essentially of, or consisting of: a liposome comprising an insecticidal protein or agriculturally acceptable salt thereof, wherein the liposome encapsulates the insecticidal protein or agriculturally acceptable salt thereof, and wherein the liposome comprises lecithin; and at least one excipient.

In some embodiments, the composition is an agricultural composition.

In some embodiments, the composition is an agricultural composition, and the at least one excipient and the liposomes are formulated into a solution, an emulsion, a powder, a dust, a pellet, a granule, a spray, or a colloid.

In some embodiments, the present disclosure provides a method of combating, controlling, or inhibiting a pest comprising, applying a pesticidally effective amount of: (1) a liposome comprising an insecticidal protein or agriculturally acceptable salt thereof, wherein the liposome encapsulates the insecticidal protein or agriculturally acceptable salt thereof, and wherein the liposome comprises lecithin; and/or (2) a liposome comprising an insecticidal protein or agriculturally acceptable salt thereof, wherein the liposome encapsulates the insecticidal protein or agriculturally acceptable salt thereof, and wherein the liposome comprises lecithin; and at least one excipient; to the pest, a locus of the pest, a food supply of the pest, a habitat of the pest, or a breeding ground of the pest; a plant, a seed, a plant part, a locus of a plant, or an environment of a plant that is susceptible to an attack by the pest; an animal, a locus of an animal, or an environment of an animal susceptible to an attack by the pest; or a combination thereof.

In some embodiments, the method of the present disclosure comprises combating, controlling, or inhibiting a pest by applying a pesticidally effective amount of a liposome of the present disclosure of a composition thereof to the pest, a locus of the pest, a food supply of the pest, a habitat of the pest, or a breeding ground of the pest; a plant, a seed, a plant part, a locus of a plant, or an environment of a plant that is susceptible to an attack by the pest; an animal, a locus of an animal, or an environment of an animal susceptible to an attack by the pest; or a combination thereof, wherein the pest is selected from the group consisting of: Eumorpha achemon; Coilas eurytheme; Caudra cautella; Amorbia humerosana; Pseudaletia unipuncta; Platyptilia carduidactyla; Datana major; Thyridopteryx ephemeraeformis; Hypercompe scribonia; Erionota thrax; Acleris gloverana; Phryganidia californica; Paleacrita merriccata; Grapholita packardi; Nymphula stagnata; Xylomyges curialis; Cydia pomonella; Acrobasis vaccinii; Evergestis rimosalis; Noctuid species; Agrotis ipsilon; Orgyia pseudotsugata; Erinnyis ello; Ennomos subsignaria; Lobesia botrana; Thymelicus lineola; Melissopus latiferreanus; Archips rosanus; Archips argyrospilia; Paralobesia viteana); Platynota stultana; Harrisina americana; Plathypena scabra; Dryocampa rubicunda; Batrachedra comosae; Lymantria dispar; Lambdina fiscellaria; Manduca quinquemaculata; Manduca sexta; Pieris rapae; Automeris io; Choristoneura pinus; Epiphyas postvittana; Diaphania hyalinata; Homadaula anisocentra; Choristoneura rosaceana; Syntomeida epilais; Playnota stultana; Sabulodes aegrotata; Papilio cresphontes; Argyrotaenia citrana; Grapholita molesta; Anarsia lineatella; Neophasia menapia; Argyrotaenia velutinana; Schizura concinna; Sibine stimulea; Heterocampa guttivitta; Estigmene acrea; Crambus sp.; Ennomos subsignaria; Alsophila pometaria; Choristoneura fumiferana; Lasiocampidae sp.; Thecla basilides; Ephestia elutella; Platynota idaeusalis; Anarsia lineatella; Peridroma saucia; Platynota flavedana; Anticarsia gemmatalis; Datana integerrima; Hyphantria cunea; Orgyia vetusta; Southern Diatraea crambidoides; Cylas formicarius; Anthonomus eugenii; Diaprepes abbreviatus; Otiorhynchus ovatus; Curculio caryae; Curculio occidentis; Lissorhoptrus oryzophilus; Hypera postica; Hypera zoilus; Euwallaceafornicatus; Euetheola humilis; Hypothenemus hampei; Listronotus maculicollis; Maladera castanea; Rhizotroqus majalis; Cotinis nitida; Popilia japonica; Phyllophaga sp.; Cyclocephala borealis; Anomala orientalis; Cyclocephala lurida; Sphenophorus parvulus; Sphenophorus apicalis; Sphenophorus cariosus; Sphenophorus inaequalis; Sphenophorus minimus; Aedes aegypti; Busseolafusca; Chilo suppressalis; Culex pipiens; Culex quinquefasciatus; Diabrotica virgifera; Diatraea saccharalis; Helicoverpa armigera; Helicoverpa zea; Heliothis virescens; Leptinotarsa decemlineata; Ostrinia furnacalis; Ostrinia nubilalis; Pectinophora gossypiella; Plodia interpunctella; Plutella xylostella; Pseudoplusia includens; Spodoptera exigua; Spodoptera frugiperda; Spodoptera littoralis; Trichoplusia ni; and Xanthogaleruca luteola.

In some embodiments, the method of the present disclosure comprises combating, controlling, or inhibiting a pest by applying a pesticidally effective amount of a liposome of the present disclosure of a composition thereof to the pest, a locus of the pest, a food supply of the pest, a habitat of the pest, or a breeding ground of the pest; wherein the pest is selected from the group consisting of: Aedes aegypti; Busseola fusca; Chilo suppressalis; Culex pipiens; Culex quinquefasciatus; Diabrotica virgifera; Diatraea saccharalis; Helicoverpa armigera; Helicoverpa zea; Heliothis virescens; Leptinotarsa decemlineata; Ostrinia furnacalis; Ostrinia nubilalis; Pectinophora gossypiella; Plodia interpunctella; Plutella xylostella; Pseudoplusia includens; Spodoptera exigua; Spodoptera frugiperda; Spodoptera littoralis; Trichoplusia ni; and Xanthogaleruca luteola.

In some embodiments, the present disclosure provides a method of making a liposome encapsulating an insecticidal protein, the method comprising: (a) preparing a homogenized aqueous solution comprising lecithin and water; (b) preparing an aqueous solution comprising an insecticidal protein; (c) mixing the homogenized aqueous solution of step (a) with the aqueous solution of step (b). In some embodiments, the mixture of the homogenized aqueous solution of step (a), and the aqueous solution of step (b), is sonicated.

In some embodiments, the present disclosure provides a method of making a liposome comprising an insecticidal protein or agriculturally acceptable salt thereof, wherein the liposome encapsulates the insecticidal protein or agriculturally acceptable salt thereof, and wherein the liposome comprises lecithin; wherein the lecithin is a natural lecithin, a semi-synthetic lecithin, or a synthetic lecithin.

In some embodiments, the present disclosure provides a method of making a liposome comprising an insecticidal protein or agriculturally acceptable salt thereof, wherein the liposome encapsulates the insecticidal protein or agriculturally acceptable salt thereof, and wherein the liposome comprises lecithin; wherein the lecithin is a plant lecithin, or an animal lecithin.

In some embodiments, the present disclosure provides a method of making a liposome comprising an insecticidal protein or agriculturally acceptable salt thereof, wherein the liposome encapsulates the insecticidal protein or agriculturally acceptable salt thereof, and wherein the liposome comprises a plant lecithin; wherein the plant lecithin is a soy lecithin.

In some embodiments, the present disclosure provides a method of making a liposome comprising an insecticidal protein or agriculturally acceptable salt thereof, wherein the liposome encapsulates the insecticidal protein or agriculturally acceptable salt thereof, and wherein the liposome comprises a soy lecithin; wherein the soy lecithin is a hydrogenated soy lecithin.

### EXAMPLES

The Examples in this specification are not intended to, and should not be used to, limit the invention; they are provided only to illustrate the invention.

### Example 1. Liposome Preparation

A liposome preparation comprising U+2-ACTX-Hv1a (“Hybrid+2”) was created and subsequently evaluated. The liposome preparation comprised reverse osmosis (RO) water, soy lecithin, and concentrated U+2-ACTX-Hv1a (“Hybrid+2”)(68 g/L). The Soy lecithin evaluated here was L-α-Lecithin (CAS 8002-43-5), a concentrate of soybean lecithin consisting of more than 94% phosphatidylcholine, and less than 2% triglycerides; and composed mainly of linoleic acid (62-65%) and palmitic acid (15-17%) esters. Soy lecithin was obtained from Sigma-Aldrich (MilliporeSigma; Catalog No. 429415; 3050 Spruce Street, St. Louis, MO 63103, USA).

The Hybrid+2 peptide used in the preparation has the amino acid sequence

(SEQ ID NO: 1)
“GSQYCVPVDQPCSLNTQPCCDDATCTQERNENGHTVYYCRA”.

To make the preparation, 37 g of soy lecithin granules were soaked in 400 mL of water for 1-2 hours, and then homogenized by mixing in a food processor for 30 seconds. Next, 15 g of powdered Hybrid+2 was dissolved in 20 mL of reverse osmosis water to achieve a high concentration, by slowly adding the powdered material and vortexing to dissolve. The mixture was then centrifuged at 5000×g for 10 minutes, to force any remaining particulate to the bottom of the tube. The supernatant was removed, and a sample of the solution was diluted 10×, 50×, and 100×, and analyzed via HPLC to determine the peptide concentration, using caffeine as an internal standard, which has a known sensitivity ratio to the peptide. The resulting concentration was 170 g/L. The solution was stored at 4° C. until the other components were prepared. Next, 37 g of soy lecithin was soaked overnight in 400 mL of water at 4° C. After 24-hours, the soy lecithin and water was homogenized in a food processor to break up the large pieces of lecithin. Once a consistent mixture was achieved the soy lecithin and water mixture was removed and returned to cold storage.

Prior to use, both the Hybrid+2 and soy lecithin mixtures were removed from cold storage. In order to achieve an ˜20 g/L final concentration, the Hybrid+2 mixture solution was diluted 2.5× with reverse osmosis water in order to bring the concentration to −68 g/L. After dilution, 75 mL of the Hybrid+2 mixture was combined with 150 mL of the soy lecithin mixture, resulting in an estimated Hybrid+2 concentration of 22.6 g/L. The resulting liposome/Hybrid+2 composition was then placed in a food processor and agitated for 30 seconds to ensure adequate mixing. The liposome/Hybrid+2 composition was then split into four 50 mL falcon tubes and placed on ice. Each 50 mL aliquot of the liposome/Hybrid+2 composition was then added into a 250 mL beaker on ice, and sonicated for 40 minutes, before being returned to the falcon tube in ice. The 50 mL aliquots were recombined to ensure homogeneity of the samples. The liposome/Hybrid+2 composition was then transferred for use in the bioassay, along with a “null formulation” comprising water in place of the Hybrid+2 solution.

Samples were spun through a spin filter (0.45 μm) for 30 seconds at 5000×g. Quantification of the Hybrid+2 was made using HPLC, which revealed that the liposomal/Hybrid+2 preparation filtrate contained 19.2 g/L of Hybrid+2 in the composition, which was slightly less than the targeted 22.6 g/L.

### Example 2. Corn Earworm (CEW) Foliar Spray Bioassay: Hybrid+2

A foliar spray bioassay was performed using liposomes compositions of the present disclosure against Helicoverpa zea (Corn earworm or CEW), and evaluating subsequent reduction in CEW leaf damage and insect mortality. The insecticidal protein used in this example was U+2-ACTX-Hv1a (“Hybrid+2”), having an amino acid sequence of:

(SEQ ID NO: 1)
GSQYCVPVDQPCSLNTQPCCDDATCTQERNENGHTVYYCRA.

Organic Romaine lettuce was cut into 30 mm diameter disks. The leaf disks were sterilized in 140 ppm bleach and triple rinsed. Next, the leaf disks were pinned to a Styrofoam board, then sprayed and dried on both sides. The arena for the bioassay comprised a 32-well rearing tray with 5 mL of 1% agar, containing 1 leaf disk per well, and 1 first instar corn earworm (CEW) per leaf disk. Twelve leaf disks were used per treatment. The trays placed in 28° C. Incubator, with three replicates (N=48).

The treatments used in the foliar spray bioassay were as follows:

(1) “Hybrid+2 alone,” which is the insecticidal protein, U+2-ACTX-Hv1a (“Hybrid+2”), evaluated alone. Here, a 2% spray solution of was created using Spear®-T Liquid Concentrate (Lot: 14143019; Vestaron®, 600 Park Offices Dr, Ste 117, Durham, NC 27709, USA), and was evaluated at final Hybrid+2 concentrations of 0, 2, 6, and 18 mg/mL. No surfactant was used in the composition.

(2) “Hybrid+2 null liposome mixture,” which is a mixture of liposomes encapsulating water (null liposomes), and Hybrid+2 (Spear®-T Liquid Concentrate (Lot: 14143019; Vestaron®, 600 Park Offices Dr, Ste 117, Durham, NC 27709, USA), was evaluated at final concentrations of 0, 2, 6, and 18 mg/mL. No surfactant was used in the composition. Briefly, a “null liposome” is made by replacing the Hybrid+2 portion of the combination with RO water, and then sonicating in the same way as the encapsulated insecticidal proteins. In addition, Hybrid+2 null liposome mixture treatment was generated by first making the liposomes according to the sonication procedures described herein, and then adding Hybrid+2 after (post-sonication): this was meant to determine whether Hybrid+2 required encapsulation in order to be effective.

(3) “Liposome-encapsulated Hybrid+2,” which is Hybrid+2 encapsulated in a liposome. Here, a 3.75% spray solution containing Hybrid+2 (Spear®-T Liquid Concentrate (Lot: 14143019; Vestaron®, 600 Park Offices Dr, Ste 117, Durham, NC 27709, USA) encapsulated in liposomes was evaluated at final concentrations of 0, 2, 6, and 18 mg/mL. No surfactant was used in the composition. Here, liposomes were prepared and used to encapsulate Hybrid+2 according to the method described in Example 1.

The foregoing groups were analyzed by taking measurements 4-days post-spraying, and assessing for leaf damage and CEW mortality.

### Leaf Damage Results

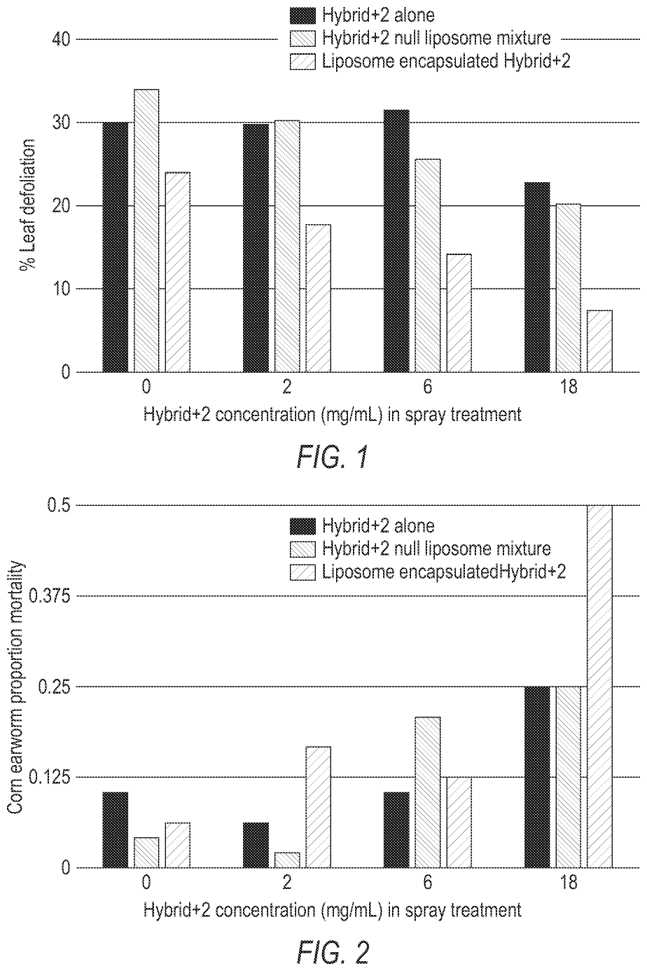

The effect of the treatments on reducing CEW leaf damage were assessed on day 4. As shown in FIG. 1, using Hybrid+2 alone resulted in 29.9%, 29.8%, 31.6%, and 22.8% leaf defoliation at 0, 2, 6, and 18 mg/mL of Hybrid+2, respectively. FIG. 1.

When the Hybrid+2 null liposome mixture was used, leaf defoliation was 34.0% at 0 mg/mL of Hybrid+2; 30.2% at 2 mg/mL of Hybrid+2; 25.6% at 6 mg/mL of Hybrid+2; and 20.2% at 18 mg/mL of Hybrid+2. FIG. 1.

Finally, when Liposome-encapsulated Hybrid+2 was used, leaf defoliation was reduced to 24.0% at 0 mg/mL of Hybrid+2; 17.7% at 2 mg/mL of Hybrid+2; 14.2% at 6 mg/mL of Hybrid+2; and 7.4% at 18 mg/mL of Hybrid+2. FIG. 1.

These results show that percent leaf defoliation was similar for Hybrid+2 both alone and when mixed with liposomes (i.e., post-sonication, and not encapsulated). However, when Hybrid+2 was encapsulated in liposomes, there was a surprising decrease in the amount of leaf defoliation. Accordingly, the results shown here indicate that encapsulation may be required to influence the efficacy of Hybrid+2 with regard to a reduction in leaf defoliation. These results implicate the surprising effect of increased bioavailability following liposome encapsulation.

### Mortality Results

The same treatments described above were used to evaluate the effect thereof on first instar CEW mortality. Here, Mortality was assessed using proportion mortality, which is the proportion of individual insects killed over the course of an experiment, i.e., proportion mortality=Number of dead individuals/Number of total individuals.

As shown in FIG. 2, using Hybrid+2 alone resulted in a proportion mortality of 0.10 at 0 mg/mL of Hybrid+2; 0.06 at 2 mg/mL of Hybrid+2; 0.10 at 6 mg/mL of Hybrid+2; and 0.25 at 18 mg/mL of Hybrid+2.

Using the Hybrid+2 null liposome mixture resulted in a proportion mortality of 0.04 at 0 mg/mL of Hybrid+2; 0.02 at 2 mg/mL of Hybrid+2; 0.21 at 6 mg/mL of Hybrid+2; and 0.25 at 18 mg/mL of Hybrid+2. FIG. 2.

Finally, when using Liposome-encapsulated Hybrid+2, proportion mortality was 0.062 at 0 mg/mL of Hybrid+2; 0.167 at 2 mg/mL of Hybrid+2; 0.125 at 6 mg/mL of Hybrid+2; and 0.500 at 18 mg/mL of Hybrid+2. FIG. 2.

The results of the leaf eating and mortality assays indicate that there was a greater than additive effect on feeding damage reduction, and CEW neonate mortality, when a liposome comprising an insecticidal protein or agriculturally acceptable salt thereof, wherein the liposome encapsulates the insecticidal protein or agriculturally acceptable salt thereof; and wherein the liposome comprises lecithin, is ingested by a pest when compared to an equivalent amount of the insecticidal protein or agriculturally acceptable salt thereof when not encapsulated in the liposome and is ingested by the pest.

As shown in this example, Hybrid+2 encapsulated in liposomes caused higher mortality in corn earworm larvae relative to Hybrid+2 when applied with or without null liposomes; and, Hybrid+2 encapsulated in liposomes caused less defoliation by corn earworm larvae compared to Hybrid+2 when applied with or without null liposomes. FIGS. 1 and 2.

### Example 3. Foliar Spray Bioassay: Second Instar CEW

A foliar spray bioassay using the liposome compositions of the present disclosure was performed on second instar CEW, to evaluate the effect of the compositions on leaf defoliation reduction and CEW mortality. Percent of the leaf eaten was evaluated on day 4 post-spraying. The treatments used in the foliar spray bioassay were as follows:
(1) UTC, an untreated control (deionized water).
(2) Liposome/Hybrid+2 composition: a composition of Hybrid+2 encapsulated in liposomes. Hybrid+2 (Spear®-T Liquid Concentrate (Lot: 14143019; Vestaron®, 600 Park Offices Dr, Ste 117, Durham, NC 27709, USA) was encapsulated in liposomes according to the methods described in Example 1. A final Hybrid+2 dose concentration was evaluated at a 0, 1, 3, and 9 part per thousand (ppt).
(3) Liposomes only: null liposomes (made as described in Example 2).
(4) Hybrid+2 only: Hybrid+2 (Spear®-T Liquid Concentrate (Lot: 14143019; Vestaron®, 600 Park Offices Dr, Ste 117, Durham, NC 27709, USA) evaluated at a Hybrid+2 dose concentration of 0, 1, 3, and 9 part per thousand (ppt).

None of the treatments contained any surfactant.

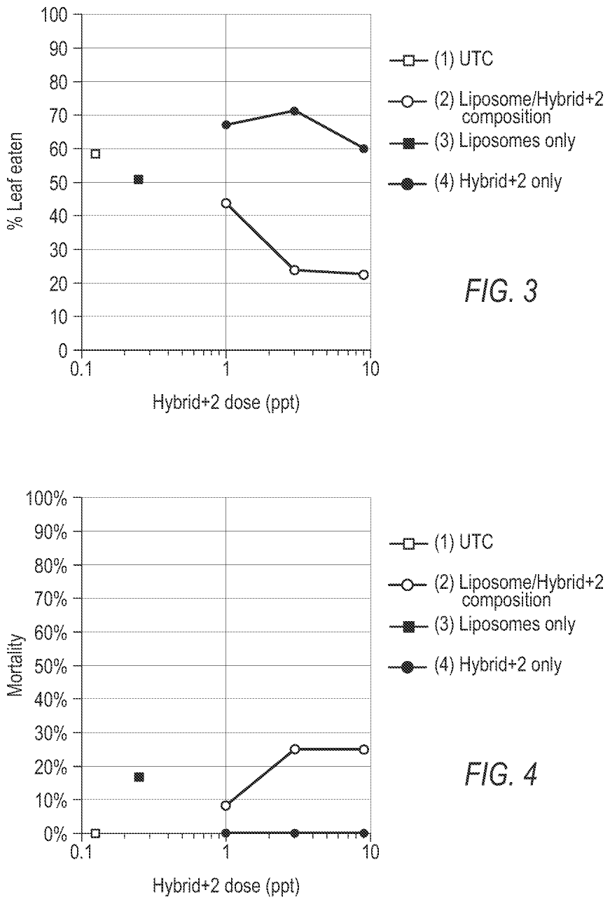

Similar to the results above, Hybrid+2 encapsulated in liposomes (i.e., treatment (2) Liposome/Hybrid+2 composition) resulted in decreased leaf damage. As shown in FIG. 3, the percent of leaf eaten for 1 ppt of Hybrid+2 only (treatment 4) was 67%. However, for the Liposome/Hybrid+2 composition (treatment 2), the percent of leaf eaten was 44%. FIG. 3. Accordingly, the insecticidal protein (i.e., Hybrid+2) is encapsulated in liposomes and ingested by a pest, there is a reduction in leaf defoliation when compared to an equivalent amount of the insecticidal protein when not encapsulated in the liposome and is ingested by the pest.

Liposome-encapsulated Hybrid+2 also resulted in increased mortality. As shown in FIG. 4, liposomes only resulted in 17% mortality in second instar CEW. The Hybrid+2 only treatment, at a dose of 1, 3, and 9 ppt, resulted in zero mortality. Surprisingly, at day 4, the liposome/Hybrid+2 composition at doses of 1, 3, and 9 ppt resulted in 8%, 25%, and 25% mortality, respectively. FIG. 4.

The inhibition of second instar corn earworm larvae feeding (leaf defoliation) using the Liposome/Hybrid+2 composition, as compared to Hybrid+2 only, was the most surprising result: indicating that the liposome encapsulation of Hybrid+2 results in increased bioavailability. Accordingly, this example suggests that liposome-encapsulated insecticidal protein or agriculturally acceptable salt thereof (e.g., Hybrid+2) has a greater bioavailability when ingested by a pest when compared to an equivalent amount of the insecticidal protein or agriculturally acceptable salt thereof when not encapsulated in the liposome and is ingested by the pest.

### Example 4. CEW Injection Assay: Hybrid+2

A injection assay was performed to determine the effect of liposome-encapsulated insecticidal proteins when injected into fourth instar CEW.

Fourth instar CEW were immobilized on ice for up to about 1-hour, prior to and during the experiment. Insects weighing between 90-120 mg were selected for injection. Injection solutions of (1) Hybrid+2 alone, and (2) Liposome-encapsulated Hybrid+2, were created as described above, and diluted in water to achieve the proper dose concentrations for injection. Next, a 1 μL solution containing either Hybrid+2 alone, or Liposome-encapsulated Hybrid+2 were injected into each insect at the base of the final proleg using a hand-microapplicator with 1 cc all-glass syringe with 30 gauge straight needle. The injected insects were then transferred to a single well containing 5 mL prepared general lepidoptera diet within a 32-well insect bioassay tray. The condition of the insects was assessed after 24-hours.

Injection dose concentrations of Hybrid+2 for both the Hybrid+2 alone and Liposome-encapsulated Hybrid+2 treatments were as follows:
0 pmol/g
1146 pmol/g
2293 pmol/g
4586 pmol/g
9172 pmol/g
18344 pmol/g

The Hybrid+2 peptide used for each experiment was:

(SEQ ID NO: 1)
GSQYCVPVDQPCSLNTQPCCDDATCTQERNENGHTVYYCRA.

Dose calculations were made using the following formula:

$$\frac{p m o l}{g} = \frac{( peptide solution , ppm ) ( injection volume , μL )}{( i nsect mass , m g ) ( peptide mol weight )} \qquad Formula ( XI )$$

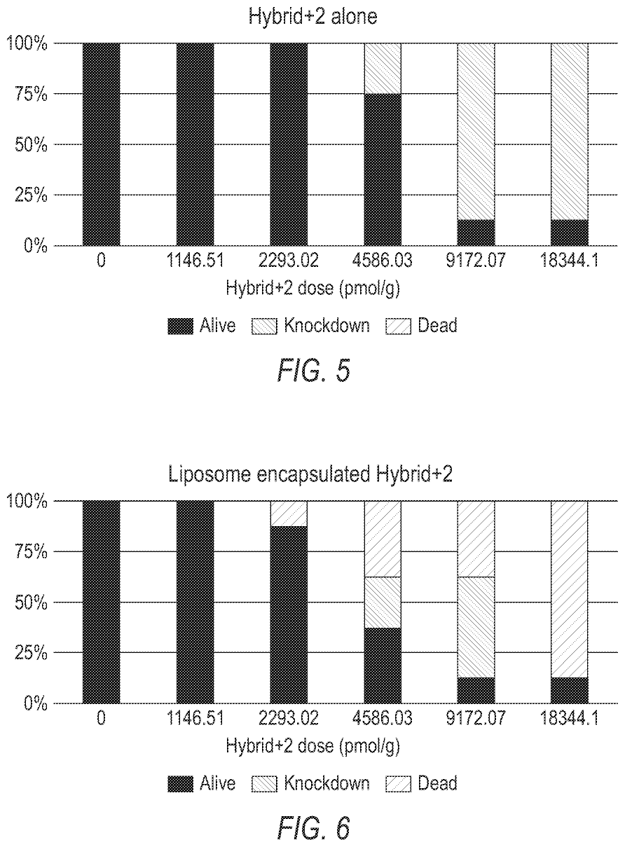

Briefly, Hybrid+2 alone or Liposome-encapsulated Hybrid+2 were combined in water in order to create an injection volume at desired concentration, according to the formula above. The doses injected were 0.0 mg/mL; 0.625 mg/mL; 1.25 mg/mL; 2.5 mg/mL; 5.0 mg/mL; and 10 mg/mL, which are concentrations corresponding to injected doses of 1146, 2293, 4586, 9172, and 18344 pmol/g respectively. The concentrations and doses are the same for the results shown in FIGS. 5 and 6.

Insect conditions were assessed after 24-hours, and insects were categorized as follows: alive (walking, eating, normal behavior); knockdown (unable to walk or eat, writhing, and tremors); and dead (unmoving, discoloration). The results of the injection assay are shown in FIGS. 5 and 6.

As shown in FIG. 5, which shows the results of Hybrid+2 alone injections, there was a dose/knockdown-response that was directly proportional to the injection concentration. Moreover, there were no dead CEW after 24-hours. However, as shown in FIG. 6, which shows the results of the Liposome-encapsulated Hybrid+2 injection, the dose/knockdown response was shifted: here, the Liposome-encapsulated Hybrid+2 injection resulted in actual mortality and at lower doses compared to Hybrid+2 alone.

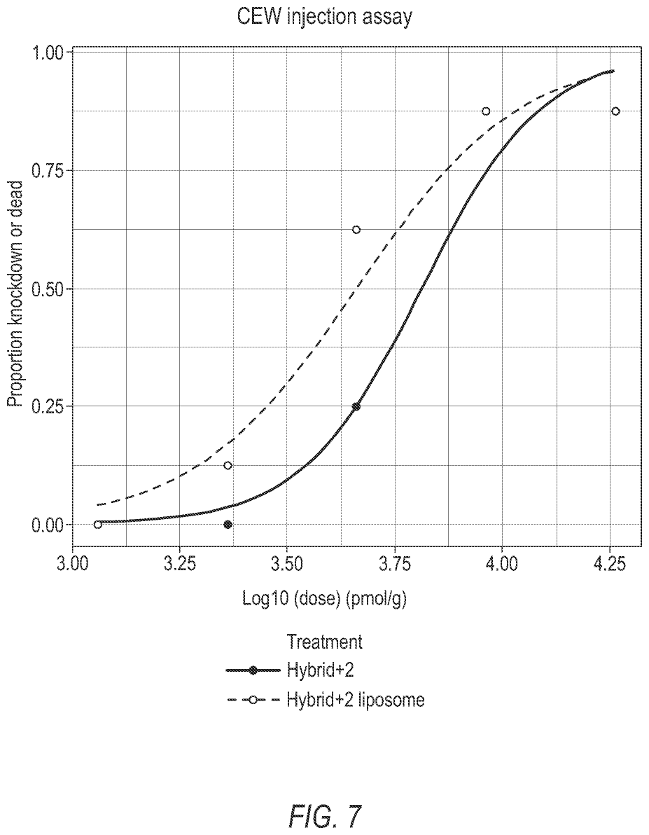

FIG. 7 presents a logarithmic dose-response plot illustrating proportion knockdown or proportion dead for the CEW injection assay, comparing Hybrid+2 alone (labeled as “Hybrid+2”) and Liposome-encapsulated Hybrid+2 (labeled “Hybrid+2 liposome”). As shown here, the KD₅₀ for Hybrid+2 alone was 6506 pmol/g, whereas Hybrid+2 encapsulated in liposomes has a KD₅₀ of 4586 pmol/g.

The results of the foregoing experiments show that, in an injection assay, Liposome-encapsulated Hybrid+2 caused higher mortality in fourth instar corn earworm than Hybrid+2 alone.

### Example 5. Housefly Injection Assay: Hybrid+2

A housefly injection assay using the liposome compositions of the present disclosure was performed as follows: adult houseflies were immobilized with CO₂ for 5 minutes, and then transferred to a CO₂ pan to keep immobilized. Insects with a weight between 15-18 mg were selected for injection. Treatments were as follows:
(1) Hybrid+2 alone.
(2) Liposome-encapsulated Hybrid+2.
(3) Hybrid+2 mixed with null liposomes, a composition composed of Hybrid+2, null liposomes that were added post sonication, and water.

Liposomes were generated according to the method described in Example 1. Each treatment was created as described above, and diluted in water to achieve the proper dose concentrations for injection, using Formula XI as described in Example 4. Injection doses of Hybrid+2 for each treatment was as follows:
0 pmol/g
30 pmol/g
52 pmol/g
75 pmol/g
112 pmol/g
165 pmol/g
248 pmol/g
375 pmol/g

Next, a 0.5 μL solution containing either Hybrid+2 alone; Liposome-encapsulated Hybrid+2 (Hybrid+2 liposome); or Hybrid+2 mixed with liposomes (Hybrid+2 null liposome), was injected into each insect at the dorsal thorax using a hand-microapplicator with 1 cc all-glass syringe with 30 gauge straight needle. The injected insects were then transferred to a 2 oz. transparent portion container with a wet #4 filter paper, and the condition of the insects was assessed after 24-hours.

To determine time-to-effect of a given composition, evaluations of insect proportion dead were also made at 6.5 hours, 8 hours, and 24 hours post-injection. Insect proportion dead=Number of dead individuals/Number of total individuals.

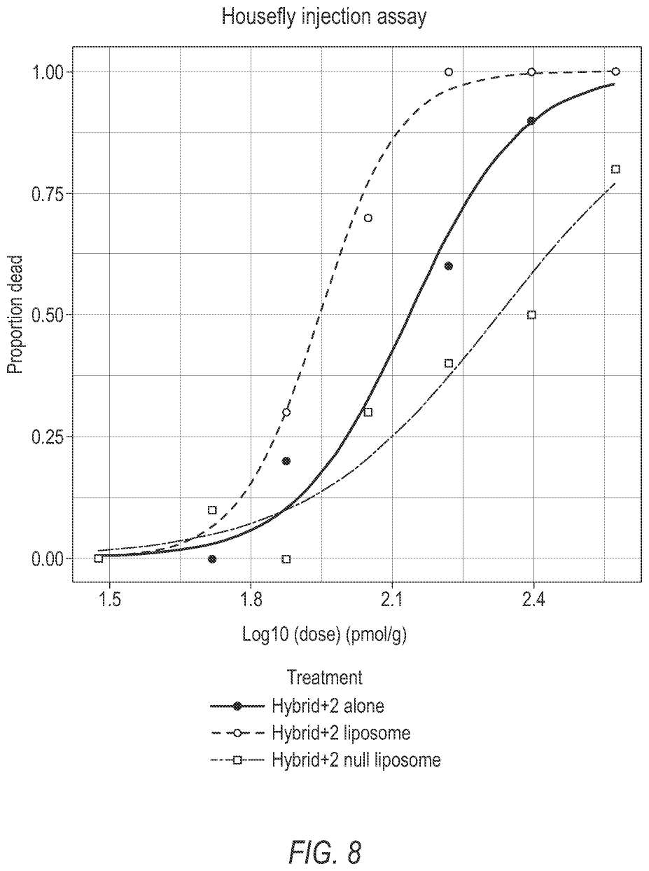

The results of the housefly injection assay are shown in FIG. 8. When Hybrid+2 alone was injected, the LD₅₀ was 137 pmol/g. When Hybrid+2 mixed with null liposomes was injected, the LD₅₀ was 211 pmol/g. However, when Liposome-encapsulated Hybrid+2 was injected, the LD₅₀ was shown to be 88 pmol/g. FIG. 8.

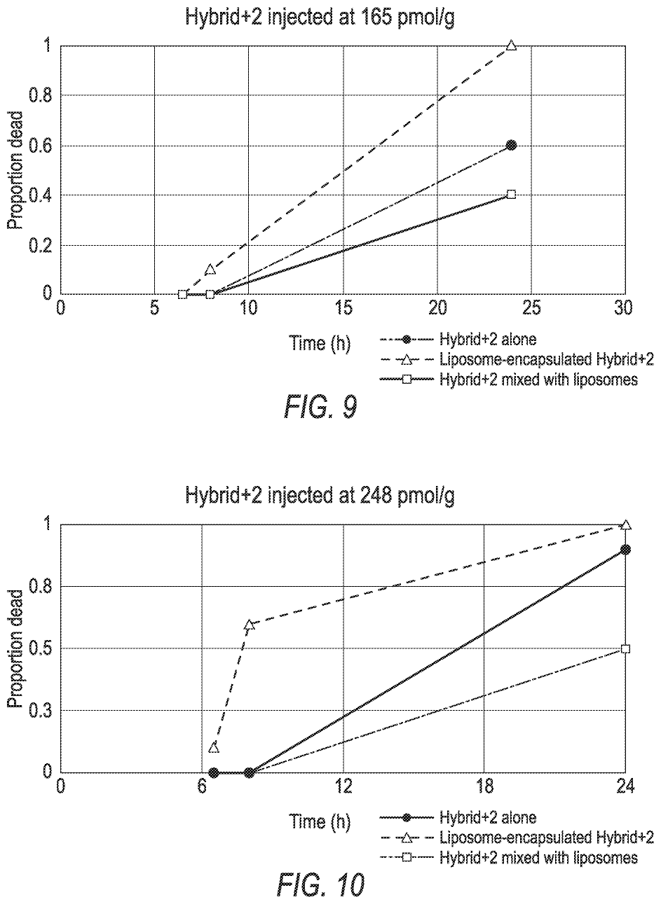

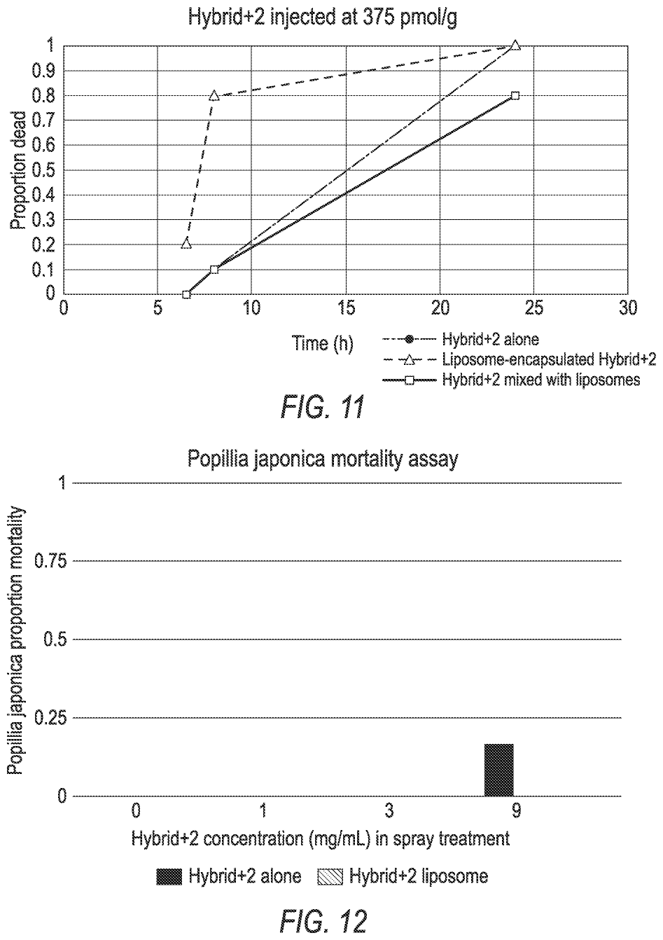

Time-to-effect of the liposome compositions of the present disclosure were also evaluated. The results of how quickly each treatment can exert its effect is shown in FIGS. 9-11. Here, the figures show the proportion dead over time in hours for concentrations of 165, 248, and 375 pmol/g of Hybrid+2 in each treatment. As shown here, for each concentration, Liposome-encapsulated Hybrid+2 was found to be active more quickly than Hybrid+2 alone.

In summary, the results shown in this example demonstrate that, for housefly injections, Liposome-encapsulated Hybrid+2 results in a lower LD₅₀ compared to Hybrid+2 alone, or when Hybrid+2 is mixed with null liposomes (i.e., not encapsulated). Accordingly, Liposome-encapsulated Hybrid+2 is more active than Hybrid+2 alone, and was active more quickly than Hybrid+2 alone.

### Example 6. Japanese Beetle Foliar Spray Bioassay: Hybrid+2

A foliar spray bioassay was performed to evaluate the effect of liposome compositions comprising Hybrid+2 on Popillia japonica (Japanese beetle) mortality.

Organic Romaine lettuce was cut into 57.15 mm diameter disks. The leaf disks were sterilized in 140 ppm bleach and triple rinsed. Next, the leaf disks were pinned to a Styrofoam board, then sprayed and dried on both sides. The arena for the bioassay comprised agar filled petri plates (100×15 mm), with 5 mL of 1% agar, containing 1 leaf disk per disk, and 1 adult Japanese beetle per leaf disk. One replicate consisted of 6 disks per treatment, per dose. Disks were placed in a 28° C. Incubator for 4 days, with one replicate (N=12).

The insecticidal effect of Hybrid+2 was tested on Japanese beetles. Two treatments were evaluated: (1) a spray solution of U+2-ACTX-Hv1a (“Hybrid+2”) (Spear®-T Liquid Concentrate; Lot: 14143019; Vestaron®, 600 Park Offices Dr, Ste 117, Durham, NC 27709, USA) at 0, 1, 3, and 8 mg/mL, and with no surfactant; and (2) a spray solution of Liposome-encapsulated Hybrid+2, at spray solutions concentrations of 0, 1, 3, and 8 mg/mL, with no surfactant. Liposomes were created as described above in Example 1.

The foregoing treatments were analyzed by taking measurements 4-days post-spraying, and assessing for Japanese beetle mortality. Proportion mortality=Number of dead individuals/Number of total individuals.

As shown in FIG. 12, Liposome-encapsulated Hybrid+2 was found to be ineffective against Japanese beetles at the tested concentrations. And, only 8 mg/mL of Hybrid+2 alone resulted in mortality, of 16.7%. FIG. 12.

### Example 7. Japanese Beetle Foliar Spray Bioassay: Av3b

A foliar spray bioassay was performed to evaluate the insecticidal effect of Av3b encapsulated in liposomes on Popillia japonica (Japanese beetle), with regard to leaf defoliation and insect mortality.

Two Av3b treatments were evaluated: (1) Av3b alone: a spray solution of Av3b (Lot: UGAIEX12NOV19; Vestaron®, 600 Park Offices Dr, Ste 117, Durham, NC 27709, USA) at 0, 1, 3, and 8 mg/mL, and with no surfactant; and (2) Liposome-encapsulated Av3b: a spray solution of Av3b encapsulated in liposomes, at spray solutions concentrations of 0, 1, 3, and 8 mg/mL, with no surfactant. The Av3b peptide tested here has an amino acid sequence of KSCCPCYWGGCPWGQNCYPEGCSGPK (SEQ ID NO: 7).

The liposome spray solution was created as follows: a stock concentration of liposomes encapsulating Av3b was diluted in water to the desired concentrations. Liposome preparations and encapsulation was performed as described above. The foregoing treatment groups were analyzed by taking measurements 4-days post-spraying, and assessing for leaf damage and Japanese beetle mortality.

### Leaf Damage Results

The effect of the foregoing foliar bioassay treatments on leaf damage were assessed on day 4.

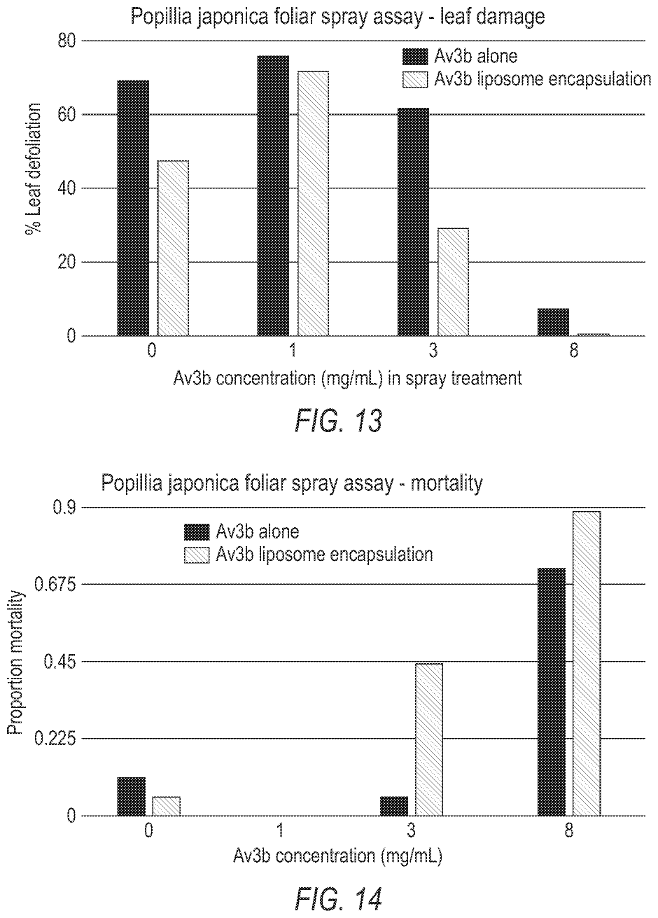

As shown in FIG. 13, using Av3b alone resulted in 69.2%, 75.8%, 61.7%, and 7.3% leaf defoliation at 0, 1, 3, and 8 mg/mL of Av3b, respectively. FIG. 13. However, when using Liposome-encapsulated Av3b, it resulted in 47.5%, 71.7%, 29.2%, and 0.5% leaf defoliation at 0, 1, 3, and 8 mg/mL of Av3b, respectively. FIG. 13.

As these results show, in a foliar spray bioassay, when Av3b is encapsulated in liposomes, it results in a reduction of the defoliation caused by adult Japanese beetles, as compared to Av3b alone.

### Mortality Results

The mortality of Japanese beetles was assessed using the same treatments as described above. Proportion mortality=Number of dead individuals/Number of total individuals.

As shown in FIG. 14, Av3b alone resulted in a proportion mortality of at 0.11 at 0 mg/mL; 0.0 at 1 mg/mL; 0.06 at 3 mg/mL; and 0.72 at 8 mg/mL, of Av3b. When using Liposome-encapsulated Av3b, the proportion mortality was 0.05 at 0 mg/mL of Av3b; 0.0 at 1 mg/mL of Av3b; 0.44 at 3 mg/mL of Av3b; and 0.89 at 8 mg/mL of Av3b. FIG. 14.

The results shown here demonstrate that in a foliar spray bioassay, Av3b encapsulated in liposomes results in higher mortality in Japanese beetle adults, compared to Av3b when applied alone. And, Av3b encapsulated in liposomes likewise results in less defoliation by Japanese beetle adults, compared to Av3b when applied alone.

### Example 8. Corn Earworm (CEW) Foliar Spray Bioassay: Av3b

A foliar spray bioassay was performed to evaluate the insecticidal effect of Av3b encapsulated in liposomes and Av3b alone on Helicoverpa zea (Corn earworm; CEW). Here, leaf damage and insect mortality were analyzed.

Briefly, organic Romaine lettuce was cut into 30 mm diameter disks. The leaf disks were sterilized in 140 ppm bleach and triple rinsed. Next, the leaf disks were pinned to a Styrofoam board, then sprayed and dried on both sides. The arena for the bioassay comprised a 32-well rearing tray with 5 mL of 1% agar, containing 1 leaf disk per well, and 1 first instar corn earworm (CEW) per leaf disk. Twelve leaf disks were used per tray. The trays placed in 28° C. Incubator, with three replicates (N=48).

Two Av3b treatments were evaluated: (1) Av3b alone: a spray solution of Av3b (Lot: UGAIEX12NOV19; Vestaron®, 600 Park Offices Dr, Ste 117, Durham, NC 27709, USA) at 0, 1, 3, and 8 mg/mL, and with no surfactant; and (2) Liposome-encapsulated Av3b: a spray solution of Av3b encapsulated in liposomes, at spray solutions concentrations of 0, 1, 3, and 8 mg/mL, with no surfactant. The Av3b peptide tested here has an amino acid sequence of KSCCPCYWGGCPWGQNCYPEGCSGPK (SEQ ID NO: 7).

Treatments were made as described in Example 7. The foregoing treatment groups were analyzed by taking measurements 4-days post-spraying, and assessing for leaf defoliation and CEW mortality.

Leaf defoliation was assessed with visual inspection and estimation of the leaf area eaten relative to the whole leaf Leaf discs are 30 mm diameters at the beginning of the experiment, which allows for easy calculation of leaf consumption by the insect.

### Leaf Damage Results

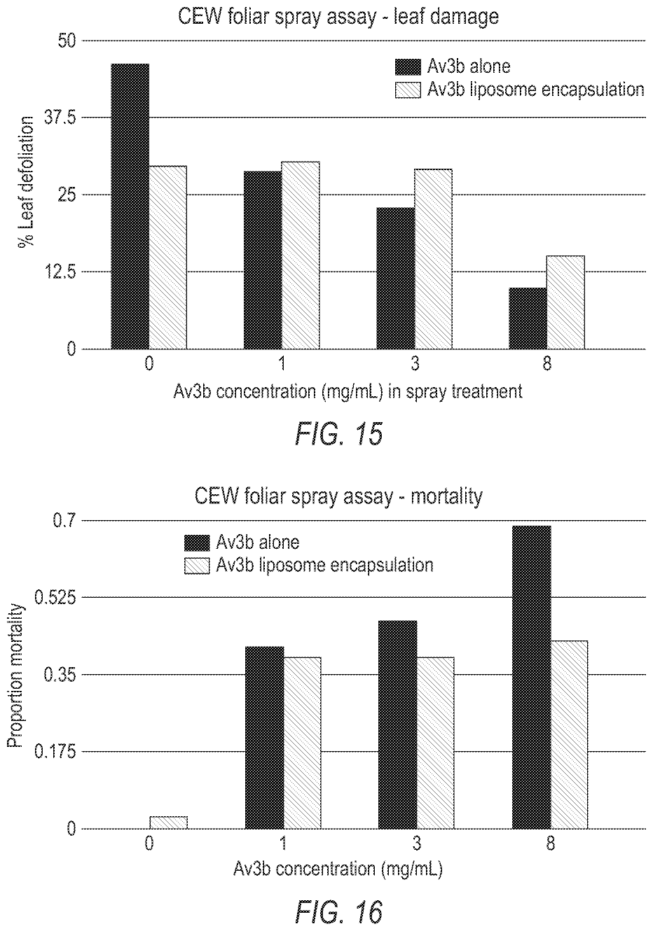

Liposome-encapsulated Av3b did not affect leaf defoliation in CEW. As shown in FIG. 15, using Av3b alone in the leaf eating assay resulted in 46.3%, 28.9%, 22.9%, and 9.9% leaf defoliation at 0, 1, 3, and 8 mg/mL of Av3b, respectively. FIG. 15. Similarly, when Liposome-encapsulated Av3b was used, it resulted in 29.7%, 30.4%, 29.2%, and 15.2% leaf defoliation at 0, 1, 3, and 8 mg/mL of Av3b, respectively. FIG. 15.

Thus, in a foliar feeding assay, Av3b encapsulated in liposomes did not cause less defoliation by CEW larvae compared to Av3b when applied alone. These results indicate that encapsulation of an insecticidal protein in a liposome does not always increase the efficacy of said insecticidal peptide, nor does it bestow other superior insecticidal properties; indeed, the fact that liposome encapsulation did not affect leaf defoliation for Av3b, evidences the unexpected nature of using liposome-encapsulated insecticidal proteins.

### Mortality Results

Av3b encapsulated in liposomes did not affect CEW mortality. Using the same treatments and conditions as described above, the effect of Av3b alone or Liposome-encapsulated Av3b, on Japanese beetle mortality, was evaluated.

Here, using Av3b alone resulted in a percent mortality of 0.0% at 0 mg/mL of Av3b; 41.2% at 1 mg/mL of Av3b; 47.2% at 3 mg/mL of Av3b; and 68.7% at 8 mg/mL of Av3b. FIG. 16.

When Av3b was encapsulated in liposomes, the percent mortality was 2.7% at 0 mg/mL of Av3b; 38.9% at 1 mg/mL of Av3b; 38.9% at 3 mg/mL of Av3b; and 42.7% at 8 mg/mL of Av3b. FIG. 16.

Accordingly, in a foliar spay bioassay, Av3b encapsulated in liposomes did not cause higher mortality in CEW larvae compared to Av3b when applied alone. As shown above with regard to leaf defoliation, encapsulation of an insecticidal peptide in a liposome does not necessarily result in increased efficacy (e.g., mortality); thus, these mortality results further demonstrate the unexpected nature of using liposome encapsulated insecticidal proteins.

The lack of increased mortality observed when using liposome-encapsulated Av3b (as compared to liposome-encapsulated Hybrid+2) may be due to the fact that Av3b acts on the peripheral nervous system, whereas Hybrid+2 acts on the central nervous system.

### Example 9. Housefly Injection Assay: Av3b

A housefly injection assay was performed to evaluate the insecticidal effect of liposome-encapsulated Av3b and Av3b alone.

Two Av3b treatments were evaluated:
(1) Av3b alone: Av3b peptide having an amino acid sequence of KSCCPCYWGGCPWGQNCYPEGCSGPK (SEQ ID NO: 7) (Lot: UGAIEX12NOV19; Vestaron®, 600 Park Offices Dr, Ste 117, Durham, NC 27709, USA).
(2) Liposome-encapsulated Av3b.

Liposomes were generated according to the method described in Example 1. Each treatment was diluted in water to achieve the proper dose concentrations for injection, using Formula XI as described in Example 4. Injection doses of Av3b for each treatment was as follows:
0 pmol/g
62.7 pmol/g
125.5 pmol/g
251 pmol/g
502.1 pmol/g
2008.5 pmol/g
6276.5 pmol/g
12553 pmol/g

Next, a 0.5 μL solution containing either Av3b alone; Liposome-encapsulated Av3b, was injected into each insect at the dorsal thorax using a hand-microapplicator with 1 cc all-glass syringe with 30 gauge straight needle. The injected insects were then transferred to a 2 oz. transparent portion container with a wet #4 filter paper. Housefly condition was evaluated 24-hours post-injection based on whether the insects were knocked-down or alive.

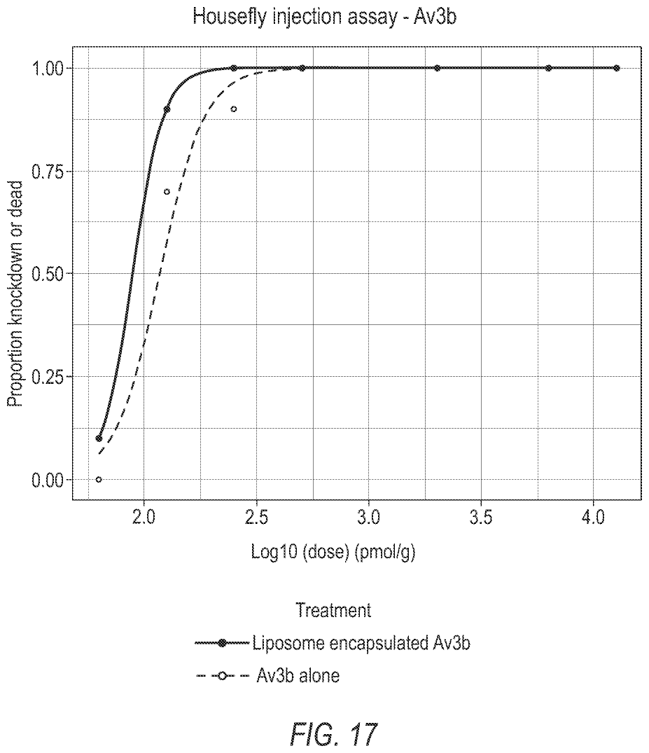

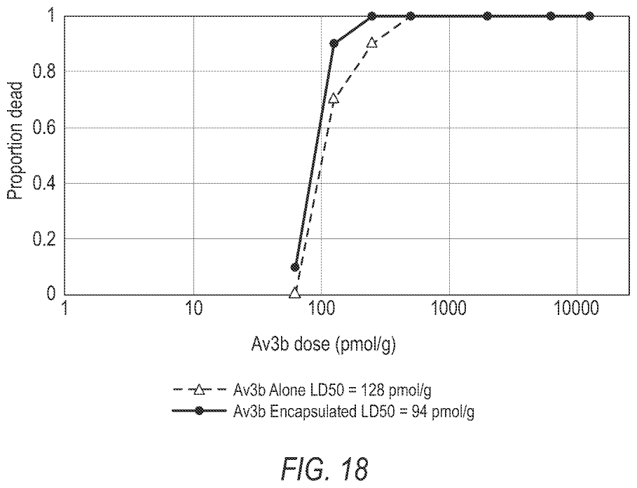

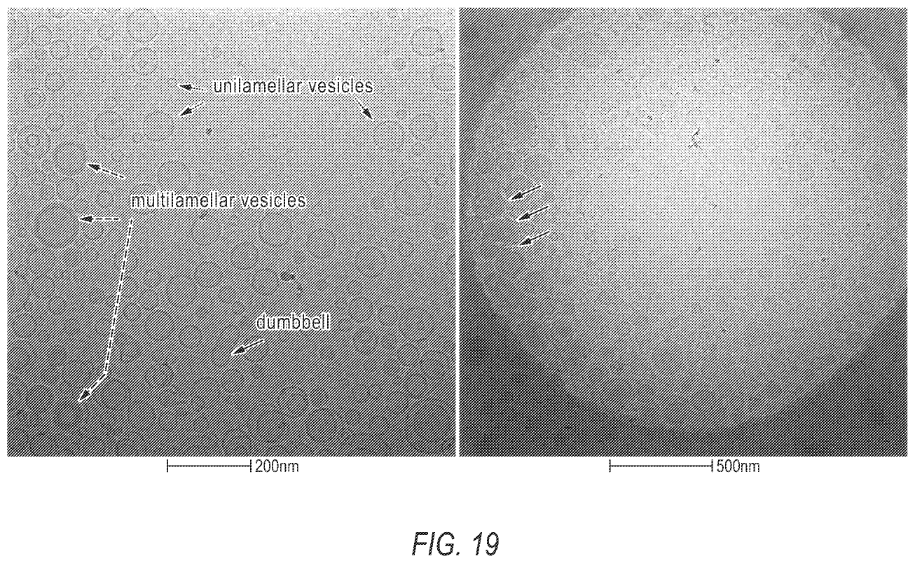

As shown in FIG. 17, a lower dose of Av3b was needed in order to result in insect knockdown or death when using liposome-encapsulated Av3b, compared to Av3b alone. FIG. 17. As shown in FIG. 18, the LD₅₀ for Av3b alone was 128 pmol/g; however, the LD₅₀ of liposome-encapsulated Av3b was 94 pmol/g. FIG. 18. As these results show, in a housefly injection assay, liposome encapsulation of Av3b results in enhanced activity compared to Av3b alone.

### Example 10. Liposome Characterization: Overview

The liposomes of the present disclosure where characterized by analyzing morphology, particle size distribution, and soy lecithin content. Images of the sample were obtained by Cryogenic transmission electron microscopy (Cryo-TEM); particles size distribution detected by Dynamic Light Scattering (DLS) and soy lecithin content was measured by Liquid chromatography-mass spectrometry (LC-MS).

### Cryo-TEM

A liposome preparation was made according to the methods of Example 1. The sample was diluted at different concentrations with water. An aliquot (3 μL) was placed on a thin copper grid (Cu-200CN, Pacific Grid-Tech) that had been glow discharged. The sample was then loaded to the freezing chamber with a low temperature (0-5° C.) and humidity control (100%), followed by blotting for 2 seconds with filter paper. The specimen was then rapidly frozen by plunging into the cryogen, with liquid ethane cooled by liquid nitrogen. The prepared grid was mounted on 200 kV FEI Talos F200C. Images were collected at 45 k magnification.

### Liposome Morphology Analysis

The sample was imaged by Cryo TEM at original concentration. Some representative images are shown in FIG. 19.

Based the observations made in the Cryo-TEM analysis, the unilamellar vesicle (FIG. 19, blue arrow) was the dominant class of vesicles in the sample. In addition, the sample contained multilamellar vesicles (FIG. 19, yellow arrow), and dumbbell-shape particles (FIG. 19, white arrow).

### Liposome Lamellarity Analysis

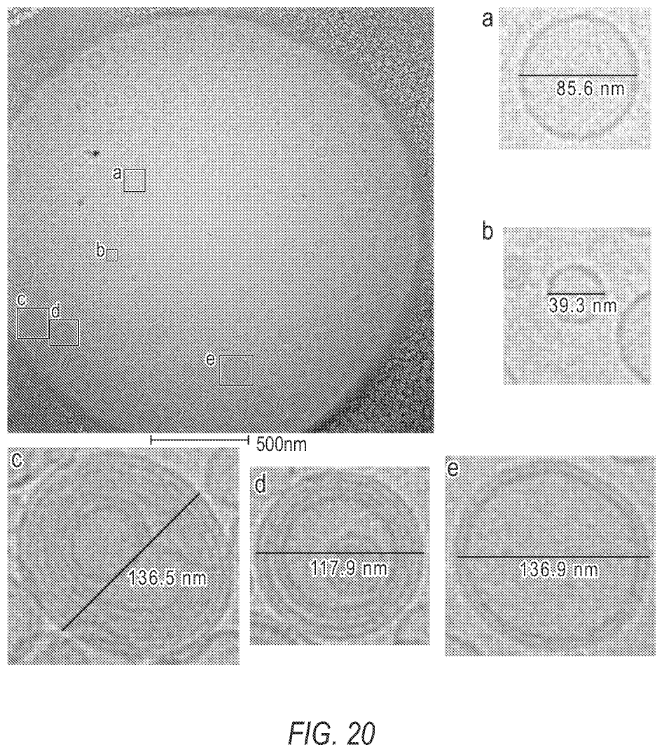

Samples comprising spear and liposomes showed a diversity in lamellarity. Both unilamellar vesicles (FIG. 20, a-b) and multilamellar vesicles (FIG. 20, c-e) were observed. The particle diameter of unilamellar vesicles was less than 100 nm, while the particle diameter of multilamellar vesicles was larger than 100 nm. Based the Cryo-EM results, unilamellar vesicles were the dominant class in in the sample.

### Example 11. Size Distribution Analysis

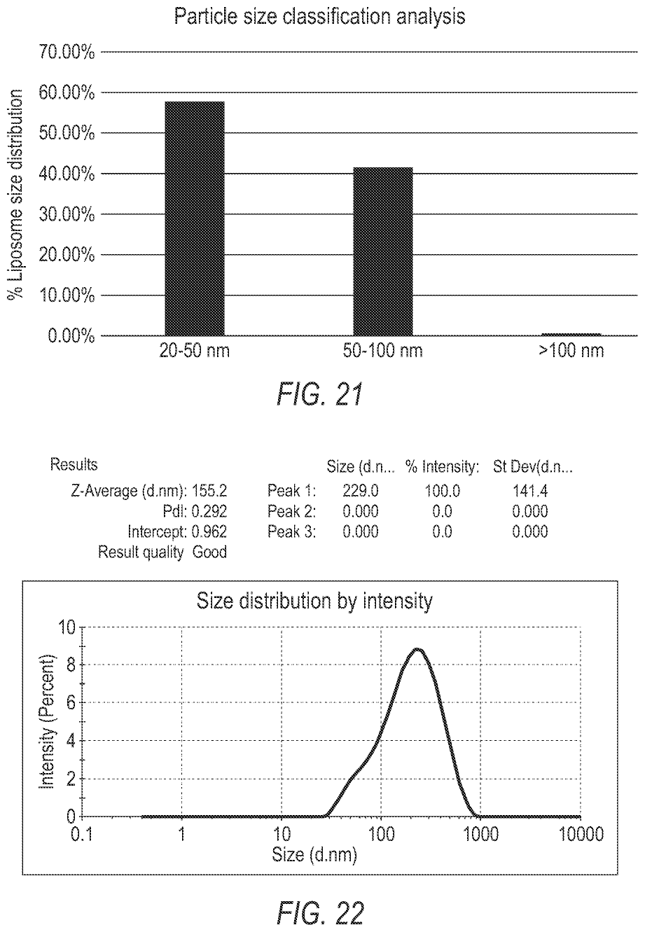

A total of 171 unilamellar vesicles were randomly selected and measured to determine the average size distribution. The size distribution results are shown in FIG. 21. Here, 57.89% unilamellar vesicles were shown to possess a diameter of 20-50 nm; and 41.52% of unilamellar vesicles possessed a diameter of 50-100 nm. Finally, 0.59% unilamellar vesicles had a diameter of >100 nm.

### Example 12. Dynamic Light Scattering (DLS)

The sample was diluted and loaded into measurement cell using a pipette. Particle size was measured by Malvern Zetasizer Nano ZS with the size mode at 25° C., and data analyzed by Zetasizer Software.

The average size of all the liposome particles was 155.2 nm, which included the unilamellar, multilamellar, and dumbbell-shape vesicles. The dispersion coefficient PDI was 0.292. FIG. 22. The DLS results are as follows: Z-Average (d.nm)=155.2; PDI=0.292; intercept=0.962; result quality=good. The size of Peak 1 was 229.0 (d.nm), 100% intensity (Std. Dev.=141.4, d.nm).

### Example 13. Liquid Chromatography-Mass Spectrometry

LC-MS analyses were performed using an Agilent 1200 series liquid chromatograph interfaced to Bruker HCT mass spectrometer followed a standard procedure. Analysis conditions are presented in the table below.

TABLE 2
Quantification of soy lecithin: analysis conditions
Bruker HCT mass spectrometer:

| Probe: | ESI | Atomizing air | 30 | psi |
|---|---|---|---|---|
| | | pressure: | | |
| Temp: | 350° C. | Nebulizer Gas Flow: | 7 | L/min |

Agilent 1200 HPLC

| Column: | 2.1 × 150 mm, C-18 | | | |
|---|---|---|---|---|
| Flow rate: | 1.0 mL/min | Volume: | 10 | μL |

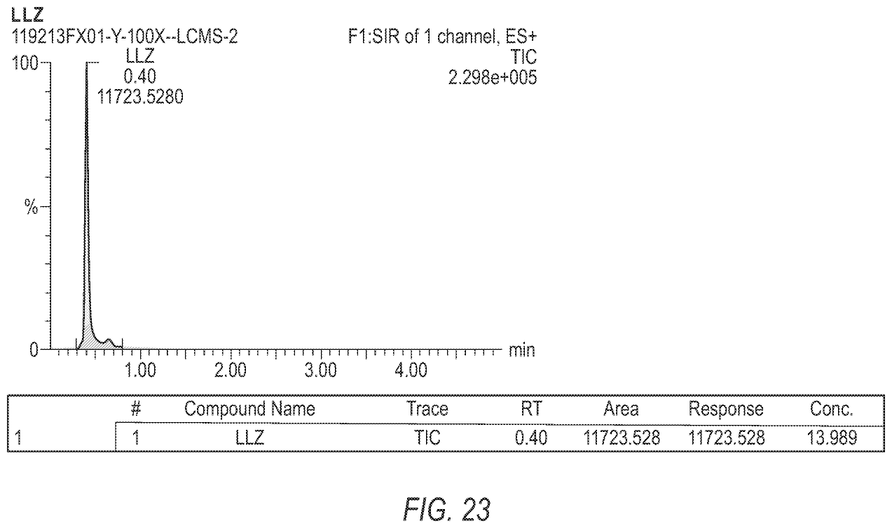

The results of the quantification analysis are presented in FIG. 23. The soy lecithin content was 27.5% in the liposome sample, which was derived by comparing the peak area to the standards.

1. A liposome comprising an insecticidal protein or agriculturally acceptable salt thereof, wherein the liposome encapsulates the insecticidal protein or agriculturally acceptable salt thereof; and wherein the liposome comprises lecithin.

2.-4. (canceled)

5. The liposome of claim 1, wherein the lecithin is a hydrogenated soy lecithin.

6. The liposome of claim 5, wherein the liposome has an average diameter of about 10-200 nm.

7.-8. (canceled)

9. The liposome of claim 1, wherein the encapsulated insecticidal protein or agriculturally acceptable salt thereof has a greater bioavailability when ingested by a pest when compared to an equivalent amount of the insecticidal protein or agriculturally acceptable salt thereof when not encapsulated in the liposome and is ingested by the pest.

10. The liposome of claim 9, wherein the greater bioavailability is a greater oral bioavailability in an insect pest selected from a lepidopteran pest, and a coleopteran pest.

11.-13. (canceled)

14. The liposome of claim 1, wherein the insecticidal protein or agriculturally acceptable salt thereof is a cysteine-rich insecticidal protein (CRIP).

15. The liposome of claim 1, wherein the insecticidal protein or agriculturally acceptable salt thereof, is an arthropod toxin, an amphibian toxin, a reptile toxin, a cnidarian toxin, a mollusk toxin, a fish toxin, a mammalian toxin, or a variant thereof.

16. The liposome of claim 15, wherein the arthropod toxin is an arachnid toxin.

17. The liposome of claim 16, wherein the arachnid toxin is a spider toxin or a scorpion toxin.

18. The liposome of claim 17, wherein the spider toxin is an Agelenopsis aperta toxin, an Agelena orientalis toxin, an Allagelena opulenta toxin, an Ancylometes sp. toxin, an Aphonopelma sp toxin, an Apomastus schleringi toxin, an Atrax formidabilis toxin, an Atrax sp. Illawarra toxin, an Atrax infensus toxin, an Atrax robustus toxin, a Brachypelma albiceps toxin, a Brachypelma smithi toxin, a Calisoga sp. toxin, a Ceratogyrus marshalli toxin, a Chilobrachys jingzhao toxin, a Coremiocnemis valida toxin, a Ctenus ornatus toxin, a Cupiennius salei toxin, a Diguetia canities toxin, an Eratigena agrestis toxin, an Eucratoscelus constrictus toxin, a Grammostola rosea toxin, a Hadronyche formidabilis toxin, a Hadronyche infensa toxin, a Hadronyche venenata toxin, a Hadronyche versuta peptides toxin, a Haplopelma hainanum toxin, a Haplopelma huwenum toxin, a Heriaeus melloteei toxin, a Heteropoda venatoria toxin, a Heteroscodra maculate toxin, a Hololena curta toxin, a Hysterocrates gigas toxin, an Illawara wisharti toxin, a Lasiodora sp toxin, a Latrodectus tredecimguttatus toxin, a Macrothele gigas toxin, a Macrothele raveni toxin, a Missulena bradleyi toxin, a Oxyopes lineatus toxin, a Paraphysa scrofa toxin, a Phoneutria keyserlingi toxin, a Phoneutria nigriventer toxin, a Phoneutria reidyi toxin, a Pireneitega luctuosa toxin, a Plectreurys tristis toxin, a Plesiophrictus guangxiensis toxin, a Psalmopoeus cambridgei toxin, a Segestria florentina toxin, a Stromatopelma calceatum toxin, a Theraphosa blondi, or a Thrixopelma pruriens toxin.

19. The liposome of claim 18, wherein the spider toxin is a Hadronyche venenata toxin, an Atrax robustus toxin, an Atrax formidabilis toxin, an Atrax infensus toxin, a Phoneutria nigriventer toxin, or an Eratigena agrestis toxin.

20. The liposome of claim 19, wherein the spider toxin has an amino acid sequence that is at least 80%, 85%, 90%, 95%, or at least 100% identical to an amino sequence set forth in any one of SEQ ID NO: 1-5, and 8.

21.-28. (canceled)

29. A composition comprising the liposome of claim 1, and at least one excipient.

30. The composition of claim 29, wherein the composition is an agricultural composition, and the at least one excipient and the liposomes are formulated into a solution, an emulsion, a powder, a dust, a pellet, a granule, a spray, or a colloid.

31. A method of combating, controlling, or inhibiting a pest comprising, applying a pesticidally effective amount of the liposome of claim 1, to the pest, a locus of the pest, a food supply of the pest, a habitat of the pest, or a breeding ground of the pest; a plant, a seed, a plant part, a locus of a plant, or an environment of a plant that is susceptible to an attack by the pest; an animal, a locus of an animal, or an environment of an animal susceptible to an attack by the pest; or a combination thereof.

32.-33. (canceled)

34. A method of making the liposome of claim 1, the method comprising:
(a) preparing a homogenized aqueous solution comprising lecithin and water;
(b) preparing an aqueous solution comprising an insecticidal protein;
(c) mixing the homogenized aqueous solution of step (a) with the aqueous solution of step (b).

35. The method of claim 34, wherein the mixture of the homogenized aqueous solution of step (a), and the aqueous solution of step (b), is sonicated.

36. The method of claim 35, wherein the lecithin is a natural lecithin, a semi-synthetic lecithin, or a synthetic lecithin.

37.-39. (canceled)
